(19) United States
(12) Patent Application Publication
(10) Pub. No.: US 2004/0009813 A1
(43) Pub. Date: Jan. 15, 2004

(54) Dynamic interaction and feedback system

(76) Inventor: Bradley Patrick Wind, Champaign, IL (US)

Correspondence Address: Bradley P. Wind, 8528 STORCH WOODS DRIVE, # 2D, SAVAGE, MD, 20763, US

(21) Appl. No.: 10/114,064

(22) Filed: Jul. 8, 2002

(51) Int. Cl. A63F 13/00

(52) U.S. Cl. 463/30

(57) ABSTRACT

A dynamic interaction and feedback system for simulating the accumulation of consequence to enhance interactive content comprises logic for determining an agent group at a state of the system (20), an active agent selection interface so that a participant may select an agent from the agent group to be a present active agent (22), active controls selection logic for selecting an active controls set related to the present active agent at the state of the system by which the participant may interact (24), and a feedback memory for recording the occurrence of feedback for the purpose of subsequent reference during operation of the system (26).

### CROSS-REFERENCE TO RELATED APPLICATIONS

Not Applicable.

### LIMITED COPYRIGHT WAIVER

A portion of the disclosure of this patent document contains material to which the claim of copyright protection is made. The copyright owner has no objection of the facsimile reproduction by any person of the patent document or the patent disclosure, as it appears in the U.S. Patent and Trademark Office file or records, but reserves all other rights whatsoever. In particular the claim of copyright protection extends to code and pseudocode in the DESCRIPTION and artwork and production and tried implementation-specific titles and artistic names in the FIGURES.

### BACKGROUND

1. Field of the Invention

This invention relates to interactive content production, specifically to such interactive content production which is used to tell a story.

2. Description of the Prior Art

An increasingly technology-savvy public raises the standards for interactive content. Thus, the time, effort, resources, and skills required to develop such content increase.

More engaging media draws in the senses. Intriguing new modes invite us to view the world of content differently—from simulation and strategy games to first-person shooters to educational lesson modules.

Conversely, while certain aspects of interactive content evolve, how we interact remains unchanged. That is, interaction remains at the level of direct manipulation of physical objects. This traditional paradigm for interaction views even characters as objects. Their purpose: to be moved like so much furniture into the proper arrangement. The arrangement in turn completes a mission, teaches a lesson, solves a puzzle. Like the characters, the puzzle is static once understood, its discernable patterns surmised.

Certain audiences have found this limited access to the interactive space acceptable. For many others, they choose to spend their time and money elsewhere.

Teams of variously skilled individuals produce interactive digital content. Consumers of these works enjoy the consequent products.

Originally, technology constrained production and reception. Text-based computer games and lessons reached consumers through traditional channels. Vendors sold boxed software to run on compatible personal computers.

Thereafter, technology advances enhanced production and reception of interactive digital content. Improved graphics and sound technologies made new representations possible. Increases in standardization of operating hardware and software, and the internet simplified distribution. U.S. Pat. No. 4,858,930 to Namco, Ltd. (1989) discloses a game console system defined by particular physical hardware components; however, underlying operating hardware and systems continue to evolve.

Despite advances, turning a concept into an engaging product remained tedious, ill-defined. Inventors created software layers to insulate their work from changes to underlying architectures. In this way each new project might provide reusable components for the next project. The work itself might survive the same continued technology upgrades that made it possible. Time to market, stability, and consumer interest in derivative future projects stood to benefit. Generally the more could be carried over, the better work might result.

Inventors looked for patterns to define a powerful, general-purpose software layer. What, in essence, constituted interactive content?

The importance of random-number generation to interactive content could hardly be overstated. Prior art codifies standard applications of this crucial aspect to game production. See U.S. Pat. No. 4,195,838 to Monosil, Incorporated (1980) and U.S. Pat. No. 5,707,286 to Mikohn Gaming Corporation (1998). Random number generation broadens the range of possible experiences contingent on user interaction. Yet it provides no structure. The technique requires a framework to provide sustained continuity to a piece.

Necessary to better define the software layer was some provision of determinism. Deterministic structure proved, however, to be a more elusive, seemingly less generalizable problem.

Inventors conceived higher-level frameworks to account for this top-down design necessity. For the sake of powerful features, some inventions accepted a high degree of environment-dependence.

U.S. Pat. No. 5,890,964 to Square Co., Ltd. (1999) requires simultaneously running applications communicating frequently. The stress on a system running such a work could be great. Frequent inter-process communication demands much of underlying operating systems and hardware. A complex system as such might be prone to failure even on a compatible system.

U.S. Pat. No. 6,179,713 to Circadence Corporation (2001) requires networked computers to run. The primary innovation therein was the ability to edit a single move repeatedly. This system requires multiple players as well. Local, single-participant versions are not provided for.

U.S. Pat. Nos. 5,498,002 and 5,498,003 both to Gechter (1996) describe a less distributed approach. Players can create new software character modules to join a game in progress. However, the preferred system is a shared-memory architecture, which is heretofore uncommon, certainly not standard. Otherwise, the character modules must be compiled dynamic libraries, a logistically tricky proposition. Not to mention, determinism loses as randomly-joining characters discourage focused, unified plots. Each participant is her own broadcaster more like a chat room.

Still other inventions accept and invite determinism to the detriment of randomness. They accept the traditional, established broadcaster-participatory audience model. They also place too much of a considerable production burden on producers. The remainder of this background discussion except the very end will describe these inventions variously.

U.S. Pat. Nos. 5,613,909 (1997) and 5,782,692 (1998) both to Stelovsky require significant start-up costs. A designer employing this system must craft parallel tracks of media and interaction. At run-time these tracks run synchronously, requiring precision matching. Presentation and interaction are tightly coupled. Thus, redesign of one entails changing the other as well. End users are afforded little freedom from the finite hardwired set of paths.

Another scheme, U.S. Pat. No. 6,126,544 to Konami Co., Ltd. (2000), emphasizes substitution to simulate randomness. Contingent on user interaction, certain events are allowed to be “skipped.” “Bridge” events fill resultant gaps so that subsequent interactive content may sensibly follow. This structure mandates creation of bridge content for the “skippable” content.

By definition this system also required the player to clear events. The present invention assumes that all events are skippable and requires users make them happen. Thus the present invention stresses user co-creation of the experience. Rather than avoiding missing anything, the goal becomes to assemble a unique experience. Otherwise, as U.S. Pat. No. 6,126,544 demonstrates, active “skip signals” must cancel event necessitation. A major drawback of this approach involves branching off plot potentialities. Branching off subplots larger than single events requires additional or different mechanisms altogether.

Still more inventions allow for subplot branching as well as determinism and randomness. One, U.S. Pat. No. 5,604,855 to Crawford (1997), does so by requiring elaborate, very narrow designs.

Each “substory” is a general placeholder ostensibly separate from plot and characters. Each assumes a character acting “with respect to at least one object”. “Plans” guide procession between substories but are purposely open-ended until run-time. The reasoning is so that substory modules are “reusable”. Order is maintained through “earliest occurrence” times assigned the substory units. The present system allows inquiry about any past state at any later point in the system without message passing. The system of U.S. Pat. No. 5,604,855 employed harder to use, more limited mechanisms. “Newsworthiness” and “gossip” channels pass state from one substory to the next.

Not any story can be told using the invention of U.S. Pat. No. 5,604,855. Not every story scenario inherently involves both a character and an object. Not every substory is general, reusable, unsequenced except for an earliest time. Despite the claim of generality, implementation can prove prohibitively complicated. A story must be rewritten entirely, not merely adapted, to fit such a system. This system sacrificed ease for questionable power, control for randomness and re-use. Besides, repeated substory modules with only the character and object changing ultimately risked seeming repetitive.

Slightly less ambitious is another mechanism offered by U.S. Pat. No. 6,267,673 to Nintendo Co., Ltd. (2001). Its premise is changing 3D world states based on character entrance into a bounded space. Reliant on movement through 3D worlds, it is also less comprehensive, less generally applicable. Simulated physicality completely guides story instead of the typically desirable other way around.

RPG (role-playing game) models address all issues raised so far categorically. RPG manifestations may achieve randomness, determinism, and branching. While obvious in terms of implementation, the format nevertheless is also widely accepted. U.S. Pat. Nos. 5,885,156 (1999) and 6,290,602 (2001) both to Konami Co., Ltd. demonstrate germane details of this genre. Not to be outdone, U.S. Pat. No. 6,267,677 (2001) to Nintendo Co., Ltd.; Game Freak, Inc.; and Creatures, Inc. would appear to subsume them both.

In an RPG game characters have attributes. These attributes evolve with the story and evolve the story as well. They are often visible as numbers or progress bars or inventory. They represent aspects of player-controlled characters from personality to personal belongings. They narrow the purpose for playing down to a singular and directed goal: better one's numbers. The present invention provides absolutely no explicit mechanism for player character property data.

If desired, a similar effect is quite possible though arrived at differently. In place of categories of characteristics are situation-specific rules governing control selection. Even these are few so as to tie cumulative action and character development closer. The present invention needs no narrow, distracting, rarely-reusable, artificial measurements of persons. Character and story progression are achieved more generally, more simplistically, through cumulative state.

The past century has seen the new field of psychology grow steadily in popularity. Quantifiable measurements are comprehensible, ultimately that which is digestible, to Man and machine. It is also possible to combine elements of RPG with other models. For such reasons, hybrid RPG's containing modules resembling the present system only far less robust, have prospered.

A previously mentioned, explicitly story-based approach (U.S. Pat. No. 5,604,855) had it partially right—only partially because it, too, fell back on RPG in certain implementation details. Earnest in its mission, this invention focused on story. Accurately representing truer character and story development does necessitate a commitment to putting story first.

How does one make the story the organizing principle? Answers lay elsewhere.

The most basic feedback model was offered by U.S. Pat. No. 5,377,997 to Sierra On-Line, Inc. (1995). An action maps to a message. The present invention improves on this design in at least two ways: first, by substituting pluralities of actions mapping to a result; and, second, the result being itself of a potentially pluralistic nature. This prior invention also assumed a much more robust central application for handling hardcoded interactive content. The present invention employs a more general central application.

U.S. Pat. No. 5,915,256 to Newsweek, Inc. (1999) demonstrates part of the notion of pluralistic representation. Like two earlier mentioned inventions—U.S. Pat. Nos. 5,613,909 and 5,782,692—this one couples interaction and content too tightly. Interaction occurs to affect presentation format only. That is, U.S. Pat. No. 5,915,256 exists essentially to provide for navigation of a static, linear story. Although potentially several media formats tell the story, a user does not explicitly guide the story; only its presentation. User interaction does not affect future interactive possibilities and the ongoing script of the story itself. Nevertheless, U.S. Pat. No. 5,915,256 exposes benefits of bimodality for matching video and text.

U.S. Pat. No. 5,174,759 to Preston, et al. (1989) “TV animation interactively controlled by the viewer through input above a book page” does likewise. Similarly although more generally, U.S. Pat. No. 4,931,950 to Electric Power Research Institute (1990) describes “multimedia commands [which] are split into at least two sets: one set which is dispatched to the user substantially immediately after displaying the corresponding text, and one set which is dispatched only upon request by the user.”

The present invention simply provides separate modes using any media together, and text only. Text display is not required. Furthermore, the “multimedia interface” of U.S. Pat. No. 4,931,950 also comprises an “input means for entering user commands” according to its first claim. Whereas, multimedia interfaces of the present invention need not necessarily bear the burden of handling interaction. Lastly, the present invention uses no expert system knowledge base such as U.S. Pat. No. 4,931,950 claims to use.

In terms of putting it all together, U.S. Pat. No. 5,801,687 to Apple Computer, Inc. (1997) proposes near suitable functionality. Stories may indeed be adequately represented by networked, nestable “state machines” and its “transient events” put forth. However, its requisite means for “locating transitions” and “capturing transient events”, which the present invention lacks, are not so important here as what is missing: purposeful structure.

Not merely ambiguous programmatic containers interlinked, the present invention facilitates interactive story design particularly. The present system employs more focused, and hence more powerful design capability for its purpose.

The present system firstly is not for generating as unified an executable. Compiled in an editor are instructions and pointers to run components of productions. No recording of content into the system is required. The present system uses only pointers to content.

More importantly, there is no concept of “state machine” generally.

The invention of U.S. Pat. No. 5,801,687 articulates “state machine” as being an inherently “nestable” unit. The present system delineates two distinct tiers of operation each uniquely defined for different functions. Thusly, the proposed is limited in order to be instructive and not degeneratively general-purpose. Units in the first network represent groups of plot potentialities. The controls networks within these groups are completely different entities for managing controls. Each new application of The older state machine -based invention lacks such all-important constructs. Each new use of that system required their reinvention—a considerable burden. Ultimately, sometimes specificity is better.

### SUMMARY

In accordance with the present invention a dynamic interaction and feedback system for simulating the accumulation of consequence to enhance interactive content comprises logic for determining an agent group at a state of the system, an active agent selection interface so that a participant may select an agent from the agent group to be a present active agent, active controls selection logic for selecting an active controls set related to the present active agent at the state of the system by which the participant may interact, and a feedback memory for recording the occurrence of feedback for the purpose of subsequent reference during operation.

Objects and Advantages

A dynamic interaction and feedback system fills growing needs of interactive content developers. It reduces time, effort, resources, and skills necessary to develop quality engaging productions. Better still is the new and unexpected benefit of an improved interactive experience.

The system presents characters, controls, results, and rules variably to the user. This without sacrificing the intrinsic satisfaction of meaningful story.

The system ensures only that the experience adds up to a unified whole. No outwardly perceivable pattern exists except the designer's potential plot events. This variance accords freedom from traditional patterns. The end-user gains a greater sense of control over the outcome. Characters seem more alive. The possibility that anything can happen each time through is more real.

The dynamic interaction and feedback system lowers development costs for superior interactive content.

A dynamic interaction and feedback system performs the role of a virtual computer. This particular virtual computer is optimized for running interactive stories. Other inventions toward such a purpose lean on physics, psychology, RPG rules, etc. Game genre world models abound. The virtual computer relies, like its real world counterpart, on logic. Stories, all of them, operate on logic.

Logic-based, the framework put forth ensures this wide range of expressive manifestations. Streamlined, it also ensures rapid development.

The system imposes few structural restrictions and design constraints while enabling fast, effective results. It is not merely a new way of applying random numbers. Nor does it presuppose any unlikely data, hardware, user arrangements or purposes. The designer has full control over all aspects. Any story may find intriguing representation here for anyone, for any reason.

Industrious, capable creators may go further, as might similarly endowed end-users of the system. But at heart, the essence of this system truly is interactive storytelling.

### DRAWING FIGURES

FIG. 1 describes a general purpose computer.

FIG. 2 flowcharts the primary function loop of a dynamic interaction and feedback system.

FIG. 3 illustrates agent group determination, selection, and system state interaction.

FIG. 4 describes static data necessary to run a dynamic interaction and feedback system.

FIGS. 5a and 5b show static data units linked into a loosely connected, directed (from top to bottom) network to form an example map of the tried embodiment; 5a the branch logic to go from each unit to lower units, 5b the agents at each unit respectively.

FIG. 6 charts agent group determination for every state of the system presented in FIGS. 5a and 5b.

FIG. 7 details program operation of the dynamic interaction and feedback system application of the tried embodiment.

FIG. 8 depicts a basic user interface for selection of active agents and standard commands.

FIG. 9 demonstrates three different examples of controls: text and image hotspots, and a 3D arcade; as well as a clickable frame.

FIG. 10 tracks general active controls selection logic for interaction sequences.

FIG. 11 groups active controls selection logic factors into six categories.

FIG. 12 lists C code of the tried embodiment's data structure for presenting any type of control.

FIG. 13 shows Venn diagrams of the six categories of FIG. 1, the complete overlap region representing the domain of selected active control sets.

FIG. 14 illustrates the six categories of FIG. 11 interacting with one another to filter active controls in the tried embodiment.

FIG. 15 snapshots a control set editor displaying a control set from a dynamic interaction and feedback system of the tale “Little Red Riding Hood”.

FIG. 16 presents as a timeline the feedback memory of another dynamic interaction and feedback system, active control selection criteria, evaluation of the latter based on the former.

FIG. 17 specifies static and dynamic data and its organization for running the tried embodiment.

FIG. 18 breaks down the story “Little Red Riding Hood” into blocks of related action and further, into logical feedback units.

FIGS. 19a and 19b define rules for creating dynamic interaction and feedback system data for a dynamic interaction and feedback system application using a rule-based editing and compiling machine.

FIG. 20 snapshots a rule-based editing and compiling machine, its major data editing and structuring features, and the content specification component of feedback presentation instructions.

FIG. 21 provides an example of customizing surrounding environment elements.

FIGS. 22 and 23 show respectively the before and after look of the surrounding environment based on the customization of FIG. 21.

FIG. 24 offers a configuration interface for associating external handler applications with types which are in turn associated with production components in the tried embodiment.

FIGS. 25a and 25b pose an external handler launch setting configurator—25a for setting up command lines for corresponding applications used for their same types and based in part, potentially, on the screen layout manager of 25b.

FIG. 26 provides a feedback memory timeline of a “Little Red Riding Hood” dynamic interaction and feedback system and how both “write the book” and “restore” functions operate.

FIG. 27 lays the framework for a multiplayer embodiment.

FIG. 28 outlines a printed manifestation of a system.

### REFERENCE NUMERALS IN DRAWINGS

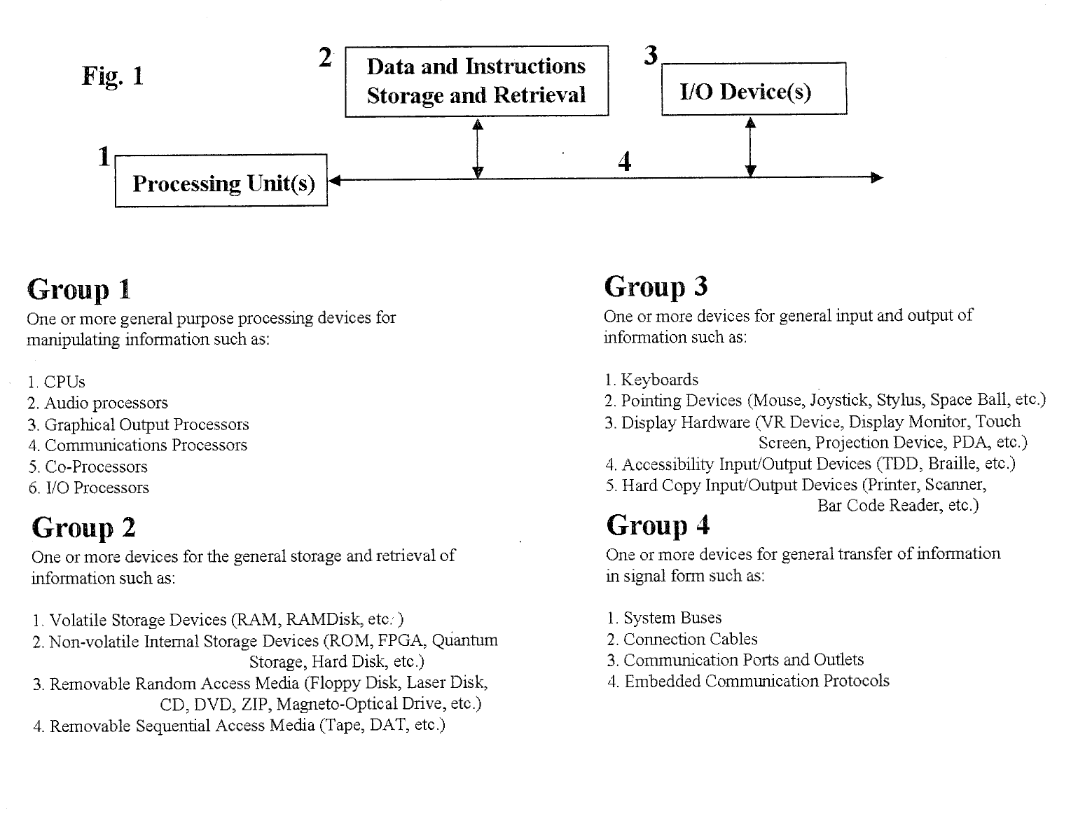

FIG. 1

1 processing devices

2 storage devices

3 input/output devices

4 data transfer channels

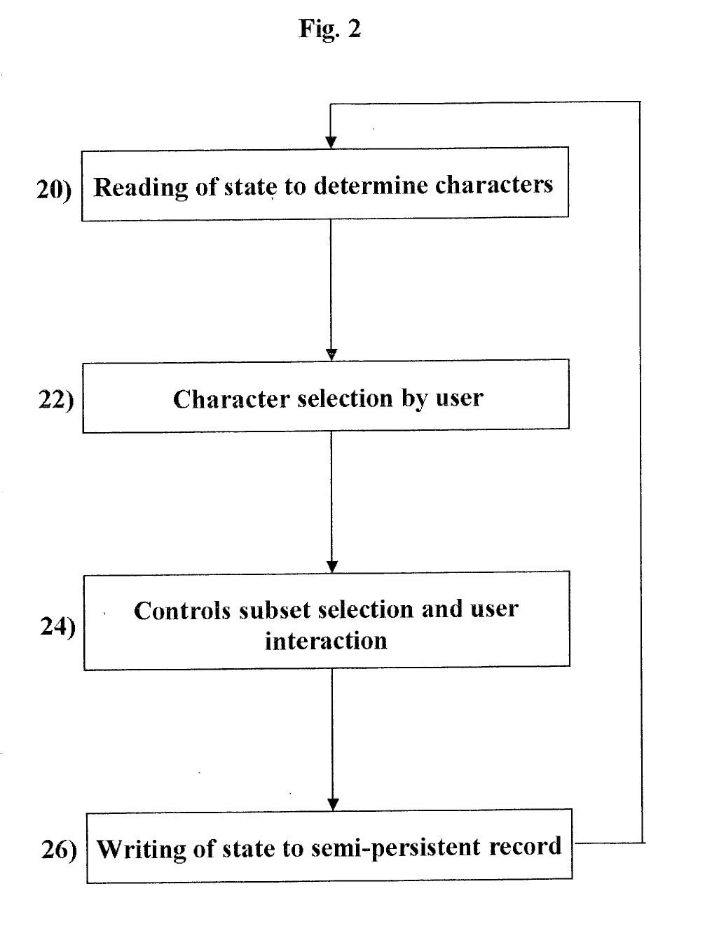

FIG. 2

20 agent group determination based on reading of state

22 user selects an agent to be a present active agent

24 the system selects and presents an active controls set

26 state changes committed to feedback memory

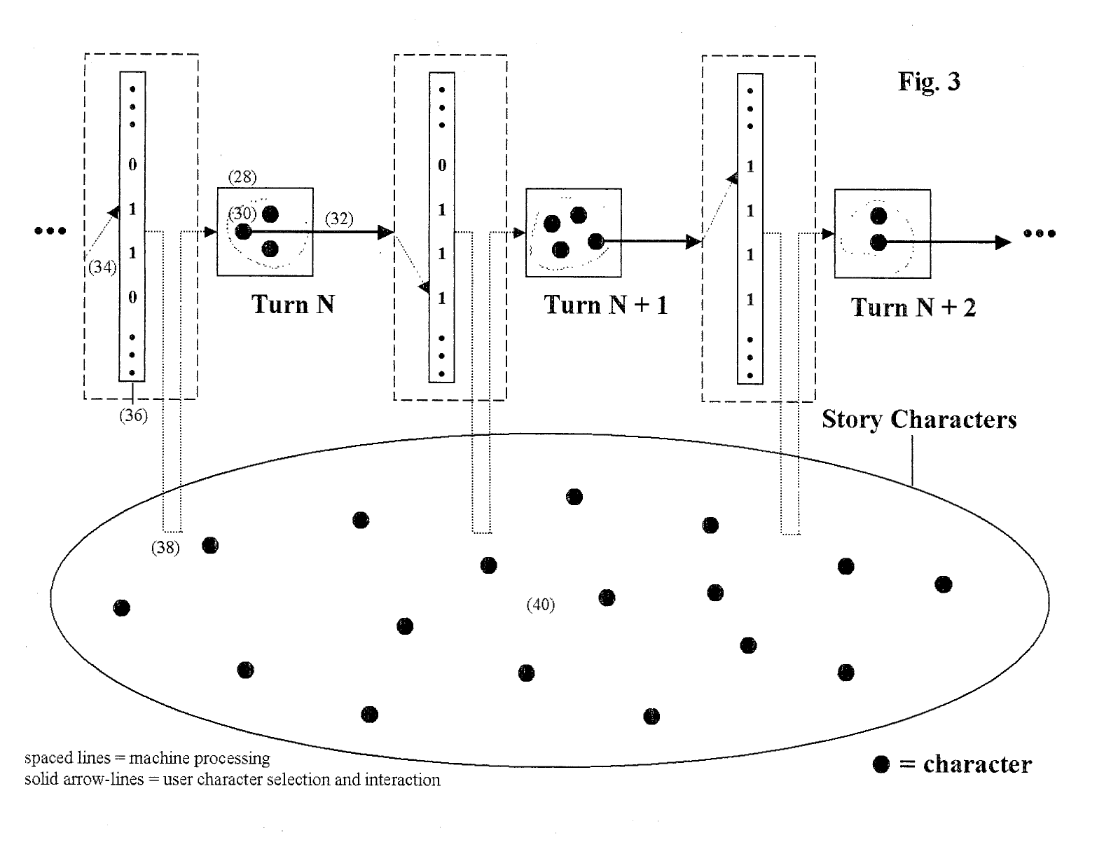

FIG. 3

28 an agent group from which the user may select an active agent

30 an agent the user selects to be a present active agent

32 user interacting with presented controls to affect change in state

34 incrementing of a state bit after interaction

36 snapshot of state at this point in the system

38 filtering of an agent group based on state here in the system

40 all agents in this system

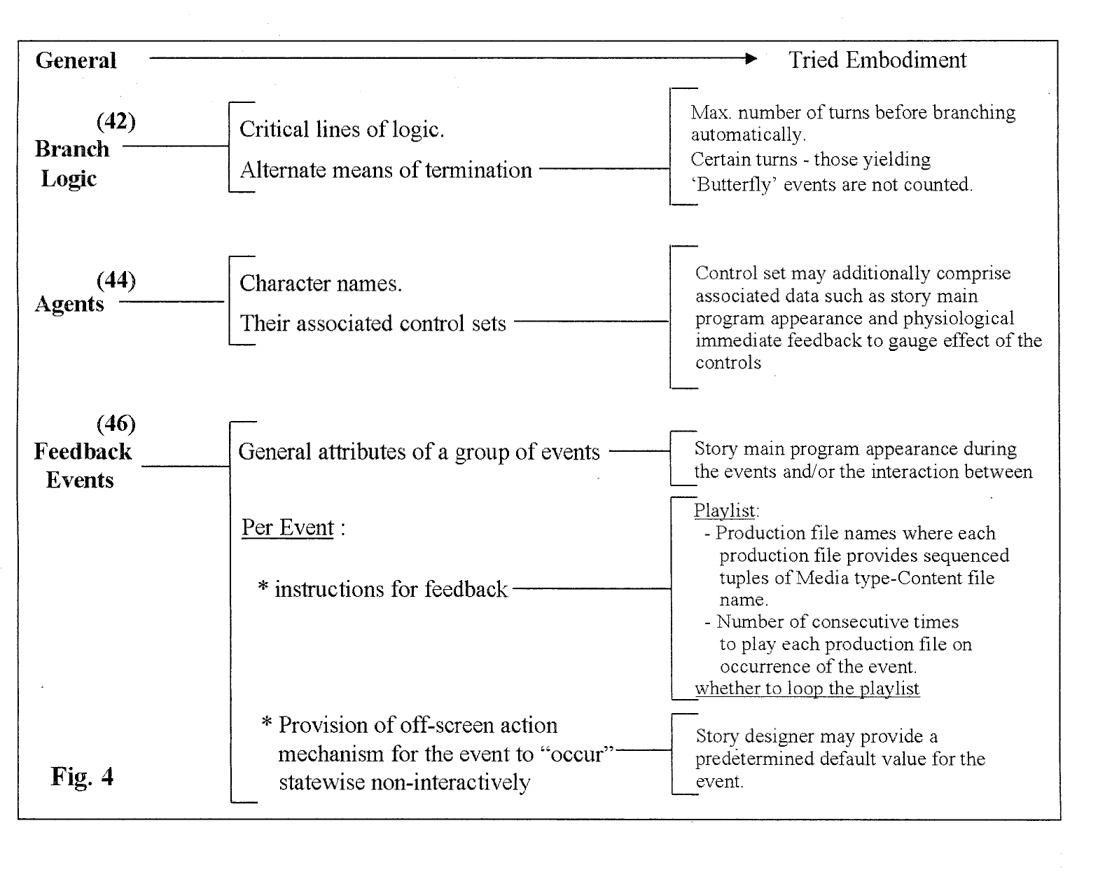

FIG. 4

42 logic instructing the system which path to take

44 data supporting determination of and interaction via agents

46 instructions for managing feedback occurrence and presentation

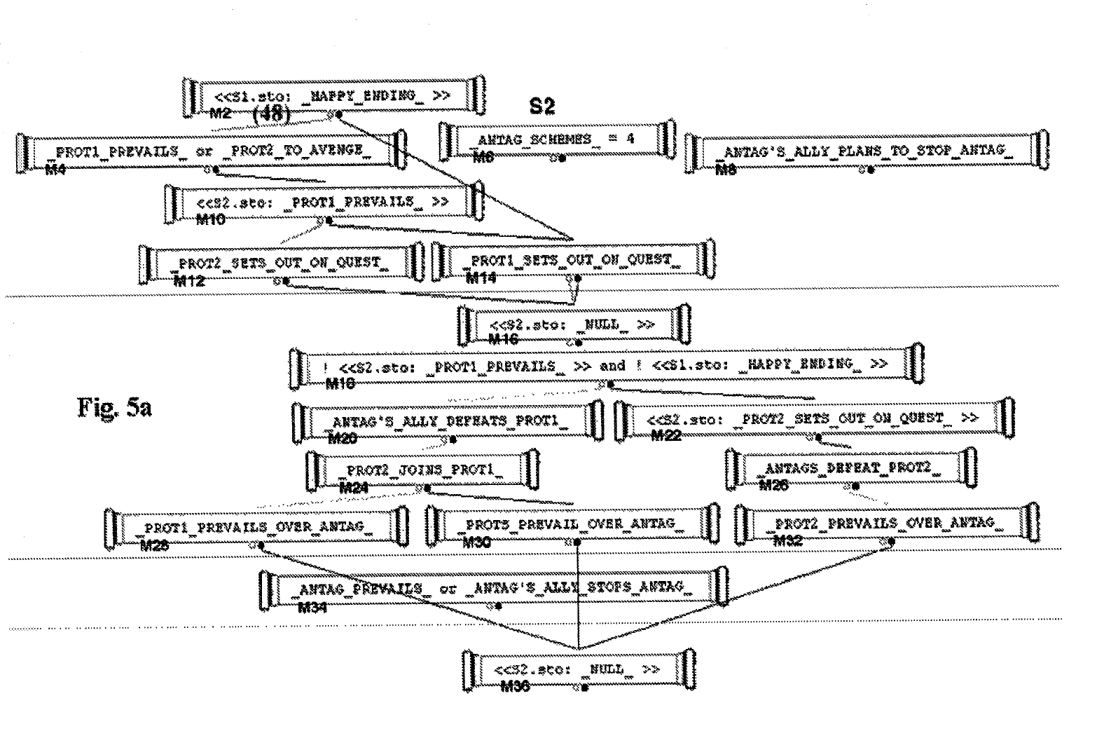

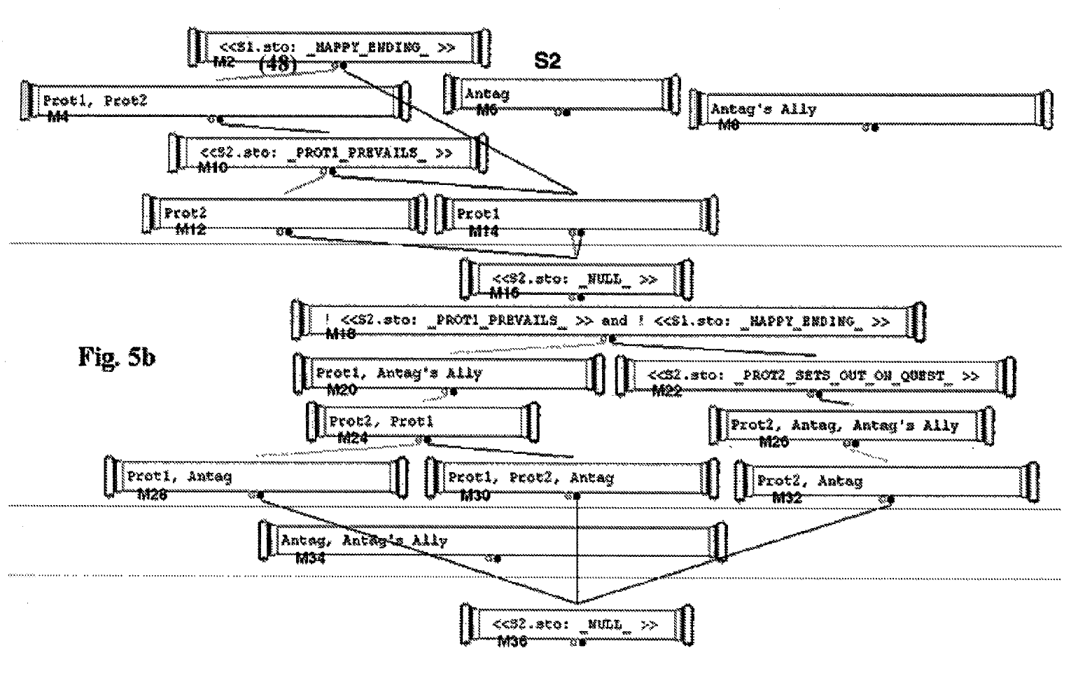

FIG. 5a

48 an alias's critical logic line referencing a past dynamic interaction and feedback system, S1 M2-M36 individual “moment” data units of the tried embodiment

FIG. 5b

No new reference numerals.

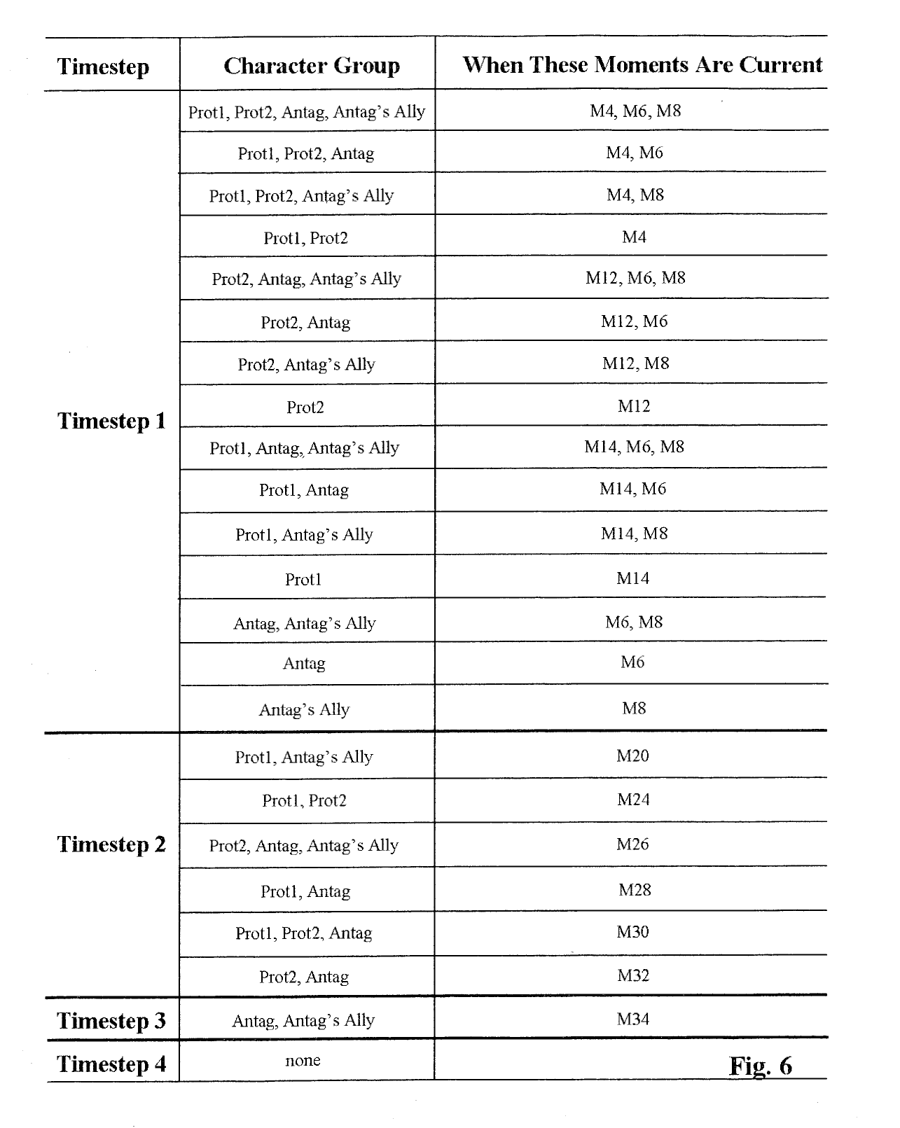

FIG. 6

No new reference numerals.

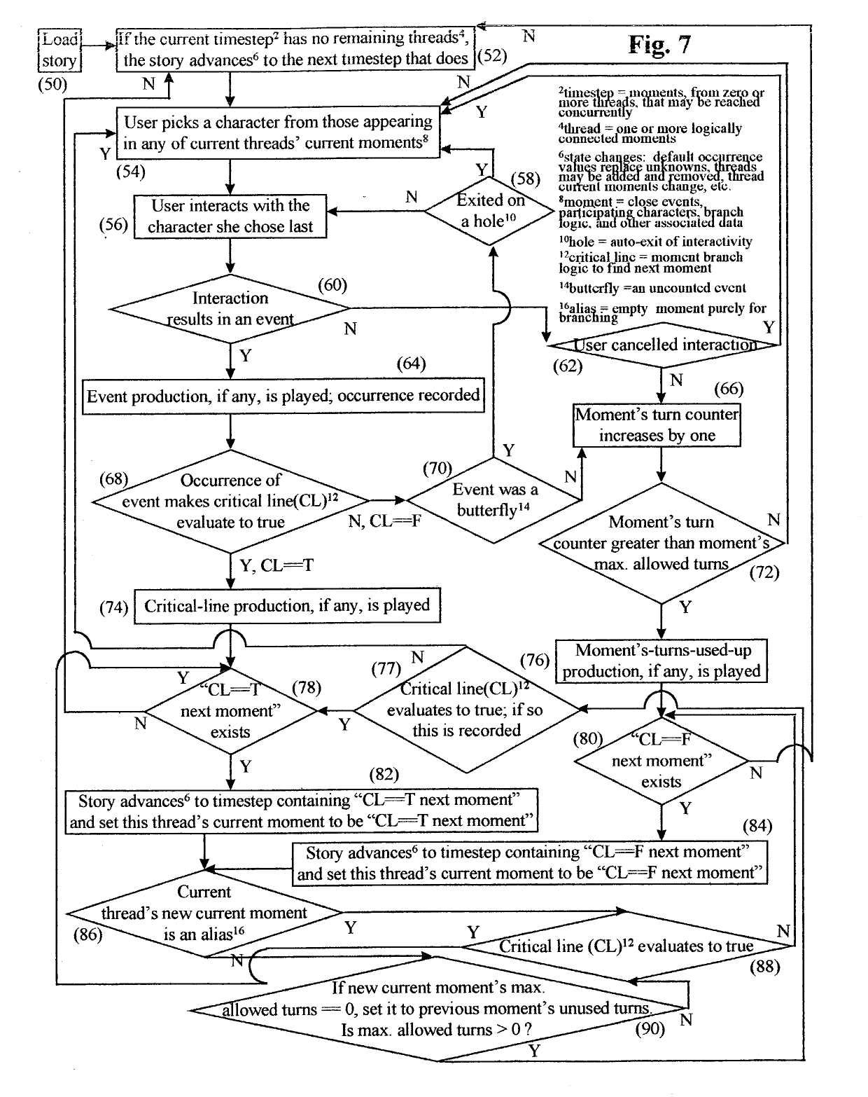

FIG. 7

50 the user loads a new or saved story into the application

52 all tasks to advance the system to a new state are performed

54 user selects an agent to be a present active agent from the current moments' agents

56 user interacts via a present active agent

58 landing on a “hole” control causes an immediate early-decision ending of an ongoing interaction sequence

60 interaction may result either in an event or nothing happening

62 the user may cancel out of interaction early with no effect

64 feedback plays, presenting to the user results after interaction; its occurrence is recorded

66 a counter for a current moment increments by one

68 the application checks if system state causes the current moment's branch logic to evaluate to ‘true’ and if so branches a certain way, otherwise, continues processing at this moment

70 a feedback event may be a “butterfly”, in which case it is not counted against the moment's turn counter and may continue the interaction sequence, skipping the usual user-active agent selection

72 the system branches in a certain direction if the moment's turn counter exceeds the moment's maximum allowed turns

74 a feedback presentation may be associated with moment branch logic evaluating to ‘true’

76 a feedback presentation may be associated with a moment's turn counter exceeding the moment's maximum allowed turns

77 an attempt to evaluate a critical line of a newly-arrived-at unit just in case its critical line already evaluates to ‘true’, in which case advancement continues

78 for the critical line evaluating to ‘true’ branch case, a thread terminates and system advances if no next moment exists or else the next moment for this case is made the current moment

80 the thread terminates and system advances if no next moment exists for a branch case in which the counter exceeds maximum allowed turns

82 if the critical line evaluates to ‘true’, the next moment for the ‘true’ branch case is made the current moment for its thread

84 the next moment for ‘the counter exceeds maximum allowed turns’ branch case is made the current moment for its thread

86 the new current moment may be an empty “alias” moment, only for immediate branching

88 critical line branch logic evaluates immediately in favor of one path

90 the current moment inherits leftover unused turns toward its maximum allowed turns. If this maximum starts out at 0, and if this maximum remains 0 the system branches

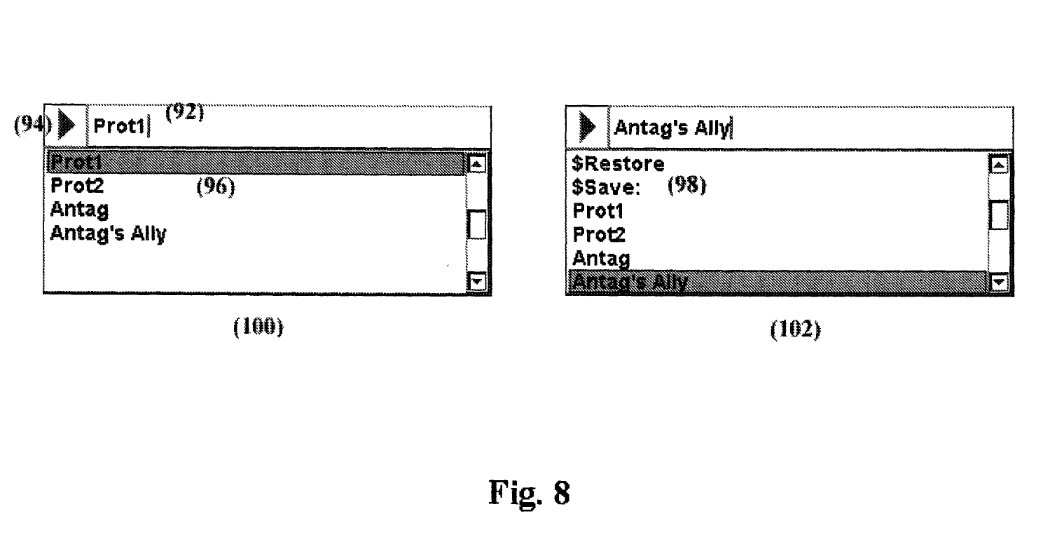

FIG. 8

92 a typing user interface for issuing standard commands to the dynamic interaction and feedback system application and for specifying agent names for active agent selection

94 a button for sequencing through items in a menu below it

96 clickable names of the current agent group

98 clickable standard commands of the dynamic interaction and feedback system application

100 a menu user interface for picking agent names from the current agent group

102 a menu user interface for picking standard commands, and agent names from the current agent group

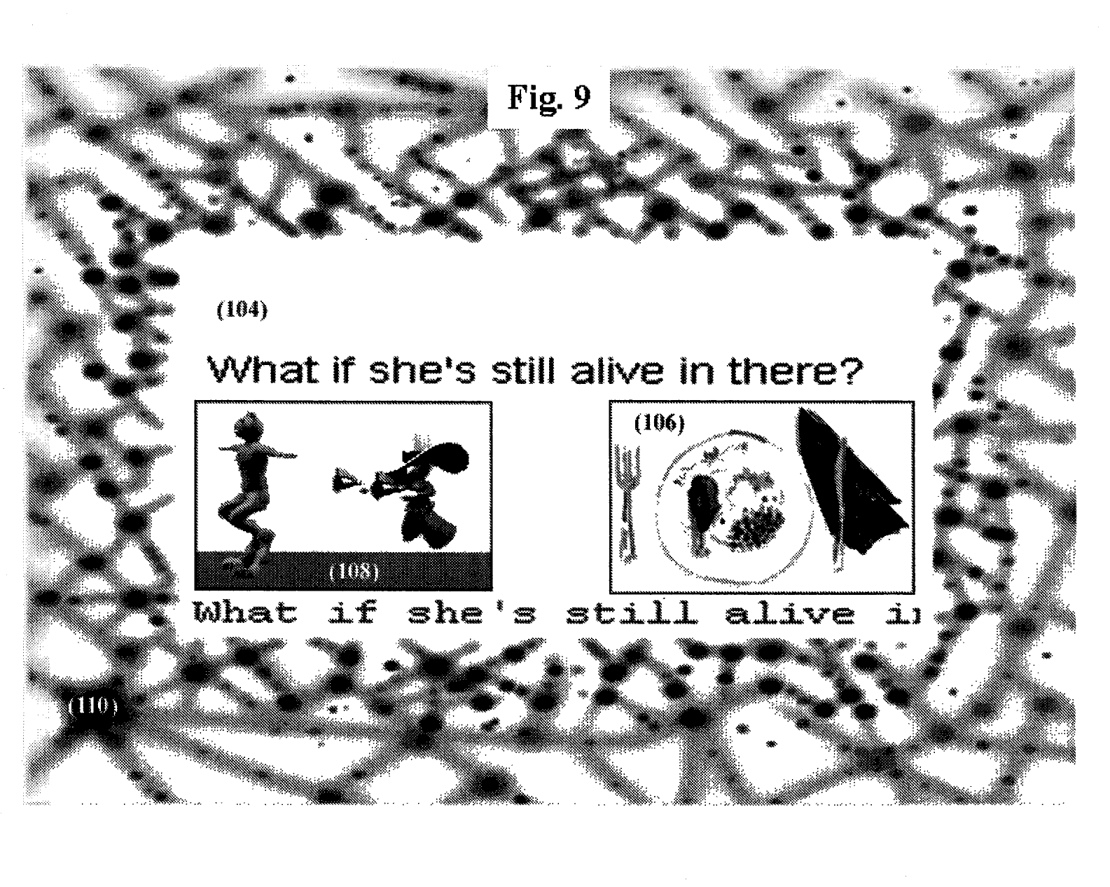

FIG. 9

104 a clickable text control representing a thought of a huntsman agent

106 a clickable image control representing a thought of a huntsman agent

108 an arcade game control of a huntsman agent

110 a frame for a control that, when a user left-clicks on it, leads to a random next control as opposed to a control that in some way logically follows from the current control. A means for ‘bookmarking’ controls is provided in the tried embodiment for certain controls by right-clicking a control to bookmark it and right-clicking this frame to return to the most-recently bookrnarked control

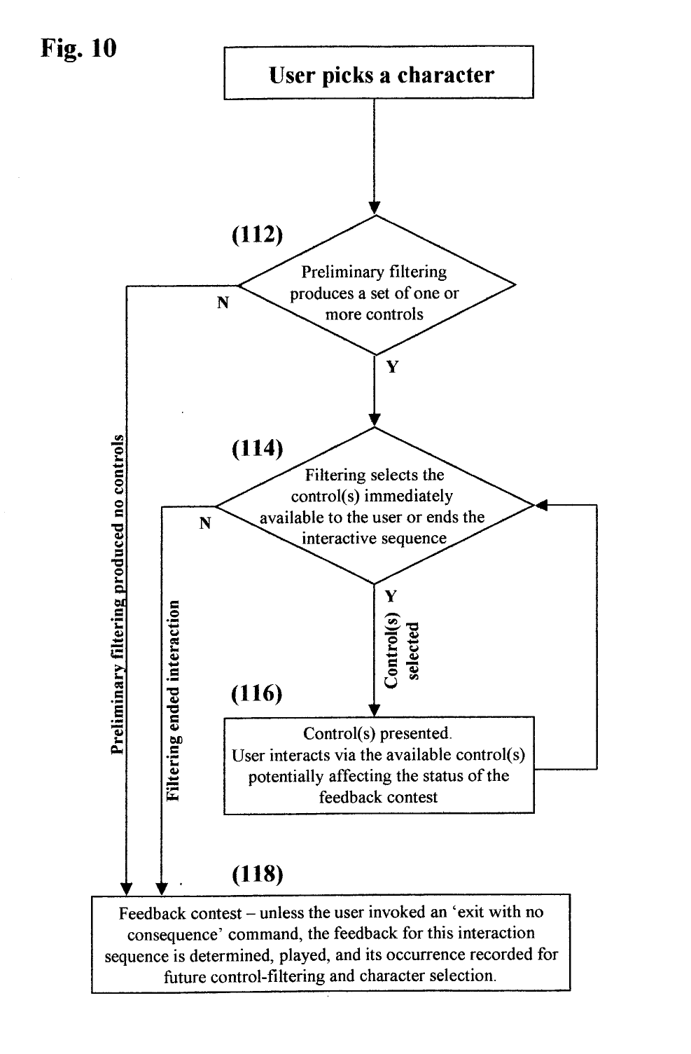

FIG. 10

112 initial filtering of controls such as filtering on a basis of story state and availability of certain other controls

114 control filtering during an interaction sequence such as filtering as a result of user interaction or based on random numbers

116 user interaction via presented controls

118 the interaction sequence ends and either the user exited early via a ‘no consequence’ command so that absolutely no change occurs (not even ‘nothing happens’ registers) or a winning outcome is determined for a feedback result

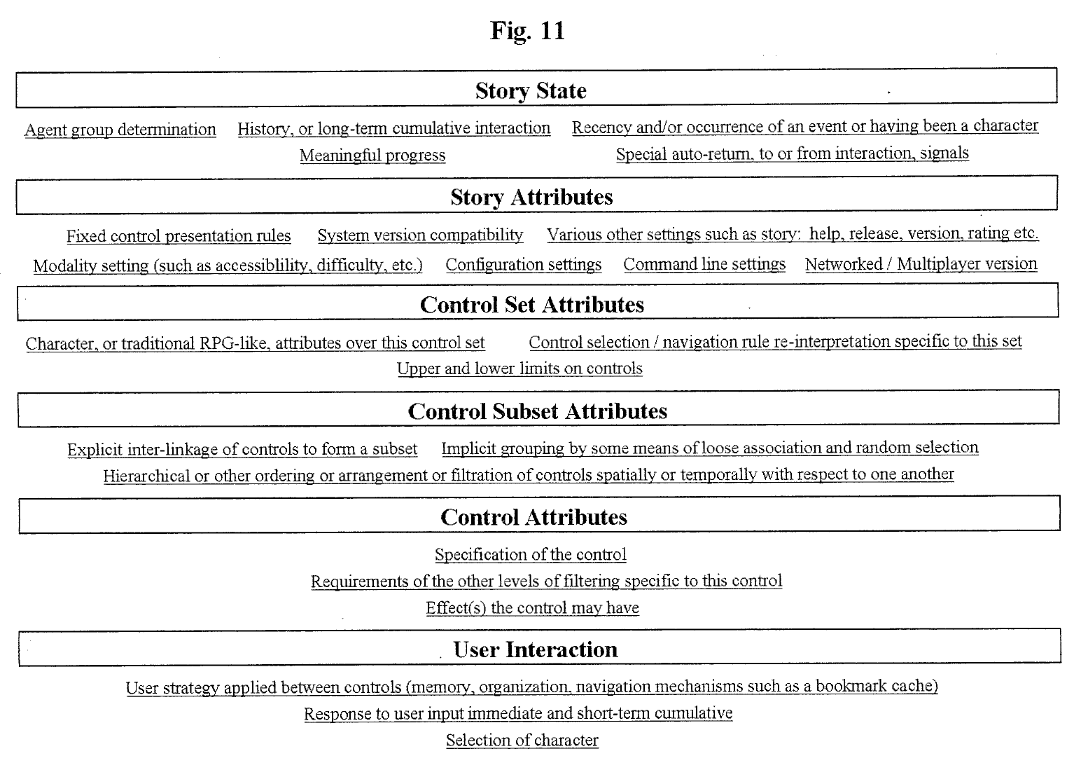

FIG. 11

No new reference numerals.

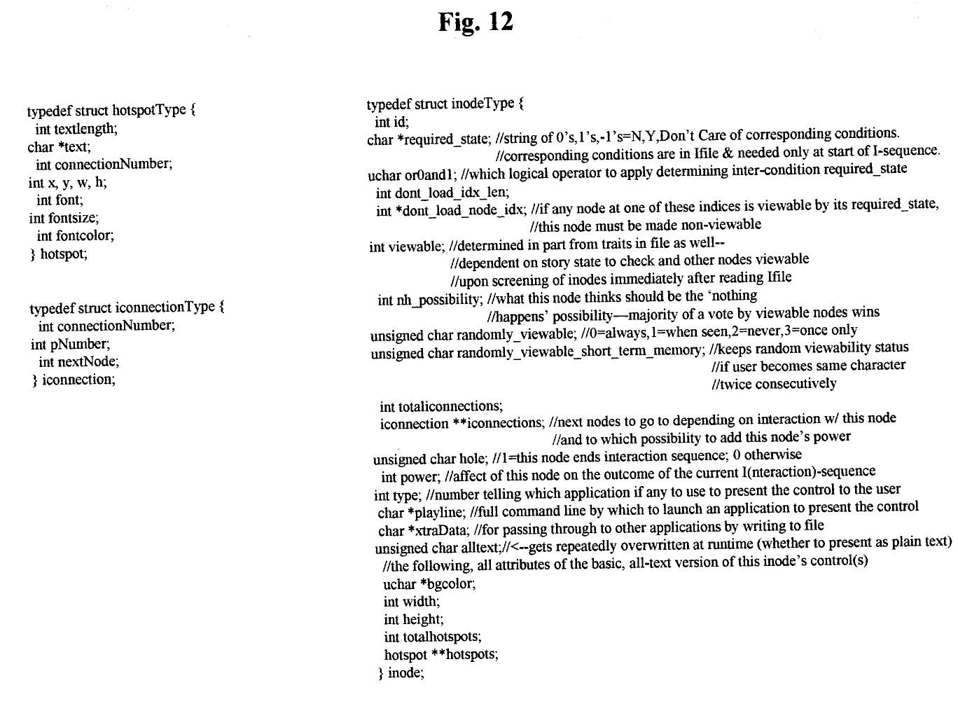

FIG. 12

No new reference numerals.

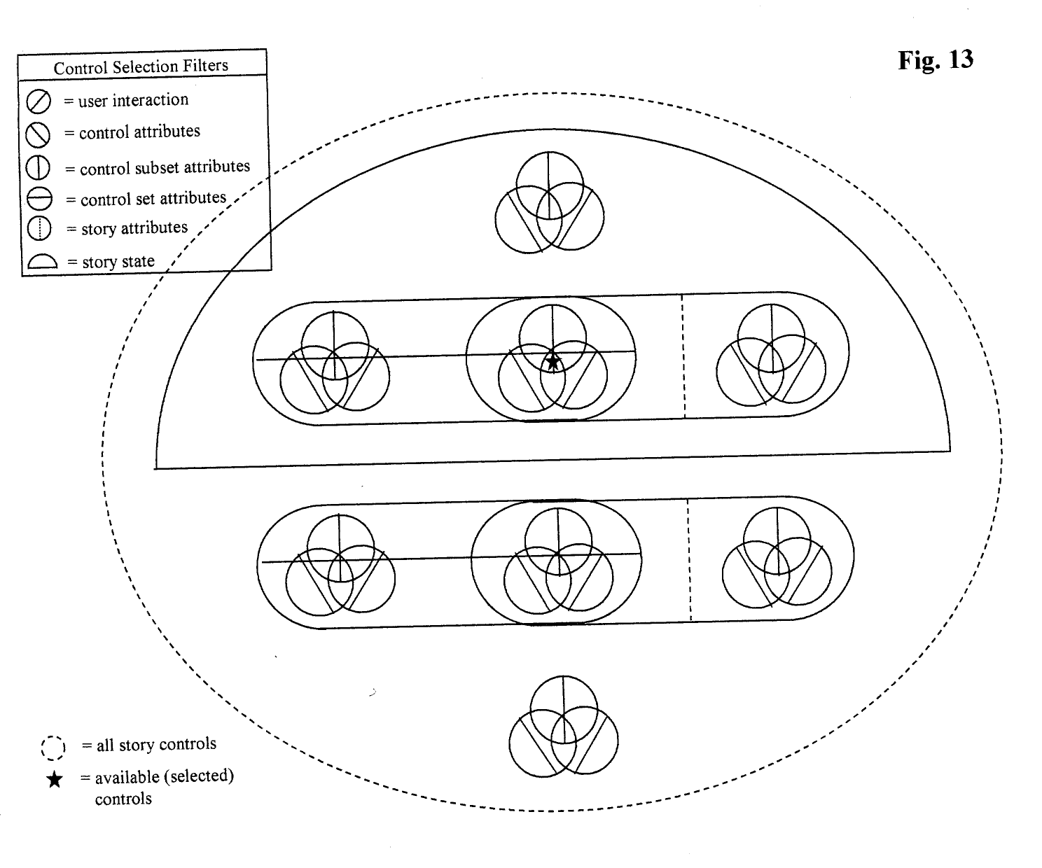

FIG. 13

No new reference numerals.

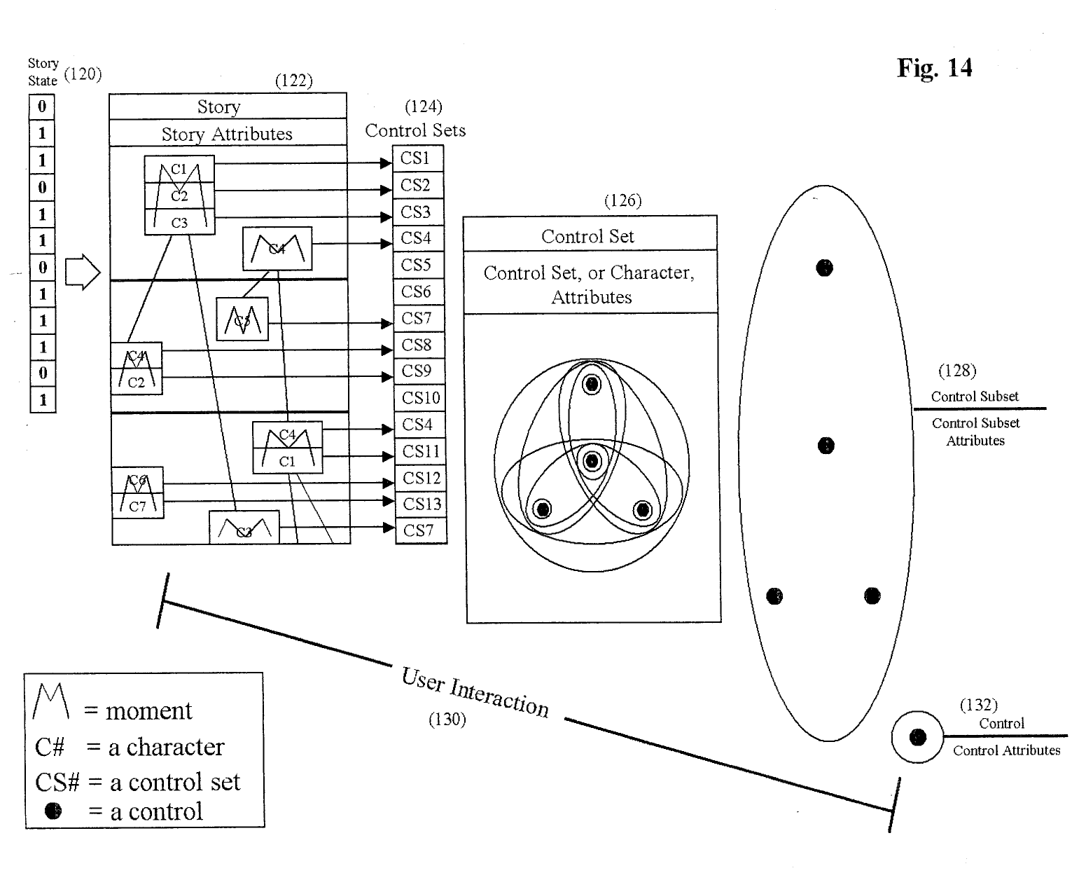

FIG. 14

120 an example state array

122 story attributes preside over the entire scope of the system

124 control sets take over as the system advances

126 control set, or character, attributes help guide control selection logic for the agent at this point in the system until the set is unloaded and a new set brought in

128 traits of one or more other controls—so-called control subset traits—may influence a control's selection

130 user interaction may at any time affect control selection logic

132 properties of an individual control may affect its selectability

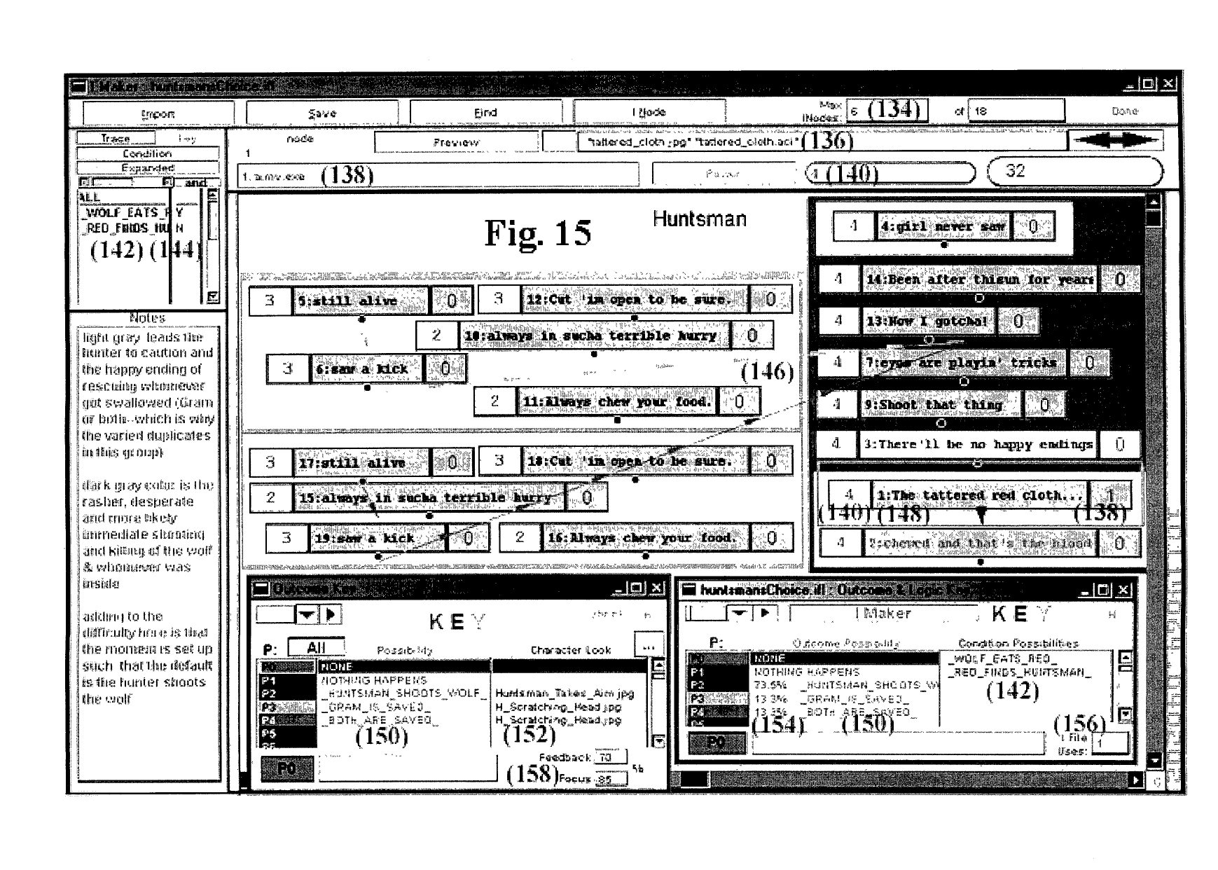

FIG. 15

134 maximum controls before the interactive sequence ends

136 command line arguments for presenting selected control(s)

138 application for presenting selected control(s). A clickable dropdown list here allows redefinition of this application for the control(s) selected

140 power points that will increase the probability of an outcome that wins on leaving selected control(s). A button to the left opens an interface for analyzing and setting relative power within the network as a whole including setting the ‘initial NH power’ of the ‘nothing happens’ feedback event (which will win initially until this initial NH number is exceeded). To the right is a larger round output displaying an amount of available power left currently to give to controls in the network (the total distributable is 5 times the number of controls)

142 conditions of the system's state for certain controls in this control set to load. A ‘Condition’ button above opens an interface for defining this list of conditions

144 the selected control(s) require(s), to be selectable, control file's conditions(left) evaluate to these values (where Y=yes/true, N=no/false, D=don't care)

146 loosely connected network of controls

148 the currently selected control, as indicated by the box around it. A round button on its underside opens a window for defining all the control's: connection information, non-viewability based on other controls, random viewability level of the control, and nothing-happens preference contribution of the control

150 a set of logical feedback units which may result from interaction with controls of this control set

152 immediate feedback instructions. Here instruction filenames refer to image files representative of physiological states of the agent to be feedback presented during interaction with this control set

154 derived statistical probability estimates based on control set data saved to the control set's file on disk

156 number of separate pointers to this control set from the system's map of “moment” data units

158 control set attributes of Feedback % and Focus % determining respectively: a probability that immediate feedback will match an associated immediate feedback (instead of being chosen at random); and probability that following a first connection with no next control specified will yield a control with a second connection, where the second connection contributes to the same feedback as the first connection

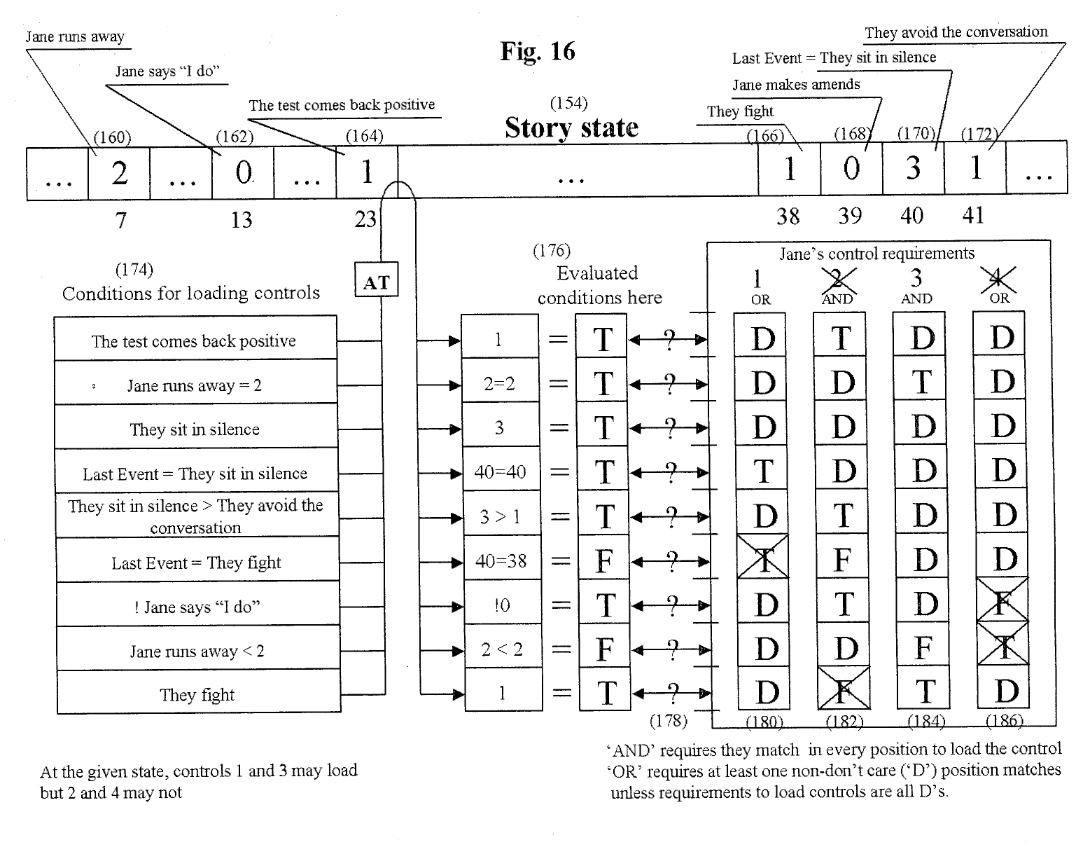

FIG. 16

160 feedback memory record indicating “Jane runs away” occurred twice

162 feedback memory record that “Jane says ‘I do’” never occurred

164 feedback memory record that the test came back positive

166 feedback memory record that “They fight” occurred once

168 feedback memory record that Jane did not make amends

170 feedback memory record that they sat in silence three times

172 feedback memory record that they avoided the conversation once

174 conditions of the system's state for certain controls in the current control set to load

176 evaluation at the current state of the system of the conditions of 174

178 bitwise comparison of the evaluated states of the conditions of 174 with the required states of individual controls in the current control set

180 required evaluation of control set conditions of 174 for control 1

182 required evaluation of control set conditions of 174 for control 2

184 required evaluation of control set conditions of 174 for control 3

186 required evaluation of control set conditions of 174 for control 4

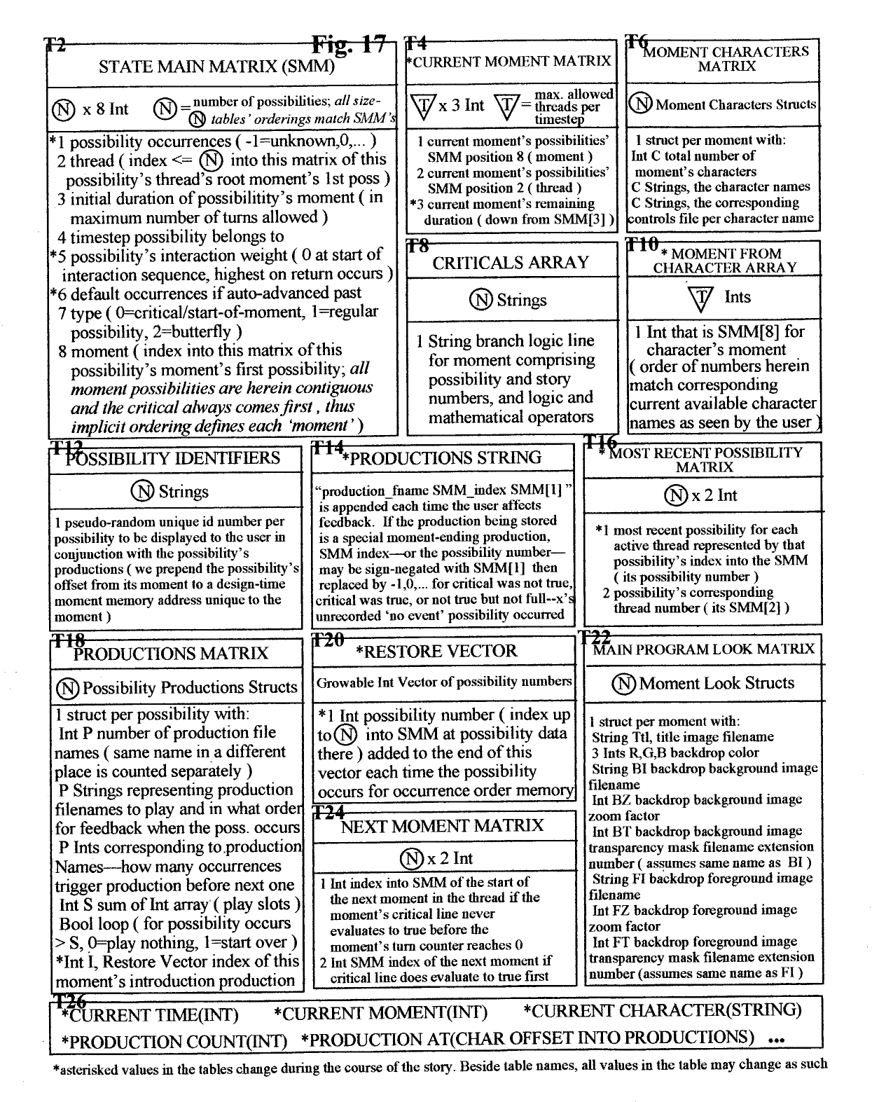

FIG. 17

T2 a state main matrix table keeps an ordered index of all static data units by storing contiguously the (reference, and static and dynamic state data for) feedback within each data unit

T4 a current moment matrix tracks which moments are current—only one moment may be current from any single thread, but several threads may be active in the current timestep. Also, to which thread each current moment belongs, and how many turns remain in each (the counter slot here starts at the maximum allowed turns for the moment and counts down in this matrix only)

T6 a moment characters matrix stores the reference information necessary to generate part of the agents list—that part associated with each moment in the event a moment is current

T8 a criticals array keeps the static, compiled critical branch logic lines for each moment

T10 a moment from character array for determining from user selection of an agent to which moment the agent belongs

T12 a feedback identifiers array of reference numbers each presented to the user in conjunction with corresponding feedback, for specificity of navigation through the system

T14 a productions string to which playback information for production-yielding feedback gets appended as it is played, for feedback replay and also for interoperating with user initiated restorations to previous system states

T16 a most recent possibility matrix equivalent to the current moment matrix only at the finer granularity of feedback, for evaluating the special cases of interactive sequence conditions such as ‘last event’ and ‘nothing happened’—the latter of which is represented by changing the polarity from positive to negative of the current thread's last possibility number in this matrix

T18 a productions matrix stores the specific, detailed instructions for presenting feedback to the user

T20 a restore vector keeps a complete, ordered record of all feedback that occurred directly from user interaction in the system so far, regardless of respective presentations to the user; an exception being ‘nothing happens’ which are important to restores but are not stored for efficiency and are instead inferred from other data as necessary

T22 a main program look matrix stores the detailed instructions necessary for automatically, based on system context, changing the graphical look of a surrounding environment

T24 a next moment matrix specifies to which next moment to go for both cases—the moment's critical line evaluated to ‘true’, or the moment's allotted turns ran out

T26 an assortment of global variables tracks other necessary information; others not shown being a ‘from past story’ table storing a 1 or 0 based on whether a corresponding feedback slot stored in the state main matrix is a reference to a previous system or not respectively, and an immediate feedback table for temporary storage of control set immediate feedback instructions

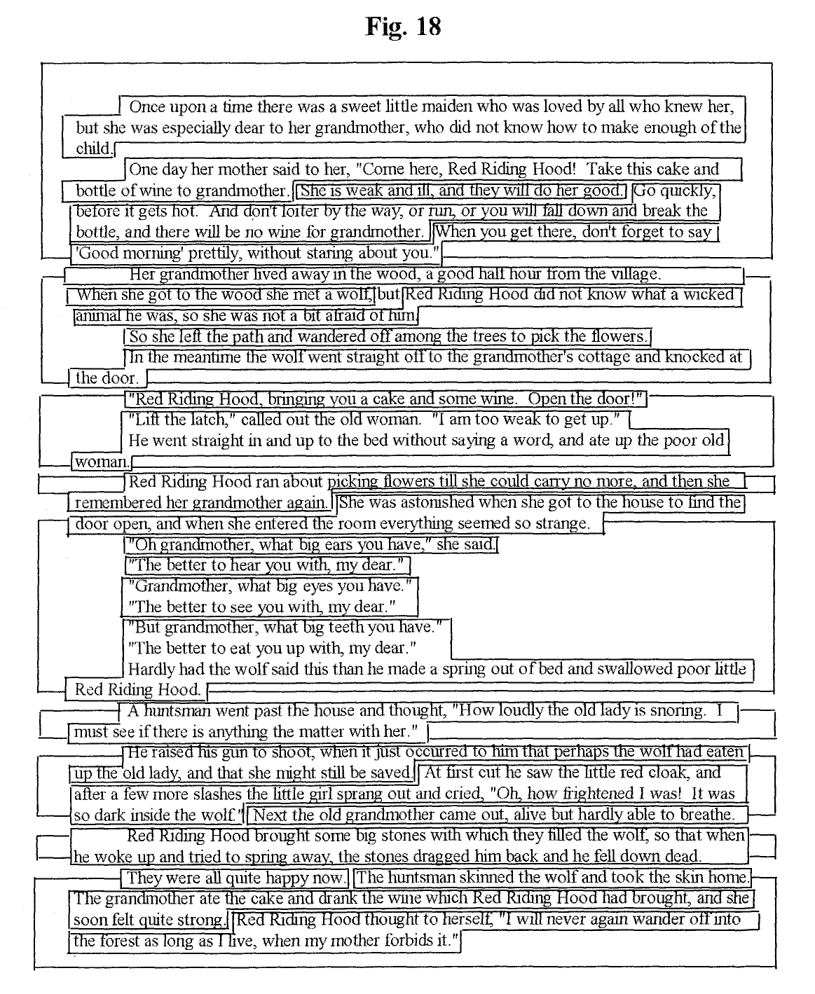

FIG. 18

No new reference numerals.

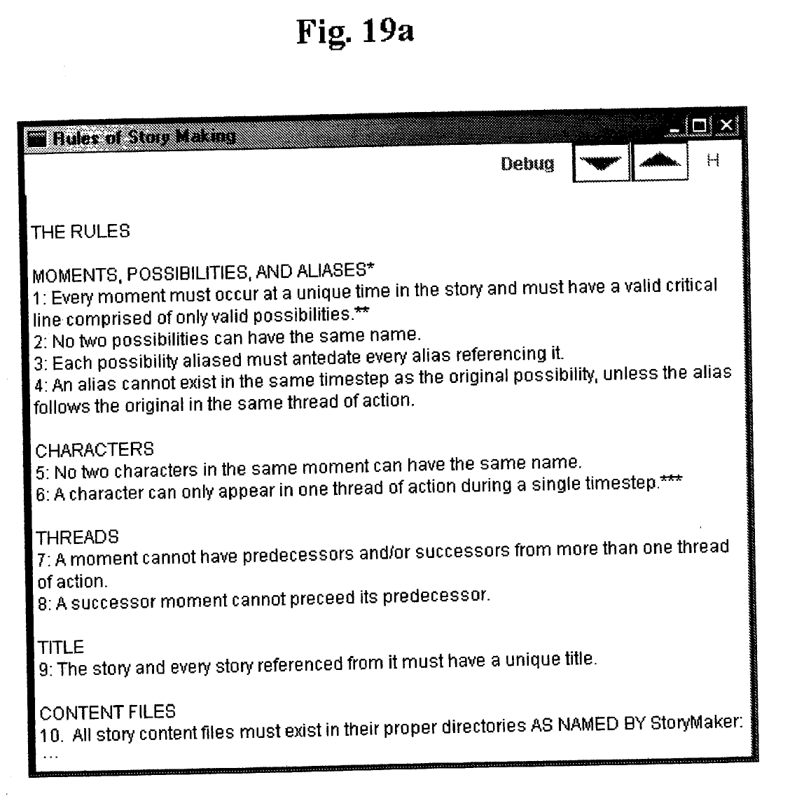

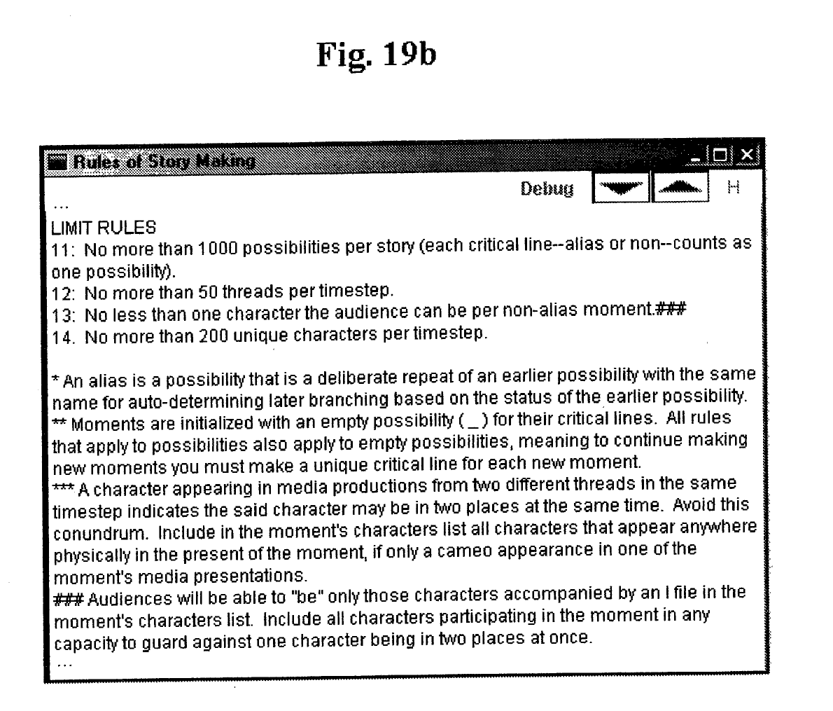

FIG. 19a

No new reference numerals.

FIG. 19b

No new reference numerals.

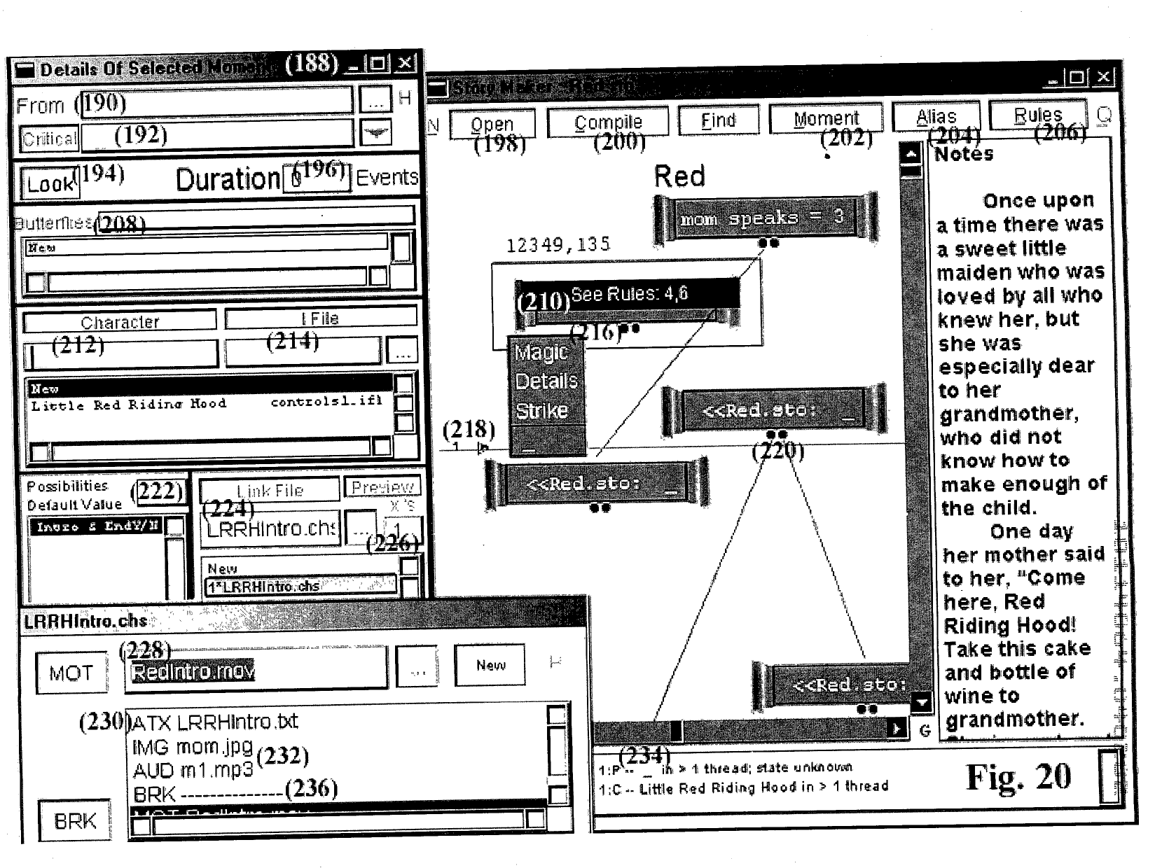

FIG. 20

188 an interface for editing initial and static data of the selected “moment” data unit

190 field for specifying from which system a branch condition reference derives—blank if from this, the current system; otherwise a name of a previous system

192 an interface for defining a critical branch logic line where a ‘Critical’ button allows for adding of feedback event reference names to the line via selection from a clickable drop-down list (populated based on the ‘From’ input contents above); the line (an uneditable output) for viewing; and a downward-pointing arrow button which brings up drop-down interfaces for rearranging and deleting all conditions of the critical line and a clickable drop-down list of logical and mathematical operators and a numerical input for inserting(removing) these elements into(from) the line in a constrained manner so as to ensure parsable integrity of the critical line

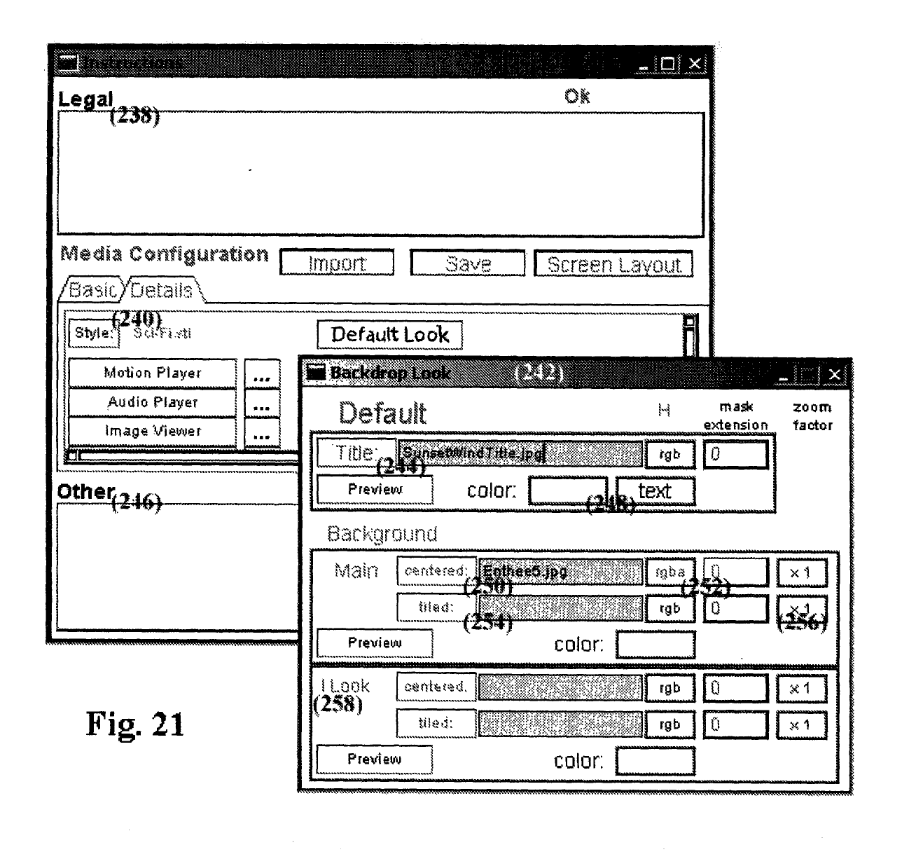

194 a button invokes an interface equivalent to a ‘Default Look’ window in FIG. 21 for defining the “look” of the surrounding environment during the interaction sequences and feedback respectively of this particular moment

196 input for specifying the maximum number of (non-butterfly-yielding) turns that may be taken at this moment before branching occurs automatically in the non-true direction

198 this button loads in a new story if the map is currently empty or combines the loading-in story with the one already present in the map

200 button invokes an interface for saving an instruction set, configuring initial recommended setup, copying, and compiling the instruction set into instructions readable by a dynamic interaction and feedback system application

202 button creates a new “moment” data unit onto the map, or right-clicking on this button creates a copy of a selected moment

204 button creates a new empty “alias” moment data unit onto the map, or right-clicking on this button creates a copy of a selected alias moment

206 button opens the rules window shown in FIGS. 19a and 19b.

208 interface for creating and managing so-called “butterfly” feedback events, named for the “butterfly effect” where a seemingly small event may have an eventual large impact: an input for typing the reference name of a new butterfly feedback event; a browser list below for viewing butterfly feedback currently in the selected moment and for removing if desired (by right-clicking on a line)

210 an editing error window reflects to the user the error status, if any, of the selected moment so that the user may correlate the error number with the rules window of FIGS. 19a and 19b to determine the nature of the problem

212 interface manages agents for the selected moment: an agent name input for typing the name of an agent to add (or change, if one is selected in a browser list below the input) by pressing the Enter key on the keyboard when done; a button for accessing a drop-down list of all agents appearing in the system, how many total appearances each, and how many “beable” times each and for selecting a name of one to populate the aforementioned agent name input; and a browser list below for viewing agents and their associated control sets currently in a moment, and deleting (by right-clicking on a line), and changing an agent name—by selecting its line and using the aforementioned agent name input

214 interface manages control sets for the selected moment: a control set filename input for typing a name of a control set file to add if an agent name is given in the agent name input to the left (or to change, if a line is selected in a browser list below the input) by pressing the Enter key on the keyboard when done; a button for opening the control set editor windows of FIG. 15 populated with the control set contained in a file bearing the name in the aforementioned control set filename input or a new file if no such file exists; and a browser list below for viewing control sets currently in the moment, and deleting (by right-clicking on a line), and changing a control set filename—by selecting its line and using the aforementioned control set filename input

216 the currently selected moment, as indicated by a box around it

218 a timestep interface showing a timestep that a tip of a left-pointing arrow is pointing into; and the left-pointing arrow which is a button allowing a user to create a new timestep by left-clicking on it or to delete a nearest timestep boundary by right-clicking it

220 the moment's two interconnection buttons: clicking the right button and then another moment below defines where the system will branch to if the critical line evaluates to ‘true’ before the moment's turns run out; doing the same for the left button defines where to go next if the maximum turns for the moment are exceeded first

222 feedback events' (otherwise known as possibilities) default values input where, having a feedback event selected in a browser list below and typing numbers defines an assumed number of occurrences of the feedback event in the case where the moment is auto-advanced past by interaction with other threads, allowing for meaningful update of any uninteracted-with moments of the system whenever timestep boundaries are crossed (the turns-were-used-up branch is taken for moments current at the time of auto-advance that have been interacted with to affect system state)

224 interface manages link files for defining a data (filenames) component of feedback presentation instructions for the feedback event that is selected in the browser list to the left: the user types a name of a link file for presenting feedback into an input and presses the Enter key on the keyboard to add the link file to the playlist (or to change the link file's name if a line is currently selected in a browser list below); a ‘Link File’ button opens a window for editing the link file (shown below populated in the diagram with the link file ‘LRRHIntro.chs’)

226 a numerical input specifies the number of consecutive times a link file should play on occurrence of the feedback event before the next link file in the feedback event's playlist should play when the feedback is affected next. If a line is selected in the below browser list, pressing the Enter key on the keyboard changes the times play number on that line to the number value in this input; and a checkbutton (not shown in the diagram) is also provided for defining whether or not to loop the playlist for the feedback event, as well as the ability to re-order the playlist by dragging on the lines in the browser list

228 interface for defining type<->media filename tuples for the link file: a button, a clickable drop-down list of types and an input for typing the media filename and pressing the Enter key on the keyboard to commit the addition (or change if a line was selected in the browser list below)

230 first line in every link file bears the type ‘ATX’ for “all text” and the filename accompanying it contains the text only representation of the contents of the link file

232 this browser list shows the contents of the link file, each line having a type that, cross-referenced with the system configuration, specifies which program to use to present the (media) data filename that is the other item on the line. Order matters—for non-text only presentation, the second line in the list is played first, then the third and so forth down to the last line in the file—so clicking and dragging on the browser list lets a user re-order the lines

234 a browser list of all known errors currently in the system

236 this break line in the link file causes a pause requiring the user to press a ‘next’ button before continuing to present the rest of the lines in the link file up to the next break line or end of the link file

FIG. 21

238 input defines legal information to be presented to user at system startup and available throughout inside an ‘Instructions’ window

240 ‘Style’ button only appearing in the editor application (not in the dynamic interaction and feedback system application) opens an interface for finding and specifying a style file on disk which is then shown to the right as the system's style file; a style file defines for a dynamic interaction and feedback system the look of various standard screen elements in the dynamic interaction and feedback system application when the system is loaded and run

242 a window available only in the editor to define the default look of a surrounding environment as it will appear when no moment-specific look is specified

244 an interface defines the title image

246 input defines all other in-program information to be presented to a user at system startup and available throughout inside an ‘Instructions’ window

248 color selectors assign a backdrop bottom-most layer color, and title font color respectively

250 an interface defines the topmost layer of a main background—the centered background image filename for the main background

252 a transparency interface sets a transparency mask of an image backdrop element to the left of it, consisting of a button that toggles whether the mask is to be applied (rgba) or not (rgb) and if applied, a numerical input to assign which image mask to apply (the full image filename plus a ‘.’ plus the number specified in the input)

254 an interface defines the second, middle, layer of a main background—the tiled background image filename for the main background

256 zoom factor multi-state button (x1,x2,x4,x8,x16 are supported) multiplies the pixel color data in the image before positioning it on the background, effectively “zooming” at the expense of resolution quality

258 an interface same as the one above it for a main background exists for defining a default interactive sequence backdrop look

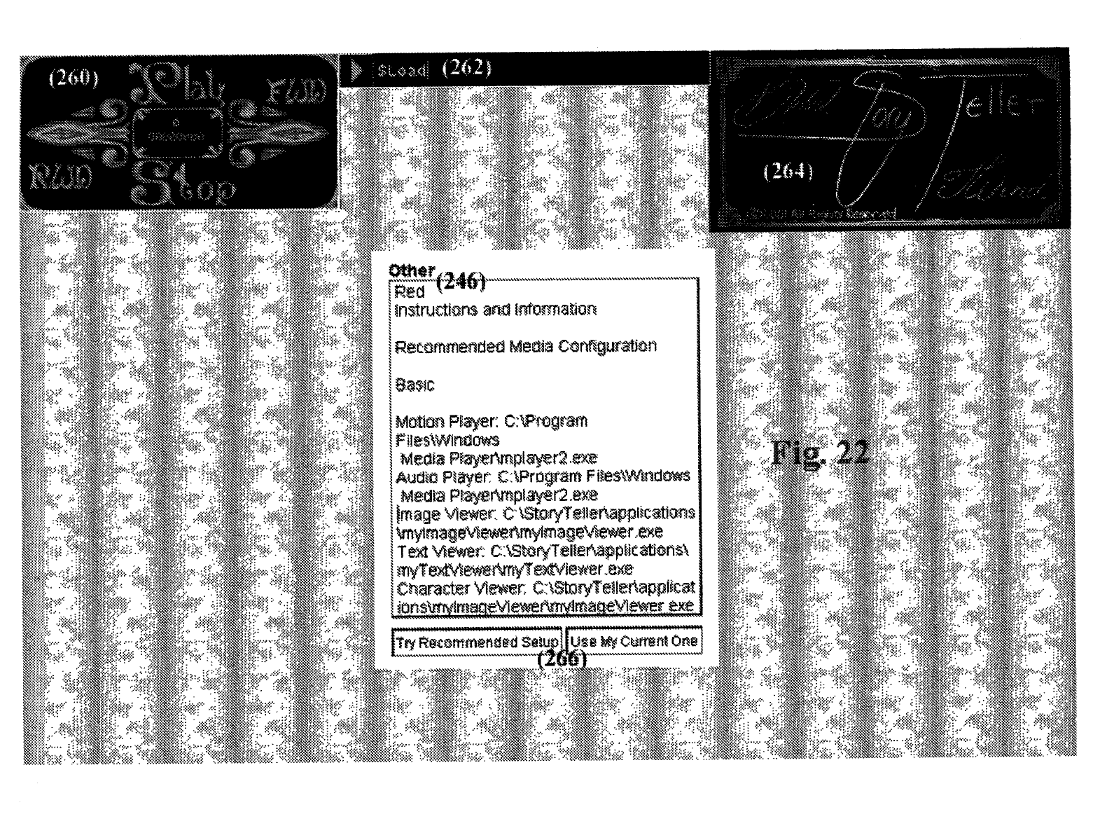

FIG. 22

260 vcr controls for rewinding, forwarding, stopping, and displaying the number of feedback events so far; and the feedback event identification number of the feedback event playing (these elements' looks all defined in the style file)

262 a ‘load’ command in this command line input of the menu interface of FIG. 8 loads a new dynamic interaction and feedback system (the color scheme of this interface defined in the system's specified style file)

264 title window displays the title graphic, defined in the look interfaces of the dynamic interaction and feedback system editor on both a default and per-moment basis (full screen main and interaction sequence backgrounds also are defined dynamically as such)

266 startup options buttons give a user the option to try the recommended configuration contained in the system file being loaded or keep the most recently loaded configuration (presumably, that worked)

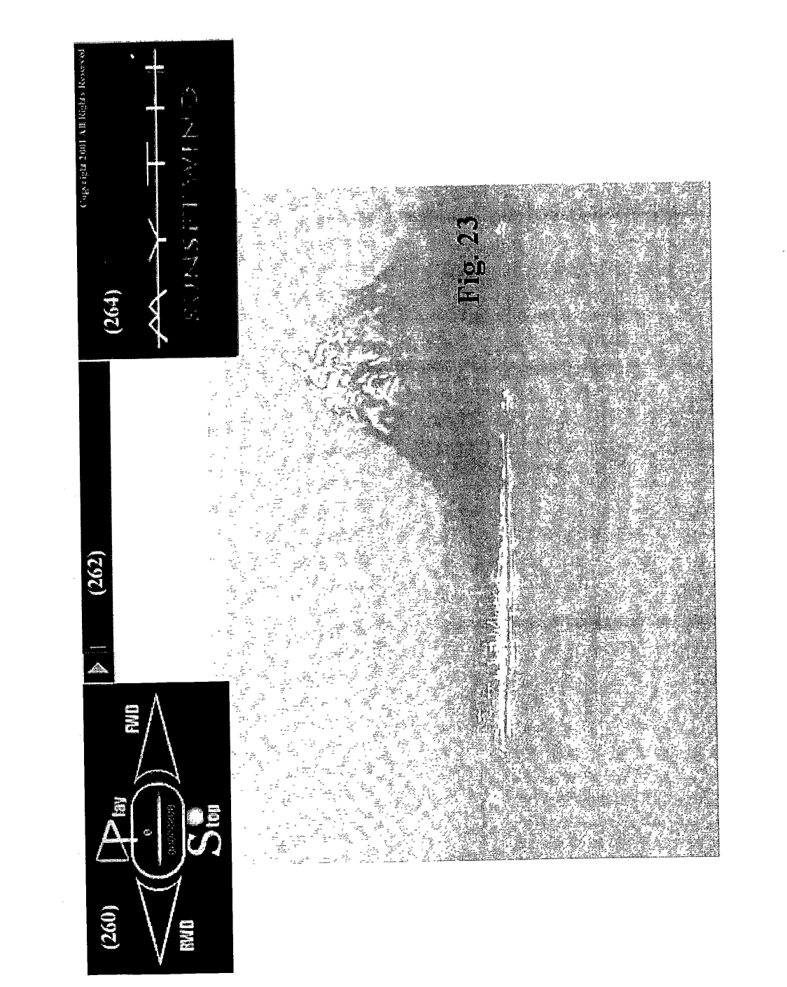

FIG. 23

No new reference numerals.

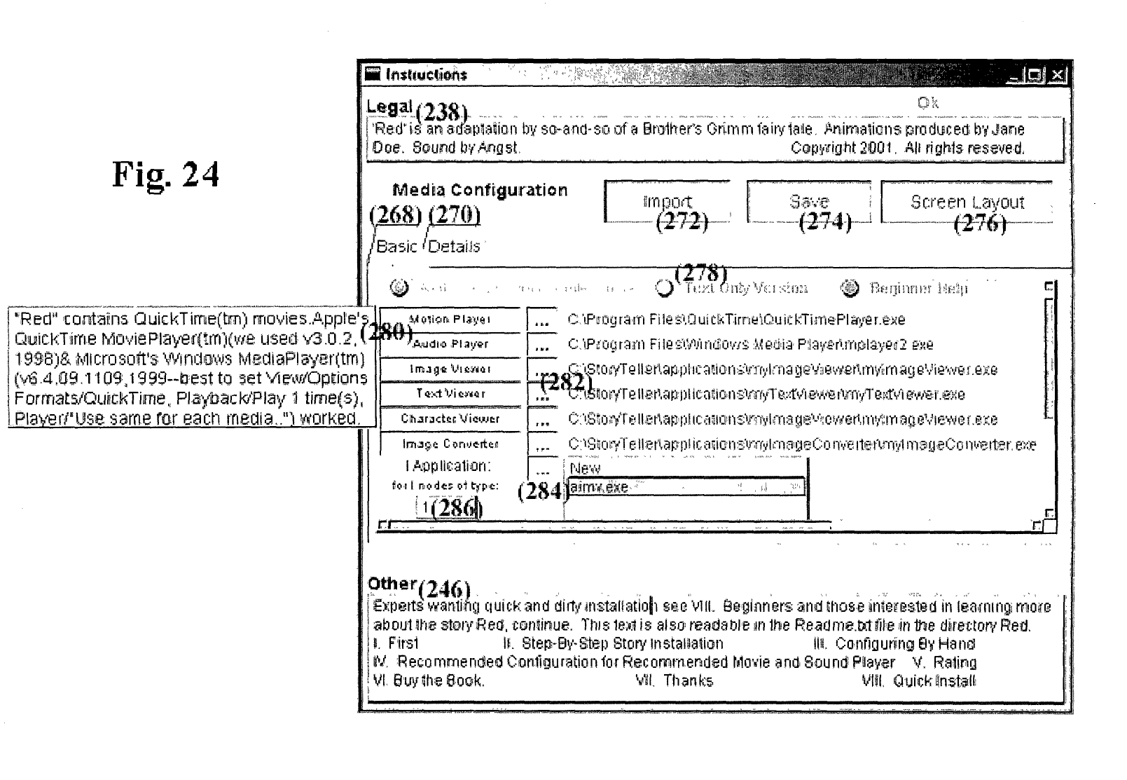

FIG. 24

268 a ‘Basic’ tab of a media configuration section of this ‘Instructions’ window contains user-definable instructions for setting up external handler applications for presenting feedback and in the editor only, external handler applications for presenting controls

270 the ‘Details’ tab of the media configuration section of this instructions window contains user-definable launch settings for the corresponding programs on the ‘Basic’ tab

272 button for importing saved configurations from file to populate the interface and be a present active configuration

274 button for saving the configuration currently populating the interface to file on disk

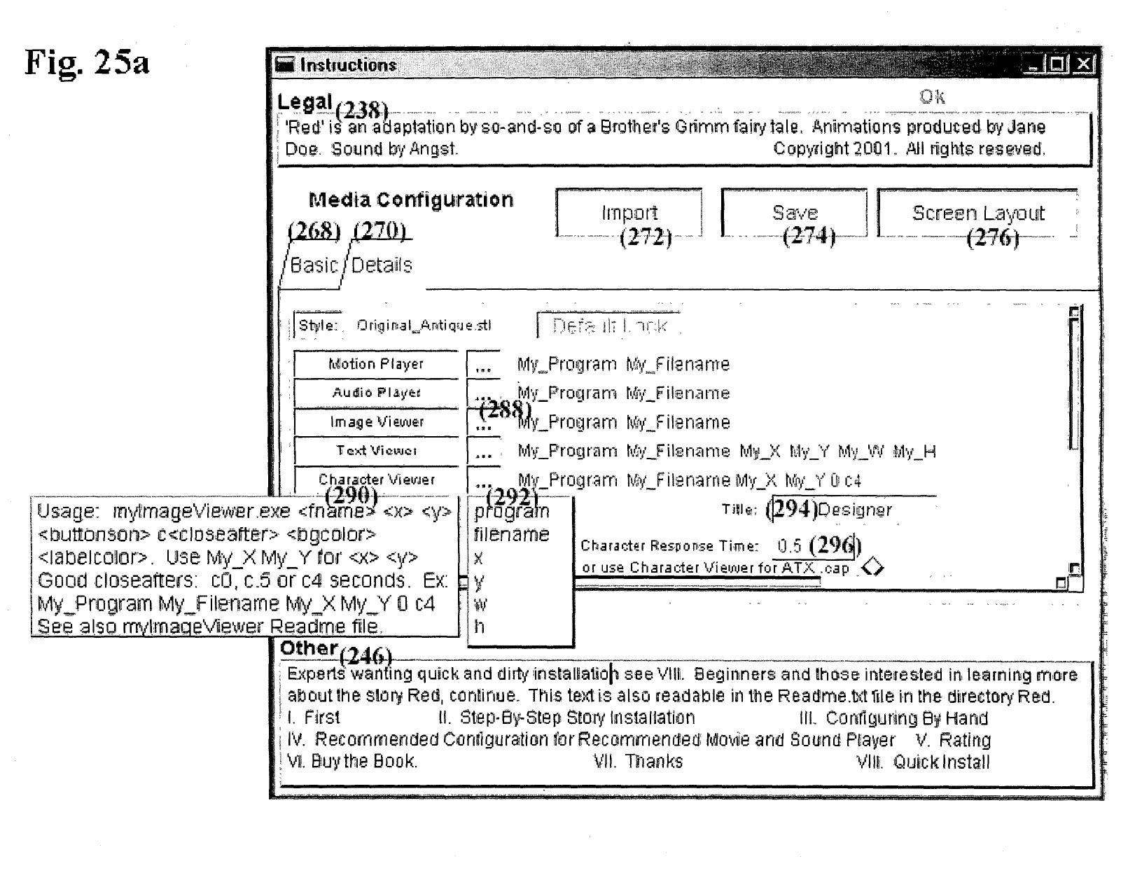

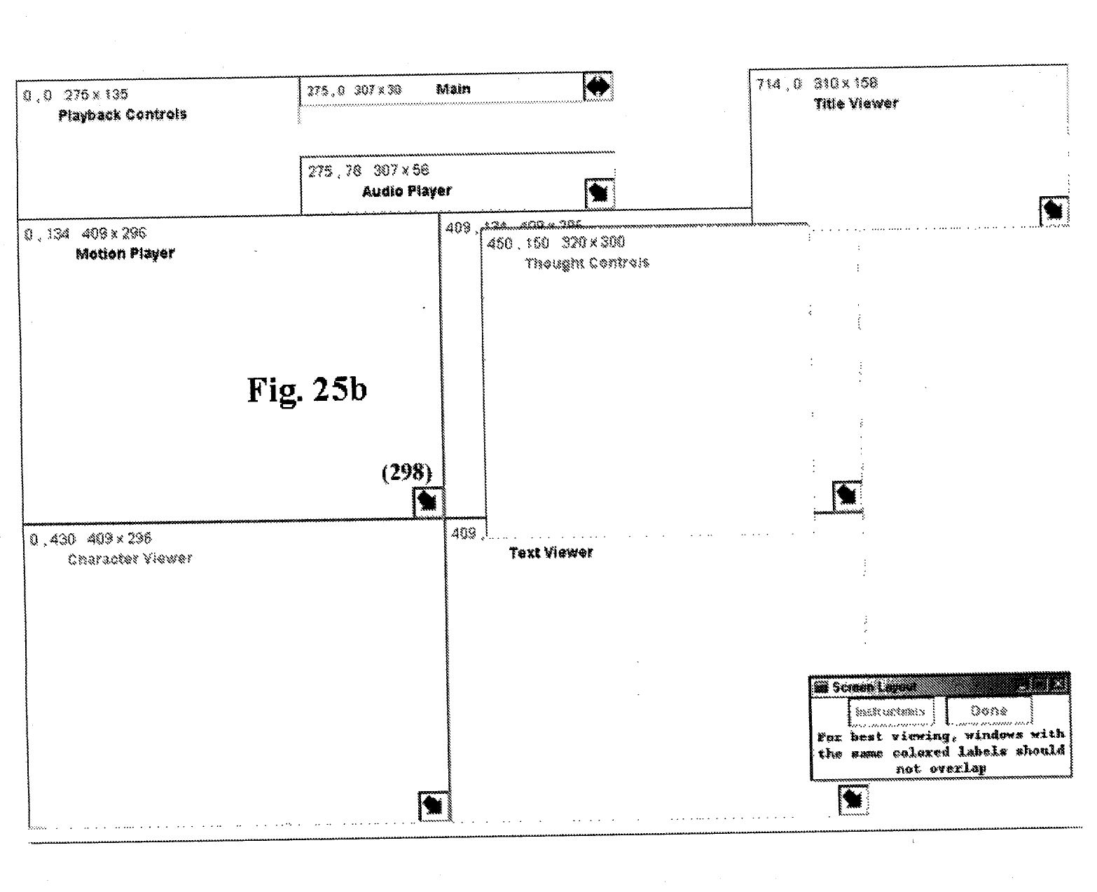

276 button opens an interface of FIG. 25b for instructing external handler applications' respective startup positions for when the system launches the applications to play feedback

278 toggle checkbutton switches on or off the ‘Text Only Version’ mode in which only the all text representations are presented as feedback and controls

280 buttons pop-up external handler application-specific metadata such as that shown popped-up on the left describing dynamic interaction and feedback system content compatibility regarding the handler named on the button

282 interface for assigning a program from somewhere on disk to perform the role of the handler named on the corresponding button to the left

284 an interface only seen in the dynamic interaction and feedback system editor, defines all external handler applications for controls to be directly invoked from a dynamic interaction and feedback system application on behalf of the dynamic interaction and feedback system

286 output displays the unique type number associated with the handler application selected in a browser list to the right—these are the same applications and type numbers available to controls through the control set editor of FIG. 15

FIG. 25a

288 interface for assigning program launch settings (command line arguments and switches) to the handler named on the corresponding button to the left; this interface letting the user type in the input to the right in a less constrained manner than the corresponding handler application specifier interfaces on the “Basic” tab which only allow the program paths to be selected from disk

290 buttons pop-up external handler application launch setting-specific metadata such as that shown popped-up below describing preferred configuration for various external handler application candidates

292 clickable drop-down list, called up by clicking a ‘ . . . ’ button, containing special tags to go into the command line input to the right; the tags to be over-written at runtime by the dynamic interaction and feedback system application with the values the application has for those components respectively: the program tag with the name from the ‘Basic’ tab, the ‘filename’ from the link file, and the application startup position and window dimension values from the screen layout editor of FIG. 25b

294 button toggles the mode between designer-specified and user-specified settings for the title window appearance

296 input for specification of how long the all-text immediate feedback of the interaction sequences remains onscreen before disappearing automatically and, appearing in the dynamic interaction and feedback system editor only, a toggle button instructing a dynamic interaction and feedback system application whether to use a specified character viewer or the application's own time-configurable all-text immediate feedback presentation mechanism

FIG. 25b

298 template windows with arrowed resize buttons for positioning and resizing to define the layout of the dynamic interaction and feedback system and external handler application arrangement

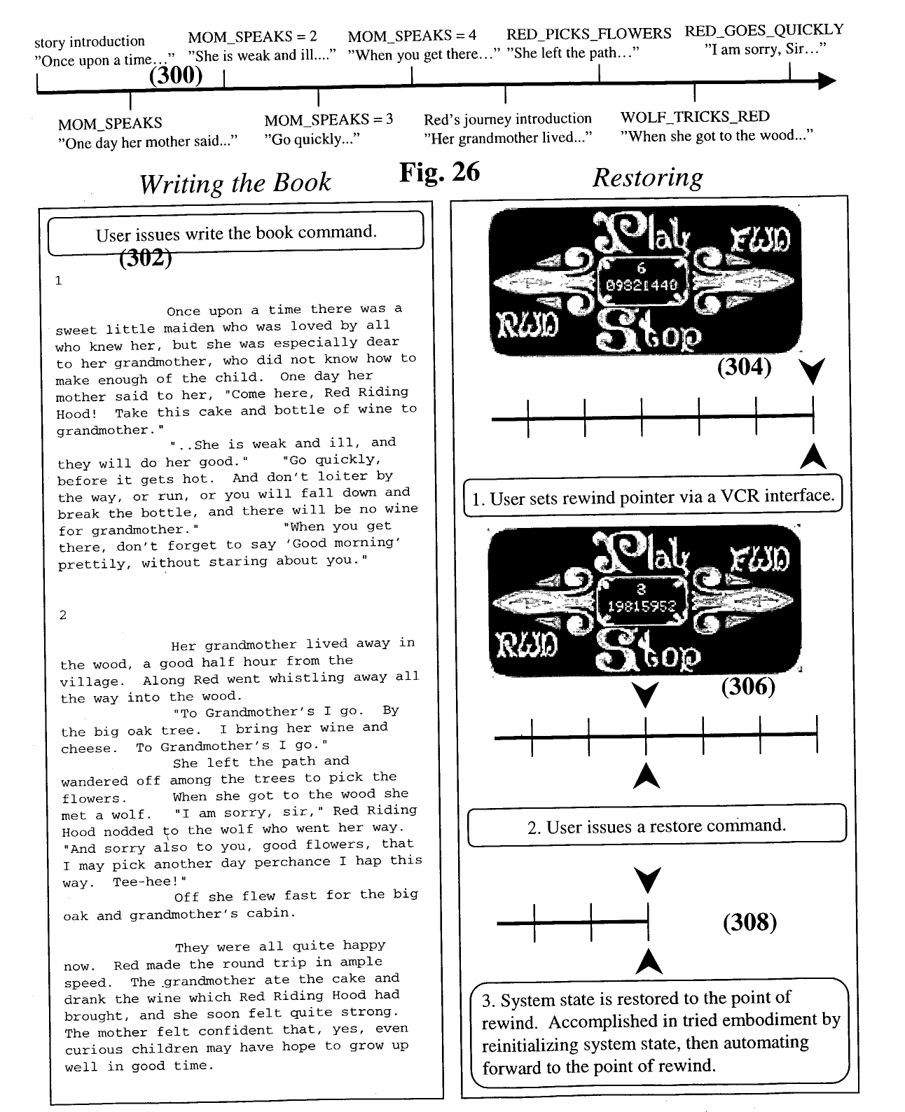

FIG. 26

300 a full feedback timeline for a completed run of the dynamic interaction and feedback system based on the tale ‘Little Red Riding Hood’

302 example of the text file output result of a user's issuing a ‘write the book’ command

304 VCR interface and feedback memory before the rewind and restore

306 VCR interface and feedback memory after the rewind

308 feedback memory after the restore

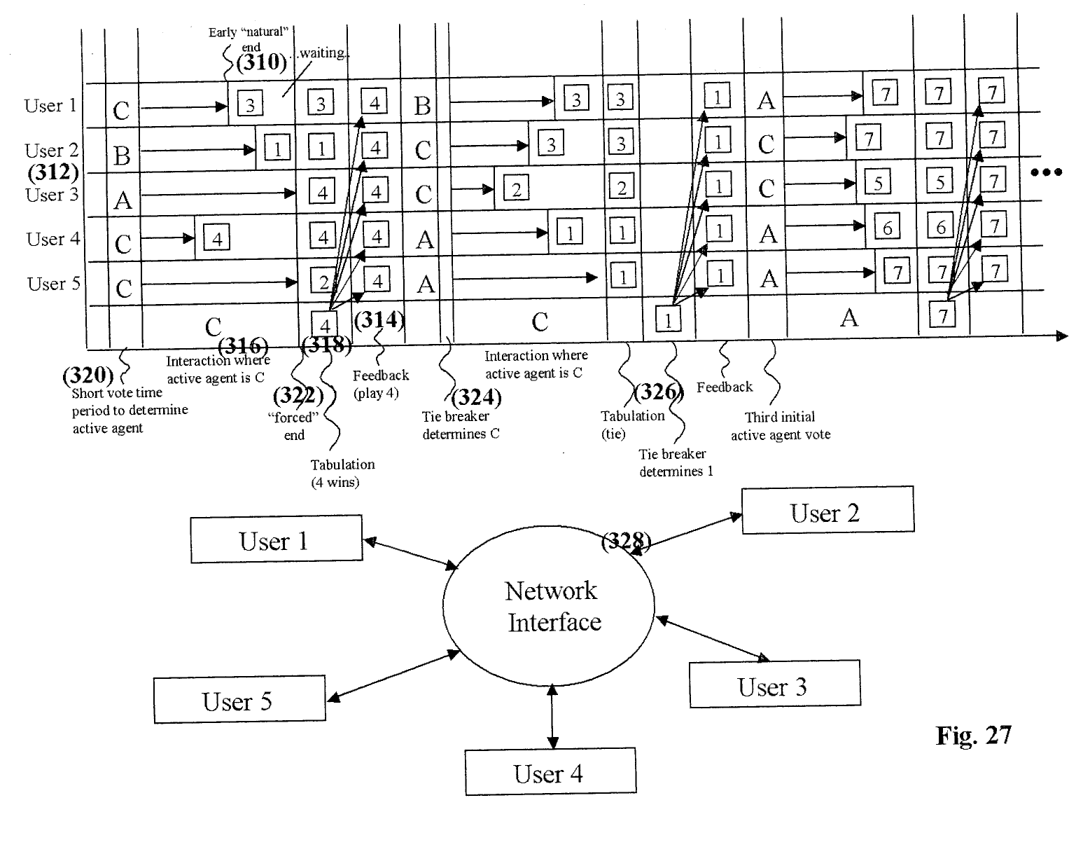

FIG. 27

310 users may complete interaction sequences naturally as they would in the single player version if they finish before a time interval allotted for the sequence lapses

312 multiple participants

314 the same feedback is presented and recorded to all dynamic interaction and feedback systems at the end of each interaction sequence

316 interaction sequence in which all participate as an agent chosen as a result of a majority vote of all participants

318 a winning outcome of the majority of participants is the winner of an interaction sequence

320 a majority vote of participants decides which agent will be a present active agent for the subsequent interaction sequence

322 the interaction sequence time interval ends and forces an ending of all participants' interaction still in progress

324 sometimes a tie-breaker mechanism may be necessary if no clear majority exists when deciding which agent should become a present active agent

326 sometimes a tie-breaker mechanism may be necessary if no clear majority exists for which feedback should win from an interaction sequence and be recorded to the feedback memory of every dynamic interaction and feedback system participating

328 participants numbering more than one, each running a separate dynamic interaction and feedback system application on same dynamic interaction and feedback system data, each on a machine that communicates with each other participating machine

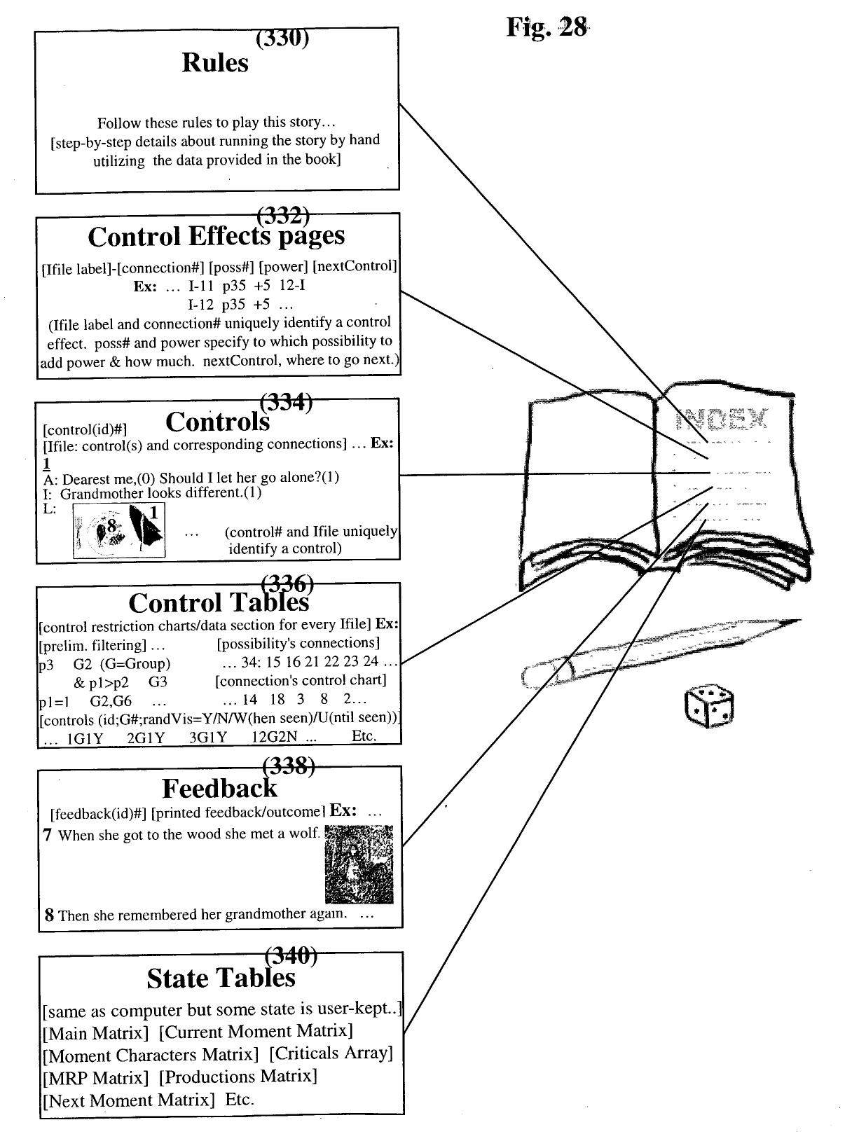

FIG. 28

330 outline description of a playing rules section for a printed version of a dynamic interaction and feedback system

332 outline description of a control-effects section for a printed version of a dynamic interaction and feedback system

334 outline description of a controls section for a printed version of a dynamic interaction and feedback system

336 outline description of a control-restrictions section for a printed version of a dynamic interaction and feedback system

338 outline description of a feedback blocks section for a printed version of a dynamic interaction and feedback system

340 outline description of a partially participant-maintained system-tracking section for a printed version of a dynamic interaction and feedback system (such as the described tables partially filled-in and then completed and updated for the dynamic slots with pencil and eraser as the system evolves)

Structural Description

Terms

“DIFS”, for dynamic interaction and feedback system, denotes the present invention.

Throughout, the text will demark tried embodiment-specific description with “(TE)”. This flags where the text gets into implementation-specific details. It is useful to know details of an implementation-specific nature both to understand mechanisms allowing the present invention to function, and to know where other DIFS implementations may vary. “Tried” instead of “preferred” is used. Tried, while true, is not intended to mean best or final. It means tried; the best implementation reasonably achievable by the programmer at the time.

Regarding <TE> and </TE>, furthermore, some entire continuous sections of this specification deal primarily with the particulars of the tried embodiment. To avoid repeating (TE) in every sentence, the start of these sections will begin with the <TE> mark and conclude with the </TE> mark. This is in the name of readability.

“characters” and “agents” are used interchangeably, although the latter, more general term, is meant whenever the former, more comprehensible, term is used.

“story” in places is used interchangeably with “system” and “DIFS”.

“RPG” stands for role-playing game, a genre of games involving user-viewable character attributes that define and are defined by progression through a game.

An “event” or “feedback event” is a discrete unit of feedback.

“possibility” is equivalent to “event”. This terminology is used to bring out the clearer, intended broad meaning of “event” as a unit. “event” might by certain readers be more easily confused with traditional terminology to describe user interaction such as event handling/listening. “possibility” more accurately describes what is intended by “event”—a discrete unit of feedback—implying nothing of interaction, occurrence, or non-occurrence.

“inode” is a tried embodiment's DIFS application's code structure for a control, though essentially it is synonymous with “control” wherever used.

“moment” is a tried embodiment's name for what is otherwise referred to here in the text as a data “unit” of a DIFS.

“duration” is the maximum allowable turns at a data unit of a DIFS.

nothing happens, used variously throughout with lowercase letters, capital letters, single or double quotation marks, and/or underscores always implies the same idea (as do NH, nh_possibilty, other nh variations). That is, nothing happens is a special feedback event caused by a user. This particular event essentially means the user had no direct effect just now.

“editor” and “editor program” are used variously throughout to mean the stated aspect of a rule-based editing and compiling machine. An editor in the context of this description is for creation and/or modification of DIFS's.

Hardware

Referring to FIG. 1, a DIFS employs the components shown on FIG. 1. This figure shows general categories of components and one standard configuration. Processing devices 1, storage devices 2, and input/output devices 3 interoperate via data transfer channels 4. This serves as an intentionally broad description of present general purpose computers.

With the exception of its printed version, a DIFS requires a general purpose computer as such to function. Creation of a printed DIFS would likely require such hardware, though use of the printed DIFS would not.

General Control Flow

Referring to FIG. 2, control of the DIFS proceeds along the following steps.

First, in step 1, an agent group is determined on the basis of reading state 20 and applying hardcoded agent group determination logic.

On initial startup, a DIFS application stages all prior saved state from disk into memory(TE). This initial state includes a system's initial session state, and other system-specified prior systems' session states.

Prior systems' state is considered to have happened in the past. Therefore, this state is retrieved once only when a user starts a new session of a current system. Never thereafter in restored sessions of a current system will this state change. Therefore, older state as-such is only retrieved separately the one time. The older state thereafter remains incorporated together with a current system's saved state.

Session initialization to start a system anew prompts a user about which past state to use. Prompting allows a user to specify particular past sessions to use or defaults. Thus, a new current system may continue one or more past systems where a user left off.

Initialization not beginning a system anew from scratch asks no questions. A DIFS application stages from disk exactly one of a current system's (non-initial) prior sessions and nothing else.

Subsequently after startup, state exists in memory(TE). Agent group determination logic merely asks true/false questions concerning this system state. Based on evaluation of the agent determination logic using present system state, a DIFS application decides on an agent group. An agent group may exist from previous executions of this first step of processing. If so, a DIFS application may retain the present agent group as-is. It may alternatively select a new group of agents. Whichever agent group results depends entirely on evaluation of agent group determination logic based on present system state.

Agents can be anything displayable at the current point in a system. Within reason, agents are entities which make logical sense to allow a user to select. Character representations are the most obvious candidates, but so too are objects, narration, or commands. For instance, the text strings “Linda's Comb”, “One year later . . . ”, or “New Game” could all work. Agents depend both on the system and where in the system they appear. The latter is why this automated agent group determination step is so crucial. In a printed DIFS, of course, “automation” may require a user to manually tally agent group determination logic evaluation to some degree. In a DIFS running on a computer, this process of evaluation is easily automated.

Next, in step 2, a user selects an agent 22 from amongst the determined active agent group. A general DIFS application handles the display/selection process here (TE). In fact, this application handles all generally applicable user interface work. It is conceivable that dynamic agent presentation and selection methods might be desired for this step. In such a case, a more robust DIFS application might prove sufficient. Equally viable: spawning a handler process that communicates back a user's selection to a main DIFS application. The latter suggestion would keep a main DIFS application general, yet empower specific implementations of the character selection function.

Thirdly, in step 3, a DIFS application selects and presents active controls 24. If active controls are available, a user interacts with presented controls. Otherwise, or at the end of interaction, a DIFS proceeds to the last step.

Concerning presentation, a DIFS application handles certain general presentation of text controls, which usually represent character thoughts and mental processes(TE). Otherwise, presentation consists of spawning external applications that in turn present controls. These external applications must terminate and write an outcome to disk(TE) for a system to proceed. A waiting DIFS application then reads a result and resumes wherever it left off.

Lastly, in step 4, a DIFS commits any state changes to its feedback memory 26. This step includes presentation to the user of associated feedback, as available. Feedback presentation employs spawned processes(TE) similarly to described spawns for controls presentation. The conclusion of this step automatically starts the process over from step 1.

Steps 1 through 4 continue to repeat in this manner. A system effectively terminates when it selects an agent group of size 0. A user realizes termination has occurred by one or both of two ways. Aforementioned feedback, from the preceding final step 4, indicates an ending. The user is unable to continue for lack of any agent to select. A DIFS's featured invocation interface with options to automate interactive aspects may come into play. A DIFS application may be invoked with an auto-exit option turned on. In such a case, automatic program termination alerts a user to the end of a system in progress.

At least four noteworthy variations on the above general control flow exist(TE). Of course, user issuance of standard commands may break the general pattern. But the following four special cases break it naturally from time to time.

The first occurs from step 4 (again, 26 in FIG. 2). An event of the recording of certain predetermined state allows for a potential skipping of a subsequent step 2 (again, 22 in FIG. 2)(TE). In other words, at times a user may not have to select an active agent. A user's previously-selected active agent remains the present active agent.

The user's act of having selected a present active agent the previous time through gets repeated on her behalf automatically. This will be discussed in greater detail (see “butterfly” event discussion), but the purpose is variance. From the user's point of view such variance breaks perception of tiresome repetition. The pattern diagrammed in FIG. 2 remains but less obviously, less obtrusively. Uninterrupted interaction, broken only temporarily by feedback, becomes possible. This is consistent with the aspect of a DIFS of a purely code-level agent selection interface.

The second major flow variance originates from the active controls selection and user interaction phase, again 24 in FIG. 2. This departure is one more of implementation than of end-user experience. A DIFS application may spawn a process for the duration of the step(TE). More radically, it may spawn an application that reloads the DIFS application state in full(TE).

An aspect of a DIFS is a completely non-graphical mode of operation. Operating as such, a second DIFS run-code may manage state inside a spawned process. A related aspect of a DIFS is a message-passing channel between a main process and related processes. In this case, the relay may consist of a file. <TE> Prior to spawning a sub-process, a main DIFS application saves its state to file. A spawned application then reads this file. The spawned application runs non-graphical DIFS state management routines in its background. These routines operate on state according to user interaction with their surrounding application. When this application terminates, it writes all state changes to disk. Included in the file written is an instruction that the main DIFS application reload itself. The main DIFS application instruments an automatic reload of state, including changes.</TE>

The net effect is relatively seamless continuation of the usual general control flow. What has actually occurred, however, is a deviation with significant underlying system state implications.

The third variance inserts presentation of feedback immediately following active agent selection. In certain situations to provide needed context a DIFS application inserts such feedback(TE). For instance, a user selects an active agent that is different from a present active agent, or one that starts a system from the beginning or at a significant point of change. Setting or time or situation may have changed in a story. Without context, interaction via a selected agent might make little sense. The interaction might seem out of place, jarring, or utterly unanticipated.

Transitioning into interaction in a DIFS entails providing feedback to introduce a situation. The next section defines standard data units of a DIFS. Connected data units follow from one another and represent a thread of action. A different data unit takes focus when a user selects an agent belonging to it(TE). A DIFS application checks a newly in-focus data unit when it takes focus. If user interaction never affected the unit's contents, a DIFS application plays the unit's introductory feedback(TE).

Otherwise, a DIFS application plays the most recent feedback(MRF) from the new in-focus unit's thread(TE). In this latter case, to justify its playing the MRF production must exhibit certain qualities. It must have originated from the in-focus unit, or a from a unit directly leading to the in-focus unit. If from a unit directly leading to the in-focus unit, no special unit-ending production may have been skipped (on auto-advance) getting to the in-focus unit from the unit directly leading to it. This mechanism and its various aspects are described in further detail below.

Essentially, from system structure, a DIFS application infers when it makes good sense to replay event productions presented in the past. This because a user may need reminding about context on certain transitions. Provision of context as such upholds the virtue of a smooth, unified experience.

The fourth major variance also originates from the active controls selection and user interaction phase, again 24 in FIG. 2. Only this variance comes, as the second variance did, during the actual interaction phase. Permitted interaction during this step includes a user's terminating interaction with no consequence(TE). Essentially, this means skipping steps 4 and 1. During interaction, a user may press the ‘Esc’ key on her keyboard. Thereby, she may escape early from an interaction sequence in progress without affecting state changes.

The system does not record even a ‘nothing happens’, explained in detail later(see OPERATION section). A DIFS application may have spawned a sub-process to handle interaction. In such a case, the sub-process would need know 1) how to register an escape or equivalent user-invoked command, and 2) report back on termination this exit status. A DIFS application provides a mechanism for receiving the result of the second aspect(TE). It reads a number from a file on termination of a sub-process to determine whether special exit status is desired(TE). In this way, a main DIFS application knows to end an interaction step in progress and proceed directly back to step 2, skipping steps 4 and 1. The same agent group remains and need not be calculated again.

This last exception to the usual flow promotes exploration. By allowing early escape free from consequence, a DIFS application encourages informed decision-making. A user may proceed more cautiously, may learn more about one or several agents. Furthermore, affording a user such control checks the power of randomness. Frequently interaction sequences will employ random number generation(TE). Randomness, then, plays a large role in determining outcomes. It should not, however, take over. Strategy requires control. A user entirely at the whim of random number generation understandably frustrates quickly. A user realizing things are not going his way may understand that they easily could. He should have the ability to try again. The early escape mechanism provides this ability.

Of course, active controls selection logic may select no controls as well(TE). This is still playing by the rules and is not an exception. However, in this case, selection of an active agent may serve only to play feedback(TE). From an audience's point-of-view, this would seem a departure from normal control flow.

A Unit of Storage

Referring to FIG. 4, a DIFS requires static data organized into functional units. Going right, aspects relate more specifically to units of the tried implementation. At left in bold are components essential to each such unit in a DIFS.

A DIFS discretizes static instructions of agent group determination logic into data units. Each unit contains firstly agent group determination logic in the form of branch logic 42. Together with run-time evaluation routines and system state, this branch logic forms the agent group determination logic aspect of a DIFS. A unit's branch logic instructs a DIFS which unit to go to next. Branch logic is agent group determination logic because each unit contains agents data 44 as well. Thus, logic selecting a next unit effectively helps select the next agent group.

At run-time more than one data unit may be current at one time(TE). Agents from all current units together, therefore, comprise an agent group. This organization allows separate threads of connected units to develop at different rates in parallel. These threads translate into separate threads of action in an interactive story experience.

Conceivably, a slightly different progression between units might work to a similar end. In some implementations, branching may lead n-ways from a single unit. Branching at run-time might make more than one next unit current when progressing. However, for simplicity's sake, a single unit may branch to at most one of at most two next units(TE). This definition allows a current unit to provide no next unit for a selected direction. In such a case, the unit simply terminates the thread it belongs to.

Branch logic instructs where to go based on system state. Therefore, in addition to where to go, branch logic may ask questions of system state. Once again, variations on a simple scheme are possible. Each DIFS unit might ask more than one true/false question of system state. For simplicity, only one critical line of boolean(true/false) logic suffices(TE). Each conditional branch necessarily requires a unique system state be met for its progression.

<TE> Therefore, a second branch necessarily requires a second, alternate prerequisite unit-termination state. An integer maximum number of turns number stored in each unit motivates this alternate branching. When a unit's turns equal its maximum number of turns, it branches left. If at any point the unit's critical line evaluates to true beforehand, the unit branches right.</TE>

A turn is one complete single cycle of the aforementioned general control flow (i.e., one complete loop of FIG. 2). A DIFS permits certain turns not to be counted against a unit's maximum number of turns(TE). Turns yielding feedback designated as “butterfly” event feedback go uncounted(TE). A “butterfly” event as such provides a construct for infinite repetition. Designating certain feedback containers as infinitely repeatable varies pace. Content becomes reusable unpredictably. Progression in general, its rate more variable, becomes less predictable.

“Butterfly” event occurrence also implicitly instructs automatic re-selection of a current active agent(TE). Interaction and feedback, while structured, appear more random and less monotonous to a user.

Concerning feedback containers, a standard unit of a DIFS must further provide feedback event data 46 (TE). This data may be organized any number of ways. A preferred methodology is to store separately: surrounding environment data, and feedback-specific data(TE).

Feedback has its own discrete data units in a DIFS: events. An event, then, is a discreet feedback data unit for presenting an outcome to a user. An outcome may occur severally, however. <TE> Thus, feedback data representing direct consequences of a common impetus may share a single overarching event. For instance, an event _HE_RUNS_ may happen numerous times. Each occurrence of _HE_RUNS_ may present different or similar feedback to a user. In this view of an event, each event comprises at least a playlist. Each time an event registers, a production at the current slot in the event's playlist plays. Each slot, in turn, specifies a production and an integer number PT. PT (for “play times”) indicates how many event registrations motivate playing of a production before motivating the next slotted production in the event's playlist.

So a playlist for _HE_RUNS_ might look like the following:

1*RunningFast.chs 2*TiredHeJogs.chs 1*CatchesSecondWind.chs

_HE_RUNS_ happening a first time plays the production contained in the file RunningFast.chs. _HE_RUNS_ registering twice and thrice respectively plays TiredHeJogs.chs once independently on each registration. Should _HE_RUNS_ register four times, the fourth registration motivates playing of CatchesSecondWind.chs. Event data storage includes also a yes/no flag indicating whether its playlist should loop. In the preceding example, affirmative looping causes any fifth registration to play RunningFast.chs. A seventh and eighth registration would again play TiredHeJogs.chs, and so forth. Looping is infinite, or until, of course, the containing unit's maximum turns are exceeded. An event with a ‘no-looping’ flag registers but motivates no further presentation beyond its playlist's end.</TE>

A production, demonstrated later, points to all data for presenting a particular outcome to a user. However manifested, productions uphold a DIFS's aspect of content organized according to representation categories. Strict formatting of production files as tuples of media-category-specifier, filename qualifies(TE). A further standard may require the first tuple of every production file stipulate a text file(TE). This text file must provide representative text for an all-text version of the production(TE).

The suggested production file format lets a general DIFS application reach a wide audience. Association of production file content files with media category tags promotes generality and adaptability. A DIFS program runs DIFS's but may not be equipped to handle all content therein. However, a user may equip a DIFS program to use programs on her system that can. Using production file category tags, a DIFS need only match content files with corresponding applications. The matching process entails matching tagged media files with corresponding handler applications. Users on different systems may thereby tap their particular system's potential.

An assured all-text version for every production ensures even wider reception. Virtually every system provides text display capabilities. Some systems provide even automated reading of text for handicapped accessibility. Furthermore, requisite all-text representations enable other DIFS features such as writing a book from interaction. Benefits of this or an equivalent bimodal scheme should become apparent as derivative features are discussed further.

One aspect of a DIFS is that the affectation by a participant of certain predetermined feedback causes automatic recording of a predetermined number of occurrences of other predetermined feedback without said other predetermined feedback actually being presented to the participant but rather assumed by the system to have occurred offstage. Meaning, one or more parallel stories (i.e. threads) can happen, can register logically in history, while a user interacts elsewhere within the system(TE).

<TE> Each event has associated with it, in addition to a playlist and a looping flag, a default value. The manner in which a DIFS advances will be discussed shortly. Suffice to say, one thread of units may advance past a timestep boundary necessitating synchronization. All current threads must then auto-advance to an agreed-upon next timestep. The agreed-upon next step is where all current threads have either terminated or contain a current unit. A current unit is a unit with at least one turn and at least one agent for user selection.

Some threads may get added along the way. Others may terminate trying to get there. Regardless, each must know how it is to auto-advance. A user may have interacted only partially or not at all with these threads. This is the purpose of an event default value. Events in units never interacted with by a user get their respective default value. Thereby, controlled progression of offstage events moves things forward in absence of user interaction.</TE>

Another aspect of a DIFS is system state-based updating of surrounding environment. <TE> As such, each unit of a DIFS should provide environment-update instructions capability. Carefully placed invocation routines employ these instructions at run-time in a DIFS application. Minimally, surrounding graphical elements should change to indicate unique aspects regarding unit context.</TE>

Discussed further later, instructions for this may consist of as little as a compatible image's filename. Additions might include background theme music and/or sound-effects. Great care ought to be taken in preservation of cross-platform/system compatibility. Especially considering most environment presentation ought likely to be handled by a general DIFS application(TE). Separate surrounding environment instructions may be stored on a per-control file basis, as well(TE). Thusly, each user-initiated selection of an agent potentially swaps-in a specific environment. Finer granularities of storage might be desired. The offered scheme minimizes design burden in this limitless direction. It also minimizes the toll more frequent environment-swapping may take on a system. Nevertheless, surrounding environment provides contextual cues to a participant as to his temporal and spatial progress through a DIFS.

The notion of a control file was mentioned briefly in the preceding paragraph. Agents 44 in a DIFS may consist of little more than names—text strings. Their true impact becomes apparent only upon a user's selecting one to be active. Only then must a DIFS provide active controls selection logic. For picking controls, a preferred arrangement enforces uniqueness amongst all agents in each unit(TE). Units themselves are unique amongst system data comprised of all other system data units(TE). It follows that a particular unit and a particular agent pair is unique in the system. Thus, a DIFS prefers mapping a control file to each such unique agent-at-unit location(TE).

By itself, this mapping provides only the beginning of active control selection logic. But a crucial beginning it is. A control file, once deduced, may further provide: the remainder of active control selection logic, all other aspects of relevant controls, environment instructions, and immediate feedback instructions. This last would be for defining a DIFS's highlighted feature of: immediate feedback during negotiation of a controls network by said participant indicating the likelihood of the occurrence of logical feedback units respectively as a result of interaction with said network.

A unit comes into focus when a user selects an agent from it. A unit may provide a special feedback production for introducing itself when the unit first comes into focus(TE). As mentioned earlier, this feedback introduces the unit so long as the unit's state remains unchanged. A user selects an agent from the unit to be a present active agent. If the unit is not already the in-focus unit, a DIFS application checks it. If checking determines none of the unit's turns have been used, its introductory feedback plays(TE).

Otherwise, checking determines that a user did interact with the unit. In this latter case, the most recent feedback from the unit's thread plays. However, certain other conditions must hold for the most recent feedback to play. The feedback must have originated from an event from the in-focus unit. Or, it must have come from an event of the most recent non-alias unit in the thread that led to the in-focus unit. Furthermore, no special unit-ending production (see below) may have been skipped. Such a skip may have occurred during the thread's auto-advance getting to the in-focus unit(TE). Alias unit specification follows in the next section. Aliases are basically empty, no-duration units containing only a critical line. They direct branching. A DIFS should take care to avoid capricious, excessive repetition. A DIFS furthermore never re-presents the same feedback production twice consecutively as a result of automatic playback on switching(TE).

Normal active controls selection and user interaction follows introductory feedback or lack thereof. An introductory feedback production, like a feedback production for an actual event for that matter, is not required(TE). Feedback productions exist purely for presentation to a user. Recording of event occurrence to feedback memory is a related but separate function(TE). The recording of feedback occurrence is what truly matters to an underlying DIFS. A DIFS functions in support of presentation, which matters to a user.

A data unit may also optionally contain special unit-ending productions for playing on branching(TE). A DIFS application plays these special productions in addition to, and after, other feedback from the final interaction sequence at the unit(TE). This feedback still fits quite naturally within the usual general control flow outlined. Where present, it really merely extends feedback played as a result of final interaction at a unit, during the unit's final feedback recording and presentation phase just prior to branching.

A System of the Parts

Referring to FIGS. 5a and 5b, a system map, consisting of such units as have been discussed, demonstrates key aspects. Each figure is a slightly different view of the same map. The top of this map represents earlier logical time, the bottom later logical time. So time moves forward going down(TE).

Topmost roots of upside-down unit tree graphs represent beginnings of threads, and come into focus first in order for their respective thread. Thusly, units never connect “up”, but rather down only(TE). In a running DIFS application, forward progression moves downward according to advance logic, which is a component of overall active agent determination logic. During the step involving user active agent selection, sideways movement within a timestep onto a unit of a different thread becomes possible. User active agent selection instigates this sideways jump between threads. Specifically, selection of an agent in a different current unit moves sideways. Only one current unit for each thread exists at any one time(TE).

FIG. 5a shows critical lines of logic for each unit, evenly numbered M2 through M36, respectively. FIG. 5b shows another view of the same system map only displaying the agents of each unit, again evenly numbered same as FIG. 5a, M2 through M36 respectively.

Various merits of the preferred data unit should be evident from these figures, actual modified snapshots of a DIFS editor at work on this particular system. Tolerating only single critical lines guides powerful, yet comprehensible design. Critical logic lines contain compound boolean logic capable of simple mathematical comparisons(TE). A DIFS designer may evaluate the powerful critical line logic by hand by viewing FIG. 5a alone. Clearly, binary branching also promotes readability without any apparent sacrifice of power. Given the expressiveness of each critical line, every branch or lack thereof becomes meaningful.

A designer may readily trace all paths and system states on FIG. 5a. Using FIG. 5b, she may also infer which agents are available under what circumstances. The map views introduce several more interesting concepts useful to a DIFS.

Firstly, an alias is a unit empty except for a critical line that refers back to some previous state(TE). Each contains no agents, but only a critical line as evinced by FIG. 5b(TE). “<<” and “>>” demarcate beginnings and endings of past-state references on alias critical lines(TE). The string of characters after the “<<” and before “:” indicate the name of the system from which a past-state reference draws(TE). Regular unit critical lines contain no such string or demarcation(TE).

The unit M2 48 exemplifies a special alias. This alias refers back to a previous system. The “S1.sto” as opposed to “S2.sto” on its critical line gives it away. The alias unit M1O below in timestep 2 also references the same state from the same prior system, “S1.sto”. Only this latter reference appears within a compound critical logic line that also references past state of the current system, “S2”. Obviously this alias sits at a lower (later) point in this system. For referencing purposes, this DIFS requires that all system names referenced be unique(TE).

The horizontal lines all the way across delineate the timesteps alluded to. <TE> As mentioned, these timesteps serve to synchronize the advancement of disparate threads. Whenever a user causes any thread to advance to a unit below the timestep boundary, the rest must catch up. They do not represent real-time passage during a live running DIFS in progress. Rather, time moves forward in turns in a running DIFS. Timestep boundaries indicate checkpoints that, when crossed, require all state above them to be known.</TE> The later section concerning operation treats advancing, and the role of timesteps, more fully. Discussion will also cover constraints on creation of system maps such as this.

An Active Agent Selection Interface

Referring to FIG. 8, a tried active agent selection interface presents selectable agents and commands 102(TE). This particular active agent selection GUI(graphical user interface) bears several obvious advantages.

First, it is simple and unobtrusive. Both compact and lacking ornamentation, such a GUI intrudes minimally in any system. By design, this interface belongs in a general DIFS application(TE). Relative invisibility of DIFS standard elements of the GUI foregrounds more important non-standard elements. The GUI occupies exactly the needed space. It serves its all-important functions. It presents a current group of selectable agents 96 and standard commands 98 to a user on demand. The menu shown below the typing user interface 92 and sequencing button 94 collapses. When a user presses the keyboard ‘Enter’ key the menu folds up(TE). When a user presses the up or down arrow key on the keyboard, the menu expands again(TE).

The simplicity of the interface invites easy user-mastery. A user may select an agent or a command any of several ways. He may expand the interface, click or keyboard arrow key to a line, and press the Enter key. Alternatively, a user may type the name of an agent or a command. Alternatively, he may left or right click on a sequencing button 94. Any of these methods puts the name of a command or agent into a typing input 92. Subsequent pressing of the Enter key on the keyboard completes a selection. Agent selection sets in motion active controls selection and interaction. Command selection executes a selected command.

The demonstrated selection interface lends itself to easy extensibility and re-use. This menu approach displays all available options no matter how many there may be. Adding additional commands and/or agents proves possible. Some implementations might separate commands and agent selection into two interfaces. In such a case, an agent only interface expanded might look like 100. Such an interface as 100 only with all commands and no agents could also work. Variations, of course, are possible but at minimum they must provide equivalent selection capability and extensibility.

According to another aspect of a DIFS, an active agent selection interface may exist purely at the code-level. In a completely non-graphical mode of operation, a dynamic interaction and feedback system has no user interface or presentation capability and said active agent selection interface is purely a code-level interface to enable active agent selection by a user via some other means. In other words, underlying functionality enabling equivalent interactive potential to that shown in FIG. 8 and described above, may prove sufficient in some manifestations.

As has been mentioned, a DIFS with a GUI may sometimes auto-select an agent. A DIFS as such employs both GUI and code-level active agent selection interface aspects.

Controls

Referring to FIG. 9, DIFS controls can come variously from a relatively broad range of interactive possibilities. FIG. 9 represents three broad example categories of potential control types: hotspotted text and images, and a 3D arcade.

A DIFS accordingly may present controls selected from the group comprising: selectable regions of text representing thoughts and feelings related to a present active agent that when selected may contribute to motivating feedback; selectable regions of an image representing thoughts and feelings related to a present active agent that when selected may contribute to motivating feedback; direct manipulation of a representation of an agent or a vehicle containing an agent through a simulated physical space; direct manipulation of representations of objects in a simulated physical space; games representing decisions an agent may have to make; games representing skills an agent may have to master; games representing state of mind of an agent; games representing obstacles and adverse conditions.

As described previously, interaction sequences of a DIFS may employ one or several processes. Essentially, a DIFS can pass-on work or handle more of the work itself. A preferred design for a general DIFS application handles much interaction itself using a multiplicity of controls(TE). The system enlists many ostensibly unordered controls and presents them one by one(TE). This is so that a user must pick from amongst many controls to affect results.

In most interactive formats a user must master an ostensibly finite set of controls. The typical game of interaction in this new format becomes, instead, understanding controls and selecting which one(s) of a multitude to use. This setup motivates understanding of character and situation, to which the controls relate. As opposed to having but one narrow way to participate, a user is presented with many alternatives.

Computers allow us to better see things through others point of view. This is quite possibly their greatest value. It is the value of the present invention, as well. Observant creators can now make DIFS's that allow us to explore the causes of conflict, strife, love, passion, war, fate, chance, and innumerable other aspects of the human condition.

Controls in a lineup may comprise clickable pieces of text such as 104 enlarged in the background of FIG. 9. Or they may comprise clickable images like 106. Or the controls may comprise full-blown 3D arcade sequences as in 108. Or, alas, they may comprise some combination of representations overlaid together and/or sequenced discretely.

These simple examples represent controls of a DIFS based on the children's fairy tale “Little Red Riding Hood.” At one point in some versions of the story, a huntsman decides to cut open a trespassing wolf character. It is an act that liberates two other characters from the creature's belly. The shown text and image controls might be part of the huntsman character's decision process at this turning point. The controls might exist amongst a pool of many other pertinent controls. A user would need to make sense of the controls to affect the outcomes. Outcomes can be those that together form the original story, or they can be other available outcomes.

Of course, the entire sequence could also take shape differently within a DIFS. One unified arcade in the traditional sense might return a single result. A DIFS application would then process the result to determine feedback and system progression. <TE> A DIFS application can serve as a full-fledged interaction engine in its own right. Or it can perform the role of a powerful centralized manager module. Or, it can do both.</TE> A DIFS thus facilitates dynamic, customizable interaction within a single manifestation of a system. Just like feedback, sequences of interaction are often best crafted a certain way. A programmer could write small modules for a user to play individual sequences or sub-sequences. A DIFS frees the interaction developer of sustaining continuity and the big picture.

A frame 110 around the text control illustrates another preferred mechanism of DIFS interaction: navigation. A limited ability to control navigation from one control to the next promotes strategy. In a tried implementation, it also neatly mimics the mental process of remembering(TE).

<TE> A user may gain some control over DIFS application-handled interaction by “bookmarking” controls. A DIFS application grants a user the ability to bookmark at most one control. A user may at any point after bookmarking a control, return to the bookmarked control. A returned-to control loses potency to affect outcomes, though may prove beneficial otherwise. The control may provide information or lead to other similar, though affectations controls.

While control sequencing is for the most part random, some general associative rules do guide it. In DIFS application-handled interaction, right-clicking directly on a control bookmarks it. Right-clicking on its frame returns to a bookmarked control if any. If no control was bookmarked, or a user left-clicked on the frame, the DIFS application chooses the next control utterly at random. If a user left-clicked on a control and a connection was associated with the region on which she clicked, the connection is followed. Its result is contributed to the race of outcomes.</TE> But this is getting deeper into active controls selection.

Active Controls Selection Factors

Referring to FIG. 11, active controls selection logic factors break roughly into six categories: story state, story attributes, control set attributes, control subset attributes, and user interaction. This section discusses examples of factors from each category.

Active Controls Selection Factors: Story State

Generally speaking, we have seen already how story state impinges on active controls selection. Story state informs agent group determination. An agent at a unit, being mapped to a control file in one DIFS implementation, implies immediately a discrete block of controls(TE). Obviously active controls selection logic may ask questions of history, the number of occurrences of past DIFS events. <TE> Preferred DIFS logic provides little support for complex, order of occurrence-tracking of events. It does, however, allow active controls selection logic to ask which event occurred last, most recently.</TE>

Recency concerns for control availability may also involve which agent was last selected. Were a current active agent reselected, the re-entrant status might bear significance to subsequent active controls selection(TE). An angry character might remain angry, or might forget his anger on immediate re-entrance. It is also possible a user may interact and affect no result; none, that is, but the counting down of a unit's turns(TE). Active controls selection logic could be altered, persuaded toward leniency, by user inefficacy(TE).

The reader has seen how special “butterflies”, state-based active controls selection logic of sorts, re-engage interaction(TE). Mid-interaction, special controls designated as “holes” may drop a user out of interaction as well(TE). Both of these—the automatic restart of active controls selection, and the automatic early ending of it by explicit specification that no next control is to be active—go directly to the heart of active controls selection logic.

Active Controls Selection Factors: Story Attributes

Story attributes apply particularly to each DIFS but generally over all respective DIFS's contents. In other words, all controls in an entire DIFS are subject to applicable story attributes.

A DIFS firstly may impose system-wide fixed presentation rules, such as strictly all-text only(TE). A DIFS application may interpret all-text as applying to controls as well as to feedback(TE). A DIFS specification as such, though strict, if adhered to by developers promotes easy generation of printed embodiments of each entire DIFS, controls (necessarily) included. Other story-wide presentation modality settings are also possible. Perhaps a DIFS provides three distinct presentation modes instead of two. The two suggested modes promote wide sharing and wide appeal respectively. Text mode provides most broad accessibility, while omni-media mode allows a dynamic multiplicity of diverse, technology-pushing media formats.

A compiled DIFS insists on a very specific DIFS application in order to run it fully- featured(TE). Various versions of a particular DIFS might exist as well. Were DIFS applications or DIFS's to advance at different rates, incongruities might arise. Version discrepancies might reasonably lead to active controls selection logic screening-out of incompatible controls. Especially regarding DIFS-handled interaction, versioning might inform control logic. For instance, later DIFS applications might natively support graphics or sound in addition to text for controls. At the present time of this writing, no DIFS application natively supports these controls formats(TE).

Other variables besides all-text mode or system version might guide active controls selection. In the interest of re-use, a single system might be recompilable different ways. A ‘Beginner Help’ switch may be thrown initially so as to familiarize users with a DIFS and its running application(TE). Helpful instruction might then accompany controls to facilitate a user getting started. Possibly, a ratings switch—this one perhaps available to designers and/or adult audiences only—could guard objectionable interactive content. A release setting might make available controls previously flagged as in-development. All such settings could factor into active controls selection logic, depending on the implementation.

Alternatively, system-wide modality settings might exist for handicapped or otherwise challenged-persons accessibility. Active controls selection logic might swap in substitute controls. The substitutes could well differ from the original controls in more than mere outward presentation. Difficulty also might be settable at the system level for users of varying abilities.

Obviously, configuration settings might interact with active controls selection logic. Presently, for instance, a tried DIFS application allows user specification of the standard text control window position(TE). Developers provide hardcoded, tailor-made interactivity programs through a system-wide configuration interface unavailable to end-users(TE).

Conceivably, a like-mechanism to the one used to specify external applications and their launch-settings for feedback presentation could apply to controls as well. 3D engine software or other interactivity programs might soon achieve a high level of generality. At such a point, it might make sense to allow an end-user to specify controls handlers as well. This, in turn, would require active controls selection logic to account for special circumstance cases. Notably, absence of suitable interactivity handler program specification for certain controls requiring it, might fork active controls selection logic. Regardless of implementation, all cases should be accounted for to ensure smooth end-user experience with a DIFS application.

<TE> Comrnand line settings of a DIFS application instruct system-wide change as well. For instance, auto-selection of an initial active agent is possible. Agent selection, as discussed, profoundly influences active control selection logic. In such ways, active controls selection logic may originate right from startup of a DIFS application.</TE>

Finally, one DIFS manifestation runs over communicating machines and involves communication between multiple user processes. Perhaps a same DIFS application as may run a non-communicating, single-player version runs such a communicating version. If so, a ‘communicate’ setting might influence active controls selection logic as well as overall general control flow.

With few exceptions, noted above with the usual TE tags, a current tried embodiment assumes outside resolution of many of these story/system-level attribute issues. Some of the dichotomies would be so profound as to warrant simply creating one or several entirely different but similar DIFS's. Should solutions prove popular or intrinsically useful enough, they might prove worth incorporating. As it stands, a preferred DIFS application includes only the all-text switch and beginner help switch; as well as optional alertion on program errors(TE). All three, as well as text control window configuration, are available to users and designers alike(TE). Only developers may specify interaction handler programs currently, meaning they bear the primary burden of providing these for each DIFS(TE).

External process invocation is not so much burden, however, as boon. Consider all that a DIFS framework provides. The DIFS gives the primary instructions ensuring a unified experience. The DIFS application assembles the experience based on the instructions.

Development of independent extension modules can focus entirely on implementation details of presentation and control. Disparate plug-in modules can be written in any language and with the absolute fewest number of constraints. A DIFS application—an operating system for digital stories—merely spawns off handler processes. Developers may employ what knowledge and skills they possess to fill these programs. Even if different ones of a team of developers know different programming languages, process spawns allow development in any language. The final DIFS can consist of only the DIFS application or a composited multiplicity. This scaleable solution invites everyone to participate equally and optimally. It best enables small teams of limited means and vast teams with comparably vast resources, alike.

Active Controls Selection Factors: Control Set Attributes

Control set attributes are header information to a control file, which is essentially a control set(TE). Control set attributes approximate character attributes when a control file maps to an agent. A preferred treatment of this level of attributes mixes its three general expressions interchangeably: psychological, navigational, and limiting. The first group, psychological attributes over a control set, nears traditional RPG obviousness of implementation and artificiality. Therefore a preferred implementation minimizes psychological attributes' prominence just as it minimizes attributes at this level in general(TE).

A DIFS may use psychology in the content contained in it. The underlying system should remain neutral on the subject. Developers and users may then read into DIFS manifestations what they will.

<TE> That said, at a control set level a preferred DIFS makes a provision for immediate feedback. This immediate feedback essentially consists of content filename strings. The number of these equals the number of unique outcomes that may result from interaction with the control set. This is the number of total feedback events in a unit from which the control set is invoked. In other words, each immediate feedback content file maps one-to-one with an outcome. In this way, appearance of immediate feedback may serve to indicate to a user higher likelihood of the corresponding outcome occurring.

A handler application shows this content whenever a DIFS application demands. The handler application is user-specifiable (and configurable) because the anticipated feedback are standard, non-interactive media formats.</TE> Possibly this handler application should not be user specifiable and/or configurable. However, a developer distributing a DIFS can instruct a user always to use her custom application, her way.

The anticipated feedback files here are image data of physiological changes in agents. Perhaps sound might work as well or so-called emoticons (e.g. from email) such as :) and :(. <TE> In all-text mode, a DIFS switches to show text for immediate feedback. Equivalent text feedback is deduced by taking specified immediate feedback content filenames and tacking a predetermined extension (‘.cap’ for caption) on their ends respectively. When necessary a DIFS application looks for equivalent text in files bearing these names.</TE> Immediate feedback data might be stored in controls or on the connection lines leading from them. However, that would require much more design for an effect that is realizable a different way already via the simpler means just described. In terms of re-use, it proved better to keep immediate feedback data at the control set level.

<TE> Otherwise, control set attributes really do involve mostly pure navigation and arbitrarily limiting the number of controls available. Two navigation-influencing integers, “focus” and “feedback”, are prescribed psychological terminology in the name of comprehensibility for DIFS designers. They are hardcoded numbers from zero to one hundred for each control set.

“focus” represents the probability that a connection with no hardcoded next control will lead to a control favoring a similar event outcome as the connection favors. This circumvents the need for each connection to connect explicitly to a related next control. Not requiring next controls for every connection makes designing easier. It obviates the need for a designer to manually link together a strongly connected neural network. Especially for text control-laden sequences, this proves an extreme benefit.

“feedback” functions as a probability determinant of whether immediate feedback, if available after a user left-clicks on a control, actually shows a meaningful or random clue about the control's favored outcome.</TE> The desired impact of these numbers is a controlled amount of randomness. Patterns should not be too apparent yet a user should rarely feel completely lost.

Scatterbrained, diluted, indecisive, schizophrenic, or daydreaming states can all be mimicked with a low focus number. From a user's perspective, related controls never seem to follow from one another no matter what. Conversely, a high focus might resemble concentration, dedication, sobriety, compulsion, or consistency characteristics, to name but a few. Similarly, high feedback might reveal consistency, predictability, confidence, and trust in others. How an agent looks outwardly, or at least the immediate feedback he triggers throughout a sequence, appears consistent with outcomes he affects and, thus, consistent with how he thinks and feels. A low feedback might indicate an agent's: state of reservation, uncertain self-knowledge, flamboyance, or eccentricity. These numbers are neither called by these terms nor intended to mean any one of them precisely(TE). They merely guide DIFS active controls selection and immediate feedback presentation. Interpretation is left to a user(TE).

Other designer specified numbers serve to set upper and lower limits on aspects of active controls selection. If no number is set for maximum viewable controls, half of those visible after all other filtering by selection logic provides a workable default assumption(TE). Otherwise, a definite, potentially lower maximum may be specified over the control set. The lower of the two maximum viewable limits is always used(TE).

This maximum limit regulates pacing. An agent alone with his thoughts or leisurely exploring might have a longer, slower sequence. A fight scene is perhaps better modeled using another spawned application. This or another situation requiring immediate decisiveness might be quicker, allowing fewer controls. A conversation involving an agent could go either way.

Ideally, control sets should not be downsampled based on these maximum limits. Rather, each presentation of a random control from the set counts against the maximum(TE). In this way, any of the set's viewable controls may be viewed. Each is equally available any time up to the end of the interaction sequence.

As has been stated, a DIFS recognizes the strong potential for inaction. This recognition saves on production work, mirrors reality, and poses a clear challenge for a user. To get an agent to do something that will affect change, a user should have some convincing to do.

<TE> Therefore, an initial magnitude is assigned a ‘nothing happens’ event. At design-time this remains 0 initially until otherwise specified. Each control having its own magnitude also has its own array of connections, each with an outcome respectively. As has been stated, when a user clicks on a control, its associated connection is followed. The control's magnitude is added to the current magnitude of the connection's favored outcome. At the end of interaction, whichever outcome has the greatest magnitude wins. Potentially this winning outcome is ‘nothing happens’. Therefore, an initial magnitude of the ‘nothing happens’ event poses a minimum influence number a user must exceed to get an agent to affect any event besides the ‘nothing happens’ event. Not so much an active controls selection factor, this limit nevertheless represents a control set-wide limit setting.</TE>

Run-time operation of a DIFS application shows none of these control set numbers to a user, but rather only presents controls themselves and immediate feedback(TE). Clever users will be able to infer these invisible forces after a very short while and adjust strategy accordingly.

Active Controls Selection Factors: Control Subset Attributes

Similarly intangible, control subset attributes contribute to active controls selection. Connections may explicitly inter-link controls into sub-networks(TE). During a user's navigation of such controls at run-time, a DIFS application would predictably select next controls. Negotiating controls by using them (left-clicking(TE)) traverses the sub-networks. The more such connections, the more the network overall operates along hardwired lines. Hardwiring encourages a strategy of memorization as much as understanding. In absence of explicit linkages, implicit groupings may guide controls' active selection by a DIFS application.

For instance, a certain group of controls in a file may each contain connections that lead to no specific next control. Each control in this implicit group instead, however, contains at least one dangling connection that contributes toward a certain same outcome. These controls' implicit commonality as such could provide a decisive selection factor.

Assume a sufficiently high “focus” percentage for the surrounding control set to which the controls belong(see above for description of “focus”). A user left-clicking on hotspots that follow connections leading to the common outcome would usually select at random controls from the implicit group to be active(TE). This demonstrates the provision of an important component of active controls selection logic. Namely, this interplay of control set attributes and control subset attributes provides a basis for active controls selection logic.

Active controls selection may also involve subordinating some controls to other controls. Many schemes could work. At design-time a developer may employ a graphical editor for controls file creation. She might lay out hierarchies through spatial arrangement of control instructions. At run-time, perhaps a DIFS could allow for control presentation not just sequentially but allow for several controls at once. Controls shown might demonstrate some functional relationship based on their presentation relative to one another. Certainly, at minimum general traces of groupings should somehow be discoverable to a user.

As for how a DIFS internally views control interrelation, many arrangements work. In fact, schemes as limitless as the study of neural networks could apply to control subset interrelation during design and running of a controls network.

A preferred DIFS implementation presents controls one at a time for simplicity(TE). In a preferred embodiment of a DIFS, static text and image controls equate to thoughts(TE). Perhaps other implementations could simulate control over simultaneous conscious and subconscious thoughts. Whether it is even possible to think consciously(or otherwise) more than a single thought at precisely the same instant is arguable. An acceptable code-level interface employed allows within one control the appearance of several.

A DIFS application presents each “control” individually to a user(TE). It applies active controls selection logic between presentations(TE). The big advantage of this organization is that it lends itself nicely to external process spawning. A single control may map to a spawned process(TE). Spawned processes may present actual interactive content in whatever way they choose. Furthermore, because active controls selection logic allows but one control at a time, confusion never arises over which application—the DIFS application or the handler process—should handle interaction. A handler process, when present, always implicitly assumes full control(TE). The handler process sits atop, initially, a full-screen DIFS application(TE). A user quickly learns she must negotiate the spawned material before proceeding.

For active controls selection logic, sometimes it is preferable to elevate the status of certain groups of controls over others. Several methods of such control subordination work appreciably in this scheme. Some work far better than others.

One method involves every control having a pecking-order number assigned to it. Each control has a unique such number. The number essentially instructs in which order to show available controls. One end of the spectrum represents earliest presentation order in the queue and the other end, lowest priority precedence. However, control sequences employing this device rapidly stagnate into predictability.

A modified approach involves allowing controls to share pecking-order numbers. Essentially, this is the equivalent of forming buckets of control subsets. Each bucket has its own priority, its own stratification in a layered hierarchy for when to show controls of the bucket. Still, taken together with all the many factors influencing active controls selection, this approach can require prohibitively complex design work. Take for instance, an interplay of maximum viewable control limits and pecking-order numbers. The combination might quite possibly put certain controls out of reach altogether.

Assume a set limit of 10 maximum viewable controls out of a set consisting of 30 controls. A designer goes for a certain effect by assigning pecking order numbers of 1 to all controls but one. This one control gets a lower pecking-order priority of 2. The remainder of active controls selection logic never winnows down viewable controls to fewer than 21 controls. So a full user interaction sequence always will view 10 controls. Even if visible after all other active controls filtering, the control with a pecking-order of 2 will never actually be viewed. It is easy to see how a developer might spend much time designing controls never realizable in the end system. Worse yet, a developer might not realize his error because of the complex interrelationships of competing factors.

The preceding example illustrates another important aspect of all active controls selection logic: factors involved ought not to conflict inherently. All factors should relate simply and obviously. Effects of tweaking should be controlled, contained, and relatively immediately knowable; inadvertent strong impact of other selection factors avoided.

A DIFS employs two favored solutions to achieve controls stratification(TE). Both are controls-centered. That is, the methods place the burden of controls selection at nearly the level of attributes of individual controls. Nearly, meaning although data in support of the methods is stored on a per-control basis, the methods essentially involve iteration over controls subsets to achieve active controls selection.

The first method involves giving each control a list of other controls whose availability make it unavailable(TE). A control from such a list may be available after all filtering except for the application of this method. If so, a control becomes unavailable if its list contains the available control(TE). For example: control A has a list containing controls B and C; control B has a list containing control A. After all initial filtering, control A and B are visible but C is not. Both control A and control B are subsequently made unavailable due to application of the described active controls selection method. Active controls selection logic overall has thus here determined none of the three controls is presently available. In such a way as this, a designer may achieve complex interrelational controls hierarchies. The problem of control screening logic is turned back on itself. No longer predicated on arbitrarily assigned, easily-mismanaged numbers, the new method depends inherently on controls availability.

Possibly a designer of a controls network desires a loose semblance of order. She does not wish for essential control availability to change. Rather, she wants to impose order on control presentation.

A second preferred method for controls stratification deals with this issue. On initial entrance into a control set via active agent selection, every control has a predetermined random viewability status(TE). This status instructs under which circumstances a control is to be randomly viewable. Qualifying circumstances are: ‘never’, ‘always’, ‘until viewed’, and ‘after viewed’(TE). As the name would imply, random viewability status affects only random selection of an active control. It does not affect arrival at an active control via a hardcoded connection.

In fact, the only way to arrive at a ‘never’ randomly viewable control is by a connection from another control, or if all other available controls presently have a random viewable status of ‘never’(TE). Those controls with a random viewability status of ‘after viewed’ essentially act as ‘never’ randomly viewable until viewed. Viewing such controls promotes them to the self-explanatory ‘always’ random viewability status. Conversely, controls with an initial ‘until viewed’ random viewability behave as though ‘always’ randomly viewable until a user views them. The DIFS application then demotes them to ‘never’ randomly viewable status once they are presented. Control promotions and demotions from initial random viewability status persist until a user selects a different active agent(TE). Of course, also just prior to advancing to a new unit, an interaction sequence closes down, destroying all this previous transient state(TE).

With random viewability statuses to go by, a DIFS application can favor earlier presentation of some controls over the others. Reasonably careful design ensures essential availability of controls goes unchanged. This criteria of active controls selection logic, like the aforementioned availability preclusion method, is relational. Its success derives from the fact that it relates to subsets of the network, and not merely to arbitrary assignment by a designer.

Active Controls Selection Factors: Control Attributes, User Interaction

Controls and interaction-level active controls selection factors should be obvious by now.

A DIFS may reasonably expect much instructive data at the individual control level to facilitate active controls selection logic. Heretofore tangentially mentioned aspects of control data as such may affect a control's selection to be an active control.

To be available, each control may require its own desired story state. In the interest of manageability, simple conditions involving story state exist at the control set level(TE). Every control in the set has its own requirement of how each condition must evaluate: true, false, or don't-care(TE). For each condition, a control specifies one of these values.

At run-time, the start of an interaction sequence evaluates conditions. For each control, evaluation at each condition is compared with the control's required state for that condition. Controls in a set also specify individually whether condition evaluation should be additive or multiplicative(TE). That is, whether evaluated<->required comparisons must match in at least one position (as though or'd together), or in every position (as though and'd together). Control requirements of story state for active selection are treated later in a case study. Numerous other schemes and arrangements may implement relation of control attributes and story state.

<TE> Relating to story attributes, each control has a type number. This number lets a DIFS application match it to a corresponding system-wide handler application. A control then provides its own launch settings in the form of a command line. As alluded to earlier under the story attributes description, inability to present a control as specified may result in the control's skipping.</TE>

Alternate implementations might match control set level attributes more closely with control attributes. Conceivably, a DIFS could employ RPG-like schemes to decide active controls selection.

Effects of controls, or more specifically in a preferred implementation effects of their connections, were discussed in the previous section on control subset attributes. Active controls may be selected on the basis of shared outcomes. Other individual control factors such as random viewability and lists of other excluding controls relate to control subsets. These factors all bear directly on active controls selection. Attribute data supporting these selection criteria are actually stored, by and large, at the individual control level.

Obviously control attributes and user interaction work together to affect active controls selection logic. Earlier, the section on controls presented a tried method for user interaction. Which region a user clicks on some controls—hotspot-based controls—helps determine a next active control(TE). Clicking on a control's frame instead of on the control itself may affect a different next active control(TE). The manner of clicking—using a right or left mouse button—determines progression(TE).

None of this, of course, describes external process controls or potential alternative interaction or its effects on active control selection. Additionally, a DIFS application might provide alternative strategic tools to the one offered “bookmarking” scheme. Another implementation might allow for more than a single bookmark. Returning to a bookmark represents direct active control selection via user interaction. Immediate feedback mechanisms could be more robust and structured, offering various cues to a user. Color, sound, flashing screen elements, and a generally flexible and reactive controls interface could further guide interaction. As shown, user interaction can prove a major direct and/or indirect factor of active control selection.

A General Control Implementation

Referring to FIG. 12, a C code listing is provided for representing a control generally. A DIFS application allocates this same structure repeatedly, once for each control(TE).

Each allocated control structure gets data specific to a unique control staged from disk(TE). To save memory, not that much data needs staging from disk. The structure is small and lightweight; its allocation quick and easy. It provides all necessary information for representing each control internally to a DIFS application(TE). A DIFS application, in turn, presents a control to a user. Possibly presentation entails spawning a handler process to present a control. Control presentation proceeds along structured but outwardly uncertain lines. Eventually an interactive sequence ends.

<TE>

The DIFS advances and/or a user selects a different agent to be active. The next interaction sequence destroys all data allocated for the previous interaction sequence and allocates control data anew.

Otherwise, no unit advance occurred and a user did not select a different active agent. The same agent remains the present active agent; controls remain in memory. However, system state may have changed from the last interaction sequence. Thus, though it may not re-fetch controls from disk, a DIFS application minimally must re-perform at least story state-based screening from scratch.

Referring to FIG. 12, an inode struct (the ‘i’ in inode short for interaction) represents a control. An inode's id integer uniquely identifies it amongst modes. As such, this number has many uses. Perhaps most notably, this id is the number cross-referenced by an iconnection struct's nextNode integer. Taken together, these numbers tell how to proceed between controls along a connection.

An inode's required_state string may consist of 1's(yes/true), 0's(no/false), and X's(don't care). A string of these values variously, succinctly gives a control's requirements of control set conditions concerning story state. These conditions are stored elsewhere in the same control file containing the control data. A orOandl uchar for an inode is a bit telling how to compare the required_state string to evaluation of control set conditions—additively or multiplicatively.

An inode's dont_load_node_idx integer array contains locations of other modes in a global array containing all inodes. In other words, integers in here refer to indices of this global array of inode structs. Each index locates a single unique inode—an equally viable alternative to inode ids for uniquely referencing modes. It may prove easier to perform equivalent remappings like this when staging controls data from file. inodes of a dont_load_node_idx array specifically are the list of inodes that if viewable preclude availability of this inode.

An inode's viewable integer is the result of its screening based on story state.

An nh_possibility integer introduces a new concept for a control. It has been stated previously that a ‘nothing happens’ event may win an interaction sequence. However, it may be that interaction resulting in ‘nothing happening’ actually causes a real event to happen. Inaction, too, by an agent might sometimes result in something happening, after all.

Which exact event happens for a nothing happens event, then, can be determined from viewable controls. To begin an interaction sequence, a DIFS application screens inodes based on story state. After each such screening, a DIFS applicalion holds a winner-take-all majority vote. Each viewable inode's nh_possibility represents a vote to determine an interaction sequence's ‘nothing happens’ event. An nh_possibility, then, maps to an event out in an in-progress DIFS.

The previous section on control subset attributes discussed control's random viewability status. inode random_viewability data represents necessary data for achieving this mechanism.

inode iconnection data represents connections from an inode. For each connection, a connectionNumber integer uniquely identifies this connection amongst other connections of the inode to which it belongs. nextNode is an inode, if any, at the other end of a connection—a notion described severally above. pNumber maps to an event out in an in-progress DIFS. Following a connection adds an inode's power to the event specified by pNumber. iconnection data except for connectionNumber is not required. However, an identifiably out of range number must be provided for no-nextNode and no-pNumber cases as such.

An inode's hole bit tells whether or not an automatic exit of an interaction sequence will occur on leaving the inode as a result of interacting with the inode.

inode power is the amount by which to increase the likelihood of a feedback event winning. Which feedback event it is, is specified by an iconnection's pNumber. A DIFS application adds this inode power on user interaction's having chosen the connection. Regardless of whether a connection leads anywhere, a valid pNumber-specified event receives the inode power.

inode type and playline relate to external handler program representation of this inode. They represent respectively a mapping to a DIFS-known handler application and a command line to execute the handler application. A default value for type flags the inode as a regular DIFS application compatible text control.

xtraData is a string for storing any extra data with an inode—intended for potential use primarily with the aspect of no-interface operation of a DIFS.

An inode's alltext bit instructs whether to present an inode in all-text form or not. A DIFS application sets and unsets this bit based on user interaction. An inode may store all-text control presentation data no matter what, regardless of whether it is specified as a default text type or not. bgcolor and width and height outline an all-text type rectangular region of a certain color. Separate GUI code capable of the tasks must handle this region's and contained text hotspots' display, and event-registering. inode hotspots represent traditional hotspots, with position, size, color, text presentation attributes, and optional text. Image hotspots could be trivial to add, though not as universal as text in some ways.

</TE>

Control Selection In Action

Referring to FIG. 13, controls actually selected from active controls selection logic fall into a relatively narrow category. A DIFS thus keeps a user's experience fresh. The scope of selected active controls, while intriguing and significant enough, may pale in comparison with the full range of controls in a DIFS. Controls in turn may result in a wide breadth of outcomes. Mappings may remain mysterious. Even for DIFS's short on content, the potential always seems to exist for seeing something new or rare. A user never knows quite what to expect. Controls usage thus optimized, a DIFS strikes the best balance between uncertainty and re-use to keep users coming back for more.

Anatomy of Active Controls Selection Factors' Inter-Relation

Referring to FIG. 14, the six categories of active controls selection interact to decide which controls to present to a user. Other implementations might lessen or heighten the influence of certain categories. One or more categories might be made to have no influence at all. In FIG. 14, a preferable relatively balanced approach by a tried implementation is shown(TE).

A state array 120, more understandable in a DIFS editor as a map of “moment” data storage units, plays a part. State will influence active agent, or character, selection at run-time. This selection in turn maps to a control set among all those control sets 124 in the DIFS. Slightly more difficult to see from this picture, state will also affect controls selection within a chosen character's control set 126. Story attributes 122 preside, system-wide, over the map of moments—the interactive story—including all data and control sets that all are essentially contained down inside the map.

Each disparate control set, as represented in 126, contains many potential control subsets, each with complex inter-relationships. Each control set also contains its own logical rules governing control selection of all subsets therein.

Controls can form control subsets unto themselves but more interesting subsets involve more than one control. Ovals around the control dots represent the many potential control subsets of the surrounding control set representation. Control subset attributes 128 help define special active controls selection rules.

A single control's attributes 132 ultimately allow or disallow its performing as an active control.

User interaction 130, from affecting state changes to configuring certain story attributes, from selecting character control sets to making sense of inferable character control set attributes, from negotiating controls subsets to the nuances of individual controls, ultimately influences active controls selection most profoundly. Arguably, this is the way it should be. As, in a dynamic interaction and feedback system, interaction defines outcome which defines interaction and so on. A user defines her own experience, creates her own history by interacting. These other nigh-equally potent forces balance things so that user interaction with controls goes smoothly.

A Controls Editor

Referring to FIG. 15, and according to the present invention, a rule-based editing and compiling machine enables DIFS creation. It includes human-readable instructions to generate dynamic interaction and feedback system data. An instructions interface lets a designer input said human-readable instructions to generate said dynamic interaction and feedback system data. A storage means facilitates storage of said human-readable instructions to generate said dynamic interaction and feedback system data. An alert means signifies that a dynamic interaction and feedback system using data generated from the current human-readable instructions may result in error.

At run-time a DIFS audience of end-users enjoys final output from DIFS editing. A user of a DIFS editor, on the other hand, might be one of many creative individuals. She could be a game industry worker, an educator, or a hobbyist. Anyone comfortable using computers and wanting to tell interactive stories might use a DIFS editor program. With few exceptions, representations in a DIFS editor bear little resemblance to a final DIFS output(TE). However, they invariably relate directly to it. Application and editor could be combined into one application. But as referred to here and in practice(TE), a DIFS application exists for end-user experience of DIFS's. A DIFS editor, more technical and exposing of, of the artifice of underlying mechanisms, exists to give a DIFS designer complete control over shaping a DIFS. Compiled, both programs have the benefit of being small, compact, graphically-accessible sets of instructions.

Originally, a preferred version of a DIFS editor suite contained two separate programs. This organization neatly followed the organization of system files in a DIFS: namely, one centralized standard format DIFS file referencing many same-format control set files(TE). A first program, then, enabled creation and editing of a DIFS file for central system data. A second application enabled working with control set files. Though the file organization remained, later in development it proved beneficial to combine these two programs into one(TE). This was because control files proved inextricably dependent upon main file references.

FIG. 15 demonstrates a control set editing module of a larger unified DIFS editor. A control set from a “Little Red Riding Hood” example populates the module shown in FIG. 15. A user of a DIFS controls creation tool as such may set interaction parameters. He may set control set parameters such as “Max. INodes” 134. Discussed previously, this value limits the number of controls a user may view during an interaction sequence. The “Max. INodes” field allows a user to type this number into the field. Clicking the “Save” button (see below) commits to file this change of “Max. INodes” and other changes made for a loaded control set(TE). Changes saved to file will be realizable in a DIFS after compiling a DIFS system(TE).

<TE>

The “of” field to the right of “Max. INodes” is not directly editable. It reflects instead the overall number of controls in a control set file. Some functions of a DIFS editor may exist purely to reflect DIFS data aspects to a user. A control set's total number of controls is not editable, but it bears importance for many reasons. This total indicates the number of controls in a set. It helps a user of the editor see the big picture, the forest among the trees. Should all controls in a set become viewable after screening by story state at run-time, this total may limit interaction.

As discussed, number of controls viewable divided by two provides another maximum limit. A DIFS participant interacting may view controls numbering the smaller of this limit or a “Max. INodes” specified. Then an interaction sequence automatically terminates. Obviously, an editor program should reflect back useful DIFS information, editable or not. Doing so helps to manage creation of a DIFS. After all, per DIFS specification, a DIFS must display the quality of being human-readable at some level.

Along the top of the shown interface other buttons facilitate highly useful functions. “Find” allows searching on text strings throughout inodes' data. “INode” creates a new inode, or copies highlighted modes if a user right-clicks. “Import” lets a user import copies of inodes from other control files into the loaded file. “Save” saves a control file. Actually, “Save” from this module of the editor saves instructions to generate controls. This is consistent with a DIFS's aspect of storage means for storage of human-readable instructions to generate DIFS data. A file saved using this “Save” function is not necessarily on its own humanly parsable. But it stores human-readable instructions. “Save” stores also additional data to assist compiling into a true control file and to assist formatting in this editor. Interpreted using this editor, contents of files saved by it are very human-comprehensible. Comprehension, as noted, begins user control over design of a DIFS.

An upper-middle panel of this editor pertains to data of selected inodes of the controls map below it.

An input for command line arguments 136 displays a command line for a singly-selected inode. FIG. 15 shows inode ‘1’ 148 selected. ‘node’ to the left of the command line input 136 displays ‘1’ below it, signifying single selection of inode with unique id ‘1’. Typing to affect change in this input changes the command line of any inodes selected to match. Thus this input serves a dual purpose: to display and affect change in inode command lines. An inode command line, as described, instructs how to present an inode when the inode's type value is not a predetermined default value.

A type menu button 138 shows a singly-selected inode's type value number, here ‘1’, and corresponding handler application name, here ‘aimv.exe’. A user may define type value<->handler application pairings elsewhere not shown in FIG. 15. Clicking on this type menu button pops a menu of type value(number)<->handler application(name) pairings defined for the DIFS. Selecting in this menu a different control type, including ‘0’ for a default value, changes selected controls' respective type values to match selection in the menu.

For selected inode ‘1’ in FIG. 15, a DIFS application would spawn a process to represent this control. The spawned process would execute as though issued from a command line:

aimv.exe “tattered_cloth jpg” “tattered_cloth.aci”

Clicking a ‘Preview’ button simulates this execution so that a user can see what a control will play like, and perhaps make desired changes accordingly. If type for a control is a default value, pressing ‘Preview’ invokes another special editor sub-module for viewing and editing standard hotspot text control data. As stated, an inode keeps hotspot text control data even when switched to a different type number.

A user may wish to switch a control to and from default later without loss of text setup or command line work. Or a DIFS application user may toggle to and from all-text mode at run-time. All-text mode requires every control keeps sensible all-text data. Keeping an all-text version handy for each control promotes general control expression, and features based on text, among other advantages. For multiple selected inodes, the ‘Preview’ button allows en-masse viewing and editing of selected mode text data. It also allows sub-selection based on mode type and various other presentation attributes.

The blank button between ‘Preview’ and the command line entry input serves another purpose. Clicking this button calls up a module for adding-to or changing selected inodes' additional data. Additional data may comprise any information expressible within a single string of arbitrary length. A creator can provide her own formatting. The module also contains a single, multi-line additional data entry input for definition of an additional data string at the control-set level as well.

Additional data can represent anything. It may serve a functional purpose or not. Its optional definition and handling is left entirely to a user. The idea here was to allow additional arbitrary storage space for undefined information. In this way, for instance, a user might send special instructions to a separate spawned application employing a no-interface version of a DIFS. Extra data might instruct formatting of controls or address which feedback event recording should initiate a segue back to main DIFS application handling. These storage envelopes allow a user to tuck away hidden, extra needed information. A DIFS application never directly uses it itself. It does, however, load it for ready availability within its organization for any conceivable use.

For editing, a user may store extra data at system level in the form of filenames. Compiling a system file into runnable data removes this list of strings from the resultant file, but in an editor program it serves a purpose. A user clicks the ‘<->’ bi-directional arrows button (right of the command-line input 136) to see this list of filenames and select a filename from it to insert at the command-line input's 136 cursor. In this way a user may insert standard, commonly-reused filenames quickly and accurately into selected inodes' command lines.

Down below ‘<->’ and the command-line input, a rounded field 140 to the immediate right of a ‘Power’ button displays a power value, here ‘4’, of a singly-selected inode. Typing in this field and pressing the ‘Enter’ key on the keyboard edits the power value of a singly-selected mode. Other sub-modules (launched from the aforementioned ‘Power’ button) let a user view and/or edit simultaneously multiple inodes' power values. As discussed, typical interaction involves a DIFS application user interacting with a control. Active controls selection logic then determines where to go next. At determination, a DIFS application adds an inode's power to a favored feedback event. At interaction sequence end, the feedback event with the highest accumulation of power wins.

Of course, many variations on such a race are possible. A race could involve multiplying instead of adding numbers. Really, feedback event competition by any number of other horse race like schemes could work. Mainly, user interaction ostensibly should affect the outcome of which feedback event wins. For this reason, a preferred embodiment couples influence over feedback competition rather tightly to controls. A control is the expressed standard unit of interaction. An integer power point is the expressed standard unit of influence over control feedback competition. That said, the expressed implementation stresses careful balance of power amongst a control set's controls.

In an effort to facilitate power management, a DIFS controls editor enforces strict guidelines on inode power allocation. On creation, an inode gets 0—no—power. The pool of total power in the set, meanwhile, increments by 5. Thus inodes initially have no influence, mandating a user's conscious decision to assign it. Assigning power to an inode takes away from the pool of free, available power. Power can only be assigned up to the amount of free power remaining in the pool. The larger rounded, non-editable field to the right of the inode's individual power shows power remaining in the pool. In FIG. 15 the pool contains ‘32’ unallocated, freely available power points as such.

Every time a user distributes control set power, these rules force conscious decision-making. To give power to one control necessarily requires either depleting reserve power or redistributing. Strengthening the influence of certain controls clearly and immediately weakens the power available to the rest of the set.

In other words, the numbers mean something. The editor limits power in order to make it a shared resource. Were power allowed arbitrary assignation, a user might never understand resulting power distribution. Non-relationally ascribed influence might easily add up to nothing but uncontrolled, incomprehensible mayhem. Left to his own devices, a user might come up with his own perfectly viable scheme for power management. Even if he were to hone an acceptable balance, he might forget the next day what the numbers meant interrelationally. A rule-based editor, like any stable API or compiler, never forgets to enforce the rules.

Nothing was lost by this power allocation enforcement scheme. The scheme is generally reusable and adds much value to any design process. The chosen method works generally, and well, adding no unnecessary work for a user. The only downside: the controls editor needed to be made robust to handle enforcement. For instance, deletion of a control requires removal of exactly 5 power points from the control set. At least that many power points must exist in a combination of a to-be-deleted inode's power and the free pool. Otherwise, the editor disallows inode deletion until 5 power points do become free to delete. A rule-based editing and compiling machine of a DIFS assumes such burdens in the name of smoother DIFS design process facilitation.

To the left, a tall panel contains state screening logic data and ‘trace’ and ‘key’ clickables(top), as well as user notes(bottom). The latter ‘Notes’ field serves purely for a user to type summary text. This text may later remind her about important aspects of the control set she devised. A ‘Trace’ button and sub-module allow a user to provide further meta-cues. Using ‘Trace’ she may define various colorful rectangles behind nodes out on the map to visually hint at groupings. These traces serve no functional purpose, but greatly help keep things organized. ‘key’ brings up the ‘Outcome Key’ sub-module depicted (bottom-center of FIG. 15).

A ‘Condition’ button 142 conjures a module for defining control set conditions 142. Conditions, discussed above, are simple true/false questions asked of system state. They are perhaps best thought of as requisitely-short critical logic lines. A preferred DIFS controls editing rule requires control set conditions be kept extremely short to promote readability. A controls editor module puts no restriction, however, on the total number of conditions in a control set.

A single control set exists in a single file. It serves to provide interaction and presentation data, and active controls selection logic. It is generic in a sense, detached in many ways from main central logic of a DIFS. Reasonably speaking then, certain control set design and/or main central DIFS situational logic may intend a control set's inherent re-use.

Instead of requiring the same control set file be copied over n-times, perhaps tweaked each time over, a controls editor module specifies certain logic hooks generically. Specifically, the module has knowledge of which unit a loaded control set will get used from. This and system logic synchronization in general necessitated controls design be a part of system design editing. Hence, the controls editing module became part of the main system editor.

Within the same editor, the controls editor module knows a unit point of reference. It then carefully treats all references to unit events with its own substitute indexing local to the control set. Other system state queries—those outside the reference unit—directly query system state as though from a unit critical logic line.

This arrangement serves to distinguish past-state conditional logic from (present) local unit state conditional logic. It also sets apart a control set's feedback events. These feedback events are necessarily unit events—those of the set's agent's unit. A control set's separation-out and generic treatment of local events make the control set referenceable from more than a single logical location out in a main DIFS.

Reference to the control set becomes somewhat transplantable in main DIFS logic. The outlined scheme achieves these benefits without necessitating wasteful recreation of multiple physical copies of the control set file. Generic hooks mean a control set is never entirely independently meaningful, of course. Only when interfaced within the context of a unit, for instance, are actual feedback events known. It is a limited but sometimes important modularity dimension to DIFS controls set design.

So really, when a user defines events for a unit out in a DIFS editor main, she is, as DIFS specification implies, providing a set of logical feedback units which may result from interaction with controls.

She provides conditional availability restrictions for each control in part by selection of modes and clicking on condition evaluation requirements lines 144. These lines reflect the present condition evaluation requirements of selected inodes. For more than one selected mode not in agreement about how a particular condition ought to evaluate, a red question mark appears on that line. Clicking on a line toggles between ‘Y’(yes) ‘N’(no) and ‘D’(don't care) (implemented with the respective underlying values 1, 0, and X as described before).

Clicking also, of course, changes selected inode condition evaluation requirements in corresponding positions. These are the modes' respective demands for each condition's evaluation. System state must meet the demands before these inodes allow themselves to become viewable. The and/or button above behaves the same as the other condition evaluation requirements lines 144 except that it toggles between ‘and’ ‘or’ and, in case of disagreement the red ‘?’. It should be noted, mere disagreement between multiply selected nodes affects no automatic change of any sort. It merely serves an informative function.

The same goes for the ‘Expanded’ button which toggles the controls editor to and from a ‘Shorthand’ view mode. The mode of viewing does not affect anything but editor display. ‘Shorthand’ shows unit event references in the controls editor module using their actual underlying local indexing. This view can help with understanding and working with a control set linked into a DIFS severally. It can also help a user repair broken control set logic caused by later editing of a control set's unit(s) of reference.

In fact, broken control set logic may involve a unit of reference or other units for that matter. Basically, a control set is its own file a user stages data from into the editor only on demand. This traditional strategy is practical and stable, saving memory resources and file management errors. It also, however, lets control set files perpetuate references to since-altered or deleted feedback events. File I/O operations on all control files for every event feedback change would prove overly taxing, worsening as a DIFS grows. For lack of synchronization, compiling nullifies completely dangling logic from compiled control set files. However, this may still lead to unpredictable and undesirable results. Therefore, the compiler also warns upon finding such problems.

For this reason, a controls editing module when loaded with a control set does perform fast, in-memory synchronization with feedback event modifications of any kind. When errors result, user alertion follows. The editor changes the text color (from yellow to red) of erroneous references.

Even moving other units around on a system map may trigger alertions. A DIFS allows a control file to reference all feedback events up to and including the current timestep, including feedback events from other threads.

Say a user transplants certain units containing certain feedback referenced by a control file. He moves them from above(or beside) and before(or during) to a lower, later timestep. Thus references in the control file effectively reference unavailable, unknowable state. A change in color immediately flags any such loaded references. Initial loading of a control file with bad references produces the same effect. Bad references get offset by color, clearly marked as in-error. This is consistent with a DIFS's alert means for signifying that a dynamic interaction and feedback system using data generated from the current human-readable instructions may result in error. Alertion mechanisms as such are designed to help a user identify and fix problems easily and early for cleaner resulting DIFS's.

The controls map area 146 shows graphically the aspect of a DIFS of a loosely connected network of controls. A user may click and drag these around anywhere in the scrollable map area.

Text on each graphical inode representation may auto-scroll sideways like a banner to help display long strings. The strings are concatenated to the stringified control id number and a colon, ensuring their uniqueness. They are arbitrarily assigned from the ‘Preview’ window in the interface that manages text representation of a control. It made sense that a user would provide identification text from representation text of an inode.

Framing each inode is its power on the left and type on the right. Sometimes for quick reference, a DIFS editor will present crucial, sufficiently condensed information redundantly. It must also, of course, take care that this information is updated everywhere as necessary.

The map displays the name of the agent. An agent name is not stored in a control file but deduced from steps a user takes to load it. This lets agents with different names or locations use the same control file, though such cases might be rare.

Traces and connections occupy the map space between inodes. Onscreen these bear various colors that help a user distinguish them. Unlike DIFS units, inodes may have any number of connections both to and from them. inodes networks are more free-form, more of a neural network than the more rigid and directed flow graphs of units that represent main DIFS system state logic.

To work with an inode's connections, define it as a hole, define its random viewabiliy status or its “don't load if these nodes are available” nodes or ‘nothing happens’ possibility, or any of its other navigational or visibility traits, a user clicks on the round circle at the bottom of the mode. If more than a single node is selected, doing so conjures a parallel sub-module for doing the same over a group of inodes simultaneously. A user also may move modes simultaneously if more than one is selected when trying to move one of those selected.

So far we have seen that single and multiple selection of modes mean different things to this controls editor module. Colored boxes overlaid on the map around selected inodes denote their selection status. The various traditional and recognizable selection options of keyboard shift and control states enhance an already-powerful drag-out a rectangle with the mouse and all nodes inside it get selected strategy. Filter-by-finding and subsequent auto-select options exist as well.

The fuss over user inode selection methods and the provision of group operations for all single inode functions can be summed up simply. It saves development time. Just as importantly, these tools help form implicit subsets that are important to active controls selection logic. Really, the tools help create the essential challenge, the problem and solution a DIFS application user will face when confronted with a mysterious array of interrelated controls. Subset operations facilitate creation of patterns, larger puzzles that if mastered may consistently affect interesting feedback as a result.

Another mode of operation of this controls subset editing module simulates run-time system state screening of controls. inodes on the map appear and disappear when a user provides pretend values for feedback events via another sub-module. This editor also grants a user other unshown, detailed searching capabilities and statistical information gleaned from a loaded control set.

A variously navigable key module shows the set of logical feedback units which may result from interaction with controls of this control set 150. A user may rearrange the feedback events' aforementioned local mappings. To do so, he need only click and drag on lines in the ‘P:’ browser. Feedback event ordering is fixed. But by realigning the local indexing beside desired corresponding feedback events, a user may change how unit references throughout the entire control set interpret local unit feedback events based on a new mapping. This saves a lot of error-prone repetitious work whenever small changes are made to a unit's event feedback. With this mechanism, a user need only to determine how to remap things, click and drag a couple of times, and click ‘Save’ to fix the control set.

As promised earlier, immediate feedback instructions 152 map one-to-one with feedback events at a single localized control-set level. In FIG. 15 the instruction filenames shown refer to image files representative of physiological states of the agent to be presented during interaction with this control set. This particular DIFS's metadata concerning setup would instruct a DIFS application user to specify a character viewer capable of displaying jpeg images. More on metadata will be discussed later.

Best-guess probability estimates 154 show respective odds on feedback event' winning a sequence employing this control set. These numbers are based on gathered statistical information entered into predictive calculations. They are not necessarily foolproof assumptions. They do a neat trick, however, of providing reasonable metrics as to the relative difficulty of affecting one outcome over another.

A user may also view a deduced reference count number of how many different agent<->control file pointers a DIFS at large maintains for this control file 156. A number greater than 1 serves to remind a user gently that editing the control set affects more than a single interaction sequence.

Compiling of a control set does not remove condition errors resulting from pre-references, for instance. Rather, during final DIFS operation unknown state, for conditions involving events that exist albeit later, evaluates to 0. This ensures that the entire control file is available wherever it may be used, as a DIFS may use it severally. A designer should be kept aware of its re-use, however. This is the reason for the stated reference count number display for the control set file.

Lastly, numerical control set attribute inputs 158 of Feedback % and Focus % let a user define respectively: the probability that immediate feedback will match the associated immediate feedback (instead of being chosen at random); and probability that following a first connection with no next control specified will yield a control with a second connection, where the second connection contributes to the same feedback as the first connection. Another numerical control set attribute input discussed previously, the one for ‘initial nothing happens power’, is out of view in FIG. 15.

</TE>

DIFS Application Run-Time Data

Referring to FIG. 17, a DIFS application stages saved or initial run-ready DIFS data into data structures for operation. It may stage data into static and/or dynamic caches. That is to say, staged-in data variously may never, occasionally, or frequently change during course of DIFS application operation. FIG. 17 presents a working, tried arrangement. Indexing in FIG. 17 for each storage container is shown to start from 1 because it is intended as a general specification not colored by any particular programming language conventions.

In practice, such as in C/C++ for instance, this indexing might actually start from 0 or follow another common technique. Code listings in the operation section assume indexing from 0 as in C++. Indexing mentioned here in this description will match FIG. 17 instead for consistency's sake. Please note that actual coding of the specification of FIG. 17 would likely index differently than what is shown.

Proper run-time data storage ought to help optimize DIFS application functioning. This storage remains resident during potentially taxing feedback and controls presentation. It should be efficient, its footprint in memory minimal. It should likewise keep resident enough information to minimize fetching from disk. Neither should its own use require prohibitively expensive functional loops. A proper data organization such as the one provided solves many such issues.

A tried implementation fixes array sizes in the name of simplicity(TE). Simplicity promotes stability and consistency. The system data footprint of every DIFS loaded into this DIFS application remains the same, populated or not. This is not wasteful as might be imagined, because the overall size remains negligible. Static storage means a reasonably high limit exists for the maximum feedback events allowed for a DIFS, for instance 1000(TE).

<TE>

A state main matrix table T2 keeps an ordered index of all data units staged from file. Each row contains a feedback event's data; each column a property of the event. Note that one additional non-event feedback event is stored for the beginning of every unit.

This “state main matrix” table preserves the separate identities of disparate static data units, albeit unobviously. In an editor, they may have been human-parsable, graphically represented. Here, each feedback event of a unit occupies a contiguous row. That is, all feedback events of a unit are stored next to one another in the state main matrix. Furthermore, each feedback event row contains as one of its properties, the row number of the first feedback event in the unit.

Units, here blocks of contiguous feedback events, also retain order respective to one another. Order of units in a DIFS editor bears enormous significance. A state main matrix, thus, preserves this order information. Earlier blocks of contiguous unit feedback events precede later unit feedback blocks. Note that loading this state main matrix table need not fill it completely.

The SMM T2 reserves as empty its first two rows. Thus, the first unit of a DIFS has its data actually start at SMM index 3. This is to avoid confusion with special values. Namely, the first index, and negation of the second index are both special event occurrence values. These mean respectively did not happen and unknown. The did not happen case must remain distinct.

As for negation of the second index to indicate unknown, this negative number also must remain distinct. However, negation of an SMM index on a critical line already means something. It is shorthand for “substitute this event's occurrence value here”. The negative sign is to distinguish an event reference from a regular numerical value. Both can be comparators. Thus, reference to a first unit's starting row must never be confused with the negative number meaning unknown. Thus, a DIFS's first unit must start from a third index.

Furthermore, certain data also repeats predictably. It exists to distinguish unit attributes, not finer feedback attributes, and so repeats inside a unit block. The table may store these integers redundantly or once per unit block. Numbers such as timestep for instance remain constant for all feedback events in a unit. Feedback memory of this DIFS comprises the first number on each row. This number is the number of occurrences recorded so far for the event of the row. As stated, a special negative value (−1 for the tried C++ implementation) marks a feedback event's special unknown state. A DIFS application may handle unknown state differently than 0 occurrence state in some instances.

A current moment matrix T4 tracks which units are current. As stated previously, only one unit may be current from any single thread. Yet several threads may be active at once in a current timestep. So this current moment matrix tracks information regarding a potential multiplicity of current units.

Each row in this matrix contains firstly a current unit's state main matrix table index. This index is the state main matrix table index of the lowest-index feedback event of the unit. The same description means the same throughout this specification: “a unit's state main matrix table index” is intended to mean this lowest-SMM index feedback event of the unit. Additionally, a thread number for a current unit is stored on its current moment matrix row.

This is redundant, but helped minimize confusion during development of this DIFS application. In the interest of stability it remains, and also to illustrate the purpose of the current moment matrix. This matrix table permits the feature of multiple separate threads of action.

Lastly, the table stores on each row a current unit's maximum allowed turns counter. It is in this current moment matrix table that the DIFS application changes this counter. Its original copy in the state main matrix table remains always the same for future reference in case a user performs a restore. When the DIFS application adds a unit to the current moment matrix, it adds the unit's original maximum turns allowed (plus any inherited turns). Subsequently as necessitated by interaction at a current unit, the unit's counter decrements. Should it reach 0, the DIFS application may instigate an alternate means of termination for the unit. Whether a count-up or count-down scheme is used does not matter. What matters is that current units remain current only for as long as their maximum allowed turns allows.

A moment characters matrix T6 facilitates population of an active agent selection interface. Agents of units in the aforementioned current moment matrix, i.e. of current units, make an agents group. A user selects an active agent from amongst this group. To operate smoothly, a DIFS application needs easy access to each unit's agents list. This moment characters matrix provides unit' respective agents lists. This matrix is sparsely-populated. That is, only the rows at unit boundaries are allocated and store agent information. Its size equals the state main matrix table's size for simplicity. References are straightforward, while space is conserved. The maximum number of DIFS units possible equals the number of maximum feedback events. Only rows at unit' state main matrix indices contain real data here.

A criticals array T8 keeps static, compiled critical branch logic lines for each unit. These strings do not change. They represent logic conditions into which the DIFS application substitutes story state.

The DIFS application uses basic, hardcoded pattern-matching and relational techniques. For instance, “−6|−10&−4=3” might, depending on implementation, instruct run-time evaluation such as (in C/C++ syntax, with SMM index 1's corresponding to event number of occurrences as in FIG. 17):

if(StateMainMatrixTable[6][1]∥StateMainMatrixTable[10][1]&& StateMainMatrixTable[4][1]==3){. . .

The negatives preceding certain numeric characters distinguish those digits so that a DIFS application does not interpret them as regular numbers. The negative sign instructs state main matrix event feedback substitution using state main matrix occurrence values at the successive digit. That is, the digit is the SMM index of the feedback event to be referenced.

Of course, this example is simplistic and incomplete. For instance, aforementioned unknown occurrence values might slip through. Unknown values should preclude evaluation. Obviously, full, robust evaluation logic handles potential cases as such correctly and efficiently. This array is sparsely populated to contain critical line data only where it is necessary, at state main matrix unit indices, yet allow simple referencing based on state main matrix unit indices. This is the case for all size-N stores in FIG. 17 and will not bear repeating here subsequently.

A moment from character array T10 helps determine a current unit from any of its agents. For user selection of an active agent or elsewhere during operation, this capability obviates inefficient roundabout searching.

A feedback identifiers array of reference numbers T12 provides useful progression metadata. Other interactive software products employ various cues to guide and reflect user progress through them: section numbers in on-line lessons, progress bars variously, and points amassed or levels passed in games. A DIFS may provide simple reference numbers to pinpoint turning points. A unique reference number appears in conjunction with corresponding feedback. By this number a user may always know exactly where he is in a DIFS.

A productions string T14 represents a highly significant component of DIFS feedback memory. Event feedback information augments this string when an event occurs and yields a production. Subsequently, this string serves as a record of all production-yielding interaction. It contains so-far the story of the system assembled out of user interaction. This string allows rewinding and replaying of what has transpired in terms of productions.

A second string pointer, not shown, holds an offset into the productions array. This offset is the current position. Rewind moves the pointer to the previous position. Fast-forward moves the pointer to the next position. Immediately following each position are three standard pieces of data. FIG. 17 shows these pieces of data under the PRODUCTIONS STRING heading.

This productions string information is particularly useful to user-initiated restorations of previous system states. These restorations should restore to expected prior state when a user initiates them. A favored method of restoration has a user rewind to an event and instead of replaying it, issue a restore command. A user reasonably expects a restoration to consistently restore system state. The state consistently restores to as it was either before or after an event production, but consistently one way or the other.

However, certain event feedback occurs not as a result of actual event occurrence. That is, a DIFS plays and records feedback productions that result from unit introductions or unit endings. A DIFS restoration handles special cases uniquely so that restore behavior always follows a predictable pattern.

A tried DIFS application takes restore to mean ‘put system state to as it was just after a rewound-to event’. Thus, unit introduction productions pose no problem. Rewind to feedback recorded prior to unit-ending productions, and issuance of restore, however, must not split two consecutive productions that essentially resulted from a single event. Thus, the storage scheme shown in FIG. 17 enables smooth restoration past these special trouble spots. Normal event occurrence and presentation records a feedback event's production filename, state main matrix index (feSSMi), and occurrences (StateMainMatrix[feSSmi][1]).

Special unit-ending event feedback records its production filename but negates its state main matrix index. This out of bounds value signifies that it is a special unit-ending record in the productions string. Then, a unit-ending feedback record further indicates unit status in the number normally reserved for feedback occurrences. The number recorded here is the unit maximum allowable turns minus all unit feedback occurrences summed.

For a unit that inherits turns, maximum allowable turns is the total inherited turns. In this case, an algorithm seeks the most recent previous unit with a non-zero duration of the current unit's thread. The algorithm performs reverse-traversal of the restore vector to find such a unit. During traversal, a number accumulates the sum of all thread event occurrences along the way down to and including the non-zero duration unit's events. This sum is subtracted from the non-zero duration of the found non-zero duration unit to get a final number. The final number represents the number of ‘nothing happens’ events that may have occurred at the current unit.

All this fuss is to determine if any ‘nothing happens’ events occurred. They may have contributed to an automatic ending of the unit, and the recording of the unit's special ending feedback. If so, restoring to after a feedback prior to the unit-ending feedback restores to before the unit-ending feedback. Otherwise, such a restoration restores system state to as it was after both feedback productions. No actual information whatsoever is kept for ‘nothing happens’ events. Keeping ‘nothing happens’ information would be wasteful and could easily get out of hand. Keeping less state requires special tricks, such as the one described, in some cases for deriving ‘nothing happens’ occurrences. This situation is acceptable because the few computations that need the information can get it on an as-needed basis.

A most recent possibility matrix T16 remembers which event happened most recently for each thread. It is like the current moment matrix only at the finer granularity of individual feedback events, as opposed to units. This matrix exists for evaluating the special cases of interactive sequence control set conditions. Special conditions involve ‘last event’ and/or ‘nothing happened’. The most recent possibility matrix represents the latter by changing the polarity from positive to negative of the current thread's last event number in this matrix. The DIFS application does this to retain the fact of ‘nothing happens’ having happened without losing the last actual user-affected event.

A productions matrix T18 stores the detailed instructions for presenting event feedback to a user. The earlier section concerning a unit of storage described this data necessary for event presentation. Additionally, for entries at unit indices, this matrix keeps a restore vector index of where in the order a unit's introduction production was presented. A restore vector (see below) keeps a running record of feedback occurrence as it occurs, in order.

However, unit introductions may happen repeatedly until a user influences unit state in some way. Otherwise, she may periodically switch to a unit, see introduction feedback, but affect no change. This special restore vector index here in the productions matrix enables a DIFS application to remove the previous introduction entry from the restore vector. A previous entry of the production is also removed from the productions string T14. Then the entry is re-added to the end of both. This ensures smooth restoring past introduction events when a user issues a rewind and restore. Removal and re-adding as such only occurs while the unit is current; never on subsequent mere re-plays.

A restore vector T20 keeps a complete, ordered record of all feedback that occurred in the system so far, regardless of respective presentations to the user. The exception is ‘nothing happens’ events which are important to restores but are not stored for efficiency. As mentioned above, ‘nothing happens’ are instead inferred from other data when needed. The restore vector simply stores on each feedback event's occurrence, its state main matrix index.

A main program look matrix T22 stores the detailed instructions necessary for automatically, based on system context, changing the graphical look of the surrounding environment. This is consistent with a DIFS's expressed aspects of a surrounding environment in which controls and feedback are presented by the system to the participant; and automatic updating of said surrounding environment based on the state of the system, whereby said surrounding environment provides contextual cues to the participant as to temporal and spatial progress through the DIFS of said participant.

A next moment matrix T24 specifies which next unit to make current for a thread on advancing from a current unit. It holds potentially two next unit state main matrix indices: one for if the current unit's critical line evaluated to true; the other for if the current unit's allotted turns ran out before the unit's critical line evaluated to true. Otherwise, if one of these branches lead to no next unit, an out-of-range value foreshadows thread termination when branching that direction.

An assortment of global variables T26 tracks other necessary information. A DIFS application uses these run-time global variables extensively to track loose, transient state. The name of each implies its meaning. A DIFS application must take care to keep status of globals as such consistently and comprehensively meaningful throughout operation.

DIFS Application Additional Derived Run-Time Data

A DIFS application can easily derive needed data from all tables and globals described whether or not such data is explicitly stored. For instance, nowhere does any table explicitly track ‘alias’ status of state main matrix feedback event blocks. A (non-event) feedback event of the state main matrix represents an alias if the following is true: there are no moment characters for that unit in the moment characters matrix. A further rule, to be discussed, of a DIFS editor requires every non-alias unit have at least one user-selectable agent. Thus, having at least one agent implies a non-alias unit. Not having any agent implies an alias unit.

Another case where derived information expedites operation is for advancing 0-duration units. To be perfectly useful, DIFS compiling must always produce consistent, predictable behavior. Unpredictable, however, is the case where several threads begin with 0-duration units.

These special units are to inherit unused turns from prior same-thread units. However, at a thread root, 0-duration threads inherit no unused turns. As we will see in the section on operation, a DIFS application advances threads in an arbitrary order. It picks a first thread to advance and subsequently tries the rest. Each advancement potentially auto-advances other threads. Auto-advance code differs from advance code in that the former assumes default values. The latter—the advance code—does not. The thread picked to auto-advance first will not use default values. It will assume non-occurrence of all contained events. The rest of the root 0-duration units will use default values. Thus, arbitrarily some threads will advance using default values while others will not. This, despite the fact of their being set-up the same way by a designer. This situation is not acceptable.

To control such a situation, a designer would require a deep and unwarranted knowledge of how a DIFS application works. Instead, a DIFS application simply does some extra work while loading a DIFS. It finds root 0-duration units and marks them as such. When it encounters one during advance, the DIFS application merely assumes default values. The marking is an example of deriving data from what is stored. For efficiency's sake, this marking is kept in another size-N ‘assignDefaultValues’ integer array not shown.

Control sequences also use some temporary storage in memory. Besides an inodes list, other pieces of data come from control files into memory. One example is the surrounding environment data for a control sequence. Another is an array of immediate feedback filename and event number tuples. The filenames are corresponding immediate feedback content for the MainMatrix feedback events encoded by the associated event numbers. The DIFS application may instruct presentation of these files during interaction. Immediate feedback helps guide a user's interaction with controls as to which event may result. The DIFS application keeps immediate feedback filenames in a short key along with Main Matrix event index numbers.

These are the primary examples of loose ends. Along with inodes, a DIFS application caches certain data to support interaction and operation.

</TE>

Turning a Written Story into DIFS Data

Referring to FIG. 18, a written story represents potential data for a DIFS. A story represents events in motion using static data. As described, so too does a DIFS. A written story, thusly, lends itself to direct translation into a DIFS. Adapting a story into DIFS data involves a few essential steps.

The present invention of a DIFS specifies a method for turning a written story into dynamic interaction and feedback system data comprising, in part: editing said story down to only aspects desired to be feedback results of interaction by a participant; determining break points in said story; providing blocks of related action, said blocks comprising text of said story between said break points respectively; organizing for each of said blocks all text within the block into logical feedback units; and determining for each of said blocks a group of agents appearing in the block whereby said participant may interact by selecting an agent from said group of agents to be a present active agent.

FIG. 18 breaks down the story “Little Red Riding Hood” into blocks of related action and further, into logical feedback units. A fairy tale such as “Little Red Riding Hood” provides a succinct example. Any story suffices, but fairy tales represent key action with a minimal amount of words. Subject and action, as opposed to description, are the premium. Nevertheless, the segment of story shown in FIG. 18 is shortened even further from a slightly longer telling of this segment of the fairy tale. Any such shortening to pertinent action demonstrates the aspect of editing a story down to only aspects desired to be feedback results of interaction by a participant.

The decision of where to insert breaks points is an involved and many-faceted one. The process of defining break points and defining feedback units may be iterative. That is, the one may influence the other, and the other in turn the first. Essentially, the step of breaking text into blocks entails a few basic questions.

First, which potential agents appear in a block. The step of deciding which agents a participant may actually “be” (i.e. via selection) comes later. At this stage, agents who share scenes help define the scenes as blocks. Blocks may divide further according to setting, action, time, or anything else. But by definition, blocks of related action here must each have clear agent casts. Each block represents a DIFS data unit. Beable agents within a block will remain beable through the duration of the block(TE). Therefore, careful breaking of blocks according to agent candidates proves essential. A user should be able to envision being any of some set of agents throughout a block's entire duration.

Second, potential feedback events contained within a block must relate. Preferably, they may occur with less order restrictions than more. The more order matters within a block, the more logic setup work will be required. Will additional logic required to force ordering be worth the effort? Generally speaking, a unit exists to allow blocks of feedback events to occur out of order. Thus, within a unit where order matters less, it is somewhat harder to achieve. The upshot of this: though harder to design for, less order proves desirable.

Allowable run-time re-ordering accords a user greater freedom, and a greater degree of influence. Additional efficacy leads to more unique and truly interactive resultant storylines. A DIFS with more events per unit is more wild in a sense, more unknown to author as well as to audience. Resultant replayability, of course, is value added per dollar spent on such a product. Obviously, a sentence is not a sentence until its words assemble meaningfully; a story, not a story until its parts align to some satisfaction. A DIFS designer creates at design time an open book, loosely structured. Only when a user interacts does true story come to be. A user is more of a co-author the less rigid pre-ordering a DIFS maintains. No matter what, break points defining unit blocks should factor in contained feedback relationships.

Third, does a block boundary hit or miss desired branch opportunities? Certain points in a story lend naturally to branching. Other more subtle events of a story may leave affectatious trace residue. These traces may not branch immediately but figure to impact tangentially or directly future branching. Actual immediate, completely hardcoded forks may happen only between blocks(TE).

An example:

A huntsman went past the house and thought, “How loudly the old lady is snoring. I must see if there is anything the matter with her.”

is its own block unit. This is because a designer decided a plot branch from this single feedback event night be justified. As has been said, a preferred embodiment allows branching either of two ways from every unit(TE). Traveling either way profoundly influences plot at least until a rejoining, likely thereafter. At first, going one direction favors certain blocks of feedback to the exclusion of others. Whole sub-trees of action open up while others close down. Powerful, this branching capability also requires block boundaries be carefully planned accordingly.

In FIG. 18, the outer, wider outlines represent potential blocks for this text. Block breakdown is a creative process, subjective and up to a designer. A particular breakdown presumes certain goals. A designer achieves these goals structurally in part by setting break points. A DIFS creator designs for certain realizable effects and does so using a certain breakdown. Goals influence structure, not the other way around.

In addition to block breakdown comes interpretive work at a finer granularity. A designer may carve story text into discrete logical feedback units. Previously, these feedback units have been referred to as events. For consistency, the convention continues here. Think of a feedback event as that which a user's interaction will cause. A feedback event can reward, penalize, or simply present action of some sort. Every one of the inner outlines around text in FIG. 18 might be an event. Another interpretation might carve this same text differently, into different feedback events.

For instance, what the inner outlines of FIG. 18 separate into two or more multiple feedback events might in an alternative implementation be united. Take the first two beginning outlined text segments:

Once upon a time there was a sweet little maiden who was loved by all who knew her, but she was especially dear to her grandmother, who did not know how to make enough of the child.

and,

One day her mother said to her, “Come here, Red Riding Hood! Take this cake and bottle of wine to grandmother.”

Instead, these could just as easily be unified into one continuous, unified feedback event:

Once upon a time there was a sweet little maiden who was loved by all who knew her, but she was especially dear to her grandmother, who did not know how to make enough of the child.

One day her mother said to her, “Come here, Red Riding Hood! Take this cake and bottle of wine to grandmother.”

Many reasons might dictate this decision. Perhaps the story should go quicker here. Or perhaps non-text content in the works dictates this unity. Or maybe another thread should never split these descriptions, or they just play more sensibly together. Innumerable causes motivate structure. Notice, too, the insertion of an additional quotation mark after ‘grandmother’ (see FIG. 18).

Text segments may need a little help to stand entirely on their own. A little touch-up work, especially at beginning and ending transitions may occasionally prove necessary.

Likewise, a shown outline representing a single feedback event might be broken into two or more feedback events:

Once upon a time there was a sweet little maiden who was loved by all who knew her, but she was especially dear to her grandmother, who did not know how to make enough of the child.

might in another DIFS from this text be broken-up as:

Once upon a time there was a sweet little maiden who was loved by all who knew her.

and,

But she was especially dear to her grandmother, who did not know how to make enough of the child.

The difference here may not seem striking. But functionally a world of difference exists between these alternative variations. Different agents might be available based on which agents perpetrate event-motivating action. Interaction, to which events are attached as results, would undoubtedly be affected. This is to say nothing of the most obvious fact. Although here we read the various versions more or less contiguously, DIFS presentation differs. Based on feedback organization, a DIFS may present this text singly or separately. If separately, depending on logic, it may play in any order. If separately, it may also play with other feedback in between. Therefore, how a designer interprets text into feedback profoundly affects operation of a resulting DIFS.

A DIFS works with any story. But does any story really mean any story? Yes. A designer should be able to turn any story into a DIFS. Occasionally slightly deeper design work may prove necessary or preferable. A designer may first realize this when about to begin attaching interactivity; or, speaking technically, when determining for each block a group of agents appearing in the block whereby a participant may interact by selecting an agent from said group of agents to be a present active agent. This step by itself should not be difficult. If other steps are performed diligently, this step should be a simple matter of picking names. However, the process of deciding selectable agents begins to focus on hooking-in interactivity. The process may shed light on ugly design flaws here and there. To one inexperienced, this primary remaining challenge probably concerns time transitions.

Concerning time, obviously, written stories have innumerable semantic and literary devices for treating the concept of time. A preferred DIFS implementation uses logical timesteps and strict data unit ordering as part of its agent group determination logic(TE). In other words, its operation assumes a present point of reference from which user interaction occurs.

This assumption does not differ from any written story really. However, what a written story ideally presents in a particular order might be better re-ordered for best presentation in a DIFS. The issue of logical time treatment has nothing to do with tense, but rather transitions. An entire DIFS can have text feedback employing ‘was’ instead of ‘is’. The difficulty comes when a written story to be adapted employs both ‘was’ and ‘is’. It is similar in some ways to the problem of adapting a book into a movie. In other ways, logical time treatment here is quite different.

In written text, each word on a page is ordered. Each word must follow from a previous word, left-to-right, top-to-bottom. At a much higher level, logical time in a text need not follow as strictly to remain sensible. A majority of a particular text might occur in one logical time. This may hold true even while certain segments of the text occur in other logical times entirely.

To achieve an optimal result, a designer must understand DIFS event ordering. A DIFS, unlike text, uses all high level event feedback semantics. The fundamental atom is the event as opposed to the word. A DIFS user interacts and affects event feedback presentation. The fact of interacting happens in real-time, in a real present. Previously presented events exist in a feedback memory. This memory is linear in the sense that earlier recorded presentations predate more recent ones(TE).

The logical time of this model, then, simulates cumulative real time. A DIFS most naturally implies newly-occurring interaction and feedback is logically present. The upshot of this design is stated simply as follows. Ordering events exactly from text might not always make sense. Interaction may seem strangely to affect events that actually happened in the past or future.

As a result, initial editing should take into consideration logical time. Editing might remove or distinguish certain non-linear segments. Anything out of keeping with an identifiable present time of a text breaks cumulative continuity. Text representing so-called flashbacks or flash forwards are candidates for removal. Besides rote removal, a DIFS designer might handle discrepancies in logical time numerous other ways.

Consider four other common strategies. First, a designer might break different logical time segments out into one or more separate DIFS's. As has been stated, entire separate DIFS's may follow from one another.

Alternatively, a designer might choose to keep to one unified DIFS. To do so, she could re-order text along logical time lines. This second method puts each logical time segment earlier or later. Placement depends on where each logical segment exists in a story's timeline respecting all other logical time segments. However, this may sacrifice some intended order of revelation. In a story, order of telling likely serves some plot, dramatic, or other function. Indeed, order of presentation may have been the very point of telling the story!

In such a case, a designer could handle logical time a third way. She could ostensibly re-interpret meaning of DIFS present time. A user would interact to affect action supposed to have happened in the past. This thinking obviates intended usage to some extent.

However, feedback and organization guide smooth presentation to an audience. Feedback can indicate the nature of interaction. Organization requires only that information about logical past is consistently known when needed.

The described DIFS implementation predominant in this document accounts for time reinterpretation, but urges caution when using it. Earlier it was mentioned that threads may reference events in other same-timestep threads. However, event occurrence within a timestep happens in any order. The rule here, then, goes as follows. Never make an across threads reference to a flashback/forward event in the same timestep. Enforcing this rule at present day requires high-level text interpretation beyond what an editor can comprehensively provide. Thus, a DIFS designer must be careful, as is to be expected, reinterpreting time.

A fourth option involves grouping feedback in such a way that it plays sensibly. This last approach most nearly approximates the written equivalent. Usually it works just fine. A single feedback event maps to a single flashback or flashforward.

Some stories favor the flashback/forward, however. They depict almost entirely past or future tense situations predicated on scantly-treated present ones. Such a story would not play well simply collected into few largish feedback events. The present would deal mainly with reflection or anticipation, usually uninteresting for interaction. The story's real action happened in the past or has yet to happen. Therefore, the past or future is where one would likely wish to focus DIFS action.

So not every technique offered here suits every desired DIFS. A combination of techniques undoubtedly may work. A DIFS assures designers of this by one simple fact. For any story to make sense, some cumulative timeline—however choppy—must exist.

Any of these methods are perfectly viable, though each best suited for certain situations. A combination of strategies can work effectively. The end goal is to achieve a controlled experience. That said, a DIFS of a given implementation may simulate any fancy time travels just like text. DIFS time may be made to seem to loop infinitely, as some science fiction stories have exemplified. It may be made into a schizophrenic jigsaw puzzle out of which a user audience must assemble the pieces. DIFS time may model time travel as plot. After all, the story of time travel itself is always ultimately told in linear fashion. DIFS time may foretell avoidable futures as in at least one famous story. In fact, a plethora of interesting incarnations abounds.

It can be as fun and liberating to play with the device of time in a DIFS as it is in text form. From the above it may seem like many exceptions exist. But remember also that most stories keep to a very few logical times. They simply must in order that they may make sense to a reader. Those that do not keep to a reasonable number of logical times, do not read as smoothly to a reader. A reader is always in her or his present. These stories call attention to time as a device. Their experimentation with time requires experimental adaptation to preserve their intended effects. To ensure doing so makes sense to an audience, a DIFS designer must merely understand these methods of design.

The Rules of Making a DIFS

Referring to FIGS. 19a and 19b, a designer should also be cognizant of mandatory rules. Any implementation of a DIFS will have its own final data format requirements. Ideally, a full DIFS system provides a rule-based editor and compiler(TE). The goal of such a program is to enable free and easy design.

Easy means that a user would need to exert a minimum amount of effort addressing data format requirements. Easy also means an editor program sees to it that design will yield sound results. For instance, an editor program should greatly reduce time required for DIFS run-time testing. Only a minimal number of types of readily identifiable and fixable errors should ever get through. These should by and large be related to logic design, not to editor-recognizable and fixable problems.

Free means allowing multivarious expressions with minimum obstacles to achieving any of them. A designer should be free to focus on design and content particulars. Unhindered, he should have little or no worry about requisite technical rules. An editor and compiler assumes this considerable burden. Even if doing so means only making a user aware of potential error states.

Along the way, the natural process of human design temporarily enters into error states. Even designer users have lives away from the program. It is understood that static files saved intermediately may contain unfinished, works-in-progress. Ultimately, design must lead to run-ready specification-compliant results.

Editor functionality should afford freedom from wasteful, time-consuming processing cycles. Editing, and design even, can occur during real-time interaction. Optimal editor performance and unencumbered interaction during these stages proves crucial. No one would use the editor program or produce DIFS's if to do so required undue labor. Best results should be achievable with minimum effort. These are some primary reasons for the existence of a DIFS. Thus, what can be solved within reason by a DIFS editor/compiler, should be.

Easy means also enforcement of rules should not mandate undue effort. So it is a fine line, the tug-of-war between ease and freedom. Rule enforcement ought to intrude as little as possible. It should tolerate mistakes, iteration, non-linear workflows, incomplete and perhaps unresolved intermediate versions. Yet rules must prevent a user from ultimately erroneous or unproductive end results. Any compiler system or API treads this fine line.

A tried DIFS rule-based editing and compiling machine employs several strategies to achieve these ends. Always it tries to balance great freedom and power with pervasive enforcement and guidance.

Firstly, it is graphical and minimal(TE). This simplicity helps with user-friendliness and visualization of complex relationships. The editor tries in essence to be the next best thing to WYSIWYG (what you see is what you get). A DIFS is neither as tangible as a text document nor as abstract as code. Thus, an editing GUI with only essential elements on-screen seemed in order. The nature of the system-editing interface will be covered in the next section.

<TE> Secondly, the DIFS editor provides much available in-program written guidance. Guidance shown in FIGS. 19a and 19b, akin to a library of code definitions, instructs little about program usage. It more speaks to requirements regarding a DIFS which the editor program helps create.</TE>

Dependant on DIFS implementation, a standard checklist of rules governs DIFS creation. Every DIFS using the implementation must abide by the rules. This tried implementation commands that DIFS's follow the rules shown in FIGS. 19a and 19b(TE). A user of this editor may or may not fully understand these commandments at first. Likewise, the list omits many certain aspects crucial to producing a specific DIFS ultimately desired. What the list does provide, however, are guidelines. Any DIFS complying with these rules will at least compile. Further guidance of a somewhat more traditional help nature may also be a part of in-program assistance. It is true, though, that stated rules and editor/compiler usage are closely related.

Respecting this relation, rule enforcement by alertion, a third aspect of a DIFS editing and compiling machine, complements rules specification. During use of the graphical editor, alertion may serve two purposes. First, alertion can ensure guided repairability of a system in error. Secondly, alertion may acquaint a user with essential constraints in an applied, hands-on manner.

In other words, through use of an editor, a user may quickly learn how a DIFS works. Surmising proper DIFS workings, she may then with more ease and consistency create DIFS's. Alertion also allows for intermediate works-in-progress. Compilers and APIs for years have employed similar methods. Markedly different here is their application. <TE> A DIFS is an entirely high-level construct, requiring no programming of its would-be creator. It exists above programming languages, though prefers a compiler to assemble its results. To create a DIFS, a user must only learn a DIFS editor and its rules.</TE> Most importantly, he must be able to provide content.

The (Tried) Rules Enforced

Referring still to FIGS. 19a and 19b, discussion turns now to explication of the shown rules and how a tried editor enforces each.

<TE>

The (Tried) Rules Enforced: Feedback Event Rules

A section to come below, about a DIFS editing and compiling machine, describes an interactive system map. This map allows a user to order a “moment” (i.e. a DIFS unit) by clicking and dragging its graphical representation. Doing so must place the unit in a unique position in the order of units according to FIG. 19a rule 1: Every moment must occur at a unique time in the story and must have a valid critical line comprised of only valid possibilities. In other words, “unique time in the story” corresponds to unique positioning on the map. Further, the editor must ensure for each unit a “valid critical line comprised of only valid possibilities.”

Enforcement of the first aspect of rule 1—unit time/position uniqueness—alerts on and auto-fixes aberrations. This strategy simply never allows entrance into an error state as such. A user may drag a unit into exact alignment with another unit. Normally, for a unique destination, releasing the mouse button or equivalent would position the unit.

However, the case of coinciding with another unit breaks the unique unit times rule. A small window pops-up alerting a user of the faulty state. The editor automatically places the repositioned unit back to its position prior to drag. The initial position, too is guaranteed acceptable. Initial creation of a unit places the unit uniquely with a find-the-first-free spot algorithm.

Regarding the pop-up window, it displays a reference to the rule number violated. Automatically after a set time, it disappears. Certain rule breaks elicit several errors. Therefore the time a rule window remains onscreen before disappearing takes this into account. Doing so lets a user read the contents of the window before it disappears while minimizing inconvenience.

The window may at times distract or annoy a user instead of helping. For this reason, a preferred DIFS editor also provides a switch for turning off alertion. For consistency and ease of specification, this switch instructs setting of the equivalent switch in the DIFS application. Compiling stores this instruction in the compiled main story file of the DIFS being edited. Thus, alertion mode may serve to assist end-users configuring a DIFS application. The switch in the DIFS application is touched on later. ‘Alert on any program or rules errors’ is the switch in the DIFS editor. It signifies, when checked, to show the rules subwindow on rules violations. Alertion, unless otherwise noted from here on out refers to this rules subwindow.

For enforcement of the second part of rule 1 regarding critical line validity, FIG. 19b sheds some light. “Moments are initialized with an empty possibility (_) for their critical lines. All rules that apply to possibilities also apply to empty possibilities, meaning to continue making new moments you must first make a unique critical line for each new moment.” This is because of rule 2: No two possibilities can have the same name. The tried DIFS editor disallows a user's naming two possibilities(feedback events) the same. A user defines a feedback event by typing its name and committing it. Issuance of a commit action checks the typed name against all present names. If unique, the name goes through, the DIFS editor makes the feedback event. Otherwise, the alertion window reminds a user about rule 2.

Rule 1 further requires every unit must always have a valid critical logic line. Each critical line of logic references at least one feedback event from its unit. A new unit's critical line references an empty feedback event contained in the unit. But to create the empty feedback event for reference is to create a duplicate.

That is, duplication results if another unit still contains the empty feedback. The DIFS editor simply prevents unit creation, alerting a user with the rule number. A user must define a feedback event for a previous new unit. This serves to overwrite an empty feedback event reference contained in the unit. Reference to the defined feedback event replaces an empty feedback reference in the unit's critical line as well. Now a user can proceed to create another new unit. Therefore, the editor essentially forces a user to create units one by one. She must fill each with at least a single feedback event before making new ones.

The described procedure does not concern aliases, which as described previously are essentially blank units. This DIFS editor handles aliases and regular units separately. FIG. 19a rule 3 demands that each possibility aliased must antedate every alias referencing it. This rule ensures system state is always available when needed. Otherwise, a user might unknowingly inject premature references throughout. She might develop in-depth content for wholly unworkable designs.

The DIFS editor program prevents this scenario from happening. It uses a strategy similar to the one described above for handling unit positions. On a user's picking up and putting down an alias, the editor performs checks. The editor may find that the alias's new position precedes feedback that the alias's critical line references. If so, the editor puts the alias back and alerts about rule 3. The editor similarly denies placement of a unit after aliases referencing any of its feedback. Finally, the editor disallows creation of new aliases above that which they reference. An attempt to do this last results in no change; only alertion. By these subtle constraints a DIFS editor ensures aliases have state when needed.

For the same purpose, the editor prevents an alias from existing “in the same timestep as the original possibility, unless the alias follows the original in the same thread of action” (FIG. 19a rule 4). Audience Progressions through independent threads may occur at different rates. Therefore, state from another thread is uncertain if a same-timestep alias attempts to reference it.

Noted above, this rule does not apply to active controls selection conditions. These conditions merely assume unknown events have not yet happened. In other words, they assume 0 occurrences for such events. Controls logic needs this ability to reference across threads in the same timestep. Some situations involve meeting up of agents initially in separate threads. Actual functional meeting would likely not commence until a next timestep. But to set such a meeting in motion conceivably requires this cross-logic. The assumption of no occurrence for unknown is perfectly acceptable. Unlike agent group selection (branch) logic, controls logic affects only current (as opposed to future) interaction.

Should branch logic ask questions of another thread, the implications are more serious. This logic's intended meaning differs from controls logic and so, too, its intended usage. Branch logic affects longer term change. Branch logic is intended to proceed based on known fact or else not at all. Therefore history in feedback memory must guide branching. To make assumptions like conditions logic's assumptions could lead to grave logical inconsistencies. Consider the following case.

Thread A advances but crosses no timestep boundary. Advancing, it branches on an alias reference of feedback event F of thread B. B has not actually reached the unit containing F yet, so F truly is unknown. But thread A's alias assumes a 0 value and branches accordingly. Later during operation, thread B reaches F and a user causes F to occur. Yet A has already proceeded, continuing to make assumptions about F's non-occurrence. Obviously, unstable state situations develop unchecked.

This is why rule 4 enforcement flags poor state for same-timestep cross-thread alias references. Enforcement works a little differently for this rule, however. During design an alias might commonly share a timestep with its referenced feedback event(s). Instead of the usual automatic un-positioning, an errors list indicates the problem. This list accumulates various errors requiring correction before the editor will allow final compilation.

A user may view the list at any time. In fact, it sits directly below the system map. Reloading a system file in progress reloads its error list into the editor. Correction of errors removes corresponding error lines from the list interactively.

Assume a user moves a poorly placed alias to a later timestep. It now succeeds all feedback events it references. The editor determines references are safe and removes corresponding error lines from the errors list. Any of the following may re-add errors to the errors list. A user deletes a timestep boundary such that alias and referenced event units coincide. Or, a user moves alias or referenced unit to the other's timestep. Or, a user creates an alias reference to feedback sharing the alias's timestep. Either of the latter two situations additionally alerts a user about rule 4. So in certain cases a combination of enforcement techniques apply in concert.

The (Tried) Rules Enforced: Rules Regarding Agents

FIG. 19a Rule 5 states that “No two characters in the same moment can have the same name.” Simultaneous same-named agents would likely confuse a user audience and/or a DIFS application. Enforcement of this rule uses the regular alertion, rules popup window, scheme. A user types an agent name and issues a commit command. The editor checks the applicable unit for other agents of the same name. If any exists, it prevents the action and alerts the user of the editor.

The next character rule (6) employs the aforementioned error list form of alertion. The editor allows list errors to persist uncorrected. Eventually before compiling a user must correct them. Rule 6 falls under this category because once again alternatives prove unworkable. “A character can only appear in one thread of action during a single timestep.” That may be for the final product. However, during mid-design, deviation from this requirement is the norm. An agent should never appear in more than one thread during one timestep. To allow it would allow the impossible. A single agent could appear simultaneously in two separate same-timestep threads of action! Same timestep threads are supposed to be occurring at exactly the same time. The list alertion method puts off enforcement until a user wishes to compile. She must then address errors to prevent potential same-name agents from separate simultaneous threads.

The (Tried) Rules Enforced: Rules Regarding Threads

FIG. 19a, Rules 7 and 8 regard threads. This editor places a fewest number of constraints on unit link-up. The expectations do force a reasonable, careful order of operations. Additional alertion schemes discussed so far here proved somewhat costly and unnecessary. Simply put, disallowed connection attempts result in no drawing of a connection line. Normally, the graphical editor draws a connection line for an allowed, successful connection. Failing to connect alerts by lack of the usual, anticipated editor behavior. This goes for both of rules 7 and 8.

Rule 7 says a moment cannot have predecessors and/or successors from more than one thread of action. This basically says threads may never unite. No thread can have more than one root. All are upside-down trees, with lesser or more strongly inter-connected branches. For branches between trees to unite might prove ruinous, at least for this implementation. Consider the implications. From which thread did a user come to a join-unit? How might processing of the rest of each thread proceed? What if continuing takes a user back into one thread or the other?

When it is desired that two threads of action become one in a story, another model works. Both separate threads end. So too does a timestep. A new thread begins. Without sacrificing any power of threads, this model achieves the desired resultant behavior.

Rule 8 basically prohibits looping threads back on themselves. A DIFS from this editor easily simulates looping behavior, although modeled differently. Event feedback playlists can loop as can each slot in each playlist. As shall be discussed, an editor also enables pseudo-duplication of units, including all contained feedback, and critical line and active controls selection logic. A user can design ostensible loopbacks using such repetition and logic.

Also good to keep in mind concerning looping is the following. Truly repetitious large scale plot structures would likely play poorly. They might frustrate a user and moreover, a designer. Debugging such loops for playability could become difficult. The more programmatic, less intrinsically useful loop construct had no place in system maps. A system map is intended to represent progression of logical story time. A loop here misses the point. Introducing one would be like condoning repetition of the same large section in a book.

The first rule alert a user encounters on starting the editor concerns rule 9. The editor disallows a user any creative action until this rule is satisfied. Many basic DIFS editor and application operations rely on there being a title. In fact, a favorite directory structure places a DIFS application(and/or editor) in a top-level directory. Each DIFS has its own directory off of this top-level. Each DIFS directory contains everything about that system and is named by the system's title. Thus, a user must provide a title up front. A user may load a title from a saved work-in-progress stored on disk. Or she may provide a title and start a DIFS anew.

The (Tried) Rules Enforced: Naming a DIFS

Title is of prime importance to aliases, which may reference other, past systems. Uniqueness amongst all titles in a system, including its own, distinguishes references. This rule required little real enforcement. Operating systems presently require filename uniqueness in each directory folder. Rule 10, described below, further requires all story content files must exist in their proper directories as named by the editor program.

This naming rule, omitted from FIGS. 19a and 19b, directs that “all story (design) files referenced must exist before compiling in the “include” directory, as well as in their compiled form if to be used as default history.” Referencing other stories using the editor involves choosing a file from this “include” directory. A chosen file may have the same name as a loaded system's. In this case, the system's title is assumed instead. In fact, initially all aliases assume reference from the current system. Therefore, when a user makes a new alias unit, it immediately incorporates the system title. After alias creation a user may add, or change an alias to use other story references.

The (Tried) Rules Enforced: File Organization

The editor alerts a user to rule 10 during certain disk operations. Namely, those considered mission critical such as past system references noted above. The editor would fail such operations, claiming rule 10, until file locations comply.

A DIFS editor imagines a DIFS's aforementioned system directory as an exclusive space. The editor desires everything crucial to operation be nested properly under this directory. The editor acts as a broker, disallowing linkage from a DIFS to stranger files. A user must move or copy files accordingly to satisfy the editor. The editor assists by providing together with general browsing, means for these transfer operations. Finally, a file is no longer a stranger once in the correct location. Properly situated files are ready for inclusion and use as part of the DIFS.

Whenever dealing with disk operations of this scale, space concerns enter in. Files need not necessarily be moved right away. Empty dummy files with equivalent names can stand-in temporarily. Shortcut or link substitutions may also suffice during design. In certain cases, a user can provide temporary, dangling references to no real file.

At distribution, however, a DIFS is its many pieces, its directory structure and contained files. The hard design work creates a central system file for a DIFS application as well as control files. These in turn instruct interaction and presentation of content of the directories, effectively tying it all together. The editor performs no assembly into a unified executable file. The system produces no binaries even necessarily. This is why the editor strictly maintains a DIFS's directory: so that a DIFS application executing DIFS instructions soft-links properly with all elements at run-time.

Most major games and multimedia software employ some strategy of like-minded directory-as-executable loose integration. Instructions auto-navigate and make meaning of many disparate parts represented by many formats. The key that turns the lock here is the DIFS application running DIFS instructions. Users everywhere can each have a DIFS application to run compatible DIFS's. Each new DIFS installation becomes a simple matter of copying a DIFS's directory tree into the DIFS application's directory. This presuming, of course, a DIFS directory includes all its own relevant content. Perhaps compression of DIFS directory trees and subsequent navigation of the unified archive might also work.

The editor must do its job of rule enforcement. It promotes best cross-platform compatibility of DIFS's produced using it by making certain reasonable requirements, i.e. a union of major operating systems' respective requirements, concerning all included files' filenames.

The editor encourages a user preview all linked-in content. Preview, in turn, requires content be in its correct location. This last proves one final point about being thorough: regardless of powerful editing tools, some checklists a user should always run through by hand regardless.

The remainder of rule 10 follows for instructional purposes (story here means the DIEFS):

10. All story content files must exist in their proper directories as named by the editor:

Audio files (any file preceded by the AUD specifier in a play link file) must exist in the story “audio” or “alternate” directory.

Character Look files (including “.cap”'s) must exist in the story “i” (interaction) or “alternate” directory.

Configuration files (recommended, popular, and/or default) must all exist in the story “config” directory.

Image files (any file preceded by the IMG specifier in a play link file) must exist in the story “image” or “alternate” directory.

Play Link files must exist in the story “link” directory.

Main Background files must exist in the story “image” or “alternate” directory.

Motion files (any file preceded by the MOT specifier in a play link file) must exist in the story “motion” or “alternate” directory.

Text files (any file preceded by the TXT specifier in a play link file) must exist in the story “text” or “alternate” directory.

Title files must exist in the story “image” or “alternate” directory.

Story (design) files referenced must exist before compiling in the “include” directory and must exist there in compiled form as well if to be used as default history.

Style files (recommended, popular, and/or default) and all image files they reference must all exist in the story “style” directory.

Interaction sequence files generated by the DIFS editor and spawned interaction applications must exist in the story “i” directory.

Interaction resources not generated by the DIFS editor—any other files used by interaction applications—must exist in the story “alternate” directory.

I Background files must exist in the story “image” or “alternate” directory.

All Text files (any file preceded by the ATX specifier in a play link file) must exist in the story “text” or “alternate” directory.

Saved story files must exist in the story “saved” directory.

And Original Story files (compiled and non) must exist in the story's root directory (the topmost level directory with the same name as the story and containing all said directories).

Further, to ensure cross-platform compatibility, no files used in the production can contain any of the following characters in their file names, as a DIFS application does not do any special processing here to bridge differences in OSs:

illegal are ˜ or − in the first position, and any of the following characters in any other position in the filename \/:*?<>″|<space>& () {}!$ ; ‘`

The (Tried) Rules Enforced: Limit Rules

Finally, another class of rules deals generally with range limits on data. Earlier, a tried DIFS run-time data specification presented fixed sized table allocation. It cited the benefits of stability and standardization for presuming reasonable limits. Reasonable or otherwise, these precise sizes are need-to-know information for a serious DIFS designer. She need know DIFS scope is not utterly unlimited. It must fit within the containers and operative expectations of a DIFS application. The numbers given in the rules limits of 19b suit a tried DIFS application.

Limit rules prove difficult not only to enforce but to construct real-time information on. Therefore, the DIFS editor performs neither function. Compiling a DIFS checks a DIFS against each of these rules. For each that fails, a list accumulates errors similar to the real-time errors list. If any test fails, a compile operation ceases prematurely just before finishing. A user may view the list of compile errors and fix associated problems.

The advantage here of course is having a frozen DIFS state to analyze. When the system is constantly under construction, it makes little sense to check bounds. A user adds, subtracts, and rearranges components variously throughout the course of editing. He can know the numbers generally by checking the rules. He can thus take mental precautions to stay relatively within acceptable ranges. The compile function will advise him of mis-steps.

Remember that each feedback event actually potentially represents numerous actual productions. All limits are thus reasonable and distant for just about any imaginable DIFS project.

The (Tried) Rules Enforced: Other Procedures

A tried DIFS gives two more rules not shown in FIGS. 19a and 19b. They are more procedures than rules really, although they behave similarly. Usual alertion enforces all three procedures. They are stated as follows:

1: To change or delete a feedback event that is part of one or more critical lines, you must first omit the feedback event from everywhere it appears in the critical lines.

2: Before attempting to combine two stories A and B into one, make sure the stories have different names and remove all references to story B from story A and all references to story A from story B; they must also reference the same number of control handler applications.

3: To assign types to controls after adding control handler applications, you must first save the story.

The reasoning for these should be self-explanatory after discussion of previous sections. The parts about handler applications are because the main story file stores them. Therefore, separate control files must be able to rely on main story file consistency. Control files and main story file must always align to some extent. Compiling double-checks as well in case a user introduced unaligned controls and/or control files. For common cases during editing, the DIFS editor maintains integrity by preventing bad state.

Once again, editing procedures exist to ensure constant integrity of references throughout a DIFS. Mandatory procedures add some minor inconvenience to workflow. However, the benefit in stability far outweighs the cost in time (that would be required regardless). Time-cost would be much higher, in fact, trying to debug unenforced DIFS development.

A DIFS Editing and Compiling Machine

Referring to figure FIG. 20, a tried rule-based editing and compiling machine enables DIFS creation. Shown is the aforementioned basic GUI expanded somewhat to show salient capabilities. Visible are the program's major data editing and structuring features. The GUI is malleable, allowing user-resizing of various elements to suit needs. Beside the story map (to the right) is a large text field for arbitrary text such as the story itself. These features of the editor facilitate development. Also shown: a content specification sub-module for feedback presentation instructions. The following several sections, respecting FIG. 20, discuss components of FIG. 20 variously.

A DIFS Editing and Compiling Machine: Viewing and Editing Unit Data

Top-left is an interface 188 for editing initial and static data of an in-focus “moment” data unit. As in the previously demonstrated controls editor module, sub-modules provide functionality. This “Details of Selected Moment” sub-module proves particularly crucial.

A user focuses on a unit out in the map by clicking its graphical representation. “Unit” (s) may be construed as unit representation(s) from here on after in this section. A user unfolds a unit's menu by clicking on a certain leftmost portion of the unit. He clicks on ‘Details’ in this menu to open the “Details of Selected Moment” sub-module 188. A user may still interact with the system map and units (shown centered in FIG. 20).

For simplicity this main portion of the editor allows only single-selection, or focusing-on of a single unit independently. A user may thus click another unit while the unit details sub-module 188 is up. The editor re-populates this sub-module, if shown, with a newly focused-on unit's information. The sub-module tries also to remain on top while letting a user navigate units. Besides just displaying unit contents, this sub-module allows editing of shown contents as well. Using this sub-module, then, a user may effectively peruse and edit all DIFS unit data.

A DIFS Editing and Compiling Machine: Referencing Prior DIFS State

A first piece among this data is a “from” string. A ‘From’ field 190 (FIG. 20) displaying it, tops the unit details sub-module. In FIG. 20, the field is empty, indicating the in-focus unit specifies no “from” string. The DIFS editor allows no typing in this field. A user may only indirectly edit this string, and only for alias units.

Specifically, a user edits a unit “from” string only: for aliases, using a file chooser. If not viewing an alias unit, a “from”-related ‘ . . . ’ button (right of the “From”field) remains inactive. If viewing an alias unit, a user may click this “from” ‘ . . . ’ button. The editor uses ‘ . . . ’ throughout to signify file choosing—another sub-module.

The file-chooser sub-module selects a file for various different purposes; not just for “from” string naming. It all depends on which ‘ . . . ’ button invoked it. Here, for “from”, picking a file using this file chooser sets the “from” string to the file's name. The string becomes only the filename, however, not the full path. Furthermore, a user must choose another DIFS main file—although editor checking for this can be minimal. A user should know to pick a DIFS main story file for a “from” string based on documented usage of the editor, such as this specification. The from file chosen should furthermore exist in the current DIFS's “include” subdirectory (for reasoning for this, see above).

If these conditions hold true, a user will be able to specify critical line references for an alias. These references will point to events originating from the file denoted by the “from” string. A user references from such files one at a time. However, a single alias may use references from several systems. To do so merely involves repeating this process of file selection individually per system file to be referenced. Alias critical line reference syntax makes this possible. Each reference in an alias critical line keeps with it a system filename. The “from” interface stated ensures alias critical line integrity by safeguarding against bad and ambiguously-defined references.

A DIFS Editing and Compiling Machine: Assembling a Critical Line

Similar to the “from” interface, though slightly more intricate, is a critical line interface 192 (FIG. 20). This interface lets a user define an in-focus unit's critical line of logic. Unit critical logic, as noted, provides the basis for tried DIFS agent group determination logic.

The ‘Critical’ button allows for adding of feedback event references to a critical line. Clicking this button drops-down a list of selectable feedback events. For an alias, the editor populates the list based on the ‘From’ input string indicated above. From the file specified by this string, the editor stages-in all non-alias feedback events. For regular units, the editor always populates the list using the unit's feedback events.

As with the ‘From’ field, the input field here exists for viewing purposes only. It displays a unit's critical line. The editor lets a user scroll horizontally, but not type, in this input. Fancier alternative interfaces might try a less-regimented approach. But here a user may only add feedback event references indirectly. She must select references from the drop-down list of selectable feedback events.

A big advantage of this no-typing interface is that typos never introduce mal-references. User-selected feedback means to the DIFS exactly what a user intends. Of course, this proves crucial for critical lines, which require exact perfection. Furthermore, the interface allows a user to select only the feedback events allowed. The set of feedback events a unit may reference matches, one-to-one, selectable drop-down list items.

For aliases, further checks intercept other mal-references based on selection. These would be harder to catch with a more fluidly interactive typing interface. Selecting present-system event feedback below an alias adds nothing to its critical line. This enforces a previously noted rule forbidding premature reference of later feedback. Likewise, feedback selected from the same timestep is added, but with alertion marking it as in-error until fixed. All of this is a kind of implicit enforcement by prevention. A user infers based on availability of options, intended DIFS structure. The editor never lets him do anything he isn't supposed to do.

Regimentation in this interface does not sacrifice any power. Merely, a user must construct each critical logic line thoughtfully, one piece at a time. The next piece of this critical line specification interface relates the pieces together.

The downward-pointing arrow button to the right of the critical input, when clicked, drops-down two lists and an input. One list contains the unit critical line discretized into individual atoms. The purpose of this list, and its companion drop-downs, is singular. The interface allows editing of a critical line via editing these atoms. An atom consists of a feedback event reference and—optionally—a unary operator, or binary operator and its righthand side operand. That is to say, atoms are expressions between the “and's” and “or's” on a critical logic line. In the list, each atom gets the logical operator preceding it. The first atom gets an obligatory ‘or’. For example, the complete critical line

_RED_GOES_QUICKLY or _WOLF_TO_GRANDMA'S_{—}

would break down into the two atoms

or _RED_GOES_QUICKLY_{—}

or _WOLF_TO_GRANDMA'S_{—}

A complete alias critical line

!<<S2.sto: _PROT1_PREVAILS_>> and !<<S1.sto: _HAPPY_ENDING_>>

would break down into the atoms

or !<<S2.sto: _PROT1_PREVAILS_>>

and !<<S1.sto: _HAPPY_ENDING_>>

respectively.

!_RED_INFURIATES_MOM_and _MOM_SPEAKS_{—}=3 or _MOM_GOES_HERSELF_{—}

would appear as three atoms:

or !_RED_INFURIATES_MOM_{—}

and _MOM_SPEAKS_{—}=3

or _MOM_GOES_HERSELF_{—}

and so forth.

A user can reposition an atom to anywhere in the order. He clicks and drags it up or down in the drop-down list described. The editor shows the results of this immediately. It moves the atom substring left or right respectively in the critical line input. The atoms drop-down list always matches the critical line input. This list is the only way to edit the atom's critical line.

A user may delete an atom as long as it is not the only atom—the editor enforces that every unit must have a valid critical line. A critical line with no atoms is not valid. A user deletes an atom by right-clicking on it in the drop-down list. Again, the editor immediately updates the critical logic line displayed in the input automatically. It does so for all changes affecting the critical logic line.

For all operations changing a critical line, the editor also at the same time updates the critical line out on the map. It does so if the unit was set up to auto-scroll, for display purposes, its critical line. This shows logic for a unit right on the system map. But the editor must carefully synchronize whenever a user changes the critical line.

A user may also edit a critical line's inter-atom boolean logic. As stated, atoms exist on a critical logic line between boolean “and's” and “or's”. In the atoms list, each atom coexists with the “and” or “or” preceding it. This prefix is the boolean operator relating the atom to the atom preceding it. The first atom can assume either “and” or “or” for a prefix. Which one does not matter because this foremost prefix goes unused. Prefixing each atom with its connective logic makes the logic systematically editable. It allows editing of associated connective logic together with the atom. The editor does allow a user to edit each part of an atom, as well.

For this last, the editor provides the second list and input drop-downs mentioned. This second dropped-down list contains operators. The dropped-down input exists for specifying comparator values. The operators list provides:

and

or

!

=

>

<

% (logical modulus)

A user's click on any of these may change a selected atom in the atoms list. If no atom is selected, clicking in this operators list has no effect. =,>,<,% require additionally that the comparator input contains a value. A user's selection of one of =,>,<,% with no value in this input, yields no result. A selected atom and a value in this comparator input may exist. Then, clicking one of =,>,<,% changes the selected atom. The atom's operator becomes the selected operator in the operators list. The atom's comparator becomes the input's comparator. That is, the righthand side of the atom becomes the comparator string. Of course, changing an atom always changes its unit's critical line as well.

A user fills the comparator input with a positive integer value by typing. She may also fill it with another feedback event. To do so, she does not use these drop-downs first. Instead, she right-clicks on the feedback event in the list dropped-down by clicking the ‘Critical’ button. Then, that feedback event list closes down and the atom-editing drop-downs unfold. In other words, the editor instruments an automatic click of the downward arrow button. Additionally, the right-clicked feedback event appears in the comparator input. The comparator of the feedback event name is ready for addition to the critical line. It is added the same way as are numerical comparators. This enables comparisons between feedback event number of occurrences on a critical logic line.

As stated, when a user clicks an operator for a selected atom, the comparator becomes the right-hand side. This comparator may be a typed number or a selected feedback event. Whichever it is, the contents of the comparator input becomes the comparator. This string becomes the righthand-side of the <feedback event> <operator> <comparator> trio in the critical line. So for an atom _MOM_SPEAKS_ clicking ‘=’ with a comparator value 3 yields

_MOM_SPEAKS_{—}=3

A user may also type a value in the comparator input and press Enter. With an atom and operator selected, this changes the atom's operator and comparator. This functionality provides just another way to do the same thing. So continuing with our example, the same atom _MOM_SPEAKS_{—}=3 is selected. A user types 4 into the comparator input and presses the Enter key on the keyboard.

_MOM_SPEAKS_{—}=4

is the result. Clicking ‘<’ in the operators list would then make the atom

_MOM_SPEAKS_{—}<4

and so forth. It can prove more user-friendly to allow several means to perform the same operation. This especially holds true for complex, rigidly-defined operations such as assembling a critical line.

To remove an unwanted binary operator and comparator, a user merely backspaces in the comparator input. He does so until the comparator input is empty. Then, with the atom selected, he presses the Enter keyboard key. Or, making sure the atom is selected and the comparator input is empty, he clicks on one of the operators =,>,<, or % in the operators list. This allows removal of existing unwanted comparisons from a critical line.

Clicking on the unary operator ‘!’ in the operators list toggles it for a selected atom. Clicking on ‘and’ or ‘or’ changes a selected atom's boolean prefix to match. Repositioning an atom also repositions its boolean prefix with it.

Taken together, this interface allows exact definition of all feedback events, operators, and comparators. Via this interface a user may precisely, yet iteratively, design critical lines. The no-typing nature of the interface also prevents syntax and mal-reference mistakes.

Critical Line Interpretation and Evaluation

All atom evaluation occurs separately and prior to relational boolean “and” and “or” evaluation. In mathematical terms, atom evaluation takes highest precedence in evaluative order of operations. The unary operator ‘!’ is considered part of an atom it precedes.

As for precedence, think of or's as +'s, and's as ×'s. Multiplications (×'s), as in math, are evaluated prior to additions. So think of

_X_ and _Y_ or _Z_ as

_X_ _Y_+_Z_ in which we evaluate _X_ _Y_ (_X_ and _Y_) first as follows:

(_X_ and _Y_) or _Z_{—}

The operator ‘<’ means less than, ‘>’ greater than, ‘=’ is equal to (== in C++); and ‘!’ means not (again, only for the expression immediately following and up to the first and/or).

The logical modulus (%) operator evaluates as follows:

Given feedback event _P_, we need to find out whether or not the most recent production we have seen from _P_'s list of productions is production number k. We would write this as

_P_% k

The expression will evaluate to TRUE(1) if we are on the kth production and to FALSE(0) otherwise. For example, we want to know if the most recent production we saw for _P_ was the 7th in _P_'s playlist. We would write this as

_P_% 7

_P_% 0 is the same as saying _P_{—}=0

All logic here is basic and simple, and so too its interpretation. Expression of certain critical lines may entail some expanding-out of terms. The syntax could be more robust to be tidier, more manageable. However, such would require a user to learn and remember more syntax as well. Implementation might prove buggier. The idea here was not to provide a language, but rather a small, fully expressive set of comparative functions. For the common cases the given set proves more than adequate. For more complex logic lines, it does not preclude their expression.

A DIFS Editing and Compiling Machine: More Unit Data Interfaces

Referring to FIG. 20, a ‘Look’ button 194 opens another sub-module. This sub-module lets a user define surrounding environment presentation for each particular unit. Environment definition will be described in greater detail.

Important to know is that a user may throw a use-look switch for a unit. During run-time, a DIFS application may reach the unit. If left ‘on’, the use-look switch instructs usage of the unit's tailored environment. Otherwise, a DIFS application on reaching the unit will present a system-wide default environment.

This ‘Look’ button also lets a user define environment presentation for unit interaction. He assigns environment on a per control file basis. First, he clicks the ‘Look’ button opening the sub-module. Then he clicks on the agent+controlset line (such as “Little Red Riding Hood controls1.if1” in FIG. 20) below in the “Details of Selected Moment” module. Interacting with the environment sub-module then affects change for the selected control set. The look information is actually written to the file named by controlset in the agent+controlset tuple. This allows for different agents to present different surrounding DIFS application environments.

As mentioned earlier, another component of agent group determination logic is an alternate means of unit termination. A user provides this means by typing a single integer into the ‘Duration’ field 196. She must give this number careful thought as it will affect pacing and progression.

An audience may affect at most this many feedback events in this unit. If the audience does affect this many feedback events, a branch occurs. Otherwise, a branch may occur beforehand from the unit's critical line becoming true. 0 is a special value. It tells the unit to inherit unused turns. These turns will come from a previous unit in the thread leading up to the unit. So a quick glance at a unit's ‘Duration’ number tells how long an audience may spend there. Editing it has profound consequences on pace.

All events including “nothing happens” (or typically non-event-yielding) events count against a unit's duration. Special “butterfly” events do not. A ‘Butterflies’ interface 208 manages these special butterfly feedback events. A user types an event into the input. The editor formats the string as needed in real-time as the user types. She presses the Enter key on the keyboard to create the event for the unit. Creation puts the event into the browser list just below the ‘Butterflies’ input. This browser list always shows the butterflies for the in-focus unit. A user may delete a butterfly by right-clicking on it in the browser list.

These event inputting methods standardize syntax of all-important event feedback units. They ensure, for instance, that feedback events never duplicate critical lines. Critical lines reference feedback units, after all. To allow feedback events to be the same as critical lines could easily create circular reasoning. To avoid this, the editor creates critical lines with different spacing than regular feedback events. An additional space appears at the beginnings and ends of critical line references. Thus, standardization avoids infinite loop situations by preventing erroneous, non-distinct references. The user never directly creates event feedback references or critical lines. He only specifies them. The editor then assists by formatting these specifications properly(e.g. uniquely) according to the rules and requirements of a DIFS application to run the specified instructions.

Lower down in the unit details sub-module, an agent interface 212 manages agents for an in-focus unit. The agent name input is for typing the name of an agent to add. An agent name may be selected in the browser list below, however. Instead of adding a new agent, typing the name in the case of a selected agent in the list, is for changing the selected agent. Pressing the Enter key on the keyboard when ready commits the name. Right-clicking on a line in the list browser of agents removes the agent clicked on.

Clicking the ‘Character’ button unfolds a selectable list of all agents in the DIFS. Beside each agent name are the agent's total “beable” appearances and total appearances. Clicking a name closes the list and puts the name into the agent name input. It serves the same function as was mentioned for typing in this input. Only, this method avoids typos and views agent usage in the system.

“beable” means an agent has a control file. Agents without control files are not errors. Compiling simply removes them from the compiled version. Specification of an agent without a control file serves a purpose. It helps double-check consistent character appearances throughout a system. The editor, remember, checks agent usage consistencies across threads. Consider the following scenario. An agent makes only a cursory appearance in a production of one thread of a timestep. However, in another thread of a same timestep the agent is beable. An agent appearing in two threads in one timestep almost never makes sense. The error list form of alertion will indicate a potentially problematic design. So it is practical use of the editor to include all agents appearing in every unit, “beable” or not. The editor can then double-check DIFS sensibility in full. It can help check that a DIFS will make sense to a user in addition to what merely must make sense to a DIFS application.

A control file interface 214 manages control sets for an in-focus unit. A control file/set is sometimes referred to as an “I File”, for “interaction file”. The control filename input is for typing a control filename to add. A control filename may be selected in the browser list below, however. Instead of adding a new control file, typing the name in this case is for changing the selected control file. Pressing the Enter key on the keyboard when ready commits the name. Right-clicking on a line in the list browser of control filenames removes the control file.

Actually, the control file and agent interfaces share the same list browser. This list browser shows agent+controlset pairings. The aforementioned interfaces, then, sharing their list browser, enable management of pairings. The agent interface affects the agent half. The control file interface affects the control file half. A user may edit the halves independently, and thus manage associations between the two. It should be mentioned that right-clicking a list entry actually deletes it in full. That is, this operation removes a line containing both agent and, if present, control file. The editor allows specification of an agent without a control set. However, it disallows a control set without an associated agent. Every entry must at least have an agent; a requirement that follows directly from the basic DIFS definition.

An ‘I File’ button opens the control set editor windows of FIG. 15. Specifically, the file named by the selected filename will load into this sub-module. If the sub-module is already open, the editor first asks if a user wishes to save the already loaded control file. Then the new control file data stages into the control set editor. Possibly no control file already exists in the expected location with the given name. In this case, the controls editor creates a new empty control file to the correct location.

A DIFS Editing and Compiling Machine: Managing Feedback Event Data

Referring still to FIG. 20, the bottom-most part of the unit details sub-module manages unit feedback event data.

A ‘Possibilities Default Value’0 input 222 relates to a selectable list browser immediately below it. This list browser displays all feedback events of an in-focus unit. Selecting a feedback event in this list browser displays its default value and allows editing of that value. Default value display occurs in an editable ‘Possibilities Default Value’ input 222. A user edits by typing a positive integer or 0 into this input. Mentioned earlier, this represents the assumed number of occurrences of the feedback event. It solves the case where the unit is completely auto-advanced past by interaction with other threads. The value lets meaningful update of feedback occurrences happen off screen.

Selecting a feedback event in the aforementioned feedback event list browser has other effects. Down and to the right of this list browser is another production file list browser. This production file list browser shows the playlist for the selected feedback event. The playlist contains all production files. Their order matches the order they will play with respect to one another; the top being first, the bottom last. Each production file may be repeated on separate lines in the list. Speaking of repeating, another checkbutton (not shown) reflects and allows toggling of whether a selected feedback event's playlist should loop.

Together with each production filename, and preceding it, is the number of times to play it. Earlier a suggested mapping described how feedback event occurrences map into production file presentation. A user manages an event's playlist using this production file list browser. By clicking and dragging on lines she can change the order of the list. By right-clicking she can delete a line. Of course, selecting a different feedback event on the left re-populates the production file list browser. In this manner, a user views and edits feedback event playlists one at a time per feedback event.

A production file interface 224 facilitates creation and renaming of production files. A user may select a production file using ‘ . . . ’ or type a production filename into the provided field. Pressing the keyboard Enter key then commits the addition to the production file list browser. If a line was selected in the production file list browser, the editor renames the file.

However, a reference-count is checked prior to rename or deletion of a production file. This is to ensure renaming or deleting of a production file in one place does not break a reference to it elsewhere in the DIFS. The editor denies production file renaming or deleting if the DIFS references it anywhere else. This also occurs on deletion of a unit, a procedure which asks a user whether she wishes to delete each production file of the unit being deleted.

A user specifies the times to play a production file by typing in a “×'s” (times) field 226. Addition of a new production file uses a play times number specified here. Likewise, a user may change a selected line's playtimes. When he selects a line, the production filename and its current playtimes populate their respective fields. A user may then type over this playtimes number in the “×'s” field. He presses the Enter keyboard key to commit the change back down to the selected line in the playlist.

Initial addition of a production file sees if that file exists in the expected location on disk. If not, it creates a new, empty production file with that name. It also, for convenience, opens the production file editor sub-module (shown in FIG. 20 populated with LRRHIntro.chs). Subsequently, a user may invoke this sub-module for an existing production file. She clicks the line of the production file in the production file list browser. This puts the name of the file into the production filename input. She then clicks the ‘Link File’ button above. This opens the production file editor sub-module on the file whose name is in the input.

A DIFS Editing and Compiling Machine: Editing Production Files

“Link File” means the same thing as production file. To recapitulate, a production file contains a list of links to content files. The production file couples a media type tag with each content filename in its list. The media type tag indicates indirectly which application should present the file. This is why production files are also known as “channel” files and each bear a .chs extension. They indicate what to present and various media channels to use for presentation.

A production file editor sub-module shown in FIG. 20 depicts its functionality. It bears foremost a media tuple interface 228 for defining media type<->filename tuples. FIG. 20 shows the interface's upper rightmost button's label as ‘MOT’ for motion type. Clicking this media type button does two things. If any lines are selected in the media tuples list browser to the right, it unselects them. Second, the clicking unfolds a clickable drop-down list of standardized media type tags.

These types are not actual file formats. Rather, media types here are three-letter general type category tags understood by a DIFS application. They are AUD, IMG, TXT, MOT; respectively reserving channels for audio, image, text, and motion-type content. Clicking one of these media types changes the label of the media type button to match. Then, clicking on a line in the media tuples browser to the right, changes the line's media type to match. Clicking the media type button again serves to fold the list back up again. Clicking on media tuples list browser lines without this tags list shown, affects no change.

When a user adds a new media tuple, the editor uses the media type button's type label for the type of the new tuple. The media filename is what a user typed in the field to the right of the media type button. For this purpose, the editor provides also a file chooser (‘ . . . ’) attached to this field. A user presses the keyboard Enter key to add a new line or clicks the ‘New’ button. To change a media filename, a user selects the line in the media tuples list browser. The media type button will change to match the type of the selected line. The user may then keep the filename already occupying the media filename input. Or, he may type, or choose a file into the input. Pressing the Enter keyboard key changes the filename on the selected line to match.

Even a fresh, blank production file bears a first line with the ‘ATX’ tag 230. This line must always be the first in a production file. It reserves standard location in the production file for an all-text version filename. This holds, regardless if one is provided. An all-text version describes, like a storied caption, the production file. Usually other representative media in the production file is derived from a script. Thus, during design, it should usually prove trivial to provide at least some rough ‘ATX’ file. The first line always has the ‘ATX’ type which no other line has. This first line furthermore is non-re-orderable.

Other various media tuples 232 follow in the file. The file is further segmented by production intermission breaks 236. A user may re-order these lines in the media tuples browser by clicking and dragging on them. A DIFS application will try to spawn one handler application per tuple. Earlier tuples, those topmost in the tuples browser, will get spawned first and the rest going downwards, progressively later in the order.

Computer operating environments many times might be configured for a low limit of allowable number of process spawns. Production breaks exist for this reason as well as to enable tighter sequencing of presentation. Often times a designer desires spawns to follow strictly in order. Without breaks, this would be unpredictable at best. Different applications take different amounts of time to start and finish presentation. Breaks may intervene and require termination of all prior processes. Until processes spawned prior to a break terminate, a DIFS application will not commence presentation through the production file's list. A user specifies a break by clicking on the ‘BRK’ button lower-leftmost in the production file editor sub-module.

There is a one-to-one correspondence between tuple list browser lines shown and lines in the actual production file. The goal here was to provide a quick view into a production file; as well as to allow editing of the file in a structured way with the fewest number of clicks (and least unnecessary work). In other words, this sub-module should not be too much of a bottleneck during production. Even were the editor a bottleneck, production files are simple. A quick but careful user might write them by hand or devise some other faster means for their creation.

Finally, back in the unit details sub-module 188, is a ‘Preview’ button. For a production filename specified in the production filename input, clicking this button previews the named production. Previewing executes via exactly the same mechanisms as real playing of the production will in the DIFS application. A user should preview every production file at least once. In this manner, she can be more certain how feedback will play to an audience.

A DIFS Editing and Compiling Machine: Combining, and Compiling

Referring still to FIG. 20, buttons along the top of the main window access primary functionality. The ‘Open’ button 198 loads in a new story if the system map below it is empty. If the map contains a story already, a dialog asks what a user intends to do. He may wish to combine the loading-in story with the one already present in the map. The dialog message looks like this:

Story already open. Combine these two stories into one? If not, click Cancel and the selected story will begin loading.

If combining, follow the procedure below to ensure the stories synch-up smoothly:

1 Prior to combining make sure every field (including Default Look, Style, etc.) in the respective stories' configurations is identical. Both configurations must agree completely. Control files, media files, and/or applications used by the stories may need adjustment before continuing.

With regard to applications, it is therefore good practice while designing to use full paths for handler programs. Only when the deliverable is ready, then make all paths relative to the root—the parent directory of the main story directory of the distribution. Relative paths make included applications automatically detectable on the audience end.

The final configuration of the load in *to* story must suit both stories' needs. The final title of the production will be the title of the story being loaded in *to*. Autosave time lapse also will remain the load in to story's current setting for this feature.

[Autosave is an editor function that saves to a backup file after a certain lapsed time interval. This interval is specified in a DIFS being edited.]

2 In the load in *to* story's sub-directories, manually copy over all files from the load in *from* story's respective subdirectories. Resolve filename conflicts in the original load in *from* story should they arise. Any changes to filenames should also be reflected in the DIFS editor at this time to ensure no links are lost.

3 After steps 1 and 2 you are ready to try importing. Click OK below. The DIFS editor will inform you of any rules violations that may initially prevent the combination of these two stories.

Possible violations are

1 The two stories must not cross-reference one another. Meaning, if the stories have different titles prior to combination, they must not alias feedback events from one another, as this can lead to logic inconsistencies on import. Once combined, it is fine to inter-alias as usual, subject to the DIFS editor's regular design rules,

2 Similarly (and more obviously) before the combine, no original (non alias) feedback event from either story can have the same name as a feedback event in the other story. The DIFS editor will print a list of name conflicts, if any, in the file CombineLog.txt in the current story directory. Conflicts in CombineLog.txt need resolving before the story merge can be successfully completed.

3 The total number of feedback events of both stories added together cannot exceed 1000.

4 The two stories _must_ have at least the same number of I-applications.

This combination ability is consistent with another feature of a DIFS editing machine. Namely, that it possess a function to combine two sets of human-readable instructions to generate dynamic interaction and feedback system data into one set of human-readable instructions to generate dynamic interaction and feedback system data, whereby two initially separate dynamic interaction and feedback system data sets may be made a single dynamic interaction and feedback system data set. All aforementioned rules must check out okay for both systems with respect to one another. The combine process does not complete before performing thorough checks. The editor alerts about any incompatibilities and how to resolve each problem. As during final DIFS compilation, it may log a file.

DIFS combination promotes sharing amongst DIFS developers. It encourages teams to develop components independently in parallel. Moreover, with multiple threads of action possible, wholly independent storylines can peacefully co-exist in a single DIFS. Intriguing and unexpected new possibilities arise from juxtapositions. DIFS scope can broaden horizontally as well as vertically. An end user gets a wider array of simultaneous agents and storylines to choose from.

The ‘Compile’ button 200 invokes an interface for saving, compiling, and configuring the full instruction set loaded.

This interface, in turn, has robust tools for handling other DIFS system-wide issues. It has buttons for configuring initial recommended setups, for saving and copying DIFS system files (i.e. storage means to store said human-readable instructions to generate said dynamic interaction and feedback system data), and for compiling a loaded DIFS instruction set into instructions readable by a dynamic interaction and feedback system application.

This last all-important feature meets DIFS specification of a converting means of human-readable instructions into data readable by a dynamic interaction and feedback system application. Compiling here can compile only a central DIFS system file or both a central DIFS system file and all control files referenced by it. Compilation optimizes each file to a minimum size. They are harder to parse for humans; a fact desirous in case cheaters try to learn about the DIFS by reading system files. Of course, the new files are also easier for the DIFS application to understand and work with, and small for optimal transfer over lines for digital distribution.

Compilation ensures a DIFS's own compiled files are minimally small. This helps for distribution over the internet or on CDs. However, compilation does not clean up the rest of its directory structure. Before final distribution, a designer would probably want to remove all unnecessary files. Removed should be any unused files to save space. These include the somewhat revealing editor-version system and control files. A good strategy would be to remove the system files last. That way, after the rest of cleanup, a designer could preview all media to ensure link integrities one last time. Obviously, for removed system files and content, keeping backups would be desirable.

As mentioned earlier, compilation also performs last-minute error checking and logs of errors and warnings to head-off potential mistakes. Besides full compilation, the interface of the ‘Compile’ button can compile other information. It has buttons for compiling outlines, required productions, and other gathered data about a loaded DIFS. Such DIFS overviews and checklists are all designed to help with development workflow processes. They snapshot a work-in-progress DIFS in comprehensible form for consumption outside the editor.

Right of the ‘Compile’ button 200 in the main window is a ‘Find’ button. Clicking this button opens a module for searching through all units' data. A user specifies at least a string in this module. She may also specify whether to search forwards or backwards. Data searched includes all data directly viewable in the unit details sub-module 188. The ‘Find’ function searches all units and fields in the order specified. In this way, ordered searches may proceed, in either direction, from any unit in focus.

A DIFS Editing and Compiling Machine: New Unit Creation

Right of the ‘Find’ button is a ‘Moment’ button 202. A user left-clicks this ‘Moment’ button to create a new unit. The present DIFS must have a title. Nor may any other unit on the system map have the default event still defined. If these conditions hold true, a new unit will appear on the map. The new unit will become the in-focus unit. If the unit details sub-module 188 is shown, it will show mostly empty data corresponding to the newly created unit.

Right-clicking on the ‘Moment’ button 202 creates a copy of an in-focus unit. Of course, this will not create an exact copy, but rather all replicable structure. What is copyable the editor will copy. However, copying connections to and from other units, for instance, would break rules. The same goes for copying verbatim a unit's feedback events. The latter problem proves most troublesome. To be useful a copy must inherit feedback events and their associated data. Therefore, all events do come across in a copy, only with a ‘.’ suffixed to each of them. So, _MOM_SPEAKS_ would, in the copy be _MOM_SPEAKS._; to copy the copied unit would yield _MOM_SPEAKS.._ and so forth.

This merely preserves most unobtrusively the uniqueness that the rules of editing require. A copied unit will function in all ways identically to how the original functions. A copied unit critical line, of course, references its own ‘.’-suffixed feedback event(s). All feedback event data remains intact. As for control files, they always reference local events from the local unit, remember. Thus, they may require little if any editing. However, a user must be careful editing such a control file. Now more than one unit references it. Customizing it to one may likely break it for the other(s). To solve this, a user may simply copy the control file(s) and point any new unit(s) to the duplicate control file(s).

A user may have any of several reasons for copying a unit. He might wish to copy structure of a complex setup. Most of a setup may prove re-usable for a new unit. He may be modeling a time-loop or an alternate branch. Perhaps only subtle changes result when going one way instead of another. Perhaps he wishes to make several copies to vary each along its own lines of variation. Another reason might be that a critical line branches more than one way. Perhaps part of it elicits a change in agent list or feedback event availability.

Yet another reason could be that a DIFS needs order information about unit events. The DIFS has no explicit means of inquiry regarding feedback order of occurrence. Usually division into units implicitly orders feedback events. Feedback events in later units always follow feedback events of earlier units.

However, in a situation where order information is desired, agent group determination logic may prove too ordered. In this case, active controls selection logic may provide slightly less restrictive structure. Given that controls lead to events, screening controls effectively screens feedback. However, another desired effect expressly unorders feedback events, subsequently checking their occurrence order.

The tried implementation discourages logic based on order for one simple reason: it's hard on a user. Puzzles involving temporal ordering are confusing at best. Figuring out which of all permutations to make happen and how is difficult enough. It can prove downright tedious to try to make events occur in order. An audience, remember, does not know which order is desired. They may easily frustrate and tire of trying to surmise a correct procedure. Forced repetition bores. Many, not anticipating such a puzzle, might miss the reasoning altogether.

A user makes an alias unit by clicking the ‘Alias’ button 204. A new empty alias results for which a user must then define a critical line. A right-click copies exactly and in full an in-focus alias unit. An alias need not be unique. Aliases are copyable because they are just references to necessarily unique feedback events.

A DIFS Editing and Compiling Machine: More about Event Duplication

It may well be desirable that a DIFS application considers separate events as one. Especially in light of unit duplication and duration inheritance, similar schemes would seem to be in order at the feedback event granularity. Indeed, a tried DIFS does provide for individual feedback event data sharing. e.g., in terms of feedback registration, several feedback events can operate as one.

Consider four feedback event names

_MY_EVENT_ _MY_EVENT._ _MY_EVENT.._MY_EVENT..._{—}

A period at the end of an event name duplicates it from a pre-existing event with that event name. So in the above example, _MY_EVENT._ duplicates _MY_EVENT_, and _MY_EVENT.._ duplicates _MY_EVENT._ and so forth.

Note that an event name can have a period at its end and not be a duplicate. A pre-existing event must bear the same name minus the period. Otherwise, the dotted name event behaves like a regular non-duplicate event; because it is not really a duplicate of any other event at all.

Each chain starts with a head that is not a duplicate. The remainder of the chain's events each duplicate another event respectively in the chain. In other words, the above example is a chain of four events. Removal from the story of _MY_EVENT._, a perfectly legal move, would break the chain into _MY_EVENT_ and a completely separate chain of the two events

_MY_EVENT.._ _MY_EVENT..._{—}

Chains of duplicates are important for three reasons. First, a duplicate D in a chain inherits occurrence values from all prior events in the chain. “Prior” means events in the chain that:

1) exist in a timestep preceding D's timestep, or, in the same unit or a preceding unit with respect to D in D's thread; and

2) are closer to the head of the chain than D (i.e. having fewer dots).

Note that occurrence value inheritance follows a chain all the way to its head. Events along the way may or may not meet conditions of “Prior”-ness. The occurrence value inheritance algorithm just ineffectually adds 0 to D for non-“Prior” events. It does not stop on them. This facilitates many various special designs for inheritance.

Also note that unit duration is not affected by inherited values. A duplicate's occurrences only count against its unit's duration when the duplicate itself occurs.

Secondly, the DIFS application will play but not re-record recurring same-name productions of events in a chain. This non-repetition beneficially affects the functions of writing out a book and replaying past action.

Thirdly, and finally, chains influence interaction sequence conditions' checking of the last event that a user directly made happen. Checking last event as such against one event of a chain effectively checks whether any event in the chain was the last event, even across threads.

A user employs chains of duplicates carefully to extend a same event further across one or more units. Keep in mind, a default value of a duplicate is actually a suggested minimum occurrence number. If the sum total of inherited event occurrences is greater than the duplicate's default, a DIFS application will never re-interpret the past. Rather, the true default value of the duplicate will be the sum of the chain leading up to it. Only if said sum does not exceed the default value will the default value increase occurrences at the duplicate's point in the chain (to be the default value). Thus, advancement may affect slightly differently duplicate event default behavior. This is to be expected. Duplicate events are for grouping them as one with one or more other events.

A DIFS Editing and Compiling Machine: Main Screen Rules Enforcement

Still referring to FIG. 20, a ‘Rules’ button 206 opens the rules sub-module shown in FIGS. 19a and 19b. These figures show most, but not all of this rules sub-module. A user correlates pop-up numbers with rules contained in this sub-module. She also may use the window at any point during design for reference.

Still referring to FIG. 20, the aforementioned rules pop-up window 210 signifies errors. The editor makes every attempt to display this window when entering an error state. The immediacy helps a user resolve problems as they occur so that the errors are not inexplicable. This window prevents problems from being missed until DIFS run-time in a DIFS application. This pop-up window 210 refers a user to a rule in the aforementioned rules sub-module. In FIG. 20 a recent user interaction has resulted in errors 4 and 6. That is, placement of a unit put the DIFS in error. At least one event of the unit's feedback now exists in the same timestep as the event's reference in another thread. Also, one of the unit's agents exists in the same timestep as another thread containing that agent.

An errors list browser 234, described earlier, notes precompile-allowed persistent errors. This is a list of all known errors in the currently loaded system. It reminds a user of the previously described errors and briefly explains each. This assists a user's understanding and preventing errors as they occur, or in her re-finding and fixing these errors later. Only when this list is empty will the editor allow compilation. Thus a much cleaner DIFS application-ready format results.

A DIFS Editing and Compiling Machine: Units, Timesteps, & Relationships

As discussed earlier, editing restricts unit positioning to only legal moves. These constraints assist clear thinking within rules. They better assure success by preventing the trickiest, most subtle logic errors.

A box around a unit indicates that the unit is the in-focus unit 216. An in-focus unit serves as point of reference. All unit details sub-module 188 information draws from this in-focus unit. A user first opens this sub-module by clicking on the leftmost part of a unit, then clicking on ‘Details’ in the drop-down menu that results.

This drop-down menu shows all regular (non-butterfly) events in a unit. It also gives options for auto-scrolling the unit critical line on the system map(‘Magic’), and deleting the unit (‘Strike’). Also, selecting an event in the drop-down menu and pressing the Delete key deletes that event. The editor disallows deletion of an event as long as a reference to that feedback event exists. Likewise, the editor prevents deletion of a unit while external references to any of its events exist.

A user may define connections from an in-focus unit to other units. She clicks on one of two round interconnection buttons 220 attached under a unit. Next, she clicks on another unit. This procedure designates the next unit to go to for that branch. Chains of two or more such connected units form “threads” as discussed.

Which interconnection button a user connects via has significance. The left interconnection button defines the case for the alternate branch. The DIFS will follow this branch when the unit duration lapses. The right interconnection button's connection defines where to go for the other case, in which the critical line evaluates to true first.

This interface provides all needed functionality so far described for interlinking units. Any number of connections may connect to a unit, but only two connections leave it. Neither, either, or both connection buttons 220 are actually required to connect to a next unit. These may connect to the same or a different unit as well. The editor requires only that connecting follow DIFS rules.

Creating and interlinking units in this editor suffices for organizing feedback blocks into a loosely-connected network. Defining these paths, along with unit durations and a limited amount of guiding logic, is a tried means of providing rules governing traversal by a participant of said loosely-connected network.

A timestep interface 218 consists of a timestep button and number display. The button is shaped like a rightward-pointing arrow. Left-clicking this button draws a new differently colored line across the screen. Lines represent timestep boundaries. To cross a line going down goes from one timestep to its successor. Similarly, scrolling down/up causes the timestep number display to increment/decrement. The number of this timestep number display always corresponds the button's pointed-to timestep. This way a user always knows which timestep is which. It helps navigation and comprehensibility. Together with the mentioned error-reporting mechanisms, it also helps resolve errors. A user may cross-reference timestep errors listed in the errors list browser 234. Thereby, using the error and this number display, he easily searches during fixing.

Errors-reporting also ensures a user knows unit positioning relative to timestep boundaries. The editor catches close-calls where units sit near a boundary line. These boundaries' implementation is consistent and clear, but a user may need reminding. She may try a temporary error case. This helps to know which screen coordinate a unit references from while determining the unit's position. The tried editor would inform that it uses the top-left corner of the unit. The editor performs all unit ordering and timestep calculations for the unit from this position.

The timestep interface 218 demarcates and defines timestep boundaries. Right-clicking on the timestep button deletes the nearest timestep boundary line to the button. This effectively unites the two closest timesteps into one.

The editor performs much error checking during such an operation as well. Several rule violations relate to same-timestep errors.

Note also: A tried DIFS application auto-advances past potentially empty timesteps throughout. Otherwise, an editor and rule might preclude timesteps containing no units.

A Surrounding Environment Interface

According to the present invention of a DIFS, a DIFS further comprises: a surrounding environment in which the DIFS presents controls and feedback to a participant; automatic updating of said surrounding environment based on the state of the DIFS; whereby said surrounding environment provides contextual cues to the participant as to temporal and spatial progress through the DIFS of said participant.

FIG. 21 depicts an example of a DIFS editor sub-module for customizing surrounding environment elements. This figure highlights aspects salient to surrounding environment (content) configuration.

Firstly, a DIFS application configures itself according to a provided “style” file. So that the DIFS application may read any “style” file, all such files share an identical format. “style” files define certain customizable GUI elements of a DIFS application. A loose equivalent to this might be the popular “skins” used in music players. These applications allow a user to provide certain predefined “look-n-feel” characteristics. Thereby, a user tailors a program to suit his personality, taste, and aesthetic. Furthermore, a customizable GUI may help a user comprehend program functionality.

“Style” here, however, is not user-customizable by a DIFS application end user audience. Only a designer—a user of a DIFS editor program—links-in a “style” file. “style” facilitates tailoring of a general DIFS application's GUI to suit a specific DIFS. A sci‘-fi’ DIFS for instance might use a futuristic-looking GUI; a murder mystery DIFS, a more conservative prevalent graphical theme.

A DIFS editor user customizes a DIF's style by first writing a “style” file. A DIFS editor comes with at least one or two example “style” files. They are human-readable/writable ascii text file scripts. Working from example and a few instructions, a user defines an appropriate style. For instance, each “style” file defines certain common placements, colors, and graphical images. The latter files must exist in the ‘style’ directory of a DIFS. A “style” file in that directory then references these items by name.

Referring to FIG. 21, a user having a style file is now ready to use the editor. She navigates menus to this ‘Instructions’ sub-module of the DIFS rule-based editing and compiling application. She has already copied and modified an existing style-file as described. She now pushes the ‘Style:’ button 240. This opens a file-chooser sub-module for specifying a “style” file. The file-chooser closes on her canceling or choosing a new “style” filename. A new name, if any, appears beside the ‘Style:’ button 240 to its immediate right.

Further right, an ‘Instructions’ sub-module of a DIFS editor lets a user define a ‘Default Look’. He clicks on the button with this label. Doing so opens a ‘Backdrop Look’ sub-module 242 crafting a DIFS-wide default surrounding environment. This default substitutes for a unit's volunteering usage (see above) of its own surrounding environment. For lack of unit-volunteered surrounding environments, the DIFS application uses this one. For simplicity and consistency, the editor uses this same sub-module for unit-defined surrounding environments as well.

At top, the ‘Backdrop Look’ sub-module 242 contains a title interface 244. Not to be confused with a DIFS's title string, this one applies to presentation. A user names a DIFS when she saves it to disk. Doing so effectively titles a DIFS. The title input of the title interface 244, on the other hand, may specify no filename. In this case, a DIFS application uses just the text title of the DIFS. This string will display in the title region of the screen during DIFS operation. The DIFS application drops any extension (such as “.stx”). This shields the audience from implementation.

Otherwise, a user provides a filename in the input of the title interface 244. She does so not directly but via a file-chooser sub-module. She invokes this sub-module by clicking the ‘Title:’ button of the title interface 244. This file may be of any type compatible with an ‘Image Converter’ application specified elsewhere into an image format natively understood by a DIFS application to be used.

Any time any interface image needs presenting a DIFS main application invokes this ‘Image Converter’ application. The main DIFS program waits for this program to terminate. On successful termination, an ‘Image Converter’ writes a result file named ‘result_image’. The main DIFS program should be able to read ‘result_image’. JPEG, for instance, is one type the main program understands. If the image is already a JPEG, the converter performs no conversion. A converter and/or main program can handle any number of formats.

This ‘Image Converter’ application, thusly, is a separated-out module purely for negotiating formats. It allows a general DIFS program to remain general. Developers can write image converter programs to accept different or emergent image formats. They need not change at all the main DIFS application. Specification of an image converter affects the surrounding environment only. Specification of feedback event presentation (media) programs will be discussed later. The major difference is that the converter produces output that the main program presents. Other specifiable handler programs themselves present event feedback.

This is what is intended by specification of the present invention that controls and feedback and the surrounding environment in which it is presented may use any representative media respectively compatible with external handler applications.

To preview the setup of the title, a user clicks the ‘Preview’ button of the title interface 244. With both title filename and image converter specified, this runs the latter (converter) on the image file specified by the former. The editor previews using all the same presentation logic as a corresponding DIFS application. It applies any specified transparency image mask(see below). With no filename or converter specified, previewing shows the DIFS's title—i.e. the name string. The desired colors for text title and its background also display.

A color interface 248 specifies a background layer of a surrounding environment screen element. The title interface 244 also specifies title text color for a non-image title. For the title text color--clicking the ‘text’ button toggles between black and white. A black text color offsets a title from a lighter-colored background; a white text color from a dark background. A user may thus offset a text title from any background color. As for defining background color, a user does so by clicking the colored square right of ‘color:’. This square shows the current background color here. It opens a color sub-module for re-specifying the background color.

Besides a title, a DIFS surrounding environment comprises a full-screen background. To define this background, a user interacts with a background interface. A background breaks down further into a centered and a tiled component. The centered component is a single image positioned in the center of the screen; the tiled component, a single image repeated from the screen's center outward in all directions. Solid color, defined via a background color interface, is the bottom-most layer. The tiled layer sits just atop the color layer. Uppermost of all, the centered image layer tops the stack of layers.

As with the title image, interfaces exist for background centered and tiled images. They comprise the background interface and operate the same way as the title interface. The background centered interface 250 allows a user to specify a centered background image. A file chooser for this purpose appears when a user clicks the ‘centered:’ button. A ‘tiled:’ button does the same for the background tiled interface 254. The centered and tiled interfaces display their respective image filenames if any.

A Surrounding Environment Interface: Real-Time Transparency and Zoom

All surrounding environment images discussed may use a transparency mask. Therefore, the interface of each contains also a corresponding transparency interface 252. This interface has a button and an input. The button toggles editability of the input and specifies whether to use transparency. The button's label also changes. ‘rgb’ stands for the solid color channels of red, green, and blue. When the button's label is ‘rgb’, the input is uneditable; the result non-transparent.

When the label is ‘rgba’ the additional ‘a’ stands for the alpha(transparency) channel. The input becomes editable. A user may type an integer into this input. The integer actually represents the filename extension of a transparency mask file. The mask file's name must be the name of the corresponding image. So a mask file for Enthee5.jpg would be this filename with an extension concatenated. Example:

Enthee5.jpg.0

These requirements enable minimal storage for unique identification of mask image files. A DIFS application may identify uniquely and thus locate each mask image.

A mask image provides grayscale pixel data. A black mask pixel instructs total transparency at the equivalent location in the image;

a white mask pixel, a completely opaque image pixel. Shades in between represent the spectrum of partial transparency. Transparency, by definition, takes into account color(s) of lower layers. The DIFS application implements transparency functionally, independent of image formats. By computing transparency in real-time, the DIFS application makes the fewest assumptions. Color combination computations merely figure a resulting flat picture based on colors and transparency at each layer.

Finally, clicking a zoom factor button 256 toggles between several size-multipliers. This button's label reflects a specified multiplier factor. The DIFS application supports zooming by x1, x2, x4, x8, and x16. Choosing any of these but x1 instructs multiplication of image pixel color data. The multiplication occurs first for the tiled layer, if any; then for the centered image, if any. Multiplication occurs independently for each layer, prior to combining the final complete image. This effectively “zooms” the image just before any positioning and potential transparency calculations. “zooming” effectively grows an image at the expense of its resolution quality. Sometimes, bigger is more important than higher quality. Especially when filling a full-screen background for a surrounding environment, zoom helps.

A “main background” supplies a backdrop for feedback presentation. In addition to these, interaction sequences also have separately defined backgrounds. An ‘ILook’ interface 258 functions the same as the one above it does for the default main background. The only difference: it exists for defining a default interactive sequence backdrop look, as opposed to a main (feedback-playing and agent selection) backdrop look.

As was mentioned earlier, units each may opt to use their own surrounding environment. A unit's respective environment may override the default while feedback plays from the unit and while a user is to select an active agent. Similarly, as stated, an interactive sequence may have its own custom surrounding environment. A control file stores data necessary for this purpose.

Two Aspects of Metadata: Legal and Other Information

FIG. 21 further highlights an editor's fields for defining legal and other information. Considerably large, these fields allow multiple lines of text input. A designer types any text she desires a user to see on startup of a DIFS.

FIG. 21 shows an editor interface. This text is also available in a DIFS application mirror interface, discussed below. However, the DIFS application does not intend any editing. It exists purely for display and audience-consumption of the text. In the mirror interface, a user may access this important information at virtually any time during DIFS operation.

When a DIFS application user begins a new DIFS or a version of a DIFS not loaded currently, the DIFS application presents dialogs. Foremost, it presents designer-specified “legal” information. This may include any text a designer types into the ‘Legal’ field 238. This text input field contains multiple lines and is scrollable.

Legal information may contain anything from credits to ownership rights, licenses to usage agreements, third-party information to any other essential need-to-know information up-front. A DIFS user audience must agree that they understand and accept this information. Startup will not proceed until they so agree. This scheme ensures end-users regard all DIFS designer legal information on entrance. Prerequisite audience acknowledgement of legal information is a relatively common practice with software and artistic pieces.

The DIFS application also presents on startup an option to use a recommended setup. Displayed in conjunction with this choice is text a designer provides via the ‘Other’ input 246. This input defines all other in-program information.

Besides purely setup-related information, this text might describe any of the following: requirements, recommendations and preferences, expert and/or beginner instruction, getting started help, hints, how-to's, step-by-step configuring help, known quirks and optimal setups of handler applications, rating and age-level appropriateness, warnings of various sorts, related resource material, inspirations, sources, promotions, thanks to others, making-of's, more legal information, and anything else related to a DIFS a user audience might like to know.

‘Other’ information provides a rich, dynamic text storage container for non-functionally-structured metadata. It is a direct communication repository, always available in-program, for a designer to reach a user audience.

Keep in mind that the DIFS application makes both other and legal information available all throughout operation.

</TE>

Operation

Agent Groups and System State

Referring to FIG. 3, agent group determination logic, user interaction, and system state interoperate. Together with active controls selection logic, these form fundamental DIFS operation. A DIFS application runs circular function calls to simulate the operation shown. Each turn ends when the end of a terminal interaction sequence breaks the circle. Then user selection of an active agent typically begins a new cycle. A DIFS application uses DIFS data compiled from a complementing DIFS editor. Operation description will focus on DIFS application operation, as DIFS application operation equates to operation of the present invention of a DIFS.

A turn begins with a DIFS application, based on DIFS state such as at 36, filtering such as at 38 an agent group such as 28. A potentially larger set of agents comprise the set of all agents 40 in a DIFS. A DIFS's state tells the DIFS application which group of agents to present. This group can be all of the set 40, some, or none of the agents in the DIFS.

The DIFS application presents the group of agents determined. A user then selects from the group a single agent such as at 30 to be a present active agent. Various DIFS implementations may color differently what happens next.

The fundamental action is that active controls selection logic determines controls. A user then interacts such as at 32 with these active controls. User interaction may result in a change in system state as at 34. At 34 the DIFS application increments a state bit(TE). This incrementing represents occurrence of a feedback event at this memory location. The incrementing simultaneously represents one way of recording of feedback to feedback memory.

Accumulative feedback memory as such, forms the basis for the beginning of the next turn. That is, consequent states of the DIFS will guide future agent group determination.

Agent Group Determination Using Current Units in a Multi-threaded DIFS

Referring to FIG. 6, regarding FIGS. 5a and 5b, current units determine agent groups.

Each DIFS data unit contains its own list of agents. A DIFS application advances each thread as far as possible. As far as possible is to the thread's next unit containing agents and turns whose critical line does not immediately evaluate to true. Otherwise, as far as possible is after the last unit in the thread (i.e. the thread terminates). When all threads have advanced as far as possible, a DIFS application waits. It presents an agent group consisting of agents from all current thread' current units. A user must select an agent to be a present active agent.

That said, FIG. 6 charts agent group determination for every state of the DIFS presented in FIGS. 5a and 5b.

Possible in the first timestep are many agent combinations. This is because multiple threads of action exist in the first timestep. One multiple-unit thread contains units that amongst them have all permutations of the agents: Prot1, Prot2. Two more separate threads contain agents “Antag” and “Antag's Ally” respectively. Thus, every permutation of all 4 agents is possible in timestep 1. That is to say, depending on user interaction, any of 15 agent combinations are possible. A user may potentially see any of these as an agent group during the first timestep of this DIFS. Which one(s) depend(s) on the user's interaction.

Timesteps two and three each contain one thread only. Thus, their potential agent groups follow agent lists of units in their respective thread. Once again, of course, in one straight run-through, not all permutations are possible necessarily. For instance, in these single-thread timesteps, branching one way instead of another yields different agent groups specific to the followed branch.

Lastly, timestep 4 contains no units bearing agent lists. The unit timestep 4 does contain, exists to allow skipping of preceding timesteps. Specifically, the empty unit in timestep 4 allows skipping of timestep 3 from certain timestep 2 branches. This is a good example of how to terminate a DIFS early. Certain branches may always lead down to an empty later(or last) timestep.

Detailed (Tried) Agent Group Determination Logic Operations

Referring to FIG. 7, a tried DIFS application applies particular agent group determination logic. Its agent group determination logic begins as soon as a user loads a new or saved DIFS 50. Live, looping functions round-out static data to complete agent group determination logic. The code shown below represents only one tried approach.

It is intended as an example. It is by no means a final, catch-all last-word. Many alternative implementations might serve agent group determination logic as well or better.

<TE>

Still referring to FIG. 7, in a first step of the functional loop, the DIFS application tries to advance the DIFS to the first active timestep, 52. “active timestep” means a timestep containing a unit with at least one agent and turn. To be an “active unit” as such, a unit must also have a critical line that does not immediately evaluate to true; the idea being an audience can participate here, hence the “active unit” designation.

The DIFS application performs all tasks to advance the system to this new state. The same advancing procedure runs when a unit's critical line evaluates to true, 82. Also, the DIFS application invokes this procedure when a unit's turns run out, 84. In other words, the same advancing occurs on branching from a unit.

The following C++ code listing gives the essential advance procedure functionality. Keep in mind subtle differences if cross-referencing with tables in FIG. 7. All indices here are one less than their FIG. 7 counterparts. “State Main Matrix” here is just “MainMatrix” for short. “characters” and “thoughts” are used to mean “agents” and “control set filename” respectively.

On startup of a DIFS, a DIFS application calls, among other things, the following below-listed functions, in-order:

useDefaultValuesForODurationThreadToppers( );

LoadNextActiveTimestep( );

PostRecursiveAdvanceCurrentMomentslnitialise( );

Subsequently, after an event at SMM_feedback_idx (or ‘nothing happens’) occurs, a DIFS application could evoke advancement via

Advance(SMM_feedback_idx, 1); PostRecursiveAdvanceCurrentMomentslnitialise( );

Of course, this latter would be after the DIFS application records the event, if any, to feedback memory (i.e. MainMatrix state bit, productions string, restore vector, and/or anywhere else it needs to). Discussed below, a tried implementation does not store nothing happens events. This is considered wasteful as these can be inferred from more meaningful storage.

As promised, the full C++ definitions for all of the aforementioned advance functions follow:

```
void AddRestorePossibility(int possibility);
void AddStandardCommandsBrowser( );
int Advance(int aMRP,int dec=1);
int AudienceAffectedMoment(int MRM);
void AutoAdvanceCatchUp(int CMRM);
void checkRuleEightPointFive(int MMI);
int FindCurrentMomentIndexFromID(int ID);
int GetPossReferenceValue(int MMidx, int ORIGINAL_MMIDX);
void InitialiseMomentStateIfIsnt(int aMRP);
int InsertNewMRPInMRPMatrix(int aMRP);
int IsAlias(int moment);
void LoadCommandsBrowser( );
void LoadNextActiveTimestep( );
void MakeAllThreadPastKnown(int moment,int andpresent=0);
void NullifyUnknownPast( );
void PostRecursiveAdvanceCurrentMomentsInitialise( );
void SetMomentPossibilityStatesToDefaultValues(int moment);
void ThreadCheck( );
void ThreadClean(int moment);
void useDefaultValuesFor0DurationThreadToppers( );
void AddRestorePossibility(int possibility) {
/*handles additions to the restore vector for later restoring. This is a significant part of the feedback memory
record.*/
  if(!RestoreArray){
  /*this is just code to make a vector (a growable array).
  The RestoreArray class is just an array. The manager
  manages additions and subtractions efficiently so that
  the array behaves like a vector.*/
  RestoreArray=new int[1];
  RestoreArray[0]=possibility;
  RestoreArrayMgr=new IntManager(RestoreArray,1);
  }else
  RestoreArray=RestoreArrayMgr->AddInt(possibility);
int pba=ProductionsMatrix[possibility].booked_intro_at;
if(MainMatrix[possibility][7]==possibility){
  if(pba>=0){
  //remove the previous restore array spot for the intro...
  RestoreArray=RestoreArrayMgr->RemoveInt(pba);
  /*and slide all ProductionsMatrix pointers to after
  removed index down by one.*/
  int I=ProductionsMatrix0;
  for(I;I<tPOSs;I++){
    if(ProductionsMatrix[I].booked_intro_at>pba)
    ProductionsMatrix[I].booked_intro_at--;
  }
  }
  /*and point the ProductionsMatrix booked_intro_at
  ptr to the new location in the RestoreArray.*/
  ProductionsMatrix[possibility].booked_intro_at=
  RestoreArrayMgr->numelts−1;
  }
}
void AddStandardCommandsBrowser( ){
/*removes former selectable commands and agents and re-adds the commands only. Agents are added separately
afterwards based on agent group selection logic. “CommandsBrowser” is an interface object for handling all data
and presentation related to a menu like the one dropped-down in FIG. 8.*/
  CommandsBrowser->clear( );
  CommandsBrowser->add(“$Load”);
  CommandsBrowser->add(“$Instructions”);
  CommandsBrowser->add(“$About”);
  CommandsBrowser->add(“$Write Story”);
  CommandsBrowser->add(“$Exit”);
  CommandsBrowser->add(“$Restore”);
  CommandsBrowser->add($Save:”);
  BASECOMMANDS=CommandsBrowser->size( );
  int ii;
  for(ii=0;ii<7;ii++)
    if(MENU_MASK[ii])
      CommandsBrowser->show(ii+1);
    else
      CommandsBrowser->hide(ii+1);
  CommandsBrowser->value(0);
  CommandInput->value(“”);
}
int Advance(int aMRP,int dec){
/* to decide how to move the storymap after the interaction ends and whatever action results.*/
  //Find where we are and Decrement the intra-moment time
  int I=CurrentMomentMatrix0;
  int D;
  for(I;I<CurrentMomentMatrixN;I++){
    if(CurrentMomentMatrix[I][I] == MainMatrix[aMRP][1]){
      CurrentMomentMatrix[I][2]=
      CurrentMomentMatrix[I][2] − dec;
      CurrentMomentMatrix[I][2]=
      (CurrentMomentMatrix[I][2]<0)?0:
        CurrentMomentMatrix[I][2];
      break;
    }
  }
  if(I==CurrentMomentMatrixN){
    //end Advance couldn't find thread for feedback event
    return 0;
  }
  /* determine the need to advance, and if so, how far to advance,
  incrementing the CURRENTTIME and collecting all new threads that
  might arise along the way.*/
  int moment=CurrentMomentMatrix[I][0],
    evaluatedstate,
    spilloverTime=CurrentMomentMatrix[I][2],
    newcurrentmoment,
    mycurrenttime,
    J,
    advanced=0;
  while(1){
/*The following ‘assignDefaultValues’ is determined at load--a ‘1’ is a root 0-duration unit:(see
useDefaultValuesFor0DurationThreadToppers)*/
if(assignDefaultValues[CurrentMomentMatrix[I][0]]){
  SetMomentPossibilityStatesToDefaultValues(CurrentMomentMatrix[I][0]);
  InsertNewMRPInMRPMatrix(CurrentMomentMatrix[I][0]);
}
/*The following evaluates the current unit's critical line based on current DIFS state:*/
evaluatedstate=(MainMatrix[CurrentMomentMatrix[I][0]][0]!=−1)?
  MainMatrix[CurrentMomentMatrix[I][0]][0]:
  EvaluateFullCriticalLine(Criticals[CurrentMomentMatrix[I][0]]);
if(evaluatedstate==−1){
  //the critical line contains unevaluatable (unknown) terms/expressions
if(CurrentMomentMatrix[I][2]==0){
    //the duration counter is 0 (unit time ran out or initially empty)
    CurrentMomentMatrix[I][2]=CurrentMomentMatrix[I][2]+spilloverTime;
    evaluatedstate=0;
  }
  else{
    //break Advance loop stopped advancing. Unused turns remained.
    break;
  }
  }
  InitialiseMomentStateIfIsnt(CurrentMomentMatrix[I][0]);
  if(
  !(
    (evaluatedstate==1)
    ∥
    (CurrentMomentMatrix[I][2]==0)
    ∥
    IsAlias(CurrentMomentMatrix[I][0])
    )
  ){
    /*no advance whatsoever to another moment unit.
    Advance loop stopped advancing*/
    break;
    }//else ... (an advance_is_in progres) ...
  advanced=1;
  /*
this first is for recording to restore vector those critical lines which immediately evaluate to true. Re-record will not
happen during restores, which use this Advance function, because we check on a global variable RESTORING that
gets set prior to restore and unset after it.
*/
if(
  !RESTORING &&
  (evaluatedstate==1) &&
  !IsAlias(CurrentMomentMatrix[I][0]) &&
  MainMatrix[CurrentMomentMatrix[I][0]][2] &&
  (CurrentMomentMatrix[I][2]==MainMatrix[CurrentMomentMatrix[I][0]][2])
  )
  AddRestorePossibility(CurrentMomentMatrix[I][0]);
/*Now, first deal with where to go next for the advancing thread*/
mycurrenttime=MainMatrix[CurrentMomentMatrix[I][0]][3];
newcurrentmoment=
  NextMomentMatrix[CurrentMomentMatrix[I][0]][evaluatedstate];
MainMatrix[CurrentMomentMatrix[I][0]][0]=evaluatedstate;
// check if the thread terminated upon advance
if(!newcurrentmoment){
  ThreadClean(CurrentMomentMatrix[I][0]);
  LoadNextActiveTimestep( );
  //we break Advance loop b/c thread terminated
  break;
}
else{
  //update the CMM to reflect new unit:
  CurrentMomentMatrix[I][0] = newcurrentmoment;
  //CurrentMomentMatrix[I][1] <--remains same thread#
  CurrentMomentMatrix[I][2] =
    MainMatrix[CurrentMomentMatrix[I][0]][2];
  mycurrenttime=MainMatrix[CurrentMomentMatrix[I][0]][3];
}
if((CurrentMomentMatrix[I][2]==0)){
  //here's where 0-duration units inherit unused turns
  CurrentMomentMatrix[I][2]+=spilloverTime;
}
InitialiseMomentStateIfIsnt(CurrentMomentMatrix[I][0]);
  /*
    We've handled the calculations for this thread's advance.
    Now we must catch-up rest of threads, which may
    in turn catch up this thread further depending
    on the DIFS design.
  */
/*be sure to get all new threads/roots into the current moment matrix*/
while(CURRENTTIME < mycurrenttime){
  CURRENTTIME++;
  ThreadCheck( );
}
MakeAllThreadPastKnown(CurrentMomentMatrix[I][0]);
//setting MRP(Most Recent Possibility) et al. from other threads
for(J=CurrentMomentMatrix0;J<CurrentMomentMatrixN;J++){
  if(CurrentMomentMatrix[J][0]>0)
    AutoAdvanceCatchUp(J);
}
LoadNextActiveTimestep( );
if(CURRENTTIME>mycurrenttime){
  /*broke Advance loop other threads advanced this thread already*/
  break;
}
  }//this closes the advance (while(1)) loop
  return advanced;
}//this closes the Advance(int aMRP,int dec) function
int AudienceAffectedMoment(int MRM){
/*to determine whether or not audience interacted at this unit.*/
  int CMRM = FindCurrentMomentIndexFromID(MRM);
  if(CMRM∥CurrentMomentMatrix[CurrentMomentMatrix0][0]==MRM){
    if(MainMatrix[CurrentMomentMatrix[CMRM][0]][2]
      &&(CurrentMomentMatrix[CMRM][2]!=
      MainMatrix[CurrentMomentMatrix[CMRM][0]][2])
    ){
      /*unit time advanced*/
      //end AudienceAffectedMoment time advanced so 1
      return 1;
    }
  }
  int I=MRM+1;
  for(I;I<MainMatrixN;I++){
    if(MainMatrix[I][7]!=MRM)
      break;
    if((MainMatrix[I][0]!=−1) &&
      (MainMatrix[I][0]!=0)){
      /*if any possibility not unknown
      and not 0...*/
      return 1;
    }
  }
  return 0;
}
void AutoAdvanceCatchUp(int CMRM){
/*We “catch-up” all other threads. We need to do this whenever
advancing because advancing may cross one or more timestep boundaries.
Threads advance one another, actually, whenever they cross over. We
model this recursively as follows (Advance, remember, calls this function):*/
  while(CurrentMomentMatrix[CMRM][0] &&
    (MainMatrix[CurrentMomentMatrix[CMRM][0]][3]
    < CURRENTTIME)
    )
  {
    if(!IsAlias(CurrentMomentMatrix[CMRM][0])){
    /*Check if the audience hasn't interacted, or
    visited current moment from thread, use the
    default values for moment possibilities...*/
        if(!AudienceAffectedMoment(CurrentMomentMatrix[CMRM][0]))
      SetMomentPossibilityStatesToDefaultValues(
        CurrentMomentMatrix[CMRM][0]);
    InsertNewMRPInMRPMatrix(CurrentMomentMatrix[CMRM][0]);
  }
  Advance(CurrentMomentMatrix[CMRM][0],
    CurrentMomentMatrix[CMRM][2]);/*<--this
                advances the unit*/
  }
}
void checkRuleEightPointFive(int MMI){
/*We check, specifically, for 0-duration units that are a thread root or directly reachable from a thread root by
aliases or by other 0-duration units. The Advance function will assume default feedback occurrence values for
these units' feedback.*/
    int was_alias;
    if(
      (was_alias=IsAlias(MMI))∥(MainMatrix[MMI][2]==0)
      ){
      if((MainMatrix[MMI][2]==0)&&(was_alias==0)){
        assignDefaultValues[MMI]=1;
      }
      if(NextMomentMatrix[MMI][0]>=MainMatrix0)
        checkRuleEightPointFive(NextMomentMatrix[MMI][0]);
      if(NextMomentMatrix[MMI][1]>=MainMatrix0)
        checkRuleEightPointFive(NextMomentMatrix[MMI][1]); }
}
int FindCurrentMomentIndexFromID(int ID){
/*just find the current unit with the given ID as its first MainMatrix
feedback event index. This will return 0 if it can't find that ID. Empty CurrentMomentMatrix entries have a 0th
element of 0. Feedback events in the MainMatrix actually start numbering from 2. Therefore, calling this function
with 0 (FindCurrentMomentIndexFromID(0)) returns the first available empty slot in the CurrentMomentMatrix.*/
  int I=CurrentMomentMatrix0;
  for(I;I<CurrentMomentMatrixN;I++){
    if(CurrentMomentMatrix[I][0]==ID){
      return I;
    }
  }
  return 0;
}
int GetPossReferenceValue(int MMidx, int ORIGINAL_MMIDX){
/*Recursive function to determine a possibiliy's number of occurrences.
This is typically just the number of occurrences of the possibility.
However, a possibility that is a duplicate may need to add the number
of occurrences of the possibility it duplicates and the possibility
that possibility duplicates and so forth up the chain.*/
  int PossReferenceValue;
  if(MainMatrix[MMidx][6]==0){
    PossReferenceValue=MainMatrix[MMidx][0];
    return PossReferenceValue;
  }
  int me=
    (
    ((MMidx!=ORIGINAL_MMIDX) &&(MainMatrix[MMidx][0]==−1)) ∥
    (EVALUATING_ICONDITIONS&&(MainMatrix[MMidx][0]==−1))
    )
    !0
    :MainMatrix[MMidx][0];
  int originalMT=MainMatrix[ORIGINAL_MMIDX][7];
  int thisMT=MainMatrix[MMidx][7];
  if(Criticals[MMidx]){
    int chain_reference = 0-atoi(Criticals[MMidx]);
    PossReferenceValue=
      (
      ((MainMatrix[originalMT][1]==MainMatrix[thisMT][1])
      /*in the same thread or*/
        ∥
      (MainMatrix[originalMT][3]>MainMatrix[thisMT][3])
      /*a later timestep*/
          &&
      (originalMT>=thisMT)/*and original we're getting the
      value of happened in this one's or a later moment*/
      )!
          me
      :0)
      +
      GetPossReferenceValue(chain_reference,ORIGINAL_MMIDX);
  }else{
    PossReferenceValue=me;
  }
  return PossReferenceValue;
}
void InitialiseMomentStateIfIsnt(int aMRP){
/*Each of a unit's feedback events' respective occurrence state bits are set to 0 from −1 (unknown). This does not
affect known state.*/
  int I = aMRP+1;
  for(I;I<tPOSs;I++){
    if(MainMatrix[I][7]!=aMRP)
      break;
    MainMatrix[I][0]=(MainMatrix[I][0]==−1)?0:MainMatrix[I][0];
  }
}
int InsertNewMRPInMRPMatrix(int aMRP){
// Must keep the state of the Most Recent Possibility Matrix up to date
  int j=MRP0;
  for(j; j < MRPN; j++){
    //update the most recent possibility for the thread
    if(MRP[j][1] == MainMatrix[aMRP][1]){
/*The following just indicates sign-negation for NOTHING_HAPPENS-triggered events. It was the most minimal,
compact way of storing NOTHING_HAPPENS. Thus you know both what happened & that NH triggered
it:(NH_WON is a global set and unset elsewhere where controls contributions to outcome are determined)*/
      MRP[j][0] = (NH_WON && (aMRP>0))?(0-aMRP):aMRP;
      break;
    }
  }
  /*or create, in an empty slot, an entry for the thread MRP
  if none for the thread was found.*/
  if(j == MRPN){
    for(j = MRP0; j < MRPN; j++){
      if(MRP[j][0] == 0){
        MRP[j][0]= (NH_WON && (aMRP>0))?(0-aMRP):aMRP;
        MRP[j][1] = MainMatrix[aMRP][1];
        break;
      }
    }
  }
  return j;
}
int IsAlias(int moment){
/*As described earlier, this is how we can accurately infer an alias. DIFS editor rules require every non-alias unit to
have at least one beable character. Therefore, those units without any agents are implicitly aliases:*/
  int isalias = (MomentCharacters[moment].size)?0:1;
  return isalias;
}
void LoadCommandsBrowser(){
/*Fills a menu--CommandsBrowser--such as is shown in FIG. 8. Fills it with all agents of the current units.
Additionally, the corresponding thought(control) filename is attached as hidden data for the agent name line. This
facilitates active controls selection logic upon a user's picking an agent. Finally, in addition to the names presented,
and unseen control files attached, we update the Moment From Character Array. This also assists operation for a
user's selecting an agent to be active.*/
  CommandsBrowser->clear( );
  AddStandardCommandsBrowser( );
  int moment,j,previous_character_at=0;
  int I=CurrentMomentMatrix0;
  for(I; I<CurrentMomentMatrixN; I++){
  moment = CurrentMomentMatrix[I][0];
  if(moment){//non-entries in the CMM are 0, and we skip them
    j=0;
    for(j; j < MomentCharacters[moment].size; j++){
CommandsBrowser->add(MomentCharacters[moment].characters[j]);
CommandsBrowser->data(CommandsBrowser->size( ),
MomentCharacters[moment].thoughts[j]);
MomentFromCharacter[
CommandsBrowser->size( )- BASECOMMANDS+MomentFromCharacter0
] = moment;
  if(CURRENTCHARACTER &&
    !strcmp(CURRENTCHARACTER,
    CommandsBrowser->text(CommandsBrowser->size( )))){
    /*the following is a global used for various
    calculations involving interaction sequence
    re-entrance:*/
    previous_character_at=CommandsBrowser->size( );
    }
  }
  }
}
void LoadNextActiveTimestep( ){
/*This function is for starting out the story and the case where we have several moment and/or alias units
... M1 A0 M2 M3 M4 A1 ...
all terminating in a timestep but none directly leading to a later timestep*/
  int I,
  MAXTIME = MainMatrix[tPOSs−1][3];//<--DIFS's last timestep
  //outer while to stay in DIFS bounds in case hit end of DIFS:
  while(CURRENTTIME<MAXTIME){
    I=CurrentMomentMatrix0;
/*this to skip potentially empty steps...*/
for(I;I<CurrentMomentMatrixN;I++){
      if(CurrentMomentMatrix[I][0])
        break;//<--found >= 1 unit w/ an agent & turn
        }
    if(I<CurrentMomentMatrixN)
      break;//<--we found an “active” timestep
    else{
      /*There should have been at least one current
      moment unit for this timestep, but there wasn't.
      Skipping empty step, filling state for next step.*/
      CURRENTTIME++;
      ThreadCheck( );
    }
  }
  /*Advance each thread, in case all units are
  alias's and/or 0 duration moments.*/
  I = CurrentMomentMatrix0;
  for(I;I<CurrentMomentMatrixN;I++){
    if(CurrentMomentMatrix[I][0])
      Advance(CurrentMomentMatrix[I][0],0);
  }
  NullifyUnknownPast( );
  LoadCommandsBrowser( );
}
void MakeAllThreadPastKnown(int moment,int andpresent){
/*Prior to auto-advancing the rest of the threads, we want to be sure that all state for the advanced thread is known,
even though state from
some of the other threads may not yet be known.*/
  andpresent=andpresent?1:0;
  int thread = MainMatrix[moment][1];
  int currentthreadtime = MainMatrix[moment][3] + andpresent;
  int I=MainMatrix0;
  for(I; I<MainMatrixN;I++){
    if(
      (MainMatrix[I][1] == thread) &&
      (MainMatrix[I][3] < currentthreadtime) &&
      (MainMatrix[I][0] == −1)
      ){
        MainMatrix[I][0]=0;
        /*Other functions require default values for
        occurred feedback events to match occurrences.
        However, we never change default values for
        critical lines in the Main Matrix. They
        remain −1:*/
        if(MainMatrix[I][7]!=I)
          MainMatrix[I][5]=0;
      }
  }
}
void NullifyUnknownPast( ){
/*Always after advancing, all state from previous timesteps must be
known. If anything remains unknown, it clearly did not happen.*/
  int I=MainMatrix0;
  for(I;I<MainMatrixN;I++){
    if(MainMatrix[I][3]<CURRENTTIME){
      if(MainMatrix[I][0]==−1)
        MainMatrix[I][0]=0;
    }
    else
      break;
  }
}
void PostRecursiveAdvanceCurrentMomentsInitialise( ){
/*all Current Moment Matrix units should have all feedback events, in the very least, initialized. That is, this
ensures that once a moment unit is made “current”, all other current units are at least initialized.*/
  int I=CurrentMomentMatrix0;
  for(I;I<CurrentMomentMatrixN;I++)
    InitialiseMomentStateIfIsnt(CurrentMomentMatrix[I][0]);
}
void SetMomentPossibilityStatesToDefaultValues(int moment){
/*This is where the “offstage” feedback occurs. Each feedback event of the moment unit is assigned its default
value.*/
    int I=moment;
    int possVal;
    MainMatrix[I][0]=MainMatrix[I][5];/*<--this is −1 and is
            overwritten based on
            evaluation using below
            default values...*/
    I++;
    int firstMomentPossibility=I,momentPossibilities=0;
    for(I;I<tPOSs;I++){
        if(MainMatrix[I][7]!=moment)
          break;
        momentPossibilities++;
    }
    int *inCaseOfDuplicateChains=new int[momentPossibilities];
    for(I=0;I<momentPossibilities;I++)
      inCaseOfDuplicateChains[I]=0;
    int isAlreadyListed=0,J,tmpPoss,
      lastMomentPossibility=moment+momentPossibilities;
    I=firstMomentPossibility;
    for(I;I<tPOSs;I++){
      if(MainMatrix[I][7]!=moment)
        break;
      else{
        isAlreadyListed=0;
        for(J=0;J<momentPossibilities;J++){
          if(inCaseOfDuplicateChains[J]==0)
            break;
          if(inCaseOfDuplicateChains[J]==I){
            isAlreadyListed=1;
          {
        {
        /*
        Here, we add immediately only “original”
      possibilities to ensure correct ordering
      and subsequent default prescription further
      below (in the loop further down).
        The possibility is “original” in this moment if
        it duplicates a possibility outside the moment or
        it duplicates no possibility at all. Duplicates
      of possibilities within the moment get special
      treatment to insure correct default prescription.*/
      if(Criticals[I]!=0){
        tmpPoss=atoi(Criticals[I]);
        if((tmpPoss<moment)∥
          (tmpPoss>lastMomentPossibility)){
          inCaseOfDuplicateChains[J]=I;
          isAlreadyListed=1;
        }
      }else{
        inCaseOfDuplicateChains[J]=I;
        isAlreadyListed=1;
      }
      /*lastly, we add a possibility that references this
        one, if such a possibility exists in the moment*/
      if(isAlreadyListed){
        isAlreadyListed=J+1;
        for(J=firstMomentPossibility;
        J<=lastMomentPossibility;J++){
          if(Criticals[J] &&
          (atoi(Criticals[J])==I)
          ){
              inCaseOfDuplicateChains[isAlreadyListed]=J;
                        break;
          }
        }
      }
    }
  }
  for(I=0;I<momentPossibilities;I++){
  possVal=
GetPossReferenceValue(
    inCaseOfDuplicateChains[I],inCaseOfDuplicateChains[I]);
    possVal=(possVal<0)?0:possVal;
  possVal=((MainMatrix[inCaseOfDuplicateChains[I]][5]-possVal)>0)?
    (MainMatrix[inCaseOfDuplicateChains[I]][5]-possVal):0;
    /*Here's where we set the default..*/
    MainMatrix[inCaseOfDuplicateChains[I]][0]=possVal;
  }
  delete [ ] inCaseOfDuplicateChains;
  }
void ThreadCheck( ) {
/*This is how the Current Moment Matrix gets populated. For all feedback events where MainMatrix[N][3] ==
CURRENTTIME check to see if MainMatrix[N][1] is a thread number contained in the Current Moment Matrix. If
not, we need to add a thread.*/
  int n=MainMatrix0,I;
  int j;
  for(n;n<MainMatrixN;n++){
    if(MainMatrix[n][3]!=CURRENTTIME)
      continue;
    j=CurrentMomentMatrix0;
    for(j;j<CurrentMomentMatrixN;j++){
      if(CurrentMomentMatrix[j][1] == MainMatrix[n][1])
      break;
    }
    if(j==CurrentMomentMatrixN){
      /*Thread wasn't found. We check to see if
      MainMatrix[N][1]==N (i.e. the unit is a root).
      We only add a thread once by adding its root.*/
      if(MainMatrix[n][1]==n){
      /*we're dealing with a new root, and so must add it*/
I = FindCurrentMomentIndexFromID(0); //<--finds first free/empty CMMidx
CurrentMomentMatrix[I][0]=CurrentMomentMatrix[I][1]=n;
CurrentMomentMatrix[I][2]=MainMatrix[n][2];
      }
    }
  }
}
void ThreadClean(int moment){
/*catch up all past possibility state bits in thread that are unknown
as in MakeAllThreadPastKnown(moment,1); as well as all present and (formerly potential) future(s) of this thread*/
  int thread = MainMatrix[moment][1];
  int I=MainMatrix0;
  for(I; I<MainMatrixN;I++){
    if(
      (MainMatrix[I][1] == thread) &&
      (MainMatrix[I][0] == −1)
      ){
        MainMatrix[I][0]=0;
        if(MainMatrix[I][7]!=I)
          MainMatrix[I][5]=0;
        }
  }
  /* erase the thread from the current moment matrix.
  Better be in there(we know it is) or we'll erase thread0*/
  I = FindCurrentMomentIndexFromID(moment);
  if(I∥CurrentMomentMatrix[CurrentMomentMatrix0][0]==moment){
    CurrentMomentMatrix[I][0] =
    CurrentMomentMatrix[I][1] =
    CurrentMomentMatrix[I][2] = 0;
  }
  // erase the thread from the most recent possibility matrix
      int j=MRP0;
      for(j; j < MRPN; j++){
    if(MRP[j][1] == MainMatrix[moment][1]{
          MRP[j][0] =
          MRP[j][1] = 0;
    }
      }
      /*
      in case all moments in this timestep
      are now terminated and we don't know
      where to go next... (this should be harmless if no advance is
  required)
      */
      LoadNextActiveTimestep( );
}
void useDefaultValuesFor0DurationThreadToppers( ){
/*this is done on load of a DIFS immediately preceding the first LoadNextActiveTimestep call. It checks the tops
of each thread for 0-duration units. We flag these to ensure consistent advance behavior in the event of 0-duration
units close to a thread root.*/
      int I=MainMatrix0;
      for(I; I<tPOSs;I++){
          if(MainMatrix[I][1]==I)
            checkRuleEightPointFive(I);
        }
}
Detailed (Tried) Agent Group Determination Logic Operations (Cont'd)
```

The above code and description demonstrates tried agent group determination logic. Referring still to FIG. 7, a tried DIFS application manages the remainder of DIFS control flow as well.

First a DIFS application running agent group selection logic determines an agent group. It then presents the agent group to a user. A user selects an agent to be a present active agent, 54. Active controls selection occurs to start off the next step and throughout it: user interaction, 56. Interaction, in turn, may result either in an event or in nothing happening, 60.

In one case, truly nothing results. Interaction caused a NOTHING_HAPPENS event with no specified alternate event to represent it. Or, a user cancelled-out early from an interaction sequence. Perhaps she is about to quit or merely non-commital. She might be viewing controls for strategical reasons. The decision at 62 asks this question. If she cancelled-out early, the DIFS is not affected. She goes back to 54 where, presented with the same agent group as before, she must again pick an active agent. If NOTHING_HAPPENS occurred, merely without feedback, DIFS state will be affected. This is discussed below.

In the other case interaction results in a feedback event occurring from the decision at 60. Actual presentable feedback in the form of a production may be slotted for that event. If so, the DIFS application instructs presentation of the production, 64. Regardless of any presentation, the DIFS application updates its tables to reflect the occurrence of the event, 64. The application in this way maintains an ongoing feedback memory of event occurrences.

A DIFS application next checks if the new system state causes the current unit's critical line to evaluate to true, 68. If so, the DIFS application presents any resulting feedback 74. The DIFS application tries to branch the DIFS a corresponding direction, 78, causing an advance. This thread either goes on to 82 or terminates back to 52; depending on whether or not, respectively, the DIFS specified a next unit for this case.

Otherwise, processing continues at this unit. Perhaps the DIFS designated the event that just occurred as a “butterfly.” Once again, a butterfly is a feedback event whose occurrence does not count against unit turns. The DIFS application determines whether the occurred event is a butterfly, 70.

If so, the DIFS application asks whether or not interaction terminated on a “hole”, 58. A “hole”, defined previously above, is a mechanism that automatically drops a user out of an interaction sequence. Every control bears a flag indicating whether or not it is a “hole”(TE). Interacting with a control flagged as a “hole” terminates interaction on exit of the control. After exit on a “hole”, normal judgment commences to decide which, if any, feedback event results.

The “hole” construct is a component of active controls selection logic. It does not apply only to butterfly event occurrence. In terms of the FIG. 7 flowchart, “hole”'s—and other active controls selection logic—apply anytime during user interaction, 56. However, exiting interaction via a “hole” uniquely terminates continuous interaction after a butterfly event. Normally, a butterfly event loops back to 56 where a user continues interaction. A “hole”, however, gives the DIFS one way to break this automatic cycle.

An event that occurred may not have been a butterfly. Instead of a user out-out, the event may have been the special NOTHING_HAPPENS event alluded to above. Or, an event that occurred did not affect the unit critical line evaluation. The event was merely a regular, non-butterfly event. In each of these cases, a unit's turn counter is affected, 66. In FIG. 7 the counter is said to “increase” at 66. Depending on implementation, it may decrease. Either way, the point of the counter's affectation is simple. A unit allows only a certain predetermined number of turns before advancing. A DIFS application decides at 72 whether these turns are expended for the unit. If not, the DIFS application re-presents a user with the same agent group as before.

Otherwise, the turns are expended. The DIFS application presents any resulting feedback 76. The DIFS application next tries to branch the DIFS a corresponding direction, 80, causing an advance. This thread either goes on to 84 or terminates back to 52; depending on whether or not, respectively, the DIFS specified a next unit for this case.

The lowermost part of the FIG. 7 flowchart exposes more functionality of the above code listing. The advancement blocks at 82 and 84 more accurately lead back to active agent selection at 54. These blocks—82 and 84—actually subsume all lower control flow (86, 88, 90). This of course means they contain also any potential subsequent decisions of where to go next at 77, 78, and 80. The purpose of expanding-out the flowchart is to show control flow clearly and comprehensively.

To be perfectly precise, after a unit terminates, the DIFS application performs an advance. This re-uses the same code from the original advance at 52. Thus, the arrows from unit-termination—blocks 74 and 76—could lead back to 52. This keeps in accordance with a previously admitted recognition: the same advance code loop and agent group determination operations run at 52, as at 82 and 84.

The DIFS application re-uses and tightly couples much functionality. This keeps advancement consistent and predictable to design; although not to run. The latter is the goal—to keep an audience guessing, feeling like they can make a difference. A user feels she can influence greatly such a highly-sensitive system.

The flowchart of FIG. 7 breaks down operation for comprehensibility. FIG. 7 expands-out 82 and 84 for exaggeration. This serves to show what happens from the point of view of a thread advancing. Of course, from this written part of the specification and from the code listing, it should be obvious: 1)that advancing really advances all threads recursively as such; and, 2)that advancing threads may, in turn, advance and/or terminate other threads along the way. Advancement depends on the DIFS. A DIFS, thus, is a powerful specification of a story in motion.

For advancement, the DIFS application automatically routes a DIFS through certain units. These include aliases, which exist for such a purpose, and must be recognized as such foremost 86. These also include units whose critical lines evaluate immediately to true. Lastly, these include units with 0 maximum allowable turns. For these last, the DIFS application adds unused turns from the preceding unit in the thread, as at 90.

As above code and description demonstrated (see the function useDefaultValuesForODurationThreadToppers), a DIFS application distinguishes certain 0-duration units. The application handles specially: 0-duration units that haven't any chance of inheriting turns. These 0-duration units are those in a DIFS specification at a thread root or directly reached from a thread root. By “directly reached” it is meant via a path consisting entirely of other 0-duration units and/or aliases.

For instance, in FIG. 7, these “special” 0-duration units would never figure into calculations at 90. In FIG. 7, “special” 0-duration units would only factor-in at 52. Unless, of course, advancement reached a new timestep with new threads. As the above code listing shows, the DIFS application stages in new threads upon crossing a timestep boundary.

Once again, however, FIG. 7's flowchart examines advancement from the point of view of a single thread. Hence, 90 in FIG. 7 would never involve such “special” 0-duration units “at a thread root or directly reached from a thread root.” 90 follows from previous termination of an active unit. An active unit, having at least one agent and turn, is neither alias nor 0-duration unit. “special” 0-duration units assume their default values when the DIFS application advances through them(TE). This keeps advancement consistent, predictable, and planned for these cases. At 90, however, the intent is that a 0-duration unit may inherit turns. Should it inherit none, as FIG. 7 shows, the same immediate decision is made for the 0-duration unit as is made for an alias, 88. Simply, a DIFS application determines how the unit's critical line evaluates.

Otherwise, the 0-duration unit inherits unused turns from the previous (non-alias) unit in the thread, 90. The unit becomes the new current unit. The DIFS application tries to evaluate its critical line 77. If it is already true, we check again for an associated next 78 and proceed accordingly. On the other hand, the new critical line may not evaluate to true. In this case, the DIFS presents an agent group for user-active agent selection back at 54.

As noted, advancement always continues until no units remain, or an active unit is found for the furthest reached timestep; whether this is a single unit or several, a regular unit or a 0-duration unit that inherits turns. The new point of reference for the DIFS will be the timestep of the new active unit(s).

Not shown is how a DIFS application terminates a DIFS. Advancement ceases at the final timestep (see LoadNextActiveTimestep in the above code listing). This is the only other case in which advancement ceases. The DIFS effectively ends at 54 after such a final advancement. Eventually, ceasing to continue to a new timestep beyond the furthest timestep of the DIFS, the DIFS application determines an empty agent group containing no agents. In this manner a DIFS reaches its end state where no more forward progression may occur.

FIG. 7 charts agent group determination logic operations. FIG. 10 charts active controls selection logic operations.

Active Controls Selection Logic Operations

Referring to FIG. 10, a DIFS application applies active controls selection logic. According to the specification of a DIFS, a user selects an active agent. Next, active controls selection logic comes into play. FIG. 10 merely shows generally how active controls selection logic breaks down.

First, a preliminary stage of active controls selection logic performs preliminary filtering, 112. This includes, first of all, staging a particular control file's contents from disk(TE).

Nextly here, other factors contribute to determining which controls may become available. Many such factors were discussed previously. Present state of a DIFS precludes certain controls and makes others available(TE). Then (an)other control(s) may preclude availability of a control(TE); or, a control's availability may preclude other controls' being available(TE).

Perhaps a user picked the same agent. <TE> Maybe certain controls just viewed were designated as conditionally available: ‘never’, ‘always’, ‘until viewed’, and ‘after viewed’. For efficiency a DIFS application keeps its previous control file contents in memory. Should a user re-select the same agent at the same unit, preliminary filtering, 112, denecessitates re-staging from disk. Fortunately, a DIFS application may also retain just-viewed status of controls. So, an initial filtering stage facilitates many forms of active controls selection logic: just-viewed status, inter-controls-based logic, and state-based filtering. A DIFS application may perform all such filtering up-front, while initializing interaction.</TE>

To indicate a control's availability(or lack thereof), a DIFS application may merely set (or unset) a control's flag(s). Later, when it comes to presenting the control, the DIFS application checks the flag(s). The DIFS application must take care never to loop infinitely. If the control is flagged as unavailable, the DIFS application proceeds to the nearest available control; looping back to the beginning if necessary. Thus, also, the DIFS application tracks available controls separately from total file controls. Knowing available controls ensures proper behavior. In the case of no available controls, for instance, interaction should terminate smoothly. Otherwise normal termination also may depend on total available controls.

Half of the available controls was a stated reasonable maximum limit to present(TE). Consider that a user sees at most half of all available controls. Available controls may be presented at random. A user will never be able to see all relevant controls in one interaction sequence. This maximizes content usage while minimizing development cost. A designer, remember, must provide each and every control. A DIFS keeps fresh as best it can, knowing nothing about these actual contents. A designer may employ other explicit DIFS active controls selection logic mechanisms similarly.

She may, for instance, vary the likelihood of certain controls appearing by repeating identical controls. During interaction, repeated controls would be more likely to appear; non-repeated controls, less likely.

Naturally, a general DIFS application needs to provide sensible filtering during interaction. Between control presentations, active controls selection logic is in full effect, 114. From the very start of an interaction sequence, a DIFS application uses random number generation(TE). As described above, this random number is used to pick a nearest available control in a memory storage of all file controls(TE). This storage is essentially a dynamically-created array of inodes (TE)(see FIG. 12).

As such, random selection performs one form of procedural active controls selection logic. Then, from a control, a user may follow hard-wired paths. The DIFS may provide explicit links so that a user's interacting always follows predefined paths. Or, the DIFS may implicitly order controls by some combination of control- and control set/subset-attributes.

For example, perhaps a subset of controls each has a connection wanting a certain outcome(TE). Whenever a user interacts to follow such a connection, another control at random from the subset appears. Aforementioned control set attributes of ‘focus’ and ‘feedback’ instruct, respectively, selection of a control from within the subset as opposed to at random, and consistency of immediate feedback presented to a user. All such filtering, “bookmarking” of controls (see above), etc. is what is intended at 114. It takes turns in a loop with controls presentation and user-interaction at 116.

The latter 116, as described, may result in process-spawns for control presentation and interaction handling. The former 114—inter-control filtering—most crucially terminates interaction. This happens one of several ways. Interaction may end normally after a maximum limit or half the available controls have been viewed(TE). “Hole” constructs were mentioned previously. A “Hole”-designated control terminates an interaction sequence after a user interacts with the control(TE). Innumerable “hole” controls may exist in a control file(TE). So a “hole” represents an alternative way of exiting interaction.

A third alternative is a conditional “hole” control. In support of dual-modality in a single DIFS, a DIFS application recognizes modality-based “hole”'s(TE). Conditional “hole” controls could predicate “hole” exit behavior on innumerable factors. A preferred factor is the story attribute of all-text modality(TE). Consider the following scenario: A DIFS uses a separate application or applications each to represent many controls respectively. The all-text controls suffer because each is inextricably bound to a single alternate control. The alternate control handles most, perhaps all, of the work in the non-all-text version. Therefore, most controls might be specified as “hole”'s. For all-text controls to work properly, however, navigation of a multiplicity is desired.

<TE>

To solve this, each control may act as a conditional “hole”. This conditional “hole” status instructs exiting only after termination of its spawned manifestation. A user may toggle between all-text and full-media versions at any time during operation. This toggling affects both event feedback and control presentation. “hole”'s based on the story-wide attribute of modality enable this flexibility.

</TE>

Finally, it has been stated that a user may initiate early exit of an interaction sequence(TE). He either exits with no effect or requests an early-decision. The manner of exit determines this. Within a DIFS, the user presses the Esc keyboard key to exit uneventfully(TE). He presses the Enter keyboard key for early-decision(TE). In FIG. 10, this last would be to go from 116 through 114 directly to 118.

So that a handler application may, if desired, implement similar exit options, a DIFS application requires that handler applications write several standard pieces of information to a file on disk upon termination(TE). This is, in part, so that the DIFS application proceeds with awareness of a user's intentions. Without this message-passing interface, the main DIFS application would have no knowledge of anything that occurred within the spawned process.

(Tried) DIFS Communication with Related Processes

According to one aspect of a DIFS, a DIFS has a message-passing channel for communication between its (main) process and other related processes. Typically, this channel involves writing of a file to disk by a handler process. A separate second process of the main DIFS application subsequently reads the file. It knows when to do so, typically, by termination of the first (handler) process. Agreement also must exist between processes on format and naming of such message files.

<TE>

Thus, the DIFS application specifies a predetermined result file format and name to be written by all interaction handler processes. This file will contain the results of a spawned process that represented a control or controls. It must be written to a predetermined directory—the initial current working directory in which the DIFS application spawns it. This way if the spawned program needs to change directories, it saves this initial current working directory(icwd).

The only requirement is that just prior to exit, in said icwd, the program must execute the equivalent of the following function (given here in ANSI C), which prints 6 space-delimited integer numbers to the file “IResult.ans”:

void WriteResult( ) {FILE*f=fopen(“IResult.ans”, “w”); fprintf(f, “%d %d %d %d %d %d”, next, mark, term, viewed, weight, reload); fclose(f); }

Where, a reload of 1 or 2 takes precedence over all and is discussed below. mark is 1 to bookmark this or 0 to retain the current interaction sequence bookmark. viewed, 1 for regular controls, is the amount by which to increment controlsViewed—the counter determinant of the natural end of the interaction sequence. weight, 1 for regular controls, is the amount by which to multiply the power value of the control when adding to the race value of the winning feedback event. And, in order of precedence, term is p1 1 to force early decision (Enter key in the main DIFS application)

2 to escape I-sequence without effect (Esc in the DIFS application)

0 by default, meaning no special exit status, consult . . .

next

the connection number chosen during the application (must be an acceptable value corresponding to a connection in the control's connections list)

or −1 for goto bookmarked control (right-clicking a text control's frame in the main DIFS application)

or −2, the default, for unknown result

The spawned application may take any command line arguments. Means also exist for message-passing the other direction: that is, communication from the main DIFS application to a handler application. A semicolon ; specified by the DIFS as the first character of the handler's command line, instructs writing of an abbreviated state file. The DIFS application, prior to launching the spawned application, writes this “IState.tmp” file. The spawned application may then read “IState.tmp” for any state it needs from the main DIFS program. Only that this spawned program terminates and writes to file in the above-specified manner matters to the main DIFS application. The result of the spawned program, like any control power designation, is winner-take-all. The semi-colon merely instructs the DIFS application to write its standard format “IState.tmp” file to disk.

“IState.tmp” suffices for the most general case of a small handler application. However, a handler application may be robust and intended to take over for some time; even uninterrupted through more than one story state transition.

This is the purpose of the reload return value, which otherwise should be left 0.

In the case of the long-running handler program, a developer compiles all DIFS application code into that program. A graphical user interface compiler flag can be set or unset. If set, a GUI will be compiled-in; otherwise, the code assumes a non-graphical mode. This keeps with the aspect of a DIFS of a completely non-graphical mode of operation whereby a DIFS has no user interface or presentation capability and active agent selection interface is purely a code-level interface to enable active agent selection by a user via some other means. A spawned handler application would have to provide any such means if necessary.

Regular DIFS application GUI or not, the new hybrid application would require some limited modifications to function as desired. Most importantly, DIFS application function calls would need to be used as intended. The code as-is would provide the template. Even without the GUI, all state-loading, updating, and re-saving mechanisms would remain. In general it is not intended that any sort of agent selection or normally DIFS main program-handled interaction would occur outside the DIFS application proper. Although possible, this might require a largely redundant and painstaking hack.

At the start of each interaction sequence, a temporary DIFS main file “.stx” is written into the same initial directory as “IResult.ans” will be written. “.stx” contains the present state of the DIFS running in the main DIFS application. The hybrid handler application should use the provided load functions to stage-in “.stx” and use the save functions to write-out the final state to the same file: “.stx” in the same initial directory.

Then, in “IResult.ans”, a reload value of 1 simply reloads the main DIFS application using “.stx”. A value of 2 instructs the main DIFS program additionally to play the most recent recorded feedback event's most recent production.

Active Controls Selection Logic Operations (Cont'd)

Referring still to FIG. 10, inter-process communication gives context to a control between 114 and 116. It helps define the control's relationship to the rest of the interaction sequence. It also may help to define such a control with respect to the DIFS.

The final stage of an interaction sequence entails tabulating a result. An analogy is an election. Only here, the voters are controls that a user interacted with. The number of votes each control has varies, based on predetermined power values for each. Who a control voted for depends on which connection a user followed from the control.

According to another aspect of a DIFS, a DIFS designer must provide a set of logical feedback units which may result from participant interaction with the controls in the controls network; and also provide contribution of said controls in said controls network respectively toward a determination of which logical feedback unit may occur as a result of interacting by said participant with said controls of said controls network.

The above-mentioned scheme of counting connections abides by these stipulations. The provided feedback units to choose from amongst are feedback events of the current DIFS data unit that the control set originated from. These are the candidates in the election. “contribution of controls” here would be each control's power value applied toward the feedback event preferred by the connection followed when leaving from the control. Determination compares the accumulated totals at the end to determine the race winner, 118. The winning feedback event, if any, then “occurs”. That is, the DIFS presents the winning feedback event and records its occurrence.

The only exception to this rule at 118 is if a user exited early via a ‘no consequence’ command; Esc, as mentioned above. In such a case absolutely no change occurs. Not even ‘nothing happens’ registers.

</TE>

Active Controls Selection Logic Operations: Case Study

Referring to FIG. 16, a DIFS designer, by definition of one DIFS creation method, provides conditional availability restrictions on controls in a controls network.

FIG. 16 depicts one behind-the-scenes view of these restrictions in action. Specifically, FIG. 16 shows application of story state-based active controls selection logic. Across the top is shown the present relevant state. This feedback memory comprises records of feedback events 160, 162, 164, 166, 168, 170, 172; respectively:

“Jane runs away” occurred twice;

“Jane says ‘I do‘” never occurred;

“The test came back positive” did happen (once);

“They fight” occurred once;

“Jane makes amends” did not happen as of yet;

“They sit in silence” occurred three times;

“They avoided the conversation” resulted once thus far.

These occurrence numbers would be part of a State Main Matrix(SMM) or equivalent.

A designer would use a controls editor such as in FIG. 15 to set the following up. But continuing to refer to FIG. 16, the controls set has various questions about story state, 174. These conditions inquire about the system's state on the controls' behalf. Certain controls may be picky and refuse to become available unless DIFS state meets certain conditions. The conditions are kept in one centralized location so that all controls may access them.

Controls, in turn, have their own local requirement or ambivalence regarding each condition respectively. Based on the current state shown atop FIG. 16, values substitute-in for feedback event references, 176. At 176, the DIFS application evaluates expressions, as they no longer contain any unknown values. Even unknown state has a value of −1, which is zeroed-out and thus assumed not to have happened yet(TE). Thus, knowing all necessary values, the DIFS application evaluates the condition expressions with respect to current story state.

The DIFS application then finishes off this portion of active controls selection logic. It compares the truth or falsehood of each respective condition with each control's corresponding requirement. This essentially masks out certain controls using bitwise-like comparisons 178.

In the example of FIG. 16, control 1 will be available. Its requirements 180 find one position matching. 180 uses an OR operator over its requirements. OR requires only one requirement be met. Control 2 will not be available. Even though it matched in almost all respects, one requirement failed to match. The AND operator of control 2's requirements 182, requires all positions to match for the control to become available. Because all of its positions do match, control 3 will be available at this stage. It also AND's its requirements 184. Control 4 declines availability on the basis that of its requirements 186, only ‘D’ values (for “don't care”) match. Unless all a control's requirements are “don't care”'s, OR requires at least one non-“don't care” to match to allow the control's availability.

Jane is clearly in a situation with another party. Control 1 might be a thought control that allows a user to make Jane think about, and as a result talk about, something not dependent on her past. Perhaps this control expresses discomfort. For instance, the immediate status of the current conversation here might let a user make Jane talk about the weather. “They avoid the conversation” could easily be the feedback event that plays production content to this effect. Thus at least one connection from control 1 might likely have “They avoid the conversation” as its expressed, underlying result.

Control 2 could perhaps be Jane getting an inkling to discuss with the other party the test coming back positive and her being out of wedlock. But, of course, control 2 is only available if “they” have not been talking much and have not yet fought—the latter of which they have done once already. So this option will remain unavailable unless the user rewinds to before they fought. More on rewinding later.

Jane is on the offensive if to use control 3. This control can be available if Jane ran away not once but twice previously and “they” have already fought at least once. Control 3 might likely lead to “They fight” again.

Control 4 is for a kinder, gentler Jane resulting from a different story behind her. For this control to be available, Jane must have either run away once or not at all, or said yes to marriage. The Jane of control 4 could well be on the road to making amends. Unfortunately, her present gloomier past precludes control 4's availability.

Thus, the example of FIG. 16 shows how past accumulated history affects controls and how controls ultimately give the present picture of Jane that we are allowed to see from moment to moment.

Surrounding Environment Presentation

Referring to FIGS. 22 and 23, and according to one feature of a DIFS, a DIFS includes a surrounding environment in which it presents controls and feedback to a participant; as well as automatic updating of said surrounding environment based on the state of the DIFS.

A DIFS application is responsible for presenting this surrounding environment. Ideally, a surrounding environment would encompass sound and switchable graphics for buttons. This would certainly be possible in another slightly different implementation. <TE> However, in the interest of simplicity and portability, a DIFS provides only static images(TE). A designer specifies all elements. Ultimately, feedback and controls are intended to take the spotlight.

Therefore, a small set of powerful image-specifying options allows for provision of sets. These options were described previously and involve layering solid-color, tiled, and centered images. Semi-transparency and zoom are also possible. The options can be thought of as a webpage-like layout specification. Only this one is somewhat richer, more robust, than HTML background tag attributes.</TE> Of course, in a DIFS background sets can also change as the DIFS progresses. As noted earlier, this occurs based on DIFS specification.

Suffice to say, these sets serve a similar function to theatrical sets. The additional twist here is that the audience interacts. The set should provide various general predefined ways of interaction with it. Several ways of designer-specification of such sets have been described. FIGS. 22 and 23 show live, running results in a DIFS application of one such setup.

Screen elements always present throughout DIFS application operation include: a full-screen background; and, a command and active agent selection interface 262.

<TE> To resolve various windowing system differences, the background element was made permanently full-screen. Thus, on startup, a DIFS application takes over so to speak. This layout has impact and the crucial benefit of being immersive. Furthermore, a user may easily exit out to her operating system shell and re-enter. She clicks on the background to open the background from the middle. All DIFS windows disappear. The background splits apart and animates outward to the screen edges. The effect is one of curtains opening. If she clicks and drags, they open faster. To close them, she just clicks(or drags) on one of their edges again; each side is clickable still at its screen edge. This draws the curtains closed and re-shows all DIFS application windows.

A DIFS application spawns processes some of which must be exited before the DIFS application allows progression. Sometimes an other-process GUI falls behind DIFS application background windows. This curtains approach allows a user to reach all other-process windows. He simply opens the curtains to reach an application that fell underneath. Without sacrificing immersiveness, a DIFS application may peacefully co-exist with its spawned handler applications. Moreover, it may do so in any graphical operating system shell.

FIG. 22 shows the most purely general default background for this DIFS application. In fact, all elements in FIG. 22 are actually compiled-in statically into the DIFS application. In contrast, FIG. 23 shows a DIFS loaded-in to the DIFS application. Many elements, including the background, have changed dramatically.

The command and active agent selection interface 262 is that of FIG. 8. Only here in FIGS. 22 and 23 it is shown in its standard, collapsed state. It occupies minimal screen space yet affords great power, accessible numerous ways. Its menu is always collapsed until a user interacts with the input. The style file(see above) specified by the DIFS file defines the color scheme of this interface: color, button color, and text color. The command and active agent selection interface's position is configuration-defined.

However, the distinction between user and configuration-definition is blurry. The DIFS application allows a user great say in customizing its GUI. A user may, for instance, reposition the command and agent selection interface 262 anywhere onscreen by dragging the interface. If at the bottom, the menu will merely unfold upwards instead of downwards when invoked. Except for the background, a user may specify position of every major element: vcr controls panel 260, selection interface 262, and title 264; as well as other more dynamic elements such as control and feedback elements.

This will all be described later, but essentially works as follows. Whenever a user saves a DIFS, the DIFS application saves with it its current configuration. Configuration includes positions of elements because these depend on screen resolution. The DIFS application saves this configuration inside a saved DIFS file. It also saves the information separately in a “LastUsed.cfg” file. Additionally, a user may explicitly save the configuration to a separate file for later import.

On (re)startup of a DIFS, a user may begin a brand new story from scratch. A workable configuration, meanwhile, is intimately tied to a particular computer system; that is to say, which feedback handler programs exist on the system, screen size, etc. The DIFS application knows, based on “LastUsed.cfg”, about its previous configuration, if any. “LastUsed.cfg” stands a good chance of containing a properly tuned configuration. If a DIFS ran smoothly last session, “LastUsed.cfg” was the configuration that enabled it. Also a recent DIFS as such stands a good chance of containing similar media formats.

If not, a thorough designer of the DIFS may have provided ‘Other’ information 246. This is the same ‘Other’ information as was mentioned earlier. ‘Other’ information 246 may help a user understand how best to configure the DIFS application. It also may help her understand how to configure her computer system. ‘Other’ information may suggest or require certain handler applications, screen resolution settings, etc. This is why the ‘Other’ information 246 is available on-call throughout DIFS application operation. A user accesses it via a menu command. Also due to its importance, ‘Other’ information 246 is available prominently on startup.

The DIFS application's DIFS-load sequence displays ‘Other’ information 246 together with a related question 266. A user may opt to try the designer-recommended configuration or keep the DIFS's current one. Each target computer system can be very particular. A designer's configuration will likely fail to match in some aspect. A user may resolve any incompatibilities by consulting ‘Other’ information 246 and configuration metadata(discussed below). A computer system may change and require reconfiguring DIFS's. Typically, however, a user should only need to configure a DIFS when starting the DIFS anew.

Alternatively, a user restores a previously saved DIFS. For this case, the DIFS application loads the configuration saved in the DIFS file. However, one important exception to this rule exists: the DIFS application may have already been loaded with another DIFS of the same story.

When switching between same-story DIFS's, the DIFS application does not change configurations. This is to keep consistency for the user. If the user wishes to use another stored configuration, she should do one of two things. She either restarts the DIFS application, loading the DIFS with the desired configuration first. Or, she can manually import a separately-saved configuration (see below).

</TE>

The DIFS application should take great pains to automate configuration as much as possible. It ought to try to make the best guesses as to desired configuration. This frees an end-user from unnecessary hassle and technical setup. The DIFS application can be powerful and highly configurable; at the same time offering convenience by automating important but mundane setup. Less technical audiences especially appreciate this feature. For such audiences, sheer number of clicks can prohibit comfortable access.

A vcr interface 260 lets a user restore to and/or review points in a DIFS timeline. These mechanisms are discussed below. <TE> The ‘Rewind’, ‘Fast Forward‘, ‘Play’, and ‘Stop’ buttons for this are actually just regions specified by a DIFS's style file. The style file also specifies the image to use to represent the vcr interface. It further specifies location and colors of event identification text. Meaning, a DIFS such as is shown loaded in FIG. 23 may uniquely define entirely its own vcr controls panel 260. As shown, these variations may differ from the vcr controls panel 260 default depicted in FIG. 22. These vcr controls perform the same function, however, in every DIFS.

A title element 264 displays the title graphic. Configuration instructs its position, as well as the position of the vcr controls panel 260. As described previously, a title graphic is part of a dynamic surrounding environment. A DIFS specifies which title graphic to present when.

</TE>

Native ambient sound and animation is certainly possible within a different DIFS application. However, such extras handled natively by a DIFS application might tend to overburden it. The DIFS application exists primarily to run a DIFS. <TE> Thus, a tried DIFS application provides the minimal presentation logic necessary. It does what it does well, providing crucial power through easy static set specification. It leaves other features for controls and/or feedback to provide.

This organization makes the available configuration options clearer, easier to specify and comprehend. A designer is not overburdened with having always to provide gratuitous bells and whistles. Constant ambient sound, for instance, can sometimes even be an annoyance to an end-user. Furthermore, standardization including only certain common elements helps familiarize audiences with the format. Only changes in decor and rearrangements distinguish one DIFS's set from another's. Yet subtle changes keep the GUI fresh and dynamic, alive. Much like its real-world counterparts, a DIFS set is a container for a boundless plethora of possibilities.

</TE>

A Run-time Configuration Interface

Referring to FIG. 24, a DIFS application provides a configuration interface that mirrors a DIFS editor's configuration interface(TE). The mirroring is almost exact, with only a few exceptions. This interface fulfills one aspect of a DIFS that it employs a configuration interface for associating external handler applications with representation categories.

Full media<->program association occurs based on another heretofore described aspect of a DIFS. Earlier description demonstrated how feedback event production assemblage utilizes general media type tags(TE). According to one definition of a DIFS, a DIFS uses representation categories into which all content within said DIFS are grouped; and, representation category specification for all content within the DIFS for specifying the content respectively as belonging to one of said representation categories. In other words, a DIFS application matches media with an acceptable handler program by matching-up media type tags(TE).

An end-user does not need to deal with tags. He does not know a DIFS as a DIFS even, but rather only by its story or chapter name. Likewise, he must only understand that various specific handler applications exist. Each has its own domain regarding which content it will attempt to present. A real-world analogy would be audio cassette tape machines and video cassette machines. Obviously, consumers understand the different purposes of these devices. They may also be familiar with, or at least cognizant of a prevalent software-machine equivalent.

So-called “MIME Type”'s in Netscape Navigator(™) perform a similar function. A “MIME Type” allows an internet browser program to spawn a correct handler application. The association is based on content filename attributes—specifically, filename extensions.

<TE> Media type tag categories of a DIFS behave similarly. They allow a DIFS application to distinguish DIFS content files. Only here which handler is chosen does not depend on filename attributes such as extension. Media type tags exist together with content filenames in production files. These tags match the content to a particular handler application specified in a DIFS configuration interface.</TE>

This introduces another aspect of a DIFS: an interface to invoke, based on respective representation category specification of content, external handler applications automatically for handling presentation of the content. DIFS application presentation logic is like a switchboard directing media to its proper handler. <TE> Hence this invocation interface works unseen, at the code-level.

However, as shown in FIG. 24, a DIFS application also provides a configuration interface for associating external handler applications with representation categories. The DIFS application allows an end-user complete control over configuration. The shown DIFS configuration interface lets a user associate external handler applications with types. The types in turn cross-reference with feedback production components' types. The DIFS application ensures the proper media is played the proper way at the proper time.

The ‘Basic’ tab 268 contains user-definable instructions for setting up external feedback-presentation handler applications. It was mentioned severally that this same configuration interface exists in both DIFS application and editor. A primary difference is the control handler applications, 286 and 284. Described below, these are available only in a DIFS editor program. Truly, an audience should never have to designate which controls applications to use. The DIFS must provide with its content these custom interaction programs. Nothing below the ‘Image Converter’ button (neither 284 nor 286) is visible on the ‘Basic’ tab 268 of the DIFS application.

The next section on presentation details and external handler launch settings covers the ‘Details’ tab 270.

An ‘Import’ button 272 imports all end-user definable information on both tabs. Clicking this button opens a file-chooser. A user then picks and okays a configuration file from disk, or cancels. Canceling of course causes no change. Okaying a configuration file overwrites all configuration information except: metadata 280, and controls handler information at 286 and 284; and style file, default look, and ‘Use Character Viewer for ATX cap’ settings (on the ‘Details’ tab 270). This information, a DIFS retains independently within its main system file. The rest of the information on the two tabs (268 and 270) are end-user-definable. Each configuration file stores all of these end-user-definable settings. The DIFS application immediately applies new configuration changes on importing a configuration. Meaning, DIFS application-handled screen elements automatically shift to new positions. New modes, handlers, and handler settings take effect for future presentation, etc.

A user may save configuration files to import as such later. Clicking a ‘Save’ button 274 opens a file-chooser for this purpose. Specifying a filename then saves the configuration currently populating the interface to that file on disk. ‘Import’ 272 and ‘Save’ 274 are convenience mechanisms to automate otherwise tedious configuration tasks.

The next section will describe in more detail the ‘Screen Layout’ button 276. Essentially, clicking it opens the interface of FIG. 25b. The interface of 25b lets a user instruct external handler applications' respective startup positions.

A ‘Text Only Version’ checkbutton 278 lets a user toggle between all-media and text only modes. While in ‘Text Only Version’ mode, the DIFS application presents all text representations of feedback and controls. Otherwise, the ‘Text Only Version’ checkbutton is un-checked to an off state. The DIFS presents non-all-text (i.e. all-media) representations.

These two modes show the multiple representation modes aspect of a DIFS. Another stated aspect of a DIFS is a mode specification interface for specification of the mode of representation the system will use. The simple ‘Text Only Version’ checkbutton 278 provides this aspect. As stated, one set of representative content for the system may replace another based on a setting of said mode specification interface.

</TE>

According to still another trait of a DIFS, a DIFS provides metadata describing the DIFS's content compatibility, selected from the group comprising: detailed descriptions of media types within each representation category; and, recommended embodiments of external handler applications; and, recommended configuration of said external handler applications; and, recommended operating environment conditions; and, essential requirements for presentation of content contained within the system.

<TE> Toward this purpose, a DIFS editor lets a designer specify metadata for each representation category. A button for each media category pops up corresponding metadata. In the DIFS editor, this metadata is editable; in the DIFS application, it is merely viewable. These media category metadata interfaces 280 exist on the ‘Basic’ tab 268 in both programs. As shown (leftmost) in FIG. 24, metadata contains external handler application-specific information. It describes the DIFS's content compatibility regarding the handler named on the button. The shown metadata resulted from clicking on the ‘Motion Player’ metadata button.</TE>

Possibly, a designer could stretch intended usage of a type category. He could re-interpret the category entirely; perhaps providing 3D VR(virtual reality) movies in place of 2D rendered ones. Or he might tuck several media into one category such as images and background sound.

<TE> He would do this by specifying the handler application as a custom-written program. This custom-written program would take in a file of pointers to: an image file, sound file, etc. Any of these might be allowed to be optional. The entire setup is at the designer's discretion. The custom program might then pair various allowed media formats to their actual respective player. The program could spawn yet more processes for each, presenting image and sound together. Through the use of production breaks(described earlier) a designer has better ways of doing this. The example merely illustrates how to use a custom application for feedback presentation. Of course, a designer would indicate to audiences in associated metadata to use only his custom program for that handler.</TE>

By providing adequate metadata, a DIFS is completely self-describing. It has its own classification of its non-natively-handled content. As such, a DIFS is much like a portable, self-contained library. Metadata certainly helps an existing DIFS endure. Preservationists, for instance, may more easily understand all formats each DIFS contains. This can help with maintaining, upgrading, or restoring old DIFS's. With overview knowledge of content, developers can more readily work with existing DIFS's. Archivists can better classify and store DIFS's for future accessibility as well. Anyone making a DIFS can rest easier, secure in the knowledge their work may survive. Hence, a DIFS serves as a sort of enduring, universal, digital story time capsule.

<TE> A user (re)specifies feedback handler applications via respective handler specification interfaces 282. Each of these interfaces displays, in an uneditable input, the full path to a current handler application. Which representation category a handler application handles corresponds to the metadata interface 280 introducing it.

For instance, the ‘Motion Player’ metadata button is on the same line to the left of “C:\Program Files\QuickTime\QuickTimePlayer.exe”. The underlying implication: this program plays media files with a media type tag MOT. The end-user does not know this in detail. He only needs to know to follow metadata directions. The closer he follows directions, the more smoothly and true to intended form the DIFS will perform.

A user may only scroll the handler path input for viewing it. She may not type in this input directly. In order to change the shown current handler application, she presses the adjacent ‘ . . . ’ button. She cancels out of the resulting file chooser to affect no change. Or, she chooses and okays a new handler application from somewhere on disk.

There are typically many capable media programs, after all. Only that a program supports DIFS formats in that particular category matters ultimately. The handler path input changes immediately, of course, reflecting a user's chosen program. Requiring a user to use a file chooser makes specification easier and prevents mal-references.

Finally, an interface only in the DIFS editor, defines all controls external handler applications, 284. This list contains all programs a DIFS directly invokes on its behalf during interaction segments. Controls individually supply their own command-line arguments to pass to handlers. However, the DIFS keeps the list of control handler programs global. It does so because a DIFS will likely re-use handler programs.

A designer using the DIFS editor specifies control handlers similar to feedback handlers. Only, the former get added without a full path and to a running control handlers list 284. Each receives, additionally, a unique, permanent identification number 286. An integer increments for each control handler addition, in order to assign an identification number to the next addition. These identification numbers correlate with controls' type numbers(see FIG. 15). A designer left-clicks on the control handlers list 284 to see a handler's id. This id number appears in the uneditable controls handler id input 286. id's correspond to slots in the handlers list; a designer does not edit them directly.

In the control handlers list 284, no full paths are necessary; only program names. Rules require control handler applications reside all in a predetermined sub-directory of a DIFS's root directory. Therefore, a DIFS need keep only the program names of control handlers. A designer cannot remove an added control handler and its id. To remove handler<->id pairings could break many control files. The editor does not update control files from this interface.

Instead, the interface allows a designer to revert a handler back to default- handling. That is, the type will behave as though it were a default text control type. He does so by right-clicking on the handler in the control handlers list 284. The operation is harmless. A designer undoes it any time by assigning that slot a non-default handler. Multiple default handlers are harmless. They merely indicate that particular id's, besides just 0, are default-text type handlers.

Finally, in addition to ‘Beginner's Help’ and ‘Text Only Version’, the ‘Basic’ 268 tab configures alertion. As in a DIFS editor, alertion in a DIFS application may not always be desired. Consider that an operating environment may be equipped to present some, but not all, feedback. After a few messages indicating potential issues, an audience desires no reminding. Perhaps the complete DIFS is not operable, but what is presentable is acceptable. Messages give an option to stop further alertion (e.g., an embedded “Don't Remind Me” checkbutton).

The ‘Basic’ tab 268 alertion switch gives a user another way of toggling alertion. Shown in FIG. 24 is the DIFS editor's switch. The same one in the DIFS application does not alert on rules errors--only program errors. It is labeled ‘Alert on Known Errors’. The ‘Alert on Known Errors’ checkbutton lets a user toggle alertion on and off at any time. This is how a user knows if there is anything seriously wrong with a configuration. At the same time a user can remove alertion that distracts from experiencing the DIFS.</TE>

A Run-Time Configuration Interface: Presentation Details

Referring to FIGS. 25a and 25b, a DIFS features furthermore: a configuration interface for specifying launch settings of external handler applications, whereby the system may be configured to use optimally the applications available in a particular operating environment. <TE> FIG. 25a exposes this interface in a tried DIFS application.

The ‘Style:’ and ‘Default Look’ buttons do not appear in the DIFS application. These were described previously and exist only in the editor.

The second part of an all-text immediate feedback configurator 296 also is unavailable. As mentioned, only in a DIFS editor can a user specify ‘use Character Viewer for ATX cap’. This checkbutton is for setting how interaction immediate feedback plays in text mode. Left un-checked at compile-time, the DIFS application running the compiled DIFS will attempt to handle all-text immediate feedback itself (see above concerning “.cap” extension files).

However, the DIFS application's own mechanism for this, though adequate, is somewhat narrowly defined. Therefore, left checked during DIFS compile, ‘use Character Viewer for ATX .cap’ instructs redirection. The DIFS in this case would include with it a very particular ‘Character Viewer’. This ‘Character Viewer’ program would need to be capable of presenting “.cap” files. Ideally, it would be the same program as the non-all-text ‘Character Viewer’. It would merely detect a different file extension and handle presentation accordingly.

Otherwise, metadata might instruct a user to switch ‘Character Viewer’ attributes when switching modes. Perhaps she must specify a different ‘Character Viewer’ application or alternative ‘Character Viewer’ settings. Less ideal, this would still enable dual presentation modes for immediate feedback external to a main DIFS application.

The DIFS does not offload too much default handling to other applications, however. While more dynamic, providing these interfaces encourages non-standardized DIFS's. Even in default mode, DIFS's employing spawned programs risk requiring those separate applications. One primary focus of a DIFS is to promote universal sharing. Thus, another DIFS implementation might even allow all-text controls to be handled externally. The tried implementation, however, reserves this functionality to itself. This ensures all DIFS's, at least on some level, may operate for all audiences. As long as a user has a working DIFS application, she never completely misses out.</TE>

Regarding missing-out, some audiences may comprehend information quicker than others. Everyone reads at different rates. Yet to others, slowing down time to reception could prove annoying, insulting even. <TE> For this reason the all-text immediate feedback timing configurator 296 has another option. The ‘Character Response Time:’ input gives audiences control over timing. All-text immediate feedback is usually handled by the DIFS application itself. Therefore, the DIFS application lets a user tell it for how long (in seconds) to show immediate feedback. Then the DIFS application automatically hides immediate feedback and proceeds.

A user may specify fractions for specific timing. She may even give timing so close to 0, that immediate feedback disappears. Otherwise, she can give 0 or a negative number for no auto-hiding. In this case, the user will have to click on the feedback. Only then will the DIFS application proceed.

A ‘Title:’ button 294 is another simple presentation setting interface. A user clicks this to toggle between designer-specified and user-specifiable settings. Both have benefits. In the former, the title always resizes automatically to show the full title. The title is unobscured, but not resizable. This ‘Designer’ mode is indicated by the label (‘Designer’) of the ‘Title:’ button 294 in FIG. 25a.

The label changes to ‘Custom’ in the ‘Custom’ mode of title presentation. A user may resize the title window in 1 Custom’ mode. However, the title window has a resize button over its lower left corner. A title may occupy too much space for a user's liking. Titles may change throughout a DIFS, remember. So, this settings interface is, as the ‘Details’ tab 270 implies, for negotiating picky presentation details.

A Run-Time Configuration Interface: External Handler Launch Settings

The described title and all-text immediate feedback interfaces illustrate two internal settings interfaces. Still referring to FIG. 25a, a DIFS application provides several external handler settings interfaces 288. A user configures launch settings on the ‘Details’ 270 tab of the configuration interface. Each line on the ‘Details’ tab 270 corresponds to a handler application; i.e., the same handler application as appears on that same line on the ‘Basic’ tab 268.

In the input of a handler setting interface 288, a user types a command line. The command line differs slightly from typing a program command in a shell. The difference is that a DIFS application substitutes values for certain words. The special words, listed in a special words drop-down list 292, represent: program(name), (content)filename, x(position), y(position), w(idth), and h(eight). Corresponding words for these are, respectively: My_Program, My_Filename, My_X, My_Y, My_W, and My_H. Each special words drop-down list 292 is clickable. A user clicks on a line in the list. The corresponding word inserts itself at the cursor in the corresponding input. This relieves users of needing to remember special words and avoids typing errors. The drop-down list comes from clicking on the ‘ . . . ’ button left of the input.

Otherwise, the input of each external handler application launch settings interface 288 lets a user type. This is far less constrained than on the ‘Basic’ tab 268. There, to specify a program name a user must use a file chooser into the input. Here, he types whatever command-line arguments he desires. This freedom lets the user tailor launch settings specific to a specific program's desired configuration.

For instance, most presentation programs have command-line switches. These switches are passed to the program to tell it how to present. Perhaps there are full-screen, color, timing, or other modes. Or perhaps a handler program needs a-f preceding a content filename passed to it. A user may set the DIFS application to call the program properly always.

To instruct the process, settings metadata buttons 290 pop-up more metadata. From the ‘Details’ tab 270, the extra information relates to launch settings. A designer may have provided preferred external handler application launch settings. This metadata, like the handler application metadata, is stored within each DIFS file. Therefore, it is always just a few clicks away. A user merely clicks on a corresponding button on the ‘Details’ tab. She learns about what to do in the corresponding handler settings interface 290. A DIFS teaches what she should type where and how to insert special words. The DIFS can thus provide information about many alternative known feasible setups.

As stated, a DIFS substitutes values dynamically for special words of handler command lines. It overwrites these words during operation with the known values. It knows these values from various sources. The DIFS knows the program name from its specification on the ‘Basic’ tab 268. It knows a feedback content filename from DIFS data during operation—i.e., a production file.

Referring to FIG. 25b, a DIFS application knows the xposition(My_X), yposition(My_Y), width(My_W), and height(My_H) from a screen layout manager. A user invokes this full-screen layout interface by clicking a ‘Screen Layout’ button 276 (in FIGS. 25a and 25b).

This screen layout manager lets a user define values for handler application startup position and window dimensions. The DIFS application will then substitute these values for corresponding special tags in external handler command line settings.

Referring to FIG. 25b, the user defines these values graphically by positioning and resizing layout windows 298. These blank windows are draggable placeholders. The southeastwards-pointing arrow button is also draggable, allowing resizing of its respective layout window. Values defined here persist within the configuration of the DIFS. Each value is merely a moot suggestion, however, unless: 1) the configuration uses the special word; and 2) the external handler application provides a corresponding command-line option to use the value appropriately. Templates arranged using the interface of FIG. 25b are idyllic. Their precise matching is a convenience, not a necessity. After all, a user may usually position and size applications after their launch. This interface is just so that applications may in a best-case scenario always start predictably in a preferred manner.

</TE>

Other DIFS Operations: Writing a Book of DIFS Progress

Referring to FIG. 26, the stated invention of a DIFS possesses several other features. While dynamic, DIFS operation leaves a structured trail. This trail consists of memory records (see FIG. 17) in support of fitting together event data. Event data consists at least in part of all-text representations(TE). Taken together, this data trail is so comprehensive that a DIFS can provide a function to assemble all-text representations together in the same order as corresponding predetermined feedback occurred, thus writing a unique book of the DIFS's progress so far.

To help understand this feature, FIG. 26 demonstrates a fully-run DIFS of “Little Red Riding Hood.” A timeline of this DIFS's feedback events 300 shows all that has occurred. This run contained a total of 9 production-yielding feedback events.

Should a user wish for a log of her experience, she issues a ‘write the book’ 302 command. The DIFS application, as discussed, keeps meticulous records of event occurrences. <TE> For writing the book, the DIFS application needs only to use its productions string (see FIG. 17). This string preserves all information about production yielding events in order of their occurrence. Furthermore, a DIFS thoroughly produced contains an all-text representation for every feedback event. Thus, a DIFS application uses a simple method to write a book. It merely iterates back over the productions string. As it goes, it combines productions' all-text of occurred events.</TE>

Of course, the user does not want a mere system log. Transitions and formatting are quite important. So merely smashing everything together might produce a vague and brutish a result. Thus, the view taken by a DIFS superimposes connective structure(TE). The structure follows from observations regarding the various data structures. That is, containers inherently imply how to piece them together into a unified story. After all, embellishments notwithstanding, DIFS data likely originated from a unified story. Once again, proper design consideration also assists re-assembly. Each feedback event's all-text text can begin and end in a readily-connectable fashion.

<TE> Each feedback event occurrence is assumed to approximate a short sub-section of text. That is to say, each event production equals text of a short-range length. This is anywhere from one word to several paragraphs. It would be extremely unusual to have a five or ten page event.</TE> Were it so, the event would largely format itself. However, a book-writing function deals primarily with transitions between separately-stored text. Even were a feedback event lengthy, it would not break transitions. Generally, it is best to err on the side of underestimation of stored text. Longer texts format themselves. Shorter texts necessitate more transition work. The fewer gaps to fill-in the better.

<TE> The next order of magnitude comes at unit boundaries. These, of course, are somewhat invisible because unit events intermingle. Thus, each unit most closely resembles paragraph to section -length text. Any one section of a book for instance, could contain several threads of action. Some shorter sections are even of paragraph-length. It all depends on formatting of the book and its story's printed break-down. DIFS formatting merely acknowledges thread-switches by inserting three lines of empty space. Switching units within a thread inserts one line of blank space.</TE>

Printed stories usually use white space similarly to indicate spatial and/or temporal breaks; i.e. scene-shifts or time progression. Print uses other styles of formatting as well, of course. Other DIFS implementations might use other methods variously. They might break the data down or organize it other ways, too. The stated way is the tried way that seemed to work best. <TE> Lines of white space provided the minimal necessary transitional formatting. Moreover, blank lines inserted properly tend not to intrude on or detract from readability.

The result is a relatively smooth assemblage, fitting neatly many broken-down texts. This minimalism also does not preclude, but instead encourages, transitional formatting within feedback event text. The log looks more like a story.</TE> Aesthetically, that is what the ‘write the book’ function is trying to most nearly approximate: a written tale automatically re-assembled; this while doing the least work possible.

Fancier logic could try to do further semantical and grammatical link-ups as well. However, touch-up work would seem more in order, seeing as everyone intends a specific effect.

<TE> FIG. 26 shows output of ‘write the book’ under the ‘User issues write the book’ heading 302. This is a text file produced from the timeline 300 above. It is essentially a written story. Perfectly readable, the example demonstrates more clearly what writing the book has done. Polishing could simply involve touching-up all-text feedback to better facilitate the function.

For instance, writing the book gives event text of a same unit no intermediate spacing. Thus, more event text could perhaps begin with a newline carriage return. This would fix up some strangeness for generating the book, while not harming regular DIFS presentation of the same text.

Finally, timelines denote long section—or chapter—boundaries. The analogy up to this point has progressed in steps: from sub-sections to sections to chapters. Chapter is the largest natively covered. Of course, introductory feedback event text could introduce parts or sub-books as well.

Timestep boundaries do tidily map to chapter breaks. The mapping does not provide exact chapter numbers due to DIFS advancement behavior. However, transitions once again prove crucial to determining what to print and how. Whenever going from feedback from one timestep to a new timestep an integer prints, then increments. This integer is the chapters number printed with three blank lines above and two below. In the shown story, its the ‘1’ and ‘2’ for chapters 1 and 2.</TE> As stated, writing a book function could employ many other such meta-formatting techniques.

Other DIFS Operations: Rewinding and Restoring

Still referring to FIG. 26, the stated invention of a DIFS possesses several other features. A DIFS application carefully tracks accumulating history in codified run-time tables as previously noted (see FIG. 17). In other interactive works, a user commonly may save progress. Later, typically by loading a file of saved state or instructions, a user may return to her previous state. A DIFS's tables facilitate more than such usual restore-session operations.

Namely, they facilitate the following types of operations: a rewind function to set a point of rewind into the DIFS's timeline; a function to replay said predetermined feedback along the timeline from said point of rewind; and, finally, a function to restore the state of said DIFS to the state of the system as it was at said point of rewind.

<TE>

The restore vector helps because it keeps state as it occurred in-order. It does so regardless of whether each event was presented. The restore vector does not store aliases. That is, it stores only directly-user-initiated events—not aliases nor special unit endings, nor 0-duration (nor any other) units auto-advanced past except for non-alias unit critical lines that automatically evaluated to true. These, for book-keeping purposes, the restore vector does keep. As has been stated, the restore vector does not store nothing happens events, although technically a user does make these happen. More than anything, this last is in the interest of efficiency. “nothing happens” events can be inferred from history other ways—namely, subtracting what actually did happen from a duration of a lapsed unit.

Unit introductions are the primary special cases in terms of the restore vector. A user may switch back to a thread and see again the introduction to a unit she had no effect on. Storing the introduction is important for several reasons to be discussed. The DIFS application (removes and re-)adds the record of unit introduction feedback to the end of the restore vector. In this way unit introductions are made to exist at their last original occurrence in the restore vector. The same goes for their appearance in the productions string.

</TE>

Automatic replay of introductions is like a reminder during participation. On rewind-and-restore, however, a user expects to see an introduction feedback once only. He also expects to be able to rewind to before or after introductions just like any other initiated event. His selection of an agent caused the introduction to show, after all. He was witness to a presentation. Rewind-and-restore functionality cannot ignore this fact.

<TE>

Preferably, introductions always relate to relevant feedback, if any, that follows them. This helps make writing a book and replaying less choppy. Thus the removal and readdition scheme for unit introductions solves many problems. It keeps the records of the first two events registered from a unit contiguous in feedback memory.

This is important for another reason as well. Special unit-ending productions, while kept in the productions string, do not exist in the restore vector. However, a restore operation depends on general alignment of the two. More on this problem will follow.

Essentially, recording of a unit introduction to the restore vector ensures a lapsed unit's presence there. Thus, if no other events of that unit recorded to the restore vector, restores to unit-ending productions still know where to go. In fact, no unit feedback whatsoever may record, yet special ending feedback plays. In this situation, a bogus unit introduction records to the restore vector in conjunction with presentation of the unit's special ending feedback.

Before one can restore, she must first be able to rewind. In order to rewind, a user rewinds through feedback that has been presented her. This only makes sense. Like traditional video cassette machines, rewind moves back temporally through what has been presented. Rewind here does not involve any aspect of controls interaction, although it could potentially. Here, for efficiency, rewind moves only through feedback. DIFS feedback event occurrences are, after all, milestones resulting between relevant interaction.

Also, for efficiency and smoothness of replay, the DIFS application carefully checks redundancy. Only the first same-name production of an event records to the productions string. Meaning, except for introductions, automatic reminder replays of most-recent events causes no change in the productions string. Similarly, a feedback event may re-use severally the same production in its playlist. However, only the first playing of such a production ever gets recorded. On replays it might seem like a glitch to see the same production repeated. The same would be true of reading a book auto-generated with the same passage repeated.

Still referring to FIG. 26, 304 and 306 illustrate a rewind operation by a user. The user interacts with a VCR controls interface to move a point of reference from a later, more recent position 304, to an earlier more distantly past position 306. A user does not see the timeline directly necessarily. Indicative numbers on the interface update, however, as the user clicks the rewind button. And of course, she may view productions along the recorded timeline. Each number represents a unique point in the system. Each provides a definitive means for referring to exactly where the associated event is. The production replaying relates the associated story event. From an earlier position, the VCR controls allow a user to replay event feedback forward. The effect is to produce a relatively continuous unified production of what has happened so far.

Restoring is another operation entirely. A user may actually revisit an older point in the story. He can participate all over again from there as if nothing afterwards yet happened. He can undo history and have an effect to redirect its outcome. 308 shows the concept. Thus, a full restore involves a rewind and a chop: 304, 306, and 308. The user instructs where to restore to by using productions, via rewind, as the timeline index. The restore command performs the chop. The latter (restore command) might even exist somewhere on a VCR controls panel. Or, it might exist separately in a commands interface.

Complete one-to-one alignment of restore vector entries and productions string entries would be ideal. To rewind, all a DIFS needs to do is to iterate backwards over saved productions. Then, to restore, it determines the matching point in the restore vector. This would suffice to determine exactly where to restore to based on a user's input.

However, as stated, a productions string represents all presented feedback; while a restore vector is intended to represent only certain events. Only events a user made happen directly belong in a restore vector. This is because a user should only be able to restore to certain points in the DIFS. In special cases regarding unit-ending feedback, two feedback productions may occur in unison as the result of one user initiation: an event's feedback, and special unit-ending feedback. A user should not be allowed to restore back to between these two productions.

The result could be disastrous as there is no real opportunity for interaction there. Splitting such feedback is misleading. It certainly does not represent true restoration to a meaningful original state. Depending on the DIFS, it might prove totally non-sensical. Worse yet, it might crash the system, as this state was obviously unintended.

Therefore, the restore function prevents harmful splitting. A user may try to restore between two events that he should not be able to. Actual restoration automatically figures the nearest safe location to restore to. This is never off by more than one feedback production from where the user specified.

Restore tries to put state back to as it was just after the user-specified production. To restore to the very beginning, a user just restarts a DIFS anew. A pseudo code specification of one implementation follows. It is based on the run-time tables and storage of FIG. 17. As FIG. 26 alludes, this implementation is predicated on a simple observation.

The concept is that dynamic system state can be first reinitialized to its startup state. Then, the DIFS application automates the DIFS forward from the beginning in increments according to what happened before. The net effect is the ability to achieve any previously achieved state. The DIFS application rebuilds previous state from scratch. It rebuilds the story from the ground up by using temporary cached data local to the restore function. The pseudo code follows:

void cb_Restore( ) {

1)Cancel interaction sequence potentially in progress or abort this function if any process is spawned. A user must terminate spawned processes before we allow this operation.

2)Return immediately if a user did not rewind at all. Restoring to where we are has absolutely no effect.

3)Update graphical user interface, if any, properly.

4)Get the production a user rewound to. Also retrieve which event and which occurrence of the event it represents (save this number to an integer event_id). Glean all of this information from the formatted data immediately after the rewind pointer's position within the productions string.

5)Also find where in the restore vector the rewound-to event is. We'll refer to this index as rst_to_index. To determine this point exactly, we use the data we found in step 5.

a)We simply keep going from the beginning up through the restore vector to where we count that event having happened that many times;

or,

b)if the user specified a special unit-ending production as the rewind-to production, we count down from the end of the restore vector. We continue downwards until hitting the occurrence of the event that caused the special unit-ending production. We save also the nothing happens's from the productions string into an integer we'll call NHs.

6)Undo certain state after the point of rewind.

a)Reinitialize all Productions Matrix I (booked intro at)-numbers, then using the restore vector, re-fill them in up to rst_to_index.

b)Check the productions array itself. The final production rewound-to may split two feedback productions that resulted from the same event. This only happens for special unit-ending productions. We don't want to split two productions from a single event unless multiple nothing-happens's caused the second production to play simply because unit time ran out. A user here might be rewinding just to get another chance at the unit because she was ineffectual there.

i)We save the rewound-to production string data to temporary variables, and auto-forward to the next production in the string, if any.

ii)IF we weren't already at the end (i.e., inequality exists between our new data and our saved data), AND the production we landed on is not a unit-ending production, OR nothing happens's occurred to cause a special time-ran out ending, THEN rewind to the original rewound-to pointer.

ELSE, we stay forwarded, neither going back wrongly nor splitting feedback of the same event.

(The GUI should also reflect whichever position we're at.)

c)Chop the restore vector by making an abbreviated copy only going up through rst_to_index, & then deleting & reassigning the restore vector to be the copy.

d)Chop the productions string similarly and put the production-at pointer to before the last production (set PRODUCTION COUNT, too).

7)Deal with unit durations. Spillover of unused turns capability requires that automation forward from the beginning take into account actual time lapse at each unit. Otherwise, automation would be untrue. All we are going to do is just set event values in accordance with the restore vector and call advance. We did not record any information regarding nothing happens events, however. This was for efficiency—it would have been highly wasteful to store a user's (repeated) inability to make things happen. However, so that the restore is faithful, we must deduce and simulate all prior nothing happens's.

a)Save actual MainMatrix durations to a tempDurations array.

b)Make a 3×MainMatrixN int array T with corresponding thread numbers and durations(durations 0 instead of the corresponding duration) and a flag, initially 0, indicating whether this index of T was an event on the restore path.

c)Up to rst_to_index, and for all restore vector entries except unit introductions, add 1 to the duration for the event's unit in the new array T. This adds up for each unit the actual total events that occurred there. Also set the flag to ‘1’ for every unit that we restore feedback for.

d)Subtract each total from the corresponding MainMatrix duration for the unit, thus giving for each unit we're restoring its unused turns value. So now, durations in T should be overwritten to contain these spillover values respectively. However, some spillover values may appear to be negative because listed duration was initially 0 for those units. Subtracting event occurrences from them produced negative spillover.

e)Going from the bottom-most index in T to the top, look for negative spillover values. Upon finding one, search backwards through T and add the most recent same-thread unit's spillover. At the end of this step, there should be no negative spillover's left. All should either be positive or 0.

f)Temporarily change MainMatrix unit durations:

i)First, zero out the MainMatrix duration of each unit that has a restore vector feedback entry from that unit.

ii)Add 1 to the MainMatrix unit duration for each occurrence of an event from that unit contained in the restore vector. The result is that each duration becomes precisely the actual number of events that happened. Units never interacted with will keep their original durations, as they recorded no feedback to the restore vector.

iii)The exception for zeroing out units that have been recorded are units that are last of their thread. That is, last of their thread up to the event at rst_to_index. Again, any unit interacted with will have a presence in the restore vector. Therefore, a reverse-traversal of the restore vector determines last-of-their-thread units. We do not zero out the duration of these. In fact, if one of their durations is zero, we give it whatever turns were leftover from the previous unit in the thread (as calculated in our array, T).

This is because otherwise, last thread units stand to inherit nothing. Each unit now has exactly the number of events that occurred in it with none to spare. Thus, we performed inheritance of duration automatically for prior zero duration units. If we did not perform inheritance for the last thread unit we're restoring, it would inherit 0 duration. Obviously, this is not how it happened the first time. Giving last units their original (or inherited) duration simulates precisely what happened before.

iv)Finally, thread units after a last restored unit get back their original durations. Threads never put in the restore array, as mentioned, already retain their original real durations. So now all durations are prepared for an automated simulation from the beginning.

v)Delete T. Always be sure to deallocate properly, depending on programming language of implementation.

8)Complete some last-minute reinitializing.

a)Set all MainMatrix state to −1 (unknown) except for past history from previous stories. We have a bitmask array of flags that keeps track of these rows, which we do not touch.

b)Reinitialize completely to empty states the

Current Moment Matrix,

Moment From Character Array, and

Most Recent Possibility Matrix

c)Reinitialize global variables

CURRENTCHARACTER=0

CURENTMOMENT=0

CURRENTTIME=0

9)Call LoadNextActiveTimestep( ) to get the restore started-off.

10)Run the following loop:

```
/*
NOTE: The restore vector is named RestoreArray. Function calls here are to same-named functions given in the
above advancement code listing. As stated, restore re-uses advancement code for automation.
*/
  for(int rst_i=0;rst_i<=rst_to_index;rst_i++){
  InitialiseMomentStateIfIsnt(MainMatrix[RestoreArray[rst_i]][7]);
  int new_ctime=MainMatrix[RestoreArray[rst_i]][3];
  while(CURRENTTIME < new_ctime){
    CURRENTTIME++;
    ThreadCheck( );
  }
  MakeAllThreadPastKnown(MainMatrix[RestoreArray[rst_i]][7]);
  //setting MRP and such from other threads
  for(int J=CurrentMomentMatrix0;J<CurrentMomentMatrixN;J++){
    if(CurrentMomentMatrix[J][0])
    AutoAdvanceCatchUp(J);
  }
  //in the case of introductions to units...
  if(MainMatrix[RestoreArray[rst_i]][7]==RestoreArray[rst_i])
    continue;
  MainMatrix[RestoreArray[rst_i]][0]+=
    (MainMatrix[RestoreArray[rst_i]][0]<0)? 2 : 1;
  InsertNewMRPInMRPMatrix(RestoreArray[rst_i]);
  Advance(RestoreArray[rst_i],
    ((MainMatrix[RestoreArray[rst_i]][6]==2)?0:1));
  PostRecursiveAdvanceCurrentMomentsInitialise( );
  }
11)Reset all Main Matrix durations to as they were before from the tempDurations array and delete tempDurations.
12)Finally, catch the last part of the system up in case there were NOTHING HAPPENS's leading to the restored-to
event. This is only important for the case of restoration to (after) a special ending. Remember, we saved NHs and
event_id earlier above.
  if(NHs){
  Advance(abs(event_id),NHs);
  PostRecursiveAdvanceCurrentMomentsInitialise( );
  }
  LoadNextActiveTimestep( );
  LoadCommandsBrowser( );
}//end of void cb_Restore() function
</TE>
```

Additional Alternative Embodiments

A Multiplayer DIFS

Referring to FIG. 27, and according to another stated manifestation of a DIFS, a multiplayer method could allow playing of a multiplayer embodiment of a DIFS. Said method further comprises providing participants numbering more than one 312, each running a separate DIFS application on same DIFS data, each on a machine that communicates with each other participating machine, represented in FIG. 27 by 328.

Said method further comprises providing said participants contributing simultaneously to which agent of an agents group will be an active agent for all the DIFS applications respectively. In FIG. 27, a majority vote of participants decides which agent will be a present active agent for the subsequent interaction sequence, 320 demonstrating one such vote.

324 represents a tie-breaker phase of this democratic active agent selection process. Perhaps a random number seeded with time could break a tie; perhaps another vote or some other germane factor. Or perhaps a distributed DIFS environment as such could employ a different tallying system.

Regardless of selection methodology, all participate as the agent chosen, one example interaction interval being 316. The stated method furthermore specifies an automatic ending after a time interval of any participant interaction still in progress. A user may complete her interaction sequence naturally, such as at 310. This is the same as she would do in the single player non-communicating version. She must finish before the time interval allotted for the sequence lapses. Otherwise, the interaction sequence time interval ends, as shown at 322. Lapse of allotted time forces an ending of all participants' interaction still in progress.

Finally, the method entails provision of said participants contributing equally to the decision of which feedback will be recorded to feedback memory for all the DIFS applications respectively. The winning outcome of the majority of participants is the winner of the interaction sequence, as at 318. Once again, sometimes a tie-breaker mechanism, this one for a feedback race—as at 326—may be necessary. Once again, a plethora of alternative voting and/or tie-breaking mechanisms could suffice. Whichever method is used, the same feedback is presented and recorded in all DIFS's, such as at 314.

One can imagine this manifestation requires many underlying network mechanisms. These are beyond the scope of this patent. Suffice to say, the scenario is a distributed approach requiring no central master server. Each DIFS application should be capable of acting as both broadcaster and receiver. The distributed model lessens the considerable prerequisite of a powerful centralized server resource. In this model, a group of friends can agree on a time to coordinate. Or perhaps some other form of session-in-progress discovery exists.

Really, the main prerequisites are separate processes numbering one per user, separate means for display to each user, separate means for interaction by each user, and means of communication between the separate user processes so that they coordinate. This is the intent of claim 6.

This text does not touch on other potential networking and collaborative enhancements. The distributed DIFS should provide plenty of “chat” capability for users to interact. Interaction with other participants is the primary feature of this embodiment. Simultaneous contribution to DIFS outcomes is the excuse for coming together.

Unlike other massively multiplayer games, the purpose of a DIFS is intentionally less immersive. This is a plus for people apprehensive to those other multiplayer formats. The DIFS is less personal. The format recognizes a healthy separation between participants and digital personas. Many possess no wont nor time nor interest in maintaining an ongoing digital self.

A stream of participatory chat on a lively interactive piece of art might prove more inclusive and inviting, perhaps in some ways even more entertaining. Participants contribute equally to shaping a highly dynamic experience.

In other massive RPG's the range of player-character actions is necessarily limited. Entertaining is role-playing. Discussing with other players the predicaments that arise is much like assuming a pretend personality in a virtual “chat room.” Like an actor in a play, all one really needs is a name and a motive.

Thus, even though graphics and delivery capabilities continue to improve, RPG story line predicaments ultimately are fun because of players' interaction with one another. A multiplayer DIFS would lose none of this benefit. Rather, the emphasis changes to working together to guide non player character actions. The value added here comes from work done previously to make a DIFS meaningful.

The goal is to make a unique story, to see other persons' views and shape them and let them shape one's own views. What is at stake constantly is much greater than in any RPG. Each carefully designed DIFS cuts to what is truly important, to the crucial action of its particular storylines. No aimless wandering in search of increasing arbitrary trait numbers is necessary.

The proposed strategy allows users to sync-up. Technically, accommodation of networking should not prove difficult. A DIFS application could be hardly changed. Merely, it could be added-to in support of dual client-server functionality. Technical advantages further include not needing to alter much, if at all, existing single-player DIFS's. Without recompilation, any DIFS could potentially instantly provide a ready-made platform for multi-user interaction.

Afore-stated DIFS combine and continuation capabilities provide further intriguing expressive avenues. Ongoing storylines may develop over time with installments like interactive sitcoms. Separate episodes can combine to form larger unified pieces. The trail of work, after all, is far from being dead or static. It remains very much alive even as time and technology progresses. Especially on a network, DIFS's can be constantly integrated for re-use into newer works.

Perhaps for a different multiplayer version, overlap of participants occurs only during interaction and/or presentation segments. In such a situation, participants could engage other participants from within separate DIFS's altogether.

Robust controls segments might remain the real crux of an experience. These could be massively multiplayer RPG frameworks already in existence or some other format. A DIFS could serve to inject sorely needed story content at key points.

In fact, databases of general DIFS's could provide such top-down modules on demand, perhaps at random. If “chat” represents free-will, these DIFS modules might alternatively introduce a satisfying sense of determinism, predestination, and purpose. DIFS's are best suited for negotiating dynamic content. Far from predictable, DIFS's have been shown to be able even to refashion themselves anew. During operation they may issue complete automatic self-reloads.

Certainly independent users can craft their own DIFS's. Likewise, they could develop only controls and/or presentation content for certain more or less open-ended DIFS's. Participating on the network might then put their contributions into immediate widespread use.

Alternatively, a more dynamic means of content generation could allow creators immediate interactive broadcast to other participants; e.g., agents' text thought controls originate from spur-of-the-moment participation by creators. Eventually, maybe even machines could participate in scripting as DIFS specification methodology and translation from written works becomes ever more codified.

Success in any of these directions will depend ultimately on users and developers. For its part, a DIFS application provides rich input and command-line startup interfaces(TE). These channels make a DIFS highly usable by external processes be they standalone or inter-communicating applications. Mid-operation input mechanisms have been discussed. <TE> A standard command line features:

DIFS.exe <story_filename>[[skip_legal][configuration <config_filename>[menu_mask <$Load0|1><$Instructions0|1><$About0|1><$Write Story0|1><$Exit0|1><$Restore0|1><$Save0|1>][play_mrp][autoselect_character<charactername>][hide_all_other_characters][autoexit][save_on_exit<save_filename>]][history<firsthistory_filename><secondhistory_filename> . . . <lasthistory_filename>]

Where history filename first-through-last must be names of files exactly corresponding to the same order in which the DIFS application (DIFS.exe) asks for this history. A caller framework should be able to provide history names if so desired. To provide ‘Default’ the caller simply specifies <storytitle>.stx. The history list must be comprehensive as well. That is, the number of history filenames here must equal the number of histories a particular DIFS needs. Lastly, these files must exist in the story's “include” directory. Note also that saying hide_all_other_characters will have no effect if no autoselect_character is specified. Likewise, if autoselect_character *is* specified, then play_mrp will have no effect (although the most recent production may play anyways as a result of the character's selection).

</TE>

The above-demonstrated commandline switches show how certain DIFS operations and commands can be made available or unavailable. An equally rich set of output options complement the input functionality. These have been put forth previously.

Together, the DIFS's robust I/O enables worlds of integration potential. In one view, a DIFS is a manager process. It acts like a turnstyle or a revolving door to coordinate sub-processes. It acts as controller. In another view, a DIFS can be thought of as a purely a pass-through process. In this role, a DIFS serves mainly to enhance existing applications. Indeed, DIFS's might initially attract more widespread use in this capacity. A DIFS's potential to be a subordinated process is as real as its potential to be a springboard, itself, for entirely new formats.

Most traditionally, of course, a DIFS is simply a general interactive story system. It comes from one or more originators. It benefits one or more participants. The works themselves, and nature and relationships of real-world entities involved, are all open to a wide array of interpretations.

A Printed DIFS

Referring to FIG. 28, a last, completely different manifestation of a DIFS is printed. This is different from the write the book command discussed above. In a completely printed manifestation of a DIFS, the system exists in its entirety on paper. That is, rules and data for running it are printed in a disassembled form for a user to piece together by playing. Playing of a print version occurs away from a computer.

Reduction to print brings many obvious advantages. Precursor nonlinear books and boxed role-playing systems have attained wide popularity, familiarity, and acceptance. The traditional format provides a set of structured rules which an audience must enact. Adventures, role-playing, and interactive storytelling come to life by audience enactment of rules on content. By its provision of a rules section 330, a printed DIFS welcomes those experienced and those who are newcomers alike.

Some existent print systems require one participant; others, multiple participants. In some, control flow is distributed and all engage in rules equally. In others, one or more individuals clearly manage play. Usually, standardized turns define the process. A print DIFS lends itself variously to all such configurations. Although it is particularly well suited to a single participant running the system in regular turns. This arrangement is the most fundamental situation imagined. From it, many other variations on the system are possible.

Most importantly, a printed DIFS benefits greatly from its medium. Print is accessible, physically portable, and requires no extraneous compatible technology, besides literacy of a participant, to run it. Thus, a print DIFS promotes sharing. Sharing many of the benefits of its digital counterpart, a print DIFS breaks new ground in a well-established industry.

DIFS specification offers a method to play a printed DIFS as such. The table of contents of FIG. 28 prefigures DIFS printed organization. Rules and structure follow closely from their digital version counterparts. The main difference is that print obviously does not automate any processes. In printed form, a DIFS is essentially its static parts. It does not run itself. Running the system by hand should require only a reasonable, minimal effort on a participant's part.

Rules 330 for doing so, would necessarily require maintenance and updates of information in certain state tables 340. These would include such information as is shown in FIG. 17. Certainly not all of the information of FIG. 17 would be necessary, nor necessarily reliant on a user's providing and/or maintaining it. Some of the information is static, filled-in already from the start and purely for reference. All main story state information, static or not, would have its own centralized location in the printed copy. A participant would likely use a pencil to track dynamic current status information. This keeps with the stated method, which calls for tracking by a participant of feedback memory and necessary system state.

Following from usual DIFS control flow, a control tables section 336 of FIG. 28 serves an independent purpose. The stated method of printed DIFS playing provides printed control-restrictions for printed controls respectively regarding whether each control may be used at a current state of the system.

Between interaction sequences, a participant negotiates system state to determine a correct agent group. On picking an active agent, he would consult a proper page of this control tables section to determine available controls. As in the digital version, certain controls get filtered out by current system state. Only in printed control restrictions (the tables alluded to by 336), a participant consults a table to determine which controls are available to be engaged.

Essentially, control tables 336 present controls availability in a quick, concise, and comprehensible manner. For example, one table might look like the following:

| | | |
|---|---|---|
| 1 | G1 | |
| e3 | G2 | |
| | & el>e2 | G3 |
| | & e4 | G4 |
| | & el=1 | G5 |
| e1=1 | G2,G6 | |
| !G5 | G7 | |
| !G4 | G8 | |

General rules for using this table might be the following:

Go through the above lines and substitute the proper event occurrences value for each e#(event number). Use the Main State table to fill in these values. The # in e# means the event's offset from the current moment index in the State Table. So at moment 4, for e3, you would substitute the Main State table value from Main State table index 7. If Main State 7 had a value of 5 for this event, you would substitute the number 5 for everywhere you see e3 above.

Next, proceed in order from top-to-bottom compiling as you go the list of control groups(G#). Add a control group to your list if the expression on the left of the line it is on evaluates to true (any non-zero and non-negative number). Never remove groups from your list once you have added them. Never go back up the list and re-evaluate any lines based on later (lower-down) evaluations.

In the above, the final controls group list result from p's 1-7 having, respectively, the values

2 0 3 1 0 2 1

would be

G1,G2,G3,G4,G7

Each controls group number (G#) represents a group of available controls. A participant having constructed these ranges(i.e. groups) of available controls, then proceeds to downsample further. e.g., she rolls dice to determine a number within the ranges, a control within the groups. Various methods of mapping dice rolls to specific controls as such might work equally well.

The algorithm of active controls selection is relatively identical to the digital DIFS. Here, by practicing a few basic rules using nicely formatted data, a participant provides the necessary processing power to run a print DIFS by hand.

To make any control truly active, there must be a control to make active. The method of print DIFS playing accordingly provides printed controls 334. These can comprise discretized pictures and/or text; anything really, that is printable. These controls are what a participant will identify with as interactive content. From a control, a participant may follow one of potentially numerous connections. So that the result of following connections is not known, control effects are preferably separated into their own section 332.

The stated method further provides for these printed control-effects of said printed controls respectively. Each control's effects may provide among other things: a power value number; an outcome identifier number if any, indicating to which outcome the power should be added; and a next control if any, or instructions on how to determine where to go next.

Lastly, of course, the stated method provides for blocks of printed feedback 338. These are the actual actions respectively that a participant affects as the result of negotiating controls.

By this method of printed DIFS playing, various levels of indirection deter cheating and more closely mimic equivalent digital DIFS operation. Unlike other similar interactive print materials, a printed DIFS truly keeps a participant guessing. Choices are not single direct conscious ones with immediate impact, as they are in some non-linear books. The participant typically must use a plethora of available controls. He cannot simply flip ahead or use bookmarks to keep his place. He must learn about characters and how to influence action through them. To look ahead in all directions would ultimately prove too tedious and time-consuming.

On the flip-side, it is intended that bookkeeping to run the system not be too laborious. With proper nice formatting, tracking should be relatively straightforward and reasonable. The focus, after all, is really not on the numbers, as it can sometimes be with boxed RPG's. Rather, the focus is on the content—the controls and feedback—and what that content says about characterization and story.

By following provided playing rules 330, a participant negotiates said printed controls, said printed control-restrictions, said printed control-effects, and said blocks of printed feedback, and hence performs said tracking of feedback memory and system state. State tables are partially participant-maintained. Other parts would be filled-in indelibly from the outset, representing unchanging system state.

Overall, system tracking sections keep a printed DIFS's ongoing history. Perhaps these records could even be converted back into standardized input to give to a digital DIFS. That way, after finishing a print version, a participant could experience the equivalent digital media path(s) through the DIFS.

Of course, to facilitate printed DIFS creation, a DIFS editor and/or DIFS application could provide capability to automatically generate a print version of a DIFS. On issuance of a command to do so, a DIFS program might provide some options. For instance, it could ask how various types of controls and media feedback should be printed. The program would ask for a ‘print’ command line option for those associated handler applications having such an option. A ‘print-to’ file should also be an available option for handler command lines.

The DIFS program would then, in the process of its assembling what it knows how to write to a print-ready file, invoke those other programs to append their contributions. Thus ‘print’ version might not necessarily be synonymous with all-text representative content. Some print-ready file formats allow static graphic images. A previously discussed write the book command could similarly take advantage of such capability.

For printed version and book version, all writer applications would have to agree on a single format. They would have to be programmed to open for append a ‘print-to’ file given on their command line.

Otherwise, a separate program altogether could perform assembly for print. It might employ a no-interface version of a DIFS application to do so.

Regardless of implementation methodology employed, a printed DIFS has another outstanding benefit. A wholly print version DIFS provides an external technology-independent, comprehensive specification of a DIFS. Together with this patent specification or merely provided rules, one could reconstruct both a non-print DIFS application and (most of) the non-print DIFS itself. This could be done without having access to any other technology whatsoever. Thus a printed form of a DIFS is able to exist in the real world, independent of the considerable technologies that enable its digital counterpart.

Conclusion, Ramifications, and Scope

Thus the reader will see that the dynamic interaction and feedback system of the present invention provides a comprehensive operating system for digital stories. With DIFS story logic, the possibilities are endless.

The reader should have seen how structurally, the general underlying qualities of a DIFS assume little. A DIFS's narrowest implementation should still prove open and adaptable to many usages. A DIFS conceives of its subject—a story—as a complex and intricate system, logically-operated. A directory tree of content and compiled instructions files support sophisticated interactive manifestations.

Unlike other similar works, plot branching in a DIFS does not merely terminate. Nor need it fork once only or merely skip events. A DIFS provides a full state machine not only capable of skipping story events, but these events' unlimited branching, repetition, occurrence, and non-occurrence.

Rules ensure success. One such rule of a tried implementation, for instance, requires each thread of events have one root only. A DIFS IDE (integrated development environment, or editor) limits design implementation. But such limitation is no different than linguistic grammar or word-order rules. DIFS implementation overall provides a robust, workable framework. Like a language of expression, it hardly limits at all what may easily be expressed. What limitation there is exists purely in the interest of standardized meaning and predictable post-compile systems.

Perhaps in another set of rules, character/agents could appear in more than one thread at a same timestep. This is disallowed in a tried implementation, for reasons given previously. One DIFS editor might enforce certain rules that another editor might not and vice versa. Generally, a DIFS editor provides the fewest constraints on design, allowing as free and non-linear a workflow as can be imagined.

At run-time a DIFS application uses agent group determination means to filter characters available at any given point in time. Once a user selects an agent, the DIFS application filters available controls. Perhaps another DIFS could allow selection of more than one agent at a time. Either way, a DIFS gives a truly dynamic experience. It is highly responsive and sensitive. Furthermore, with rewind and restore functions one can go back and change DIFS history, effectively stepping in the same river twice.

For their part, controls were shown to have PLA(programmable logic array)-like filtration based on conditions and story state. When interacting with a control, a user sometimes exerts influence indirectly. A control suggests action to an agent. A user, therefore, seeks deeper understanding of controls and agents.

A DIFS is general purpose, desiring that any storied work could find a suitable manifestation through its form. The realistic goal of DIFS designers: to create a true-to-vision interactive experience representative of the particular story.

A DIFS follows the traditional producer<->consumer model. An originator broadcasts content via more or less static data to an audience. Processes in a DIFS application together with user interaction assemble the pieces dynamically. Another model has potential for multiple users in an intercommunicating, e.g. networked, environment affecting outcomes democratically.

Of course, various takes on structure could allow pass-throughs such as alias units to play productions, or feedback to be interactive as well. But the general operative structure of the claims is the fundamental premise of any DIFS.

DIFS specification and editing tools are writerly tools, accessible to technical and non-technical types of persons alike. A DIFS helps organize creative thinking. Characters, for instance, may or may not actually appear as interactive agents. Yet a DIFS editor may allow tracking of such extras; anything to help enhance the resultant product.

A DIFS wants to weave new art forms out of stories and technology, out of poetry and videogames, and all the various expressions.

Musicians, artists and programmers all have had their place in the emergent genre of video games. Story, meanwhile, has typically been undertreated or licensed material decided on ad-hoc or in committee sometime between the start and finish of a major work's development cycle. Consequently, story reaches audiences of interactive formats only in side-references and notes, as filler in manuals and only occasionally in the game itself. Story has been a mere augmentation of graphics, gameplay, and sound.

If it were the center, as marketing would have us believe, then writers, creative writing and English specialists, would be in high demand and an essential member of every production team. No—guided, storied vision has been replaced in many (most) instances by implementation and flash; the deep, enduring, longtime love and friendship of a favorite story experience, replaced by the fleeting sex of moving graphics and sound.

For all developers, a DIFS specification and editor make versioning and iterative design easier. Developers gain newfound ability to concentrate solely on high plot and ideas. Perhaps story truly will re-emerge from its backseat status in computerized interactive fiction.

A most complete method for turning arbitrary writing into a DIFS involves iteration, adjustment, and embellishment. Still, a writer can write a story and take it to a full DIFS form by keeping very few rules in mind. The responsibility for rules enforcement and story integrity rests mostly on a DIFS editor tool.

Just like sound code compilers, a DIFS editor relieves authors of much of the burden of making a piece work. Logical errors of course may still result. In general, though, automatic DIFS rules enforcement keeps works tight and consistent. Far less bugs will result, and a developer stays on track. She can even preview and simulate how various aspects will play.

All in all, these benefits significantly lower costs to produce DIFS's: from games to educational modules to any other application that comprises one or more DIFS'S. Less time to creation, and fewer impediments to crafting quality experience add up to realistic RAD (rapid application development).

A DIFS specification has built-in modularity and flexibility. It is designed to use and/or be used by other programs. It can serve as (a) sub-module(s) into another game or work. As such, it may provide crucial turning point sequences to a variety of different productions.

Within a DIFS re-use of components includes transplantable control files and extensible story files. For the latter, one can imagine other stories sequenced together, in parallel, woven as separate threads into a whole. A developer can broaden scope of any DIFS simply, by using a combine process. Then he aligns the combined stories properly so that sequencing of their parallel threads allows discovery of fascinating juxtapositions.

Migration of logic never occurs from the main system to its spawned parts, unless of course desired. DIFS control flow is always best described as a carefully controlled distribution of control.

The bottom line in terms of making money from a DIFS looks very optimistic. One contributing a DIFS editor generates revenue from DIFS designers for licensing its use. DIFS designers come out ahead from the usual benefits of producing interactive content. Perhaps saved DIFS sessions create another niche as well.

After all, unlike saved sessions of other systems, a saved DIFS lets one go back and explore its full path of recorded history. A saved DIFS file is its own hint-book so to speak. It exposes many secrets that might otherwise be challenging to reveal.

Of course, unlike other hardware platforms, a DIFS application for end-users is an entirely software system. Meaning, audiences need not bear the brunt of additional hardware costs. A DIFS application can and should be free and open source. DIFS's take full advantage of existing and emerging technologies.

The bottom line is, a DIFS may create its own new industry entirely!

From the standpoint of distribution, both DIEFS editor and DIEFS application need only be small applications. Compiling DIFS instructions also minimizes their size for ready digital distribution and transport. The end-to-end solution of a DIFS does not stop there.

To be able to interface with any operating environment, a DIFS application provides external handler hooks. Each DIFS has its own content and requirements. Each DIFS accordingly instructs its configuration and describes all content contained within the installment. In a sense, it is its own self-describing multimedia library of content into a story. The central story file serves as the index of organization of all of its content files. Its self-describing nature is useful for archival purposes as well.

Currently visual and auditory technologies top the list of those sensory technologies supported by machines. Those are the interfaces currently most widely supported by personal computers. Certainly, a DIFS is extensible to other sensory interfaces as well. It is limited only by the boundless progression of external hardware and software components it references.

A DIFS is independent by not being dependent on (making fewest assumptions about) other hardware and software systems. A DIFS is positioned to take advantage of all the latest technologies yet not be dependent on them. It can be a container for all that is the forefront of computer game technology, for instance. At the same time, a DFS is a technology in its own right, completely independent of media program details.

DIFS's anticipate text readers that can communicate out loud to the blind. DIFS specification includes an all-text version. Proper handler programs could communicate this text to the blind and/or illiterate. Text is a most universal medium. It reaches nigh as far as computer technology among people today. A DIFS's goal is to reach as wide an audience as possible, to broaden accessibility to all able and literate and beyond. A DIFS emphasizes sharing.

Its format stands further to embrace broader demographics than certain traditional interactive content. Its unique method of play may cut further across gender, age, and taste borders than some other more narrowly targeted products. Study, as well as entertainment, stands to benefit. A DIFS brings together the best of story, technology, tellers, and audiences.

The experience of playing a DIFS is like no other. At its best it is smooth and rich, lively and deeply entertaining. A DIFS application adds proper sensible sequencing. It gently formats the spatial and temporal experience, finessing the what's where's when's and why's into a sensible and satisfying totality. This nicety of play often includes special precautions concerning sequencing certain segments without interruption, or repeating them to remind a user, etc. Various cues as such smooth transitions and tie an otherwise highly dynamic experience neatly together.

Much is made these days over the use of AI(artificial intelligence) in computer applications. A DIFS provides AI readily, reliably, without itself relying on any unusual architectural assumptions. DIFS specification merely acknowledges that authors for years have been making AI. Just ask their faithful readers.

A DIFS standardizes and codifies, centralizes and localizes all story logic to a brain center—a story file—that affords a designer control over the fixedness of progression. Add the notion of control sets, and the specification further lets personality arise out of situation and situation out of personality accumulatively. Extreme entertainment value is the result.

While the above description contains many specificities, these should not be construed as limitations on the scope of the invention, but rather as an exemplification of one tried embodiment thereof. Many other variations are possible. For example, anywhere noted by a TE, for ‘tried embodiment’, in the above description in particular could easily be implemented differently.

Accordingly, the scope of the invention should be determined not by the embodiment(s) illustrated, but by the appended claims and their legal equivalents.

1. A dynamic interaction and feedback system for simulating the accumulation of consequence to enhance interactive content comprising:
agent group determination logic for generating an agent group of one or more agents at a state of the system
an active agent selection interface so that a participant may select an agent from said agent group to be a present active agent
active controls selection logic for selecting an active controls set from a set of predetermined controls related to said active agent at said state of the system
providing a feedback memory for recording the occurrence of predetermined feedback resulting from said participant interacting with said active controls set so that said feedback memory may assist said agent group determination means by providing a component of a new state of the system.

2. The dynamic interaction and feedback system of claim 1 further comprising:
all-text representations for said predetermined feedback respectively
a function to assemble said all-text representations together in the same order as corresponding said predetermined feedback occurred, thus writing a unique book of progress so far of said dynamic interaction and feedback system.

3. The dynamic interaction and feedback system of claim 1 in which state of said dynamic interaction and feedback system comprises:
state recorded from the current dynamic interaction and feedback system
state recorded from previous installments of dynamic interaction and feedback systems described in claim 1,
whereby history may accumulate from prior dynamic interaction and feedback systems to subsequent dynamic interaction and feedback systems.

4. The dynamic interaction and feedback system of claim 1 in which said feedback memory retains a timeline of order of occurrence of said predetermined feedback, further comprising:
a rewind function to set a point of rewind into the timeline
a function to replay said predetermined feedback along the timeline from said point of rewind
a function to restore the state of said dynamic interaction and feedback system to the state of the system as it was at said point of rewind.

5. The dynamic interaction and feedback system of claim 1 wherein the affectation by the participant of certain predetermined feedback causes automatic recording to said feedback memory of a predetermined number of occurrences of other predetermined feedback without said other predetermined feedback actually being presented to the participant but rather assumed by the system to have occurred offstage
whereby said feedback memory may assist said agent group determination means by providing a component of a new state of the system dependant not entirely on direct participant interaction but on mere temporal progression of the overall system as well.

6. A method to play a multiplayer embodiment of the dynamic interaction and feedback system of claim 1 further comprising:
providing participants numbering more than one, each running a separate dynamic interaction and feedback system application on same dynamic interaction and feedback system data, each on a machine that communicates with each other participating machine
providing said participants contributing simultaneously to which agent of said agent group will be said active agent for all the dynamic interaction and feedback system applications respectively
ending automatically after a time interval any interaction still in progress by said participants
providing said participants contributing equally to the decision of which feedback will be recorded to said feedback memory for all the dynamic interaction and feedback system applications respectively.

7. The dynamic interaction and feedback system of claim 1 further comprising:
a mechanism for integrating with caller frameworks—so-called game engines and even itself should a designer of the system design for a recursive spawn—selected from the group comprising
a message-passing channel for communication between a dynamic interaction and feedback system process and other related processes and
an invocation interface so that said dynamic interaction and feedback system may be invoked externally with options, said invocation interface comprising options to schedule automation of certain normally interactive aspects of said dynamic interaction and feedback system and
a completely non-graphical mode of operation whereby a dynamic interaction and feedback system has no user interface or presentation capability and said active agent selection interface is purely a code-level interface to enable active agent selection by the user via some other means;
whereby the system may more seamlessly integrate into and interoperate with said caller frameworks.

8. The dynamic interaction and feedback system of claim 1 further comprising:
representation categories into which all content within said dynamic interaction and feedback system are grouped
representation category specification for all content within the system for specifying the content respectively as belonging to one of said representation categories
an interface to invoke, based on respective representation category specification of said content, external handler applications automatically for handling presentation of the content
whereby controls and feedback and the surrounding environment in which it is presented may use any representative media respectively compatible with said external handler applications.

9. The dynamic interaction and feedback system of claim 8 further comprising:
a configuration interface for associating said external handler applications with said representation categories
a configuration interface for specifying launch settings of said external handler applications
whereby the system may be configured to use optimally the applications available in a particular operating environment.

10. The dynamic interaction and feedback system of claim 8 further comprising:
multiple representation modes
a mode specification interface for specification of the mode of representation the system will use
whereby one set of representative content for the system may replace another based on a setting of said mode specification interface.

11. The dynamic interaction and feedback system of claim 8 further comprising:
metadata describing said dynamic interaction and feedback system content compatibility, selected from the group comprising
detailed descriptions of media types within said representation categories and
recommended embodiments of said external handler applications and
recommended configuration of said external handler applications and
recommended operating environment conditions and
essential requirements for presentation of content contained within the system.

12. The dynamic interaction and feedback system of claim 1 further comprising:
a surrounding environment in which the dynamic interaction and feedback system presents controls and feedback to the participant
automatic updating of said surrounding environment based on the state of the dynamic interaction and feedback system
whereby said surrounding environment provides contextual cues to the participant as to temporal and spatial progress of said participant through the dynamic interaction and feedback system.

13. A method for turning a written story into dynamic interaction and feedback system data comprising:
determining break points in said story
providing blocks of related action, said blocks comprising text of said story between said break points respectively,
organizing said blocks into a loosely-connected network
organizing for each of said blocks all text within the block into logical feedback units
determining for each of said blocks a group of agents appearing in the block whereby said participant may interact by selecting an agent from said group of agents to be a present active agent
associating a control set with each agent of said group of agents respectively whereby said participant may interact via said control set to affect said logical feedback units respectively as feedback
providing rules governing traversal by said participant of said loosely-connected network.

14. A method for turning a written story into dynamic interaction and feedback system data extending the method of claim 13 and further comprising:
editing said story down to only aspects desired to be feedback results of interaction by a participant
said determining break points in said story
said providing blocks of related action, said blocks comprising text of said story between said break points respectively
said organizing said blocks into a loosely-connected network
said organizing for each of said blocks all text within the block into logical feedback units
embellishing said network by writing and adding more blocks
embellishing the blocks of said network by writing and adding more logical feedback units to the blocks
said determining for each of said blocks a group of agents appearing in the block whereby the participant may interact by selecting an agent from said group of agents to be a present active agent
said associating a control set with each agent of said group of agents respectively whereby the participant may interact via said control set to affect said logical feedback units respectively as feedback
embellishing control sets of respective agents by adding more controls respectively therein
embellishing controls in control sets of respective agents and said logical feedback units by creating and linking in alternate forms of representative content
creating and linking in contextual media environments to be the stage for said blocks of related action
said providing rules governing traversal by said participant of said loosely-connected network.

15. A rule-based editing and compiling machine for enabling the method of claim 13 comprising:
human-readable instructions to generate said dynamic interaction and feedback system data
an instructions interface for inputting said human-readable instructions to generate said dynamic interaction and feedback system data
storage means to store said human-readable instructions to generate said dynamic interaction and feedback system data
alert means for signifying that a dynamic interaction and feedback system using data generated from the current human-readable instructions may result in error
converting means of said human-readable instructions into data readable by a dynamic interaction and feedback system application.

16. The rule-based editing and compiling machine of claim 15 further comprising:
a function to combine two sets of said human-readable instructions to generate said dynamic interaction and feedback system data into one set of human-readable instructions to generate said dynamic interaction and feedback system data
whereby two initially separate dynamic interaction and feedback system data sets may be made a single dynamic interaction and feedback system data set.

17. A method for making a control set for a dynamic interaction and feedback system comprising:
providing controls grouped into a loosely-connected controls network
providing for each control in said controls network instructions for presenting the control to a participant
providing conditional availability restrictions on said controls in said controls network
providing a set of logical feedback units which may result from interaction with said controls in said controls network
providing contribution of said controls in said controls network respectively toward a determination of which logical feedback unit may occur as a result of interacting by said participant with said controls of said controls network.

18. The method of claim 17 in which
said controls are selected from the group comprising
selectable regions of text representing thoughts and feelings related to a present active agent controlled that when selected may contribute to motivating feedback and
selectable regions of an image representing thoughts and feelings related to a present active agent that when selected may contribute to motivating feedback and
direct manipulation of a representation of an agent or a vehicle containing an agent through a simulated physical space and
direct manipulation of representations of objects in a simulated physical space and
games representing decisions an agent may have to make and
games representing skills an agent may have to master and
games representing state of mind of an agent and
games representing obstacles and adverse conditions.

19. The method of claim 17 further comprising:
providing for immediate feedback during negotiation of said controls network by said participant indicating the likelihood of the occurrence of said logical feedback units respectively as a result of interaction with said network
whereby said immediate feedback may help guide said participant in deciding which controls to use and how to use them.

20. A method to play a printed dynamic interaction and feedback system of claim 1 comprising
providing printed controls
providing printed control-restrictions for said printed controls
respectively regarding whether each control may be used at a current state of the system
providing printed control-effects of said printed controls respectively
providing blocks of printed feedback
tracking by the participant of said feedback memory and necessary system state
providing playing rules by which the participant negotiates said printed controls, said printed control-restrictions, said printed control-effects, and said blocks of printed feedback, and by which the participant performs said tracking.
